(19) United States
(12) Patent Application Publication
(10) Pub. No.: US 2019/0068044 A1
(43) Pub. Date: Feb. 28, 2019

(54) In Evolution of Gravity Fields

(71) Applicant: Svetozar B. Petrovich, Chicago, IL (US)

(72) Inventor: Svetozar B. Petrovich, Chicago, IL (US)

(21) Appl. No.: 15/932,502

(22) Filed: Mar. 7, 2018

Related U.S. Application Data
(63) Continuation-in-part of application No. 15/731,310, filed on May 22, 2017.
Application No. 15/731,310 is a continuation-in-part of application No. 15/530,056, filed on Nov. 28, 2016, now abandoned.
Application No. 15/530,056 is a continuation-in-part of application No. 14/545,930, filed on Jul. 9, 2015, now abandoned.
Application No. 14/545,930 is a continuation-in-part of application No. 13/999,086, filed on Jan. 10, 2014, now abandoned.
Application No. 13/999,086 is a continuation-in-part of application No. 13/135,617, filed on Jul. 11, 2011, now abandoned.
Application No. 13/135,617 is a continuation-in-part of application No. 15/330,085, filed on Aug. 2, 2016, now abandoned.
Application No. 15/330,085 is a continuation-in-part of application No. 13/999,105, filed on Jan. 13, 2014, now abandoned.

(30) Foreign Application Priority Data
Jan. 25, 2010 (US) PCT/US2010/000188
Jul. 11, 2012 (US) PCT/US2012/000319
Dec. 6, 2012 (US) PCT/US2012/000572

(51) Int. Cl. H02K 53/00; H02K 19/06; H02K 3/47; H02K 1/14; H02K 3/34

(52) U.S. Cl. CPC H02K 53/00; H02K 19/06; H02K 3/34; H02K 1/146; H02K 3/47

(57) ABSTRACT

A forever technologies ultimate energy device affecting energy dynamics planet genesis, gravity fields do: embodies sui generis boundaries perfections in ultimately compact structures, discerns, distinguishes forms of cycling energy genres, effectuates an energy form respective directionality and embraces energy cycling maximum conductance, or maximum ultimate Heat Rate efficiency or maximally, ultimately short paths-of-passage lengths' sums comprising a least sum (PPLSLS).

### BACKGROUND OF THE INVENTION

The 21^{st} century must place emphasis on energy cycles perfect devices, primarily electric motors, generators energy cycling a Heat Rate efficiency, applied by industry and academia technologies, ignored in intellectual property licensing, in general. This application discloses induction motors energy cycles Heat Rate maximum efficiency. It discloses Universe structure, Earth gravity field origin and evolution; it discloses global air warming root causes and the prior science deep flaws, proving beyond a doubt, cycled energy adequately disclosed details, only, can evaluate structure.

Induction devices, the Earth, the Universe effectuate energy analogies, which, by applied science innovation, disclose cosmological gravitational dynamics theoretical sciences real understanding. Turns out with extraordinary regularity, theoretical sciences theoreticians misconstrue cycling of cosmological gravitational dynamics, because fundamental science is in infancy, and because the theoretical science circumvents misconstrues the Laws of Thermodynamics in last eight decades.

Cosmological gravitational dynamics in Universe cycles plasmas; Earth gravitational field cycles light molecular fluids and plasma. The light molecular fluids, the plasmas cycle incompatibly; in time domain, Earth gravitational field climate change, energy dynamics outflow plasma to space, which, in time domain, gravitational dynamics effect from nitrogen, oxygen, hydrogen and water vapors—the light fluids—converted to ions to outflow all of energetic fluids plasma ions to space.

First, foremost, Universe and Earth are precise devices cycling energy quanta. Induction devices precisely cycle atoms bounded electrons lightest fluid electromagnetism energy cycling; the light fluids monocular, plasmas cycle separate incompatible densities in energy boundaries perfections.

Cosmological global gravitational dynamics concomitant electromagnetism energy fields balance atomic plasma, molecular fluid bound energy cycled in boundaries perfections; energy transports environment cycled atomic and ionic mass energy boundaries perfections affect electrons energy eternal cycling, fluxing sustained boundaries respective perfections Heat Rate 100% efficiencies. Plasmas energy boundaries perfections retain eternal cycles; conversely, molecular fluids do not.

“In theory, theory and practice are the same. In practice they are not.”—Einstein. Energy fields, energy longevity boundaries of Fluid Elements, Advanced Fluid Elements, and induction devices show that theories must comply with technologies ‘global warming’ global air warming realities.

Prior science misapplies cosmological global gravitational dynamics. Advanced Fluid Elements, Fluid Elements, induction devices, in environment energy technologies, amend Relativity Theory embedded theories to maximally boost Heat Rate efficiencies and longevities of all such devices.

The application explains the energy source of gravitational energy. The thermodynamics Second Law origin tracing of the gravitational energy in the Universe claims energy technologies science and cosmological gravitational dynamics science technologies, respectively. Proven and verified fundamental science and technologies correct the prior science profound deep flaws promulgated by classic science theories. The prior sciences corrected flaws allows licensing key technologies.

Quantum energy precise energy models of gravity fields and energy structures of the Universe in entirety comprise the Universe energy modes comprising energy structures respective models the application explains. It explains science of global warming, global air warming, quantum precise technologies, generally, and electromagnetic induction devices, particularly, which appose global air warming; technologies revaluated sciences in ubiquitous utilization advances the human race.

To date theoretical sciences promulgated, licensed profound deep flaws, wherein this application exposes, explains, discloses, corrects, at least one century, of patent Laws and Regulations by the prior sciences and art inadequate technologies; the applications claim innovating technologies, in turn, claim to correct and supervene upon pending and abandoned patents, which stand to benefit by the disclosures of the innovating technologies and sciences and may improve the prior patents allowance. Validated nonpublication requests, thus, reinstates prior applications abandonment of continuity, going back for no more than 20 years, for the USPTO and, also, the USPTO Regional Office managed PCT filed applications on behalf of the World International Patent Organization.

In general, the application(s) unshackle inventor inventions and innovations from stranglehold by the prior sciences, especially theoretical sciences profound flaws by global elite and elite at large. Provided incontrovertible, prima facie evidence reveal an elite flocking poses risk to human race; where, applied sciences lead science, and not centuries of deeply and profoundly flawed theories.

### SUMMARY OF THE INVENTION

The present invention a three phase, four pole induction device motor utilizes a hexagonal barely rectangular cross-section of a pre-insulated copper wire in a dual-layer, a maximum copper mass fill in a stator, a plurality of a stator slot, the stator slots, and coils, the coils, a maximum number. A maximum thermal and electrical conductance spawns an ultimate electromagnetic flux density. Forever technologies apply technologies of gravity field genesis energy, wherein electromagnetic poles, mechanical, electrical, thermal energies cycling engenders Heat Rate maximum efficiency.

A structure environment evolves to affect energy dynamics maximum electromagnetic, electrical thermal, including mechanical energy, energies conductance, which in technologies language are evaluated under term—Heat Rate efficiency. A structure given and taken maximum conductance spawns ultimate conservation of energy, and is precisely what energies in the Universe do inside boundaries perfections taken eternal and sui generis boundaries close, but less, perfect structures.

Where, licenses structure appearance, one aspect of the present invention takes structure appearance of the sui generis boundaries of energy, to explain that structure is eternalized energy and by unique appearance of the present invention yields structures shown sui generis boundaries which communicate innovative technologies of energies conductance and Heat Rate efficiencies. Wherein, the structure is static, cycled Heat Rate efficiencies energy dynamics govern structures.

Heat Rate maximum efficiency pertains to the maximum Heat Rate efficiency a structure can do. The copper wire of said cross-section area in a dual-layer of a maximum cross-section area and a maximum surface area of the dual layer and each wire coils affects the slot, steel laminations, the stator respective sui generis boundaries a configuration of boundaries perfections of each and all.

Wherein a maximum conductance yields Heat Rate maximum efficiency. A winding coil, a wire least electrical resistance, a converse of conductance, transfers a cycling electrical energy portion into heat energy, heat byproduct. Cycled mechanical device induced, forced air draft, converting radiation to convection, thermal energy transfers affect trade-offs in Heat Rates high efficiencies. All such associate with an induction device, here excluding enclosures, are taken as known in the art, such as an enclosure heat radiation fins, a rotor shaft mounted cooling fan and various means for cooling of the rotor shaft, especially where necessary to sustain a longevity of a rotor bearing.

Stator steel laminations an aluminum enclosure optimally retains an electromagnetic field flux of electrical energy cycling in concentric coil windings, which optimizes generated thermal energy transfers into epigene surface gravitational sink; unavoidably thermal energy affects concomitant energy radiations, convections transfers in environment forcing successive boundaries fluxing, or boundaries perfections imbalance, reposition and/or disconnect. Aforesaid explains Second Law of Thermodynamics spawned environment energy infinite successions of boundaries perfections.

Boundaries perfections, a boundaries perfection, and boundaries perfection sets forth one and the same general reference pertaining to precise boundaries of forms of energy types cycling, fluxing in environment by either atomic, molecular or plasma fluids, electromagnetic, thermal, electrical, or stress energy, either in environment or in structure, pertain to discussion in these paragraph(s).

Sir Arthur Stanley Eddington famously “The law that entropy always increases holds, I think, the supreme position among the laws of Nature. If someone points out to you that your pet theory of the universe is in disagreement with Maxwell's equations—then so much the worse for Maxwell's equations. If it is found to be contradicted by observation—well, these experimentalists do bungle things sometimes. But if your theory is found to be against the second law of thermodynamics I can give you no hope; there is nothing for it but to collapse in deepest humiliation.” It is forever!

Hexagonal, pre-insulated wire of stacked coils fills the stator slots stator coils volume nigh 100% compared to entirely round wire hand stacked coils which fill armature slot-volume to nigh 75%. Copper fill wires, small gage rolled hexagonal shapes, surface intersections rounded micro-fillets match small electrical energy conducting skin and proximity effects, power loss of entirely round wires to affect six surfaces area, uniform distributive conductance and heat energy flows, thermal energy outflow that avoids electrical energy insulation a flashpoint. The stator slots stacked coils nigh 100% copper fill maximizes the maximum conductance heat energy outflows to stator steel.

A hexagonal cross-sectional area of stacked wire coils in the example, here, 140% larger number of turns (31/22) is important increase, 140% greater copper mass fill compared to 22 coils cross-sectional area the PRIOR art illustration shows. Each of 31 coils has a cross-sectional area about 10% greater than each of 22 coils and the copper mass fill 154% greater than the prior art can do.

The present invention shows 31 coils 154% greater a copper mass fill cross-sectional area greater conductance than in the prior art 22 coils and the stator slots, 31 coils lower resistance by 154%.

The 154% greater conductance over the prior art coil(s) avoids (I²R-energy, power losses) affects much higher efficiency than EPAct Energy-Efficient, NEMA Premium Motors Minimal Nominal Efficiency respective range of 87.5 to 96.2 at 100% load. Wherein, present electric motors round wire coils are stunningly overrated in respect to electric motors slots-volume maximum potential.

It may seem that increasing the copper mass fill, number of coils, adds more electrical resistance, only. However, power input loss (I²R) varies with electrical current squared shows that 11 added coils in the same slot significantly drops needed current, the I² term, to meet a torque load energy demand; and, the power input loss drops, the motor runs cooler rotor bearings last longer. Where a car battery pack supplies power, car required recharging intervals and travelling range increase.

Hexagonal wire coil windings allow slut shape ratios geometric flexibility, copper cross-sections to armature lamination steel cross-sections, the slot, the copper mass fill, a slot gap width and the wire hexagonal cross-section by the coils maximum number minimal skin and proximity effects, grant electrical current the maximum conductance. Drawings illustrate, describe a slot shape; the slot shape geometrics grant induction device and the stator configurations respective flexibilities.

And this we think, we know it is for certain—mass energy cannot be created nor destroyed—then, Universe mass energy flux must cycle eternally to Heat Rate 100% efficiency, with no exception. Wherein mass energy longevity weak, strong boundaries continuously shift, expire and reemerge elsewhere, constituting strong, weaken fluxing boundaries mass energy densities such as Earth's troposphere, tropopause the stratosphere, ionosphere, magnetosphere highly dynamic boundaries, these applications set forth as energy relativity of Earth's atmosphere energy relativity structures.

Hexagonal wire slots hard and flexible insulation coats precise tolerances, maximally conserving electric current cycles to sustain maximal electromagnetic flux, Heat Rate maximum efficiencies. Said hard and flexible insulation coats consist of one, or two shellac coatings of a hard coat and a flexible insulation coat, which insulate electrical energy essentially same potential; slots copper and laminated steel ground potential and slots dual layers, two phase potentials plastic insulation respective wrapping liners insulate. Said insulation, respective compositions is known in the art.

Two, three or more insulation layers insulate electrical energy one, two, and three phases of one, two and three phase motors; one phase of three phase motors has electrical ground zero potential.

Said insulations set forth said layers restricts cycling directionalities of electrical power; wherein industry prefers four pole three phase motors, which as such are illustrated and described, herein.

The coil windings cycling electrical power directionalities force an electromagnetic field cycling, where aluminum casing about and surrounding a motor maximizes its Heat Rate efficiency. The coil windings cycling electrons, by skin and proximity effects, generate a thermal energy cycling, which by conduction must pass thru insulation boundaries and by conduction and convection and radiation must avoid cycling temperatures concentration a windings flashpoint an electrical short.

In environment quantum mass energy paths-of-passage (PP) least lengths, PP length sums a least sum (PPLSLS) in boundaries perfections affect ultimate longevity, upright direction paths innate gravity force multiple and PP least lengths sum, the nullities' sums nullity. Wherein, boundaries perfections include cycling electrons mass comprising atomic boundaries and gravitational sinks. Said coils, insulation retains electrons mass, unless a ground-phase zero-potential leaks electrons.

Electromagnetism energy cycling according to Thermodynamics Second Law yield radiation and convection energy emissions into global environment. Thermal radiation, convection boundaries energy flow paths PP, the PP entirely unaccounted, missing or undefined in the prior sciences art as an order trifling effects, yet cosmological global gravitational dynamics comprise such effects.

Contradictions arise from curved space-time science “pet” gravitational theory violated mass and energy conservation laws, which assumes mathematical theorizing governs Nature. As language, mathematics communicates known facts and unless by now Nature proven for certain are flawed.

Maxwell's four famous equations communicates parameters of energy relationships, all of which omits thermal radiation, convection omnipresent energy “space-time” parameters of gravitational dynamics; since Maxwell sciences add no missing gravitational parameters to the four equations.

First, prior sciences do not embody Fluid Elements existence. Prior applications shows that even most basic fundamental Fluid Elements affect complexities beyond present mathematics; second, theorizing cosmological gravitational dynamics require entirely recognized existence of all Fluid Elements omnipresence wherein all mathematics are but useless; third, atomic boundaries energy exemplifies boundaries perfection of the Fluid Elements, which are the Universe building blocks.

Missing among four Maxwell equations are quantum mass paths-of-passage energy work done in atomic or gravitational sink, Fluid Elements boundaries perfection which conserves mass energy, mass energy densities which, in turn, retain or dissipate boundaries perfection. Atomic boundary exemplifies perfections subatomic particles conserved energy, including electron masses cycling.

In infinitesimal time at any location of each quantum mass energy, a first-hand observer observes quantum mass PP lengths inside boundaries perfection bound PP lengths nullity sums bound sum spawning the nullities' sums nullity. The Relativity Theories, stout proponents professing admits that a first-hand observer at a location observes nigh infinitesimal time spans, Newtonian physics governed motion—commonly taken as conforming to Theory of Relativity. However, such show curved space-time, if it exists, is accounted inside each boundaries perfection atoms, ions cycling electrons mass and energy densities effects eternal cycling energy by each boundaries perfection.

A first-hand observer need not address curved space-time relativity theory, most stout professing proponents admit, also. However, if said rational for tropopause, troposphere and ionosphere are inclusive of each quantum of mass energy PP lengths work done in the Milky Way Galaxy, Solar System curved space-time must, likewise, effect the nullities' sums nullity, boundaries perfection longevity. All of which point to the Universe shown mass energy genres curved space-time that, in fact, does not exist inside gravitational fields mass and energy spawned boundaries perfection.

A first-hand observer at each mass energy quantum comprises mass energy in the entire Universe at a same instant in time experiencing, quantum respective disposition, a locality momentum, and a PP. An Advanced Processor gravitational field, an Advanced Fluid Element, PP quantum sums of PP lengths mass energy yielding a nullities sums' sum nullity boundaries perfection longevity; wherein the Universe mass energy, as mother of all gravitational fields, effects identical sciences.

Prior application discloses the Advanced Processor Earth's gravitational mass energy boundaries perfection as one among infinite number of Advanced Processors, and applied sciences perpetual motion God particles cycling fluids potential energy in the Earth's gravitational field; the Earth's energy budget, documented scientific consensus and the prior entirely discard light fluids energy.

Photographic film or weakest magnetic field records presence of light energy. Most energy mass blocks, diffuses, deflects or reflects light. In space, gravitational fields readily curve light beams.

Newtonian physics confutes theorized curved space-time, when first-hand observer observes it as supra states. In vacuum, light speed—c, extending in Cartesian coordinates—x, y, z axis, and time—t, as velocity divided by time a distance in x-direction, moves enormously faster than all else is in reference to a first-hand observer. Whereas, light propagating linearly, curves in response to a gravitational field presence. Mathematical equations yield light travelled distance inequalities as seen by first-hand and second-hand observer disposed moving through different localities. Thus, infinite number of observers moving at different localities, at different speeds must note different light speeds travelled path and distance; thus, raising curved space-time precise properties issues, rules out all but Newtonian physics, said first-hand observer path speeds and pathways distances.

Light speed more than one magnitude exists, also; simply because infinite number of light speed magnitudes embody only rational conclusion. Since relative time light speed escapes Newtonian physics first-observer science, Newtonian physics dominate all and any human survival measure.

In vacuum, no energy field presence is physical impossibility wherein gravitational and magnetic fields respective energy inversely varies with squared, cubed distance seldom attain energy fields magnitudes the nullities sums' sum nullity. Quantifying speed of light absolute value(s) in space is physical impossibility, likewise. Magnitude of that absolute value is dependent on proximities of energy fields, especially by time infinity impact on energy fields' magnitudes and proximities.

Consumed by curved space-time theorizing unbounded exuberances, global science communities entirely overlook cosmological global gravitational dynamics energy which perilously endangers human existence. Relativity Theories infer potential curved space-time existence in the Universe based on static mechanics in coordinate system statics computed relative location, space and time observed as supra briefly detail. However, only energy in the light beam passing thru space-time dynamics can differentiate between real curved space-time and an illusion; only energy dynamics balance or imbalance in space-time conclusively prove or disprove curved space-time theorizing.

And, that is humanly impossible to do, because computing complexity in mathematical functions of energy dynamics, especially fluid dynamics are at infancy. The prior applications and applied sciences in general avoid mathematical functions complexity in gravitational sinks, especially the Advanced Processors cycling fluids energy fields, resorting instead to finite elements computing, since no mathematical function exist for surfaces the fundamental Fluid Elements innately affect.

At best curved space-time is hypothetical theorizing that substantiate Theory of Relativity, which fails to predict global air warming phenomena and, thereby, in turn, is taken as embodying flaws. Tesla, “ . . . Supposing that the bodies act upon the surrounding space causing curving of the same, it appears to my simple mind that the curved spaces must react on the bodies, and producing the opposite effects, straightening out the curves. Since action and reaction are coexistent, it follows that the supposed curvature of space is entirely impossible—But if it existed it would not explain the motions of the bodies as observed. Only the existence of a field of force can account for the motions of the bodies as observed, and its assumption dispenses with space-time curvature.”—All that shows: Tesla sees energy dynamics in environment; Einstein sees space-time relative statics.

Also Tesla, “Throughout space there is energy. Is this energy static or kinetic! If static our hopes are in vein; if kinetic—and this we know it is, for certain—then it is a mere question of time when men will succeed in attaching their machinery to the very wheelwork of nature.” Also, our hopes are in vein, if referring to curved space-time theory does not preclude potential human extinction.

Prior applications support Tesla claims. Cosmological global gravitational dynamics comprising cycling energy in the atmosphere is revealing the fundamental Fluid Elements and the Advanced Processors and applied sciences God Particles potential perpetual motions respective efficiencies Heat Rates. Tesla discloses energy fields' dynamics nearly hundred years ago, and he is ignored. The fact that hydrogen ions escape attraction force(s) of Earth's gravitational field strongly point to flaws in the key scientific theories, since hydrogen ions such practice of escaping is consistent.

Falsely, scientific community assumes that deep core borings sampled deposits self-deposited by self-energy means, ignoring cycling fluxing cosmological global gravitational dynamics presence effecting glacial-interglacial periods thru billions of years, which, in turn, yield epigene deposits. The scientific community ignores atmosphere Air Cells and Jet Streams kinetic energy dynamics or blames power plant stacks forced and induction draft fans for global cycling of CO₂ emissions.

Prior applications cosmological global gravitational dynamics sciences community et al. discards and mass media outlets, publications and documentaries, governments, institutions, even political leaderships nationally, as global elites in unison, showers unprecedented praises with exuberance on curved space-time theorizing. However, curved space-time validating by mathematical proof compounds most basic sciences fundamental blunders caused mass and energy illusions in space.

Theoretical sciences inappropriate graphical designation misuses mass with energy cosmological gravitational dynamics x, y, z axis inappropriate axis resolution that overlooks gravitational sinks Advanced Processors, the Advanced Fluid Elements, quantum energy PP lengths, nullities' sums nullity boundaries perfection. Curved space-time, in fact, substitutes for cosmological dynamics; wherein, all of prior sciences substitute optical illusions for cosmological gravitational dynamics, mass and energy cycling inside successive boundaries perfections comprising gravitational sinks.

A coordinate system time domain showing the speed of light resolution would show Earth's time zones by a dot, since photon has passed the Earth in instant time. On the other hand, an observer on Earth attempting to graph a time-traveling path cannot even initiate his observing, because the photon passed not only the coordinate system—it has passed domain of Earth's gravitational sink.

First-hand observer seen mass and energy genres separately considered in appropriate resolutions show curved space-time not to exist by Newtonian physics. Photon infinitesimal mass or energy, taken one and/or the other, curves its path under gravitation force effects set forth in gravitational lensing and other observed illusions. And, no curved space-time mechanics is shown to occur by mathematical example that claims it, first-hand observations ordinary physics which disproves it.

Fundamentally summarized—speed of photon is vastly greater than velocity of almost everything else and optical illusions occur—furthermore, photon particle embodies mass or energy genre and responds as one or the other, depending on energy in environment inside a boundaries perfection, deflecting its path deflected by passing thru or passing in gravitational sinks and/or energy fields. Enormously fast and manipulated, influenced by energy fields energy, only a first-hand observer, photon itself, sees a true photon path. Mathematical curved space-time proof is an illusion itself.

When mass and its energy is in ionosphere, that mass energy belongs concomitantly to the Milky Way Galaxy, the Solar System and the Earth, three gravity fields, concomitantly, shared amongst atmosphere spawning three boundaries perfections, there included the energy relativity structures boundaries perfection. Prior applications reveal such boundaries, the energy relativity structures.

Thus, first-hand observers at each mass and energy quantum observing ordinary physics observe the Universe cosmological global gravitational dynamics—mass energy disclosed gravity causes. The Advanced Processors and the fundamental Fluid Elements mass energy and mass and energy in general are not one and the same. Mass and energy of mass embodies a boundaries perfection, prior sciences not properly distinguished, generally; energy may embody a boundaries perfection as do electrons, such as photons, or may or may not or do not, such as thermal radiations or strain stresses penetrated environment, which sustain, distend, or break a boundaries perfection present. The actions, reactions conserves mass and energy eternal cycling at 100% Heat Rate efficiencies.

In all of instances, energy actions flowing directionalities toward Black Holes of Galaxies energy reactions opposes till capitulations occur. Actions, reactions may continually switch dispositions depending on energy reaction prevailing over energy power, thus constituting energy action, with opposing responding energy force, power of energy reaction. Energy action, reaction continually switched roles eternally perpetually balances the Universe. Stars and cores of most planets, after Big Bang masses centrifugal energy actions, force nuclear energy chain reactions energy actions.

Mass and energy conservation engender mass energy dynamics maximum interaction synergy as energy dynamics relativity energy that acts to merge into one boundaries perfection and exists as a relativity energy and eternal energy action originating in mass energy of the past, which at such a time cycles one and the same body. The relativity energy embodies one body's a mass remnant residual stresses energy reactions resisting a split existing in past and at a time prior to Big Bang.

Consequently, celestial bodies balancing energy actions and energy reactions interact universally comprising the relativity energy interacting forces balance. Energy actions and energy reactions Heat Rate 100% efficiencies must embody such Heat Rate inside a boundaries perfection or such boundaries perfection fails releasing energy; past sciences refer to such as forbidden mechanism.

The Second Law tracing the Universe entire mass energy to one body existing before Bing Big is possible by tracing the relativity energy of celestial bodies. However, all such tracing or its parts is way beyond vision of sciences and technologies, which praise curved space-time or still ignore the Second Law. From photons, electrons to galaxies boundaries perfection internal mass energy actions, reactions sustains all of boundaries perfections. Amazingly, astoundingly, exemplifying the Universe boundaries perfections, from photons to fundamental and Advanced Fluid Elements to mass and energy Galaxies perfections, balancing effect, as is observed in enormously stunning deformations of the magnetosphere boundaries, dispenses with any curved time-space theorizing.

Cosmological gravitational dynamics effectuates gravitational mass and energy actions, reactions effecting a gravitational sinks presence, the Advanced Processors, the Advanced Fluid Elements, therein mass and energy sinks interaction switching actions, reactions. And, gravitational effects Earth's gravitational sink cosmological global gravitational dynamics actions and reactions in the atmosphere embody the energy relativity structures prior application details. When cosmological global gravitational dynamics energy actions overpowers Earth's gravitational sink conserving of mass and energy reaction, plasmas outflowing to space temporarily balance mass and energy into glaciation period gravitational sink lengthy period energy actions spawned an interglacial period.

Gravitational energy sink yields its boundaries perfection maximally conserved mass and energy, by cosmological gravitational dynamics effects switched actions and reactions spawned in, about gravitational sink environment energy quanta cycling quantum kinematics of the PP lengths sum, the nullities' sums nullity. All vectors environment or wherein curved space-time does not exist.

The prior application points out clearly, the scientific community bungled interpretations of deep soil borings on top of bungling global air warming total disregards for the Thermodynamics First and Second Law and the Advanced Fluid Elements, the Advanced Processors, and gravity causes and cosmological global gravitational dynamics origins, thereby to bungle induction devices. All that is prima facie credibility indisputable evidence that applied science leads theoretical science; wherein, theoretical incomplete speculative sciences build barriers to inventions and innovations.

To understand global air warming all fundamental roots, one must understand most cosmological global gravitational dynamics affected quanta quantum energy cycling energy kinematics PP and the nullities sums' sum nullity embodying boundaries perfections. And, one must understand the energy relativity structures. Most importantly, gravity roots and causes require clear understand. Except for Tesla's work and visionary comments, scientific community at al. ignores, overlooks, or is uninterested in all of it. Wherein, in adequate detail, all of it, these applications accomplish.

Identified gravitational force origins and causes and spawned ramifications grants cycling energy environment analogies between electrical induction devices and Earth's Advanced Processor, the Advanced Fluid Element, which, in turn, permits cycling fluxing energy in environment common understanding. What is known—for certain is ample—solves technologies, sciences, basic issues.

Cosmological gravitational dynamics fragments, dust and plasma, spinning disk mass and energy proportions bind solar nebula atomic elements mainly of hydrogen, helium ions, extending about a nullity energy plane in cosmological gravitational dynamics depression; the solar nebula timely yields a boundaries perfection, a Sun and maximum conserved angular momentum of the nebula.

Energy depression nigh nullity potential energy levels diffuse and trap interstellar dust and gas in oblong surfaces yielding cosmological gravitation dynamics energy progressively lower potential energy levels concentric oblong surfaces of an oblong nebula. Said progressively lower potential energy levels sloping gradients effects nigh nullity oblong perimeter least potential energy plane.

Evolving celestial body boundaries perfection coincidental with the invariant plane perpendicular to the angular momentum vector of the nebula, energy and mass energy centers of balance reside in the least potential energy plane, also. A spiraling energy vortex proper, symmetrical about the least potential energy plane, saps energy from adjacent nebular proper and segregates itself into a body of evolving a solar system and a planet. Cosmological gravitational dynamics mass energy imbalances separating in cosmological gravitational dynamics energy depression caused planet's genesis are entirely free of a gravitational mass attraction force which the prior sciences theorize.

Geneses of a nebula evolving a solar system and its orbiting planets shown boundaries perfection comprise prima facie credibility evidence that the prior sciences gravitational mass attractions do not exist. As energy imbalance of vortex proper frees itself from a significantly larger portion of said nebula oblate proper, energy imbalances of both must balance. Imbalances bound mass and energy balances also validates completely beyond any doubt the prima facie credibility evidence.

Symmetrical about the invariable plane, the nebula mass and energy change precession, spin, and orbit dynamics of its oblate toward a spherical body and pressure gradients equipotential surfaces toward spherical surfaces. Released mass and energy imbalances by the vortex proper separating unbalanced mass energy, centrifugal forces pass from the nebula into the vortex proper; spawned energy compresses both masses and keeps both mass and energy centers in the pressure gradients a nigh nullity plane. Pulled toward center, mass boosts the spin and centripetal forces sum which reside in, balance about the nigh nullity plane. Such energy dynamics in the oblates and surfaces compress each of the two bodies from oblong into eternal globose spherical surfaces, constituting cosmological gravitational dynamics energy and the nigh nullity plane split in two; each plane, in turn, shrinks to a mass and energy core, each core affecting a spinning, an orbiting celestial body.

That said explains quantum resolution jaw dropping realities which surpass all imagination; only, indisputable reality can do that. Wherein cosmological gravitational dynamics energy depression spawns potential energy globose spherical equipotential concentric surfaces of pressure gradients which converge into an energy depression eye. Such depression energy comprises a gravity field depression and not mass attraction genre which the prior sciences wrongly stipulate for centuries.

All begins with cosmological gravitational dynamics depression trapping interstellar gas and dust particles into a nebula diffuse energy mass cycling in space and time. Such diffused energy mass accrues in cosmological gravitational dynamics energy depression, similarly outflowed in nebula releasing energy as the nebula accrued energy exceeds gravitational dynamics energy depression.

As mass and energy significant portion breaks away from the nebula, thus, to create two celestial bodies, evolution in mass and energy become apparent, especially in the smaller of the two. The smaller of the two dramatically segregates energy dynamics by directionality and form of energy and in geological time mass of each body and density, weight, buoyancy an overburden pressure.

A centrifuge device celestial body delineated energy dynamics, therein, unified centrifugal forces engender orbits of smaller about the larger mass and spinning of each mass about its axis; in turn, delineated centripetal forces profoundly changes an oblate nebula proper and a three-dimensional diffused, loose confinement into a hydrostatic compression, a globose spherical confinement, and two bodies diffused energy. The least potential energy plane with equipotential lines shrinks into the globose spherical depressions diffused energy in the two bodies which compress and densify.

Centripetal forces densifying energy boosts centripetal, centrifugal forces and engender a nuclear reaction in core of each mass. Respective centripetal, centrifugal and overburden pressure forces boost each body balance by further densifying, which increases its spin and nuclear reaction with the smaller body spinning into an orbit further away from the larger mass. Such nebula evolving boundaries perfection evolves a solar system comprising system components maximized entropy consistent with entire Universe maximized entropy. Each quantum distinguishable by its energy form, type, magnitude and dynamics engendering its boundaries perfection and disposition and a successive boundaries perfection respective forms of energy type, density, magnitude, dynamics, and respective body disposition a celestial entity quantum a molecule, atom, electron disposition.

Concomitant mass energy maximum conservation, cycling energy Heat Rates 100% efficiencies, and mass and energy maximum entropy create, evolve the Universe, system of globose spherical centrifuge devices, which balance imbalance of concomitant centripetal, centrifugal and torsional forces by centrifugal, torsional, centripetal forces spawning respective spin, orbit and precession.

Absolute maximum energy with energy maximum entropy constitutes the prima facie credibility evidence that the Universe is unique and that no other system may replace it or take its space and time. Specifically, any model of the Universe must comprise verified quantum energy accuracy. Note that curved space-times combined space and time domain cuts entropy by 50%; and, stated “curved” drastically lowers entropy to an undefined percentage as the whole system is undefined.

Boundaries perfection integrity comprises binding energy that resists its breaching due to energy imbalances that occur comprising energy imbalance in a geological time cycle. The troposphere, tropopause and magnetosphere boundaries perfection show such energy cycles, the Milankovich cycles; buoyancy, energy segregated boundaries perfection of said three, especially the first two, are only such boundaries in the Universe, based on all of astronomical observation made to date.

Cosmological gravitational dynamics accrue diffused gases and particles in an energy depression engendered boundaries perfection of an oblate. Cosmological gravitational dynamics spin, orbit, and precession of the oblate eternalize globose spherical depression engendered gravitational and magnetic fields evolved boundaries perfection. An evolving globose spherical body, a centrifuge modifies itself by density, overburden pressures weight and buoyancy, spin, orbit, precession and concomitant cosmological gravitational dynamics, needing no gravitational mass attraction force.

Evolving the nebula transition into spin and orbit of a centrifuge device unrestricted by space and time in space are restricted by energy dynamics, only—energy spawned energy cycles boundaries perfection eternalized mass and its energy in a gravitational field complies with Heat Rates 100% efficiencies, only. A space-time must conform in every respect; only, cosmological gravitational dynamics energy cycles eternal dynamics and boundaries perfection are sole governing principle.

Profoundly flawed theory may theorize space and time scalars somehow possess energy of action to overcome energy of cosmological gravitational dynamics and make it reactions energy. Intent of such validates a flowed theory and discredits the reality, thus, to claim and set forth undefined curved space-time in unknown fashion, to rule over cosmological gravitational energy dynamics.

This application tries to correct these 20^{th} century profoundly, deeply flawed theoretical sciences. The technologies today know—for certain—that for such to occur, the curved space time presence should account for Solar System energy precise dynamics. The observed Solar System dynamics comprises prima facie credibility evidence—mass gravitational attractions, in reality, do not exist; Moon, Earth in increasing separation creep is yet another prima facie evidence that cosmological gravitational energy dynamics govern over space time and said bodies' genesis explain the creep.

Cosmological gravitational dynamics spawned a potential energy nigh nullity depression spawns such energy eternalized mass density, overburden pressures and buoyancy of accrued eternalized energy in space bound in boundaries perfection energy bounded in the Advanced Fluid Elements.

Respective spinning, orbiting forces reshape, compress said depression spawned by cosmological gravitational dynamics depression boundaries perfection into respective mass energy depressions occupied by two separate bodies confined by biaxial compression regions of the invariable plane, evolving an oblong into boundaries perfection potential globose spherical two centrifuge devices. The nebula mass energy evolving globose spherical bodies reconfigures said oblate and stays the angular momentum plane orthogonal to the angular momentum vector and splits said nigh nullity plane potential energy of cosmological gravitational dynamics energy two boundaries perfection, two gravitational field sinks, gravity centers, eternal energy eternal spins, precessions, and orbits.

Quantum energy sensitivity of a gravitational field, an Advanced Fluid Element, a planet granted eternal space and time segregate energy centripetal forces which embody globose spherical body, energy centrifugal forces which spawn the body orbit characteristics, with centrifugal, centripetal combined energy in-common energy mass torsional forces which effect precessions of that body.

The Advanced Fluid Elements, as celestial bodies, for that matter postulating the entire Universe, embodies a respective common nebula or the Universe in-common energy portions which evolve portions of cosmological gravitational dynamics, energy that embodies the relativity energy. The Second Law tracing the relativity energy reveals history and energy evolution of celestial bodies, the Advanced Fluid Elements. The prior sciences curved space-time theorizing disregard for the Second Law misconstrues all of it. The prior sciences continuing nonexistent gravitational mass attraction profoundly flawed, inaccurate sciences, in turn, miss on the relativity energy, entirely.

Mass weight perfectly balanced engendering mass density and composition overburden pressures is energy eternalized mass; wherein buoyancy forcing presence is, in common, energy with mass.

Aforesaid energy present is energy of boundaries perfection comprising the Solar System. All of the Solar System mass and energy comprise the invariable plane inclined at an angle of about 64° in respect to the Milky Way Galaxy disk plane and Black Hole engendered centripetal force spin.

Mass and energy are not manifestations of one and the same. Eternal energy boundaries embody mass epitomized by atoms and molecules. In Universe, all forms of energy must yield Heat Rate 100% efficiencies or mass—eternalized energy—shifts must occur. Energy boundaries perfection either eternalized or cycling energy, Heat Rate 100% efficiency, components of the Second Law, is Nature. Scientific, governing entities slight both—imperil Earth's life. The following explain.

Conserving the nebula's angular momentum, maximally conserving vortexes' energy draw mass of the nebula towards each respective vortex which, in turn, evolves the nebula into components' evolving balls of hot rock. Drawing the nebula mass toward axes of the vortexes, evolves higher spins of the evolving balls, wherein radioactive decay, heat of planetary formations, space rocks, fragments and collisions cause planetary creation science theorized accretions and compressions.

The Earth's magnetosphere and magneto tail and solar radiations absolute mass energy, spin, and drag and Solar and Earth radiations and wind pressures embody the energy evolution remnants in nebula of the past. All of which comprise evolving energy of cosmological, Solar System, global gravitational dynamics evolutions energy eternally cycling 100% efficiency Heat Rates, eternally perfecting omnipresent mass energy boundaries perfections, exemplified by the atomic elements.

The relativity energy, the force between two celestial bodies, embodies an all-inclusive mass and energy in-common, with both of the two, a mass energy in time domain instance originated from postulated Big Bang Universe genesis, since then evolution energy of energy and mass. Analysis of root cause origins finds that cosmological gravitational dynamics affects the evolution energy.

Thus, the Earth gravitational components of cosmological, Solar System, and global gravitational dynamics, the Universal imposed gravitational force is gravitation potential energy disposition of mass energy engendered linear and/or angular velocity, acceleration, jerk, force—in time domain, instances comprising vectors. All which embody Universe time domain mass and energy eternal maximum conservation, Heat Rate 100% efficiencies, exemplified by magnetosphere boundaries perfection flux enormous energy cycling that does exactly that. Curving space-time mass energy vectors—we know for certain—do not, cannot coexist in space-time. Curved space-time does not exist, since it cannot support eternal mass energy conservation evolutions the following describes and—for certain—violates mass energy fundamentals, the First, Second Law of Thermodynamics.

If it were to exist, the Universe mass energy, the magnetosphere boundaries perfection enormous fluxes would not occur, but distribute to energy free curved space-time cycling flux. Distributing of energy is known to occur at a structure yield point, but only if structure stress exceeds strength of that structure and assumes that energy-free curved space time occurs throughout the Universe, yet dissipates at every mass energy quantum the first-hand observer takes to measure or define it.

Curved space-time disassociates such specified vector from other mass energy vectors except for curved space-time in-common relationships and in curved space-time association, only; which, is not an energy vector property, as such possessing no energy defining directionality. Conversely, cosmological gravitational dynamics comprise energy vectors. Especially in space evolution, the actions, the reactions of the Advanced Fluid Elements, the celestial bodies' boundaries perfection embody the nullities' sums nullity, PP lengths sum, quantum vectors, with no curved space-time.

Curved space-time uncontrolled exuberance, in fact, disguises astronomical observations proof a gravitational lensing phenomena that yields prima facie credibility evidence of gravitational sink, a celestial body bound quantum mass dynamics, mass energy conserved in boundaries perfection cycling Heat Rate 100% efficiency into eternity. Observations which invalidate curve space time are especially those of photons observed passages through cycling mass and energy gravity field.

Enormously disingenuous Relativity Theories curved space-time derails advancement in sciences in general, especially in applied science and in fundamentals of life as we know them as not true. Wherein, at least, we know—for certain—that life exists in a tiny part of the Universe, and our life billions of years old is highly different from the rest of the Universe, if not all of it. Furthermore, that living organisms cycle life fluids' energy inside relative boundaries perfections, significantly below Heat Rate 100% efficiencies. Yet, they survive, live, because they do it inside a protective shell of the Ionosphere, as long as that shell lasts, fluxes, spinning about itself at Heat Rate 100% efficiency. All of it is the light fluids cycled matter, the Advanced Fluid Elements evolution luck and not much else, as the Universe spins balancing boundaries perfections of the Advanced Fluid Elements, the Advanced Processors, to Heat Rates 100% efficiency dynamics of celestial bodies.

The energy relativity structures the previous application explains; Herewith, set forth boundaries perfection cosmological global gravitational dynamics, as defined by Newtonian physics, explain applied sciences a first-hand observer oversees mass and/or energy quantum's presence. Known, for certain—the Advanced Processors, the Advanced Fluid Elements Newtonian physics—applied sciences overrides all prior Theories, which, likewise, the first-hand observer observes, confirms.

Thus, Tesla sets forth valid rational that questions the Theories of Relativity even when few parts of it may hold true. Prior theories on energy in environment miss boundaries perfections binding the fundamental, the Advanced Fluid Elements of primary structures. Universe constructions by: electrons, atoms, ions, isotopes and molecules spawn boundaries perfections extension into those of celestial bodies including said Advanced Processors, Advanced Fluid Elements and the energy relativity structures, the Galaxies, with the fundamental Fluid Elements spawning key inventions.

Scientific community partiality toward own preferences is beyond stunning. For nearly a century the scientific community pursues Relativity Theories as well as subatomic physics, in spite of the fact, the all-time greatest inventor denouncing all such. The scientific community breakthroughs in these fields shows not much, yet consuming enormous global resources, brain power and time.

Trying to beat the Universe at its evolution—cycling energy eternity—is pushing human luck. On the other hand, Universe evolutions assisting effectuates inventions and innovations for centuries to come. The prior application exemplifies the energy relativity structures, boundaries perfection of the atmosphere, while nuclear super plant sustains energy cycling, within cosmological global gravitational dynamics cycling energy in environment, at Heat Rates efficiency exceeding 100%.

Effecting a boundaries perfection evolution is different from outdoing cosmological gravitational dynamics evolution, since said effecting tweaks innermost boundaries perfection primary cycling and fluxing energy directionalities, only. All other cosmological global gravitational parameters, boundaries perfections stay unchanged. Outdoing evolving cosmological gravitational dynamics can only happen by lowering energy of atoms, the Universe building blocks, which, in turn, must irreversibly impact the Advanced Processors, celestial bodies, and overall boundaries perfections infinite cycling energy boundaries interacting evolution. Any such endeavor bears no credibility.

Evolution or extinction matters risk life existence. Scientific community is buying into evolution of intelligence, by subatomic particles composition taken unknown risk, by not accounting for all cycling energy dynamics boundaries perfection energy relativity structures flux taken evolutions.

Evolution is primarily a matter of evolving energy dynamics by specific cycling fluxes, evolving mass energy dynamics effecting boundaries perfection spawned longevities. Thus, cosmological gravitational dynamics caused evolution dynamics of energy relativity structures effects, wherein atomic elements eternal boundaries embodies energy dynamics mass; thus, atomic elements chart atomic boundaries contained boundaries perfection dynamics eternal diversity and mass weights.

Except for the energy relativity structures, boundaries perfection of the Advanced Processors and the sui-genres boundaries of the fundamental Fluid Elements, which the prior applications claim, including clustering of the fundamental Fluid Elements, remain unknown in the theoretical, prior applied sciences. Heat Rate nigh 100% efficiencies, boundaries perfection millennia longevities, with a potential to exceed Heat Rate 100% efficiencies distinguishes such energy born structures.

Existence of the energy relativity structures—Einstein avoids, by quoted “theory and practice are not the same. By prior quoted, “environment is energy matter”—Tesla insists. Revisiting curved space-time conundrum, it becomes apparent that, passing energy fields, in time domain, photon's paths change, deflect. Wherein, measured time fraction cannot distinguish among all of observer locations on Earth whose environment energy and velocity remain relatively constant. Wherein, photon paths, in time domain very short intervals, deflect in passing highly diverse energy fields.

Photon paths curve in space-time domain, not space-time, which, to an extent, explain the energy relativity structures obscurity till disclosed by these applications. Applied sciences cited in these applications claim applied science perpetual motion electron God-particles, which, in turn, reveal theoretical sciences huge flows. Wherein, these applications disclose inventions and innovations of the energy relativity structures and energy fundamental Fluid Elements sui generis boundaries perfections clustering in boundaries perfection analogies to atomic elements mass energy cycling eternal perfection, comprising cycling energy mass clustering into millennia longevity structures.

Fluids energy cycling environment Tesla invents with alternating current, electromagnetic fields' electric motors and generators; in Nature, the actions, reactions conserve mass energy boundaries perfections whose cycling at less than 100% Heat Rate must have caused the theorized Big Bang.

Actions, reactions evolution eternally cycles mass energy conserved 100% Heat Rate efficiencies to boundaries perfection ultimate longevity as long as 100% Heat Rate efficiency is concomitant.

The Uniformitarianism Theory and Evolution concomitant coexistence is due to the First and the Second Law cycling and fluxing all mass energy into evolving boundaries perfection boundaries, wherein, likewise, the actions, reactions cycles spawn mass contained in boundaries perfection as exemplified by atomic elements embodying mass and contained energy in boundaries perfection.

We know—for certain—energy by itself, such as no mass photon paths, energy only cannot curve, curved space-time vector cannot exist, likewise—for certain—mass gravitational dynamics energy curves orbiting matter cycling paths effecting mass portion relative boundaries perfection energy. In weak energy field photon acts as energy, while in strong energy field it shows mass properties.

That in itself is fundamental sciences Thermodynamics First and Second Laws, which forbids the Universe total mass energy cycles above Heat Rate 100% efficiency. Prior application Heat Rate above 100% efficiency in the energy relativity structures and fundamental Fluid Elements cluster recoups a cycling energy portion that sustains crucial boundaries perfection maximum longevity.

The crucial boundaries perfection maximum longevity emits thermal radiation portions back into the Solar System, to sustain the Earth's gravitational sink, the mantle and said crucial boundaries perfection maximum longevity. All of that justifies said efficiencies, as it counters energy cycles in the Solar System and the Galaxy, which, in fact, is threatening life existence on Earth, because cosmological gravitational dynamics cycle molecular and plasmas energy in separate boundaries.

Earth's gravitational sink dominates the atmosphere molecular fluids cycling while Solar System gravitational sinks levitate Ionosphere's mass energy, which confines the troposphere tropopause cycling energy. Magnetosphere boundaries perfection violet fluxing betrays the energy relativity self-genesis structures generic metastable balances, also seen in Earth's surficial geology; energy cycling in environment by the Fluid Elements yields human race survival technology sole means.

In cosmological global gravitational dynamics environment, Fluids Elements clustering uniquely cycling energy to cumulative Heat Rates overall 100% efficiency uniquely cycling energy effects means for human survival; prior applications detail it, including perpetual motion electrons God-particles applied science technologies; therein, presents technologies and sciences energy cycling in environment binding in boundaries perfection energy boundaries spawning all Fluid Elements.

Unless eternal energy cycling binds Atoms, Ions and Isotopes respective masses into boundaries perfections, energy cycles boundaries perfections into potential energy of the relativity structures metastable states prior to a collapse. Gravitational dynamics gravitational sinks, celestial bodies, energy masses bind or amalgamate eternal and metastable boundaries into metastable boundaries perfection, evolving into eternal boundaries perfection, which embodies various longevity stages.

Prior applications exemplify energy cycling respective Heat Rates unique boundaries perfection, as well as yields the Fluids Elements clustering concomitant energy cycling; the energy relativity structures atmosphere's energy cycling binds into time domain metastable boundaries perfection.

Perplexed sciences key question—where is everybody? Best response—everybody else is extinct. Deep core borings soil samples very thorough analyses, in respect to glacial, interglacial periods, indisputably reveal that the Earth as an induction energy device continually overheats throughout the Pleistocene, Holocene Epochs. All that points to cosmological global gravitational dynamics wherein cycling plasmas are incompatible with cycling tropopause, troposphere molecular fluids.

Earth environment cycling molecular fluids overheat repeatedly with systematic regularity, in the Pleistocene Epoch, on 41 ka interval cycles. The deep core borings soil samples show it, for over two million years, the prior application details. Cycling systematic regularities, likewise show in deep soil boring samples impurities concentrations, small percentages of CO₂, methane and other gases, including organic matter small amounts, cycling to repetitive patterns striking regularities.

Each of the 41 ka interval cycles comprises a glacial, an interglacial period that completes “global warming”, the global air warming, one cycle which ends with ceasing of plasma outflow to space thru a magnetic field cusp. Fluxing air temperature continual rising in each 41 ka interval cycle is prima facie credibility physical evidence of global air environment energy, temperatures rise to a respective peak, only to drop precipitously to prior default levels, subsequent the plasma outflow.

The energy, temperatures rise—energy buildup in air environment—taken as energy action spawn equal energy reaction by plasma outflowing to space. All which continues actions and reactions, cycling energy balancing everything in space by energy chain invents in time domain originating from each nebula genesis, including the Solar System nebula, the Solar System creation. Energy magnitude action, reaction can vary, but each is energy vector, which—for certain—cannot curve.

Uneven energy buildup, energy imbalance in the Earth's gravitational field cycling said nullities' sums nullity. Earth's spinning centrifuge segregates mass by specific-gravity, density, buoyancy and energy spawned orthogonal directionalities. Mass and energy components orthogonal to the troposphere, tropopause cycling the nullities' sums nullity, while exceeding Earth's gravitational sink centripetal forcing, spawns Earth's antigravity directionality imposed on the magnetosphere. Conversely, centripetal forcing moves high density mass energy toward gravitational sink center.

Mass energy antigravity directionalities respond to enormously bigger mass energy in boundaries perfection confining such mass energy, effecting outflows from its present gravitational sink into said bigger mass energy. Such cosmological gravitational dynamics mass energy directionalities outflow the light fluids in form of plasma fountains outflowing into larger boundaries perfection.

An Earth's mass energy imbalance spawning antigravity directionalities originates in tropopause, troposphere cycling mass energy imbalance in environment; balanced by an air ionization pushed into ionosphere, plasma fountain outflows or blows-off into space as the light fluids mass energy. Cosmos observation video shows a planet blowing-off light fluids up to atomic weight of carbon. Deep core borings soil samples of Pleistocene Epoch deposits, with Solar System geological data and history, predict with high degree of certainty a discovery of water traces on Moon, which the continuation-in-part applications timely describe/explain and document prior to their discoveries.

The Pleistocene Epoch shows the Earth mass energy, specific gravity densities precise balancing, affecting its core, and spins, orbits angular velocities, and spawned epigene surfaces, atmosphere and magnetic field engendered boundaries perfection of the magnetosphere—mass energy eternal actions, reactions to eternal 100% efficiencies Heat Rates. Noteworthy are outflowing hydrogen, oxygen, and nitrogen ions mass energy plasma fountains reactions balancing cosmological global gravitational dynamics radiations, irradiations energy actions. In global air temperature rise, ions mass energy losses Earth's energy balancing most unacceptably imperils all life species on Earth.

Global warming, the global air warming, all-inclusive Earth's life environment actions, reactions cycle molecular fluids air in troposphere, tropopause boundaries perfection, spawning Heat Rates less than 100% efficiencies. These Heat Rates generates the Earth's antigravity mass energy, the troposphere, tropopause global air warming. North Pole, north magnetic field, more active of the two poles/cusps, due to the Earth's antigravity mass energy global temperature rise phenomena is losing its ice cap—by global cosmological gravitational dynamics forces spawned energy actions.

The deep core borings soil samples, indisputably, without any uncertainty whatsoever, shows the troposphere, tropopause warms continually thru the Pleistocene and Holocene Epoch; the plasma fountains outflowing, in turn, boosts the Air Cells, Jet Streams cycling the nullities' sums nullity, which drop global air temperatures, all which is misinterpreted by the global science community. Carbon dioxide concentration is assigned the blame; however, in any and all instances, no matter how small CO₂ concentration, the deep soil boring samples show—fluxing temperatures continue rising, once the plasma fountains outflowing is taken into account; no doubt about it, whatsoever.

The Earth's antigravity mass energy spawned global air warming phenomena in the troposphere, tropopause with energy reactions spawn life in environment on once frozen lifeless planet. Now, the same phenomena threatens its existence; no doubt about it, whatsoever. Thus, at the core, are inabilities in any and all living organisms to cycle molecular fluids at Heat Rate 100% efficiency.

Global scientific community, furthermore, consumes valuable resources by undertaken a reversal of mass energy universal evolution, from subatomic particle energy level. A very brief history of Solar System creation yields insights into such reversals, “there is nothing for it but to collapse in deepest humiliation”, or otherwise spawn life on Earth extinction. Inevitably, all such endeavors must fail. Universe evolves from top down, from unbound mass energy into subatomic particles, in successive steps successive boundaries perfections, all which embody concomitant evolutions.

Prior sciences testing the atomic elements eternal boundaries, which cycle energy at eternal Heat Rate 100% for potential benefits, is beyond comprehension. How one improves such performing of omnipresent boundaries perfection through 13.8 billion years—impossible. Tesla foresaw that, nigh century ago; yet it persists, at negative Heat Rates efficiencies beyond comprehension, also.

Theorized multiple parallel existences in the Universe are flawed, likewise. The Universe allows unpredictable subatomic particles mass energy electron vectors directionality variation within the atomic elements known eternal boundaries perfections, only, which remains unchanged thru 13.8 billion years old enormous mass energy actions, reactions cycling. Prior sciences overrate life on Earth is untested intelligence—known for certain—and may not survive even in any one Universe.

Prior paragraph brief list, mentions scientific community slanting, bungling existences of life key issues in the last hundred years. Tesla's inventions, innovations, technologies and sciences show initial insights to human survival roadmap starting points. That period sciences and such confuse and/or misconstrue. Herewith makes it clear—only absolute paths toward survival embody 100% Heat Rate efficiencies. Otherwise, adhere strictly to the Thermodynamics First and Second Law, maximum conservations of mass and energy and its boundaries perfection maximum longevities.

That is exactly what the fundamental and Advanced Fluid Elements and the PP lengths sum least sum, the nullities' sums nullity does. Whereas, clustering of the fundamental Fluid Elements, the nuclear super plant absolute maximum mass energy conserving of the magnetosphere boundaries perfection connect Nature, the Air Cells and Jet Streams, the nullities' sums nullity and a nuclear super plant boundaries longevity, fields of energy cycling at efficiencies Heat Rates above 100%.

Overall atomic elements eternal energy boundaries perfection, eternal Heat Rate 100% efficiency cycles are crucial, also. The Universe structure yields eternal boundaries perfection two pillars—one at a lower end, the other at the evolution chain uppermost end—both, eternally cycle and flux energy eternal Heat Rates 100% efficiency. Universe intermediate third pillar, may and also may not comprise a dated boundaries perfection, depending whether or not within its boundaries mass and energy cycles eternally fully compliant to the two pillars eternal Heat Rates 100% efficiency.

Eternally stable first of the two pillars omnipresent and most fundamental finite mass and energy blocks boundaries perfection, the atomic elements, the prior sciences pick to research and benefit in unforeseeable future. In the meantime and into foreseeable future, metastable state of the third pillar imperils global civilizations and evolution chains comprising energy boundaries perfection.

Advanced Fluid Elements magnetosphere boundaries perfection of the third pillar—we know, for certain—do not cycle, flux viscous molecular fluids mass energy boundaries perfection Heat Rate 100% efficiency. Cosmological gravitational dynamics mass energy evolutions dated metastable structure of the magnetosphere boundaries perfection is of paramount importance to civilizations.

The third pillar, of paramount importance to survival of global civilizations, the dated boundaries perfection of the magnetosphere comprise prima facie credibility evidence that the prior sciences misconstrue cosmological gravitational dynamics mass and energy evolutions, which traces back to the First, Second Law which explain mass energy evolutions global air warming phenomenon.

Milankovich cycles date periods, intervals during which the magnetosphere retains its metastable boundaries perfection. The prior applications explain cycles and insolation magnifications which modulate radiations, irradiations environment intensive energy cycling between epigene surfaces and troposphere, tropopause boundaries perfections. Earth's all molecular viscous fluids cycling, energy cycling which account for all life on Earth, cycles at less than Heat Rate 100% efficiency.

The prior science bungles the deep core borings soil samples analysis, as well. Interpretation by said analysis deep flaws ignores energy cycling in environment, the first and second pillars in the Universe structure eternal boundaries perfection Heat Rate eternal 100% efficiencies imposed on the magnetosphere and, in turn, on the tropopause, troposphere metastable boundaries perfection.

The Milankovich cycles, the deep core borings soil samples analysis leaves no doubt, prima facie evidence, global air warming phenomenon is global warming phenomenon itself spawns, with its molecular fluids environment energy cycling inside metastable boundaries perfection enclosures. Said prima facie evidence shows, with life on Earth, no CO₂ or any other particulates technology in atmospheric suspension stops global air warming advancement; such can slow its momentum, not its advances by drastic cuts in anthropogenic global warming (AGW) particulates emissions.

The prima facie evidence, without any doubt whatsoever, show global civilizations existence ties to coexistence of the third pillar mass energy cycling sustained metastable atmosphere's structure and concomitantly complying with the first and second pillar configuring mass and energy cycles in the Universe structure. The third pillar, Air Cells and Jet Streams primarily cycle mass energy which sustains the troposphere, tropopause and magnetosphere metastable boundaries perfection, conforming to the First, Second Law, sub-serves the first, second pillar in the Universe structure.

The deep core borings soil samples separate, joint and in-common data show consistent, amazing uniformity affirm not only the Milankovich cycles but also show energy cycles, flows, dissolves, deposits stunningly precise stunningly uniform distribution of CO₂ and all other gases very small concentrations from atmosphere into soil, during a period exceeding two million years. Wherein, energy, fluids is one and the same flows; and these flows, time flow record are one and the same.

Thus, recorded very small concentrations of various gases in atmosphere shows First and Second Law effectiveness, forms of energy in environment unquestionable flowing dissipating precisely. Said First and Second Law effectiveness to precisely flow and dissipate energy in atmosphere, as the Universe finite macro scale sample of best prima facie evidence science can obtain pertaining to no curved space-time. Such effectiveness precludes precisely any curved space-time potential.

The scientific community bungles deep core borings soil samples analyses of the deposited in the Pleistocene Epoch, claims CO₂ concentrations in the troposphere impose global air warming, and ignores energy in environment cycling the Air Cells, Jet Streams and plasma fountains' outflows. Whereas, the Universe structure evolves boundaries perfections of the energy relativity structures requiring cycling energy Heat Rate 100% efficiency, which forces global air warming, in turn, to demand precise technologies implementations, to positively counter root causes of that warming.

The prior sciences relegate to discard the Second Law technology in the Universe structure; from smallest to largest of in-common boundaries perfections eternalized mass and energy cycles Heat Rate 100% efficiency. Energy modes energy dynamics in the in-common boundaries perfections innately engender a spawned interdependences interrelated longevity affecting energy structures.

A basic example is an induction device cycling heat energy outflows with electrical energy flows an input yielding mechanical work. The two forms of cycling energy dynamics in said induction device heat and electrical energy mutually affect the interdependences interrelated longevity—the former is unavoidably dependent and also related to the latter, and vice versa; the latter overheats its boundary unless the former outflows. Longevity of one energy cannot exist without the other.

The Universe energy structure affects energy genres innately mutual interdependence interrelated longevity comprising said—interrelated, interdependent energy and interdependences interrelated longevities. The prior science improperly substitutes mass for energy modes energy dynamics or vice versa, affecting profound, deep flaws in the prior science and the prior science technologies.

Earth's centrifuge device cycled insolation energy input, in analogy to the supra induction device basic example, unavoidably cycles a global climate temperatures thermal energy, the interrelated, interdependent energy—the interdependences interrelated longevities—forms of specific energies. The forms of specific energies are those of molecular mass weights specific ingredients—specific energy forms cycling energies, specific energies cycling directionalities, specific cycling periods.

From its advent, science assumes superior importance, rights and knowledge. In that context, the prior sciences and art practitioners assume structures of energy device discloses functionality and utility; in ignoring the Second Law, the prior art sciences misconstrue cosmological gravitational dynamics, the interdependences interrelated energies, in turn, misconstrue structure performance.

In most instances, if not all, a lesser, mundane, or undefined energy and even static energy forms improperly substitute for energies which cosmological gravitational dynamics comprise; all these avoid the Second Law, which mandates discerned energy cycles and energy dynamics. The prior science takes nigh century in validating itself, only, to disprove soundly nigh century of its work.

A most stunning paradigm substitutes the interdependences interrelated energies among forms of cosmological gravitational dynamics which CO₂ concentration affect in the atmosphere response to isolation energy, which, in turn, claims valid sciences and technologies of global air warming. Noteworthy in these claims are complete absences of cycling Air Cell and Jet Streams with Earth evolving spawned by energy dynamics present in environment, all which is undeniable; whereas, Earth's energy cycling in Universe environment is the real cause that requires real solutions. The details of correcting the prior sciences a century of misconceptions justify this application length.

There is a valid way to evaluate an energy device structure and not to set forth, define, Heat Rate efficiency that validly evaluates structures; these applications do; the prior applications advanced structures and associated technologies do exactly that. However, licensing regulations disallow a “functional language”, which precludes the Second Law discerning energy device dynamics and, in turn, precludes best of the best devices—flawed science precluding the best of applied science.

Thermodynamics First and Second Law entirely prove demise of curved space-time theory, since in each and every instance, the Advanced Processor, the Advanced Fluid Element, balance yields a proper disposition of each boundaries perfection. In turn, said curving space-time theorizing is forced physical improbability that says the Universe by not complying with the First, the Second Law improperly balances mass and energy, and which—for certain—we know is not a possibility.

Absolutely, no energy device should impose its energy cycling which opposes, relegates or slows mass with energy maximal cycling that stays the troposphere, tropopause and the magnetosphere boundaries. All environment boundaries bound energy cycling nigh 100% Heat Rate efficiencies toward in-common 100% Heat Rate efficiency is crucial; otherwise life on Earth is going extinct.

Cycling energy influence zones in environment which hinder, abstract, trap, block, or slow down maximally efficient energy cycling paths in tropopause, troposphere environment energy cycling is undermining the energy relativity structures boundaries perfection energy cycling longevity; in the tropopause troposphere such zones, the cycling fluxing mass energy environment imbalances effects the Earth's antigravity mass energy phenomena root causes and insolation magnifications of global air warming phenomenon. For above stated reasons, wind turbines and solar panels are unacceptable “green technology” devices, which, likewise, yield unacceptably low unsustainable Heat Rate efficiencies. In light of recent flooding which most environmentalists blame on global air warming, in fact, occur as unbalances in the Air Cells cycling water vapors in the atmosphere.

Global civilizations sole paths to survival mandate all energy boundaries occurring and bound by the atmosphere engenders Heat Rates absolute maximum efficiencies. Any and all inefficiencies eventually yield a gravity sink an antigravity mass energy forcing by the Universe structure mass energy cycling overall Heat Rate 100% efficiencies—globally forcing Milankovich cycles plasma fountains outflowing, and on Mars, the gravitational sink, with no AGW present, losing its water.

Afore confirms—Evolution is primarily a matter of evolving energy dynamics by specific cycling fluxes, evolving mass energy dynamics effecting boundaries perfection and spawned longevities, The magnetosphere's boundaries perfection longevity, nigh 100% Heat Rate efficiencies cycling mass energy in unrestricting environment absolutely maximal cycling exemplifies best induction device technology. The Advanced Fluid Elements bound mass energy by boundaries perfections technologies—boundaries perfections by the nullities' sums nullity—also affirm hexagonal cross-sections winding wire maximum cooper fill in the stator slots of electrical motors and generators.

Induction devices top five failure causes—excessive heat, power supply issues, environment dust particles, humidity-moisture and improper lubrication effect are also, likewise exemplified by the energy relativity structures, magnetosphere boundaries perfection changing climates same issues.

Of the five, very interesting is improper lubrication, most important to Earth's climate changes, the Advanced Processor energy functions. It exposes the prior sciences perpetuating deep flows. Water vapors, in environment air cycled as Earth's Advanced Processor an all-purpose lubricant, effectuate global air warming fundamental issues. Electrically charged, frictionless cosmological plasma and neutral, frictional gravitational sink bound molecular fluids embody entirely different mass boundaries perfection domain. Earth's gravitational sink environment, water vapors lack or over abundance in molecular air fluids spawns glacial interglacial climate changing cycle. When diatomic air, water vapors has contaminants typical lubrication issues rising temperatures occurs. If Air Cells cycling, lubrication-leads are too long, molecular air fluids insolation magnifications raise air temperatures, which eventually effects a failure (plasmas mass energy outflow to space).

Cycling humidity and moisture effecting corrosion and short circuits of motor parts correspond to streams and rivers almost entirely facilitating water flows directionalities towards tropical belt, eroding channels or gorges; all which shorten water flows time durations inside gravitational and epigene surface temperature sink. In fact, all of that shortens cycling of water toward the tropics, and, in turn, magnifies water vapors mass in atmosphere, which slows, lengthens air cycling time periods. And, in turn, insolation magnifications, likewise, raise global air warming temperatures.

Dust and contamination of motor environment correspond to CO₂, methane, and all greenhouse gases and particles cumulating effects in the atmosphere. In part environment phenomena for the last three hundred years, from start of the industrial revolution; the scientific community elects to ignore climate changes all causes which continually cycle the global climate for 4.5 billion years.

Voltage, current power supply issues and current harmonics distortion dynamics or an overload or overheating are a child's play compared to cosmological global gravitational dynamics energy mass and energy densities cycling radiations and wind pressures. The magnetosphere boundaries stunning instantaneous deformation balanced cosmological global gravitational dynamics energy actions, energy reactions mass energy densities affirm the nullities' sums nullity quantum energy dynamics crucial boundaries perfection precise dispositions. Thus the Advanced Fluid Elements, said First, Second Law effectiveness in Nature's precision precludes curved space-time potential.

Cycling fluids, including electrons, inevitably excessive heat and thermal energy buildup inside a boundaries perfection, which, also unavoidably occurs in induction motors, in Earth's magnetic field, unless boundaries perfections continually, effectively emit thermal radiation. Biggest killer of electric motors and boundaries perfection fluids cycling maximal Heat Rate efficiencies inside boundaries perfection effected by Earth's magnetosphere is thermal energy buildup. The Earth's gravitational field boundaries perfection, water environment presence responds to thermal energy radiation. It comes down to—effectuate the magnetosphere boundaries perfection thermal energy thermal radiation flow entirely balanced transfer, in time, at Heat Rate 100% efficiency or perish.

Possible Heat Rate efficiency above 100% can timely recoup the Earth's antigravity mass energy potential spawning. Promptly implementing nuclear super plants number may potentially recoup industrial age 300 years of energy emissions before these emissions actions becomes irreversible.

The Earth's magnetic field, motors and generators, especially induction motors generators shown analogies, all show that forms of energy cycling in respective environment boundaries perfection longevities highly depend on boundaries perfection maximum cycling sustained energy potential.

Simplest analogy explained global air warming comprises the Earth's magnetic field overheating due to cosmological gravitational dynamics cycling plasmas, especially solar insolation, imposed thermal loads on troposphere, tropopause molecular fluid cycling, which cannot spawn balancing mass energy densities, and magnetosphere boundaries perfection and Heat Rate 100% efficiency. The Universe structure, Heat Rates 100% efficiency, energy relativity structures, magnetosphere boundaries perfection cycle energy flux imposing disposition stresses and strains in the magnetic field outer lines which must disconnect whenever Heat Rate 100% efficiencies are not occurring.

Likewise, in induction devices, the electrical motors, a mechanical torque overloads can overheat the device. Nowadays, such devices have thermal overload fuses which break electrical circuits, an electrical supply typical fuse disconnects, which effectively prevent electrical shorts or a fires.

Earth's magnetic field outermost lines act as induction device shaft bearing outer surfaces, which precisely self-deform, self-sacrifice to effect Heat Rate 100% efficiency. The Universe structure, the First, the Second Law, cosmological Heat Rate 100% efficiencies and the nullities sums' sum nullity quantum precise invalidate existence of curved space-time phenomena. The basic applied sciences in practice an overdue massage to theoretical sciences—“Your theorizing” is “killing us”.

A precise disposition of the coil windings in steel laminations and in a volume of a slot affects an ultimate structure of the stator armature, which affects thermal energy outflow and the maximum conductance of a coil and the slot, an electrical and a thermal conductance, Heat Rates maximum efficiencies. A maximum ultimate copper fill, a maximum coil number, the compressed volume of insulation, a maximum conductance of electrical energy, and a maximum conductance of thermal energy respective cycling yield an electromagnetic maximum torque and a mechanical maximum torque at relatively low a slot temperature. All of which impacts Heat Rate maximum efficiency. All of these embody an ultimately compact structure and boundaries perfections of that structure.

Only thermal energy radiation into diatomic air, epigene surface by conduction effects said stator armature thermal energy maximum outflowing absolute configuration and maximum longevities.

Diatomic air 99.9% purity is not electrical motors or generators function a critical detriment. All impurities concentrations, herein, refer to an estimated less than 0.1% of CO2 and all other gases and water vapor respective concentrations in air environment; clearly, this concentration is small.

Air cycling thermal energy convection is taken as natural or a device environment energy unique cycling; each improving said stator armature, said maximum mechanical torque effected cycling, separates from said stator armature cycling forms of energy. Wherein, concomitantly, said stator armature absolute maximum longevities configurations, maximum outflowing of thermal energy, cycling effected maximum mechanical torque effected by frequency of electrical current cycling, yield the thermal energy maximum outflowing absolute configuration and maximum longevities.

Stator armature slots configuration honeycomb fills cycling synchronous electromagnetic energy cycle dynamic energy modes mechanical loads to pre-conditional maximum longevities potential maximum Heat Rate efficiencies which the honeycomb fills hexagonal wire cross-sections grant.

The stator conforming to the First, the Second Law cycles energy Heat Rate maximum efficiency affected by electrical phases' electrical current cycling electromagnetic poles fluxing in insulated slots in the stator affects three energy forms concomitant transfer into mechanical torque cycling.

Or vice-versa and at a Heat Rate maximum efficiency, maximum mechanical torque load cycling as seen by the stator effects electrical current demand, magnetic field and thermal energy cycling a torque load. The maximum efficiency Heat Rate varies forms of energy input/output, electrical current cycling input and dynamic loads torque energy congruous thermal energy cycling output.

The stator armature comprises hard-wired, solid metal construction. The insulated slots, the pre-insulated copper wire insulation fatigue aging restricts the pre-conditional maximum longevities, restricting potential of an unlimited longevity. The hexagonal wire stack coils cross-sections, the insulated slot maximized continual uniform thermal energy outflowing avoid hot spots, which, in turn, conduce potential of the unlimited longevity to copper wire coils in a stagnant environment.

Air environment cycling energy nullities' sums nullity in boundaries perfection curtails potential of the unlimited longevity of the stator armature unless that boundaries perfection embodies Heat Rate 100% efficiency, which is never the case. A stator coil armature that is hard-wired for Heat Rate maximum efficiency cannot cycle 100% efficiency, unless it is wired to a super plant cycled power cycling environment energy Heat Rate efficiency above 100%, within the troposphere and tropopause affected boundaries perfection and is cycling in at least first half of stated 41 ka cycle.

Newtonian gravitation, herein, also, attraction force (F), in fact, is not a property that is known to occur between unlike magnet poles. In cosmological global gravitational dynamics unequivocal, omnipresent and uncompromised Heat Rates 100% efficiencies, a dis-union mass energy cycling segregates any mass into at least two definable parts generally each cycling, orbiting, spinning in each part separate dispositions, orbits and spins, to achieve, maintain Heat Rate 100% efficiency.

Thus, originating from one cycling mass, Universe energy may potentially reunite into one mass. Excluding mass cycling dynamics, the gravitational attraction force is materially in error, at best.

As it happens mass energy cycling action and energy reaction uncompromising Heat Rates 100% efficiency embodies cosmological gravitational dynamics mass energy Universe forces universal efficiencies, cosmological gravitational dynamics energy balancing mass energy action, reaction. In these applications, the energy relativity relative space dispositions, spinning, orbiting, taken as a body mass energy continuous enforcing relative disposition, spinning, and orbiting in Universe, are the prior sciences set forth and taken as the gravitational attraction force between two bodies.

A mass spinning orbiting disposition, cosmological gravitational dynamics, and Heat Rate 100% efficiencies yield mass energy of the relativity energy relative to that mass. The relativity energy and the prior sciences attraction force energy magnitude or energy type are not one and the same.

Gravitational mass and mass density comprises atomic elements weight of atomic elements chart and volume inclusive in gravitational fields mass and gravitational sinks energy make-ups. Such a mass, then, becomes a mass energy node an integral effective unit in the Universe structure that balances cycling energy boundaries perfection infinite successions to Heat Rate 100% efficiency.

Cosmological gravitational dynamics energy, cosmological centripetal force defines the relativity energy, a cosmological energy binding energy force, comprises the relativity energy of a celestial body. It is that and much more. It cycles cosmological potential energy, which evolves the mass energy nodes, the gravitational sinks energy dynamics said mass energy nodes and binds each by pretentions, tensions and posttensions and retentions or relaxes an energy binding and constitutes successive boundaries perfection, a binding system that complies with Heat Rates 100 efficiency; it does that by the energy evolution a related in-common energy dynamics spin, orbit, precession.

Gravitational sinks, the gravitational fields evolve respective hydrostatic compression depression centripetal forces comprising at least in part the Universe structure, a galactic, a solar and its own spins, orbits and precessions gravitational energy dynamics in-common centripetal forces; the in-common, yet separate energy dynamics a spin, orbit and precession of celestial bodies, at least in part, spin, orbit, precession portions engender the relativity energy in-common energy dynamics.

Centripetal force energy in environment cycling in mass energy nodes, the gravitational sinks, on most fundamental level in individual or in-common atomic boundaries spawn structural integrity effect, unity, in Universe energy cycling structure bracing which embodies stunning flexibilities. Energy structure technologies are known in the art; however, Universe creativity in utilizing and applying energy technologies and are stunning, beyond belief, amazing to say the least. Newton, Einstein, Cavendish, CODATA, NIST and SI stipulate gravitational constant (G) values or such.

The prior sciences require in the art a rigidity in the Universe structure that requires curved space time. The prior sciences misconstrue and overlook the Universe structure mass energy dynamics stunningly precise boundaries perfection boundaries existence, from atomic elements to galaxies.

Celestial bodies as boundaries perfection centrifuge devices engender infinite numbers of energy devices which spin, rotate and orbit electrons, atoms, molecules of celestial bodies, solar systems and Universe galaxies in respective, successive boundaries perfection. A gravity field engenders balancing a centripetal forces centrifuge a spin, orbit, and precession energy dynamics actions by energy sum reactions—not a mass attraction force mass genre the prior sciences claim. A gravity field, an energy device dynamics spin, orbit, precession and magnetic field boundaries perfection yield the relativity energy, the interrelated, interdependent energy, the energy relativity structures aggregate cosmological gravitational dynamics, potential energy in globose spherical depression.

The energy relativity structures of Earth's atmosphere embody modes of energy dynamics which evolving from aggregated potential energy in the solar nebula require a redistribution of potential energy to potential energy sinks, the planets, inside the Solar System perfection boundaries. Said energy evolution phase in Earth's gravity field Milankovich cycles depict by effects of changing climate observed in Earth's epigene. An overall redistribution of energy modes energy dynamics by disclosed sciences and technologies of this and continuation applications claim the inventions; the inventions are claims to global energy policies and sole solutions to fight global air warming.

The gravity fields in the Solar System embody Earth's version of the energy relativity structures, apparent in in-common configuration cycling dynamics and cosmological gravitational dynamics having the solar system disk plane, the gravity fields, the celestial bodies, engendering respective interrelated, interdependent energy spin, orbit, precession dynamics. Gravity fields constitute the relativity energy, the energy relativity structures, the interrelated, interdependent energy affected energy dynamics in-common associations configured spin, orbit and or spiraling and precessions an in-common galactic boundaries perfections cycling, about Black Hole, such energy dynamics.

Gravity fields centrifuge devices, Black Hole galaxy fields inverted centrifuge device engender a boundaries perfections structure of energy systems and subsystems; a galaxy system solar system embodies energy system intermediate structures, the gravity fields of respective structures, which bind their own, their galaxy and the Universe energy structure energy modes energy dynamics by four boundaries perfections each a larger gravity field bound in one mega system mega structure.

The one energy mega system mega structure, the Universe energy structure, spin, orbit, or spiral, or tumble and precession bind the four boundaries perfections, the four structures, into one mega system mega structure. The mega system mega structure each of the four boundaries perfections cycles energy dynamics balancing own and balancing each of the other three in-common energy.

A photon essentially straight path deforms only slightly by gravity and electromagnetic fields. A gravity field straight path in space time evolves from a straight path into a spiral path by spinning and orbiting gravity field and such evolving of the straight path in space time domain in the other three in-common energy structures necessary to have in-common structure and in-common space time domains. An irrational number, an irrational solution, manifests that theoretical computing, if correct, does not comply with reality, which the prior sciences taken rational imposes sciences.

The incontrovertible realities of Nature, the First and the Second Law says otherwise. These, the accompanying Laws of Thermodynamics, say that the last century sciences bungle fundamentals, especially the Second Law, that a structure cycling energy dynamics details prove performance—efficiency—and, concomitantly, prove that set forth a structure appearance misleads, without said cycling energy dynamics confirmation details. The prior sciences confirms it for the last century.

Earth's nebula mass evolving hot rock then a mantle bound magma centrifugal actions, unless an electromagnetic field and conducive environment energy slows or prevents it, radiate its plasmas energy into space. All stars steadily centrifuge plasma, each such at Heat Rates 100% efficiency.

Gravitation attraction force as defined by the prior science does not exist. If it were to exist, such attraction forces taken up energy through 13.8 billion years would sap the Universe gravitational dynamics cycling energy. Of course, such attraction force does not exist. Gravitation eternalizes epigene surface cycling 100% Heat Rate efficiencies bound energy boundaries perfection, which, concomitantly, engenders gravitational dynamics energy boundaries perfection nigh eternalizing.

Thus, planets effect, configure cosmological gravitational dynamics cycling energy nodes, bound energy dynamics boundaries perfection bounded space, in turn, engendering cycling energy Heat Rate 100% efficiency. All such constitutes much more than the prior art gravitational force does.

Past sciences gravitational attraction comprises scientific communities misconstrued energy form analogous to curved space time, which violates the First and Second Law and, therefore, does not exist. Electron alignment in an atomic boundary shows strictly an electrical attraction. If it were is present, to date, no mass attracting mass attraction force aligning spin and/or cycle is observed. Instead, the interrelated, interdependent energy maximum conservation of energy dynamics Heat Rate 100% efficiencies sustaining boundaries perfection by any gravitational sink is such a force.

Space cosmological gravitational dynamics cycling eternalizes a boundaries perfection. Wherein cosmological gravitational dynamics spawn a nebula's partition, then, contraction to disks and/or rings configuring spinning, cycling, orbiting a moon or a planet boundaries perfection. Eternally cycling energy maximal mass energy conservation, therein, embodies a gravitational sink energy.

While still in a nebula mode, cosmological gravitational dynamics stunningly sensitive to energy dynamics Heat Rates 100% efficiencies distinguish among potential centrifugal mass and energy dynamics distinguishes mass energy dispositions separation in space, eternalizing a spinning and precession orbiting. Globose spherical shape arises from mass energy spinning, centripetal force centripetally compacted densified mass, eternalized shape initiating a nuclear reaction in its core.

In time, core becomes molten lava and a mantle develops. Still acting as a centrifuge comprising centrifugal forces separate mass energy disposition of spins, orbits, and precessions about gravity mass energy center. Cosmological gravitational dynamics centripetal forces effect said shape; in Earth's gravitational field, sink, centripetal direction dispositions yield 32.2 ft./sec² acceleration.

The atomic boundaries embodied energy fiercely resist boundaries change, verified and affirmed by cycling cosmological gravitational dynamics sustaining maximum Heat Rate 100% efficiency mass energy conserving throughout the Universe. Past sciences Earth's gravitational force is not a mass attraction force. Instead, Universe balancing energy cosmological gravitational dynamics configure, bear and fiercely resist change in Earth's gravitational field sink boundaries perfection ersatz proper and that the past sciences claim celestial bodies a nonexistent mass attraction force; Also, that misconception shows Higgs bosons a myth and potential loose, loose experimentation.

Thus, the 32.2 ft./sec² acceleration is not gravitational field's attraction but rather a mass energy magnitude needed to potentially negate cosmological gravitational dynamics configuring Earth's effecting mass energy quantum quanta dispositions boundaries perfection. In Pleistocene Epoch, Earth's gravitational field buildup to picks of such mass energy magnitude occur about 50 times.

Mass energy spinning, orbiting, cycling configure, evolve and sustain said magnitude buildup of boundaries perfection to a point, only. Earth's gravitational sink mass energy magnitude buildup superimposed over energy of creation refines and conserves evolution steps evolving eternalized boundaries perfection which add to or detract from mass energy of gravitational sink depression.

All of which shows, in geologic time, gravitational field, gravitational sinks, mass energy varies. The Universe compelling forces balancing the Earth's gravitation field boundaries perfection are relatively weak at the boundary. Milankovich cycles and deep core borings sampling of deposits show Earth's gravitational field boundaries perfection breaching occurs in the Pleistocene Epoch about 50 times on 41 ka cycles, which, in turn, during the Holocene Epoch shortens considerably.

All of which show global scientific community is out of touch with cosmological observations of the Universe shown cosmos planetary systems' mass and the energy evolution many stages. The energy evolution and mass many stages, the Uniformitarianism Theory pieced together, confirms validity the above discloses as scientific facts set forth sciences; disclosed gravitational dynamics intertwining technologies show the prior theories science is profoundly flawed and unacceptable.

Each gravitational field boundaries perfection embodies its specific eternal mass energy creation, evolution and sustenance. Each comprises a boundaries perfection separate evolutions, all which comply with the Uniformitarianism Theory, the First, and the Second Law. And, each claim or a disclosure yields diversity of the Universe, also. Cosmological gravitational dynamics, bound by said Theory and Laws, conserve mass energy, the interrelated, interdependent energy and cycling gravitational fields; all these arise from eternal conservation in-common mass energy cycling the interrelated, interdependent energy, mass conservation, from existences prior to the Big Bang. In all respects, gravitational field sink origin discloses sciences self-verifiable indisputable veracity.

The interrelated, interdependent energy mass eternal cycle conservation inside gravitational field sinks spawns angular momentum conserving the interrelated, interdependent energy mass, within respective boundaries perfection. For gravitational sinks that magnitude comprises cosmological gravitational dynamics mass energy in-common eternally evolved conserved mass energy, which the First, Second Law uniformly govern throughout space applying Heat Rate 100% efficiencies.

Cosmological gravitational dynamics omnipresence unequivocally impose uncompromising Heat Rate 100% efficiencies on Earth's gravitational sink magnetic field boundaries perfection, which molecular fluids cycling finds unsustainable. In Pleistocene Epoch, plasma fountains outflow on 41 ka cycle periods and subsequently in Holocene Epoch on sporadic, varied, and shorter periods.

“Global warming”—global air warming—is entirely Nature cycling phenomenon which in the last three-hundred years human activities energy demands aggravate. Global air warming underlying root cause is cosmological gravitational dynamics uncompromising 100% Heat Rate efficiencies, which poses mass energy demands on the Earth's gravitational sink boundaries perfection, in the Earth's instance an ability to retain and sustain water vapor cycling, average global temperatures.

In retrospect nearly fifty years ago, at the time the University of Illinois, the top civil engineering school and consistently rated as one of the U.S. top three technology schools, faculty undertakes a program to augment intellectual property licensing. The program “unpersuasive” outcome and effort, in turn, reverberate through technology schools, without detail. The above lend few clues.

Herein the Theory of Uniformitarianism, deep core borings sampling correct interpretation of the Pleistocene deposits and the Solar System, the Universe overall observations and pieces together the Universe mass the energy evolution stages and steps, varying with a particular system age, in each instance. Such scientific data piecing shows that evolving the Solar System drives the light fluids, water based ions, nitrogen ions to Solar System perimeters. As Mercury, Venus and Mars have lost respective water budgets, the Earth heats up through the Pleistocene, Holocene Epochs.

Pieced together Universe eternalized energy, the energy evolution of the Solar System positively shows that Mars' evolution status is ahead of the Earth's evolution status, in spite Mars' orbiting the Sun at much greater distance. Both, Earth and Mars during period of the Earth's Pleistocene, Holocene Epochs incur water mass budget losses, essentially Mars losing its entire water budget.

Fruitlessly, the scientific community pursues atomic boundaries energy in pursuit of God particle discovery. That theoretical scientific particle research has undefined, negative infinity Heat Rate efficiency. Scientific community atomic boundaries research seeks an improvement to an eternal cycling which affects the interrelated, interdependent energy mass perpetual cycling in respective boundaries perfections in the Universe. If it were to exist, such a particle in Nature must cycle in the Universe above present Heat Rate 100% efficiency in as yet undefined perfection boundaries.

By contrast, the prior applications, this application claims the Earth's magnetosphere cycling and fluxing boundaries perfection spawned longevities improvements by improved energy cycling in troposphere, tropopause fluids and ionosphere plasmas energy cycling boundaries. Whereas, the prior applications explain the Earth's gravitational sink mass energy cycling the Air Cells and Jet Streams energy cycling and electrical power generations Heat Rate efficiencies above 100%, this application claims electromagnetic thermal radiation energy boundaries efficiency and longevity.

Perceived gravitational attraction force misconstrues the interrelated, interdependent energy mass perpetual cycling centripetal forces which by three-dimensional compression evolved boundaries respective perfection can sustain eternal Heat Rates 100% efficiency. These evolving centripetal three-dimensional compression forces occur following maximal distension of a nebula perfection boundaries dissipated centrifugal forces evolved by nebula spinning mass energy collapsed into a spinning disk clouds and rings. All of such evolves cosmological gravitational dynamics energy.

Evolving nebula mass and energy into spinning disk rings evolves into a planet further increasing the centripetal forces three-dimensional compression, in specific technologies confining pressure overburden pressures. In a celestial body, overburden pressures affect a triaxial compression. In most instances, in the Earth's core, overburden pressures spawn a nuclear reaction and, likewise, affect the energy relativity structures, the atmosphere and magnetosphere boundaries perfections.

Sun's overburden embodies entire Solar System boundaries perfection mass density and sustains, spawns a nuclear reaction longevity. A nuclear reaction evolves Sun's atomic structures of 98% hydrogen and helium spawning high-speed particles electromagnetic waves energy spiraling into space sustaining Solar System boundaries perfection perimeter. Black Hole overburden unwinds atomic to sub particles structure wherein pressure above vacuum affects the overburden pressure.

Interrelated, interdependent energy mass Heat Rate 100% efficiencies cycling eternal conserving of all gravitational field sinks pertain to gravitational sinks interrelationships arising from energy mass in the past at one time in-common origin. Such interrelationships stunningly sensitive to all energy dynamics bridge cycling mass energy time proximities as if it is in-common mass energy.

Said overburden pressure gravitational sinks interrelationships stunningly sensitive to any energy dynamics Heat Rate 100% efficiencies, a nuclear reaction in its core and a continuous boundaries perfection convert a planet mass and energy dynamics centrifuge device into an induction energy electromagnetic device spawned respective boundaries perfection energy cycling in environment.

Past sciences deduce, stipulate the gravitational attraction force energy engenders tides in oceans. In fact, as supra states, that attraction force does not exist. Solar System fluids rising overburden pressures with depth evolves its boundaries perfection sustenance, from perimeter to mass center. Overburden huge hydrostatic pressures hold enormous magnetosphere boundaries perfection and magnetotail flux, held against Earth's gravitational field mass; Moon's gravitational mass energy orbits, dynamics while crossing solar radiations wind pressures and magnetosphere deformations magnetotail, —cosmological gravitational dynamics wake, drag and backwash—effect ocean tides.

Centripetal force hydrostatic overburden confining pressure lower on Mars than on Earth spawns Mars entire water budget loss, in spite the greater distance from the Sun. Boundaries perfections centripetal forces confining hydrostatic overburden pressure effect celestial bodies, solar systems and galaxies random boundaries perfection relative spin by cosmological gravitational dynamics.

Cosmological gravitational dynamics spawns each boundaries perfection and its spin, and energy fluxing and cycling affects relativity energy dynamics and longevities. A star's energy dynamics energy emissions evolves a boundaries perfection spin, orbit, precession, while centripetal forces hydrostatic overburden pressures evolve mass energy dynamics inside of boundaries perfections.

In a galaxy mass energy and boundaries perfection, Black Hole does exactly opposite what a star does by backpressure energy potential which avoids mass energy outflowing from its boundaries perfection by conserving longevities, relative spins of all boundaries perfection in its boundaries.

Said all boundaries perfection includes atomic boundaries. Hadron cyclotron research is risky at best. Causing one, consequently all perfection boundaries change in the Universe, is unfounded.

Heat Rate 100% efficiencies, nuclear reaction, boundaries perfection and Tesla's electromagnetic inventions owns the future. As Tesla predicts in his time, a subatomic costly research misguides, which global air warming phenomenon reality indisputably confirms, these applications confirm.

A solar system, a galaxy energy evolution electromagnetic fields science technologies back-trace Heat Rates 100% efficiency by the Second Law, Advanced Fluid Elements boundaries perfection by the First Law of Thermodynamics discerning the Universe basic structures quantum accuracy.

Nebula evolves mass energy centrifuges effecting subsequent mass and energy induction devices and boundaries perfection status, including the energy relativity structures in Earth's atmosphere. Wherein, mass energy centrifuge status evolves globose spherical shape boundaries perfection of celestial bodies, which sustain cosmological gravitational dynamics Heat Rate 100% efficiencies.

About or in cores of respective celestial bodies, enormous overburden pressure initiates a nuclear reaction, which in Earth's instance spawns the energy relativity structures of Earth's atmosphere. Thus, Universe ubiquitous celestial bodies show nuclear reaction as the only energy valid source.

Pleistocene Epoch soil deposits, astronomical observation show the energy relativity structures in Earth's atmosphere warm and destabilize, which plasma fountain outflowing to space rebalances.

The energy relativity structures cycling the light fluids by themselves are doomed, as Pleistocene Epoch data reveal, their boundaries perfection structures cannot avoid outflowing the light fluids.

Superimposed a centrifuge an induction devices actions reactions in boundaries perfection moves high density mass, light fluids plasmas toward overburden pressure core, perimeter, respectively.

Evolving energy cycling in environment brings about induction device failures same phenomena, all which is well documented in technical literature and which aforesaid to an extent summarizes. The energy relativity structures in Earth's atmosphere are doomed by the troposphere tropopause cycling Heat Rate efficiencies—Pleistocene Epoch soil deposits, astronomical observation shows.

Earth's gravitation field must significantly boost its energy efficiency or its existing life perishes.

Mars', Earth's surficial features geologies disclose Mars energy evolution much advanced passed Earth's disclosing the First, Second Law induction devices centrifuge diversities in the Universe; curved space-time, global warming science, the gravitational constant, the gravitational attraction force engender science crutch factors' terminologies, which detail to obfuscate gross inadequacy. In fact, all of these fail to comprehend gravity evolution by cosmological gravitational dynamics.

Thermodynamics First and Second Law, Heat Rate 100% efficiencies, Advanced Fluid Elements boundaries perfection infinite diversity discloses Universe sciences, structures, and technologies, and the Universe structure boundaries perfection quantum resolution Heat Rate 100% efficiency.

Cycling energy plasmas in environment show a celestial body stunning orbit, spin and precession that appear random; yet, these are extremely precise; each celestial body yields centrifuge device effects omnipresent centripetal axial radial and centrifugal and torsional components, in-common mass quantum energy uniquely exact, interrelationship balance of the interrelated, interdependent energy. That unique balance of a planet outflowing no heavier fluids than the light fluids plasma constitutes the uniquely exact quantum energy balance of structures in Universe energy structure.

Likewise, the energy relativity structures must embody Heat Rate 100% efficiencies which avoid plasma fountains outflowing. Otherwise in foreseeable future certainty, the Earth joins Mercury, Venus and Mars waterless state. Nexus in a survival are Nikola Tesla's motor, generator devices ubiquitous utilizations maximum efficiencies. Entirely uniform rounded wires are worst possible compaction shapes. A yoke of the stator of three phase motors or generators four poles per phase and said compaction of the slots to boost Heat Rate efficiency affect environment positive effects in each and all respects and excellent, optimal, starting points, thereby, to oppose climate change.

Induction device ultimate heat transfer engenders no fan or a blower Heat Rate highest efficiency and thermal radiation which outflows with speed of light passing through diatomic air into space; thermal energy transfers other means embody cycling molecular fluids insolation magnifications.

The Universe cosmological gravitational dynamics evolves cycling energy spawning boundaries perfection of atomic structures boundaries perfection with respective centrifuge devices, celestial bodies, Heat Rates overall 100% efficiencies, evolving boundaries perfections longer longevities.

And, that shows the Earth's centrifuge device, evolving its magnetosphere boundaries perfection, spawns the root cause of global warming, global air warming. Milankovich cycles, the deep core borings soil samples correct interpretations of Pleistocene deposits furnish prima facie credibility evidence, Earth's centrifuge cycling molecular fluids Heat Rate less than 100% efficiency causes global air warming! Universe balancing, Heat Rate 100% efficiencies effect global air warming.

Specifically, insolation warms air cycling the troposphere and tropopause due to molecular fluids insufficient cycling rate, less than Heat Rate 100% efficient. The prior application explains all of Earth's 5% to 6% thermal energy unbalance and Mars entire water vapor mass outflows to space. During the Pleistocene Epoch, Mars evolves its present frozen surfaces, while Earth's boundaries perfection is concomitantly, intermittently outflowing light fluids budget plasma energy to space.

Insolation hitting a planet's atmosphere warms the atmosphere, especially if molecular fluids and especially if water vapors are present; as long as life exists on Earth, Earth's centrifuge/induction device cycling gravitational field's mass energy at Hear Rate less than 100% efficiency global air warming becomes life or death issue. That efficiency first and foremost arises as life/death issue.

AGW CO₂, and all impurities concentrations, emissions into the atmosphere are the industrial era short geological period phenomena. Global civilizations absolutely highest and first priority is to boost Earth's centrifuge/induction device Heat Rate efficiency. Bungling of universal science by global scientific communities, in general, the IPCC specifically, expounding and professing strict guidance promulgating sciences absolute truths by consensus executes applied sciences hara-kiri.

By consensus, democracies condoning bungling science condone hara-kiri of their plebiscites. It comes down to bungling the root cause of cyclic failures of a centrifuge/induction device cycling eternal heating/cooling energy power failures, irrespective of air impurities concentrations issues.

The deep core borings soil samples correct interpretation shows 41 ka periods Milankovich cycles in 2.2 million years of Pleistocene, Holocene Epochs show global temperature/energy repetitious pattern cycling when the impurities concentrations in air in most, if not in all, of 41 ka periods are the least, which indisputably shows no epigene emission reduction can avoid global air warming.

Avoiding the Earth centrifuge/induction device a heating/cooling power cycling failure mandates one and only one possible, all-inclusive course of action—boost the existing Heat Rate efficiency of that device, presently at 94% to 96% efficiency, by at least few percentage points. Short term valid action disconnects from service cycling devices having very least Heat Rate efficiencies, as such devices consume cycling energy environment generates and utilizes at 94%-96% efficiency.

Clearly, such action optimizes Heat Rate efficiency of bulk electrical power generation. Industry readily employs such; these applications science technologies valid claim potentially boosts Heat Rates to nigh 100% efficiencies relying on intermediate and long term nuclear power generation.

Boundaries perfection sciences and absolute technologies Heat Rate maximum efficiencies effect Fluid Elements ions, isotopes, principles, methodologies, inventions, and innovations (FEIIPMII) these applications disclose, explain and exemplify. Said Fluid Elements refer to molecular fluids and the light fluids which converting into ions enter space. Solar radiation also includes isotopes of Hydrogen, while nebula contains atomic elements, ions and isotopes varieties. Fluid Elements sciences and technologies discloses, explains, detail respective fluids mass boundaries perfection cycling Heat Rate maximum efficiencies, in turn, anticipating longevity of boundaries perfection.

Boundaries perfection longevity cycling eternal energy Heat Rate 100% efficiencies complement completely atomic mass structures, maximum longevity boundaries perfection genres. FEIIPMII sciences yield cycling energy cosmological global gravitational dynamics technologies Heat Rate maximum efficiencies; wherein, of course, atomic mass structures include ion, isotope structures.

Said universe genres geneses embody eternal energy cosmological gravitational dynamics whose existence can precede a nebula formation that precedes a celestial body geneses. All which yield centrifuge/induction device boundaries perfection, evolving a planet's spin, orbit, and precession.

Spin, orbit and precession comprise eternal energy evolving a planet geneses genres. We know—for certain—a celestial body migrates high, low densities mass to its core, perimeter, respectively. We know—for certain—mass density migrations occur in a centrifuge/induction device and not in a nebula. Thus, a planet spin, orbit and precession evolving geneses genres eternal energy causes mass density migration; and, we know—for certain—said mass density migration causes layering.

Fluids buoyancy density migrations and solids overburden pressures and volcanic activity evolve planets geneses mass dominant genres; omnipresent gravitational mass attraction force an energy component also appears according to the prior sciences. Omnipresent in the Earth's gravitational field force an attraction acceleration of 32.2 ft./sec.² shows up as energy genre not as mass genre. In fact as supra explain, all such are the relativity energy in cosmological gravitational dynamics.

Celestial bodies—for certain shown geneses—discloses globose spherical planets definitive forms and a gravitational sink presence. Also, these applications disclose gravitational field boundaries perfection ultimate mass energy conservation cycles and Heat Rate 100% efficiencies. We know—for certain—nebulas likewise ultimately conserve mass energy and Heat Rate 100% efficiencies; wherein Heat Rate 100% efficiencies and ultimate mass energy conservation is one and the same inside boundaries perfection. Nebula cloud, disk or ring shows no interaction mass attraction. A planet origin shows strata density or buoyancy high dominance, no mass attraction genre present.

A planet centrifuge/induction device embodies spin, orbit, precession enormous energy which, in turn, comprises centripetal and centrifugal components energy. Centripetal component energy or force is product of angular velocity squared w² and radius r or w² r. Spin orbit, angular velocities vectors are very large, especially. Radius r, in turn, is small, in atmosphere constituting radius of diatomic air hydrogen, oxygen, nitrogen molecule, ion or isotope, which, in turn, spins randomly.

The atmosphere has angle of repose angles rise from each polar cap proximity to tropical belt. If it were to exist, a gravitational mass attraction force as the prior sciences affirm, angles of repose angles would not rise from each pole toward equator, persistently show shapes of the atmosphere as if caused under triaxial compression, since pole proximity angular momentum spin, orbit have rotational momentum forces which should bare each pole; but, reality shows such is not the case.

Earth's centrifuge centripetal force compacts and forces atmosphere against epigene surface and, in turn, concomitantly, the Solar System disk plane spins on 63° angle in respect to the disk plane spiral branches of the Milky Way Galaxy, as that disk plane spirals, spins, precessions and orbits.

The relativity energy nigh nullity in boundaries perfection disk plane of celestial bodies a system or a galaxy aggregate diffused gas and dust particles of a potential nebula. Such relativity energy nigh nullity engenders a potential gravitational field a sink center. The relativity energy, diffused in the disk plane a potential energy nigh nullity, the disk plane confines till a spin of the relativity energy interrelated, interdependent energy mass portion of nebula mass spawns centripetal forces which shrink a nebula boundary. Thus, centripetal forces grow and balance the relativity energy, rounding the nebula boundary into globose and spherical bodies. Evolved centrifugal, tangential forces spin and orbit the bodies to quantum accuracy; a confinement by hydrostatic pressure very precise dispositions effectuates a nebula boundary embodying the centrifuge/induction respective devices. In turn, a celestial body cycled spin, orbit, precession balances and resolves imbalances.

Spherical and globose spherical shape geneses disclose causes of such shapes of celestial bodies. The Universe spinning, spiraling and cycling likewise includes Air Cells and Jet Streams cycling Earth's gravitational sink; said angle of repose affirms air uniformly applied triaxial compression fluids pressure on and about epigene surface, which said spinning, spiraling, and cycling spawns. All such energy in environmental phenomenon comes into focus as the following further explain.

If dominant mass attractions were to exists, amorphous shapes, not globose spherical or spherical mass celestial bodies, would populate space. In a nebula dust cloud, each dust particle must spin and orbit individually and jointly. In such dust cloud, prevailing centrifuge dynamics force high, density particles to a respective center of mass of such dust cloud, thus, boosting such dust cloud spin and its centripetal forces. In turn, interstitial spaces among dust particles shrink, which must boost said spin and centripetal forces segregating centrifugal tangential forces mass into an orbit.

Huge overburden pressures spawn nuclear reactions which melt a centrifuge core of high density layers, boost respective centripetal and centrifugal energy dynamics and energy cycles eternalize thermal, compaction and sedimentation processes irreversible dynamics converting cosmological gravitational dynamics into a celestial body energy mass. All which spawn geneses, evolution of Universe versions of spherical, globose-spherical celestial bodies—the Advanced Fluid Elements.

Everything in the Universe essentially effectuates either eternalized energy mass celestial bodies, mass energy dynamics energy reactions which constitute and sustain structure of the Universe, or exclusively cycle mass energy dynamics energy actions comprising Heat Rate 100% efficiencies; there is no curved space-time or mass attracts mass, it is all cosmological gravitational dynamics.

Curved space-time and gravitational attraction genres are creations of scientific community, at al. bungling mass and energy actions and energy actions reactions, Second and First Law, to entirely bungle timing of cosmological gravitational dynamics, in turn, also to bungle scientific advances.

The prior application discloses the Advanced Fluid Elements, the Advanced Processors, celestial bodies cycling the nullities sums' sum nullity by boundaries perfections and cycling mass energy actions, mass energy evolution and energy reactions eternalized portion of mass energy structure. Energy actions, reactions eternal balances eternalize parts of the Universe structure. Only energy mass timely cycling effects evolution, while eternalized energy structures portion is untouchable.

The former evolves cycling energy, only; whereas, the latter evolves eternalized energy structure portions cycling environment energy balances structures. The nullities sums' sum nullity cycling a celestial body boundaries perfections respond to boundaries perfections cycling energy balance on each side within evolving energy boundaries perfections longevity a timing mechanism. Said interrelated, interdependent energy boundaries perfection dynamics embody the relativity energy evolving portion of boundaries perfections energy dynamics, which Milankovich cycles disclose.

A celestial body boundaries perfection longevity cycling energy rates effect timing mechanisms, which Milankovich cycles exemplify. Time, mass energy diverse infinities cycling said nullities' sums nullity comprising celestial bodies constitutes eternalized structures in the Universe cycling energy rates timing mechanisms. Once eternalized by structures of celestial bodies, mass energy and time oppose mass energy and time eternalized structures reconfiguring. These, mass, energy and time energy dynamics spawn the relativity energy; wherein, said interrelated, interdependent energy boundaries perfection dynamics comprise a portion; in turn, that energy portion modifies, reconfigures boundaries perfection an eternalized portion. Boundaries perfection energy cycling, below Heat Rate 100% efficiency spawns such reconfiguring; Milankovich cycles shows it, also.

Celestial bodies evolve cycled mass energy boundaries perfection lowest potential energy levels, embodying timing mechanisms and evolving mass energy cycles to lower potential energy level. Such cycles instance invariably lowers a celestial body lowest potential energy level, which, also affects changes in its timing mechanisms; the prior science gravitational attractions force bungles space-time notions into nonexistent delusional energy dynamics devoid of the Second, First Law.

We know—for certain—environment energy cycling at less than Heat Rate 100% efficiency raises environment energy potential energy level, therein raising environment temperature. We know—for certain—applied sciences God particle exists, embodies energy eternal boundaries perfections and can cycle 100% and greater Heat Rate efficiencies fully conforming to boundaries perfection sciences and boundaries perfection associated timing mechanisms. We know—for certain—living organisms cannot cycle molecular fluids energy in environment boundaries perfection complying with the Universe environment omnipresent mass energy cycling to Heat Rate 100% efficiencies. And, we know—for certain—Earth's life forms existence is a rarity in the Universe and in danger.

Likewise, we know—for certain—the Solar System and its planets originate from the same nebula and, thereby, in similar past, embody alike atomic and molecular masses, similar water presence. The scientific communities fail to date curved space-time, or how or where all such comes about.

These applications predict water traces on Mars and Moon prior to space probes confirming such presence. Further, we know—for certain—global air warming phenomenon is over 2 billion years old, during which Earth loses good portion of the light fluids and Mars even before that period in time loses its water. Wherein, solar insolation spawns electrolytic processes which convert water molecular fluid into plasmas and raises potential energy temperature of heavy fluids such as CO₂ and methane. In turn, a planet exposed to solar insolation through geologic epochs loses the light fluids and overheats, because its boundaries perfection Heat Rate efficiencies are less than 100%, as presently is the case of Venus and Mercury. Or, conversely, planet's surface must stay frozen.

All bits of the necessary evidence are in and in these applications, now. Devices to generate and conversely to utilize God particle, Tesla discovers; traits known as electric motors and generators among many devices Tesla claims; and, tesla gets its name, as standard unit of the magnetic flux.

It turns out, happens, polar ice caps irreversible retreats prevent Natural insolation magnification, thermal potential energy rise, reversal in environment of the North Hemisphere. One of the prior applications details, explains all of it, also. Relying on Tesla technologies, especially motors and generators, all devices globally must cycle energy with Heat Rate efficiency absolute maximums.

Unless cycling cosmological gravitational dynamics universally affect energy mass transforming, consistently configuring spherical or globose spherical structure of celestial bodies is impossible. No mass attracting mass exists in cycling negatively charged mutually repelling plasma particles, and no alternative grants cosmological gravitational dynamics energy in environment evolving or cycling energy Heat Rate 100% efficiencies, comprising gravitational sink boundaries perfection of any celestial body fluxing and cycling the nullities' sums nullity. It is either comply or perish. Of course, Heat Rate 100% efficiencies and shapes of celestial bodies reveal direct relationships.

The above affirms global air warming phenomena, why Mars loses water and the light fluids and why the energy relativity structures in atmosphere as environment energy phenomena which cool water vapor into liquid phase rain drops densities precipitated from troposphere. If vapors do not precipitate, neither troposphere's air nor epigene surface cools. If the Air Cells do not cycle Heat Rate 100% efficiencies and we know—for certain—they do not, then, we know in the Pleistocene, Holocene Epochs they also did not; then, for certain global air warming cycles persistently recur.

Solar System planets, planets in general, cycle Heat Rate 100% efficiencies and are either too hot or entirely frozen, except for the Earth. As far as we know, no planet supports life, except for the Earth, even though all of Solar System frozen planets do possess a respective water budget mass.

Earth's periods of inter-glaciation climates boost life flourishing on Earth—we know for certain—which, in turn, regresses during glaciation period cycles, or life species become extinct or evolve. The Milankovich cycles reveal Pleistocene Epoch 41 ka period climate changes; each 41 ka period of the Pleistocene Epoch affirms the Earth's atmosphere overheats cyclically—all which the deep core borings affirm. Milankovich cycles show Heat Rate cycling efficiencies collapses Air Cells cycling, as Earth slips toward a frozen default state, which exposure to solar insolation precludes.

Fifty times in the Pleistocene Epoch, alone, Air Cells collapse. In turn, insolation magnifications occur, irreversibly forcing polar ice caps retreat. Wherein, one more glaciation period in Earth's climate is highly unlikely and such climate event forced change is extremely unpredictable, now.

History of invention sciences show Tesla's work keeps global theoretical scientific community in check, which boosts global civilizations survival chance. His applied science inventions disclose electrons cycling machines and devices, which utilize cycled electrons energy, generating power.

Cycling energy Heat Rate 100% efficiency boundaries perfection is an absolute must; otherwise, these applications show, boundaries perfection energy eventual breaks up. Electrons boundaries perfection, atomic elements boundaries perfection and cycling energy in environment boundaries perfection longevity, in most instances, is prerequisite musts to effect, support and/or sustain life.

Boundaries perfection sciences and technologies affirm deep flaws existence in the prior sciences stunning omissions crucially misconstrue the energy relativity structures boundaries perfection of the atmosphere. Misconstrue the troposphere crucial boundaries perfection, which we know—for certain—fails at least fifty times in the Pleistocene Epoch alone. The Milankovich cycles show it.

No mass energy structure in the Universe survives through geologic periods, unless that structure evolves cycling Heat Rate 100% efficiencies inside its structure outermost boundaries perfection.

In the troposphere instance geologic periods, entire epochs transpire. The Earth's magnetosphere energy flux evolved Heat Rate 100% efficiency must become a reality in the next century or two.

Said FEIIPMII undertake exactly such. The FEIIPMI sciences, technologies are exactly those of cosmological global gravitational dynamics precisely employing strict compliance with the First, Second Law mass energy flux cycling environment which yields boundaries perfection structure.

That mass energy flux cycling environment evolves a compatible boundaries perfection structure eternalized structure and environment boundaries perfection maximum longevity structures. The FEIIPMII Heat Rate maximum efficiency, a boundaries perfection structure maximum longevity, as the first priority, effect design methodologies, principles, inventions, and innovations. In mass energy flux cycling environment, structures yield maximum longevity and Heat Rates efficiency.

The FEIIPMII priority change in structure design circumvents the prior art and sciences bungling the First, Second Law. That change indisputably shows deep flaws in the prior sciences, because the prior sciences art cannot define cycling mass energy fluxes a Heat Rate maximum efficiency, wherein the FEIIPMII Heat Rate maximum efficiency embodies a maximum longevity structure.

The FEIIPMII design structure reversing the prior sciences, technologies of design procedures by granting mass energy flux cycling environment do structures boundaries perfection all designing. Said reversing the design procedures shows the last century prior sciences consequently the prior technologies disregard of said Laws fundamentals, claims to outdo Nature, lead to life extinction.

Cycling mass energy comprising a gravitational field sink engendering the nullities' sums nullity concomitantly yields Heat Rate 100% efficiency inside its boundaries perfection. A fundamental Fluid Elements structure does exactly, precisely that, embodying Heat Rate maximum efficiency.

Aforesaid boundaries perfection longevity of Earth's gravitational field sink is its magnetosphere boundaries perfection. Consequently, energy cycle originating from epigene surfaces must cycle above Heat Rate 100% efficiencies; or, otherwise, seeing life extinction on Earth is in our future.

Life existence mandates Heat Rate 100% global efficiency which FEIIPMII claims show entirely possible. However, concomitantly, the FEIIPMII show stunningly persistent human flaws which persistently preclude absolute scientific truth. Nothing lasts in the Universe, unless cosmological gravitational dynamics embody a boundaries perfection eternalizing. Cosmological gravitational dynamics embodies the Universe disclosed reality, by existence of the Advanced Fluid Elements.

The disclosed Advanced Fluid Elements, the nullities' sums nullity of cycling mass energy, yield the Universe entirely accounted mass energy cycling nullity; the nullities' sums nullity precisely, unavoidably accounts for the quantum mass energy paths-of-passage (PP) least lengths, which, in turn, comprises each mass and/or energy quantum motions, paths. Consequently, concomitantly, cosmological gravitational dynamics account for each quantum motions, paths disposition and/or energy. Quantum mass and/or energy effects a straight path; unless an outside force acts upon it, each mass and/or energy quantum and such quantum all motions, paths take straight paths—only.

Cosmological gravitational dynamics energy cycling in the Universe keeps time, measures space distance, which embodies entire mass energy and space time; all of which is one and same entity. Coexistence of cosmological gravitational dynamics space-time and curved space-time engender two unrelated domains. The former is real in entirety, the latter is theoretical, entirely imaginary.

Here disclosed FEIIPMII sciences and technologies (FEIIPMIIST), the FEIIPMIIST, account for and trace evolving Advanced Fluid Elements' paths of evolution, which account, trace for energy mass energy paths conforming to the Second and First Law; in space time, the FEIIPMIIST show projected evolution trending. Said solar nebula evolving the Advanced Fluid Elements, the Solar System present planets, show evolution diversity stages, which, then, project into the future, also.

The FEIIPMIIST effect and reveal the Universe unequivocal, infinite diversities evolution stages and trends. Solar system centrifuge/induction devices energy, mass must cycle Heat Rates 100% efficiency. Or, cycling rate, mass, energy, boundaries perfection any or all of these must change.

Cosmological global gravitational dynamics energy cycling enforces all that in the last 4.5 billion years. For at least the last 2.2 million years, compositions of deep core borings sampled deposits do confirm Earth's troposphere mass energy cycling which the prior paragraph claims. Mercury, Venus, Earth and Mars portions of the same nebula embody mass energy compositions spawning the present status and in Earth's gravitational sink magnetosphere light fluids cycling crucial that sustains life. Narrowing the Universe to said four planets, said four centrifuge/induction devices under similar cosmological solar gravitational dynamics seam to reveal evolution different paths.

Indeed, that is not the case at all. Mars, Venus and Mercury orbiting distance, distancing each of the three from the Sun, effects insolation intensity and each planet's evolution rate present status; Earth mass changing boundaries perfection, orbiting separations from the Sun and the light fluids cycling rates, slow evolution aging rates, therein, show an enormously different rate of evolution.

Earth's evolution, rate of aging, increases when the light fluids cycling rates decrease. In Earth's evolution, the light fluids prevailing winds cycle, rejuvenate epigene surfaces by precipitation, in cyclical exchanges of insolation warmed humid, light air near epigene surfaces with cool, heavy, dry, upper troposphere air which cools by water vapor precipitating, thermal radiation outflowing to space. Epigene insolation invariably yields troposphere's warmer and cooler air temperatures.

We know—for certain—global air warming is evolution phenomena, wherein Mars loses all of the light fluids in its one time atmospheric budget. And, computed Earth's energy budget shows that troposphere air cycles below Heat Rate 100% efficiency. Polar caps and glaciers ice historic low levels and correct analyses of the deep core borings sampled deposits affirm that such is the case.

Global air warming root cause arises in Earth's centrifuge/induction device evolution phenomena within troposphere, in turn, magnetosphere boundaries perfection, by the troposphere cycling Air Cells air masses at less than Heat Rate 100% efficiency. We know—for certain—molecular fluids drag and friction effect viscosity, which preclude mass energy cycles Heat Rate 100% efficiency.

Glaciation periods show that increased cycling speed of Air Cells lowers global air temperatures, with upper troposphere a heat sink. Glaciation period occurs when air cycling Air Cells speed up to nigh Heat Rate 100% efficiencies, which spawn least water vapors, impurities concentration by global air cycling fluxing state and glaciation temperatures. Air conditioners do such air cycling.

The scientific community takes the impurities concentrations fluxing states as the cause of global air warming effects. The deep core borings sampled deposits, soil samples correct analyses show that in the Pleistocene and Holocene Epochs excluding AGW recent period, only, converse holds true: troposphere cycled Air Cells Heat Rate inefficiency forces global air warming water vapors, impurities concentration. The scientific community bungles energy actions, energy reactions; by itself, that is a fatal flaw, as insufficient energy by energy reactions can overcome energy actions.

In the early Pleistocene Epoch the Air Cells appear to cycle Heat Rate 99% efficiencies which, in turn, preserve 41 ka period Milankovich cycles. Very likely, at that time if not earlier, Mars loses the light fluids in its energy budget. In the late Pleistocene Epoch, said efficiencies drop to about 97% as evidenced by irregular shorter Milankovich cycles cycling periods. During the Holocene Epoch, including AGW effects, said efficiency is down to about 94% as evidenced by computing Earth's energy budget. Recent, asymmetrical, more frequent, huge precipitation, rare and violent events distributions frequency, the scientific community attributes to global air warming, and not to Air Cells energy cycles Heat Rate inefficiency again bungled energy reactions, energy actions.

The scientific community links planet potential water presence similar to Earth with an existence of life. Mars losing the light fluids in its energy budget provides prima facie credibility evidence that is not the case. Again, repeatedly, the scientific community overlooks Air Cells cycled Heat Rate efficiencies. It is quite likely that no Air Cells eternal longevity boundaries perfection type, enclosed by the energy relativity structures which yield Air Cells boundaries perfection, exists in the Universe. Our survival depends on Air Cells. Yet, no Air Cells viabilities concern is voiced!

Induction device analogy potential five causes of failure in environment cycling energy-power is critical and yet ruthless. Environment direct interventions only exacerbate energy issues present. Energy devices energy-power supply potential issues unavoidably disclose five causes of failure:

An improper lubrication—Water vapors concentration performs as lubricant of its environment. Surface water evaporation cools that surface; evaporated water condensation recycled evaporated water vapor cools environment. Energy-power forcing evaporation/condensation rates is crucial.

Cycling humidity and moisture effecting corrosive environment—Such environment pertains to global air warming insolation magnifications, modifying Earth's surficial features cycled energy.

Voltage, current dynamics and current harmonics power distortion supply—Energy-power, said global air warming insolation magnifications engender energy concentration rare climatic events.

Cycling fluids excess heat and heat energy buildup—These causes of failures pertain entirely to energy devices in-common globally cycling ultimate Heat Rate efficiency warming of global air.

Dust and contamination—Scientific community addresses unpersuasively these issues, in parts, rather than global Heat Rate efficiency as crucial concern. None such is appropriate or adequate.

The deep core borings sampled deposits, soil samples correct analyses show the Air Cells energy cycling environment air mass spawns Milankovich cycles, which, in fact, are environment power cycles, which likewise cycle the impurities concentrations byproducts energy in air environment. Scientific community bungling energy cycling in environment which deposits all soil samples, in turn, misconstrues the root cause, among five listed causes, of Earth's induction device warming.

Of course, all of the five listed causes of failures can arise concomitantly, especially when power supply root cause of global warming environment. Gravitational field dynamics cycle impurities concentrations density, weight relative to those of the light fluids, primarily in elevation plane up and down direction. Air Cells cycling power and impurities concentrations buoyancy dissimilate eventual deposition localities. Impurities concentrations trapped in precipitation process cool the lower troposphere, also. Air Cells latitudinal temperature gradients, thus, air pressure differential gradients spawn the light fluids cycling densities and Air Cells cycling air masses energy, power.

Of course, the impurities concentrations and the Air Cells cycle concomitantly. These two effect gravitational filed altitude, latitude directions air mass rotations energy cycles. Cycling Air Cells spawn global cooling in the third orthogonal longitudinal direction, Earth's spin assisted cooling. In the three orthogonal directions, air cycling includes impurities concentrations energy cycles to Heat Rate below 100 efficiency. Fundamentally, global air warming is environment phenomena. Milankovich cycles of the Pleistocene-Holocene Epochs glaciation periods prove it conclusively.

Thus, it becomes apparent that any manmade energy devices in environment cannon help the Air Cells energy cycles, and thus can cause only harm, since we know—for certain—that environment cools itself, cycling Air Cells nigh 94% to 98% Heat Rate efficiencies. Wind turbine, solar panel devices respective claim to oppose global air warming are substantively flawed. Their nigh 50%, 30% respective Heat Rate efficiencies directly syphon cycling Air Cells air mass cooling energy, very efficient cooling, to emit back to environment respective energy byproducts thermal energy.

Earth's centrifuge/induction device centripetal, centrifugal forcing concomitantly subdivides said three orthogonal direction into centripetal forcing and epigene surface paralleling directionalities. Condensation of sublimations and evaporations vapors heat of evaporation and condensation and mass density buoyancy forcing associated with such thermal energy flowing spawn directionality and time interval duration of that energy flow, comprising generally up or down centripetal force directionalities. Said sublimations, evaporations, and condensations and electromagnetic thermal radiations spawn relative directionalities modest, short and instantaneous time interval durations.

Thermal gradients in a centripetal force direction spawn Air Cells modest time period cycles; Air Cells prevailing thermal gradients spawn air masses dominant cycles comprising epigene surface paralleling directionalities long, lengthy periods. Air Cells cycling directions, especially epigene surface paralleling directionalities effecting cycling periods' lengthy exposure to solar insolation and cosmological global gravitational energy dynamics effects global air warming phenomenon.

Cycling directionalities, cycling Air Cells time periods, cosmological global gravitational energy dynamics with polar caps, glaciers ice advance, retreat in glacial, interglacial periods effect solar insolation Earth Advanced Processor, epigene surface features boundaries perfection, boundaries perfection successions, boundaries interdependence embodied in the energy relativity structures.

Therein, boundaries perfection successions said interdependence, we know—for certain—celestial bodies, Earth included, spin, orbit and precession embody Heat Rate 100% efficiencies. We also know—for certain—sublimation, evaporation, condensation, and alike thermal energy transferring in a closed boundary, cycle Heat Rate 100% efficiencies, mandated by the Second and First Law. And, we know—for certain—solar insolation stays relatively constant throughout Earth's lifespan.

Said ‘for certain’ facts of Air Cells directionalities cycling the troposphere boundaries perfection, density and buoyancy forces not cycle Heat Rate 100% efficiency, effectuate global air warming. Overall density, buoyancy with Air Cells directionalities in-common environment cycling energy sublimations, evaporations to condensations to cycle restarts time intervals common period bears overall time intervals a common cycling period, the period, the root cause of global air warming.

Air Cells directionalities in-common environment energy cycles with the period perceive latitude bearing energy cycles spawn thermal energy flowing in latitudinal gradient directions by relative times, distances of the period. Wherein, each time, distance specific period affects time intervals from vapor evaporating to precipitation returning to epigene surface. All of such spawns thermal energy cycling complying with the Second, First Law and not limited to latitudinal bearing, only.

Said cycling period time and distance corresponds to Air Cells overall relative latitudinal lengths. Said latitudinal lengths include polar caps, glaciers ice surfaces covering epigene surface, which, in turn, embody Air Cells energy cycling and boundaries perfection of troposphere affecting time periods of that cycling. In energy environment, precipitation spawns a milestone event, initiating a comingling of fluids and energy between adjacent boundaries perfection spawning troposphere, epigene surface in-common boundaries perfection said interdependence, which yields period and time interval of Air Cells cycled energy. Precipitation lowers the impurities concentrations in air and emits air thermal energy magnification and radiation to space. Latitudes distance accounting for insolation magnifications and the period of cycling, the prior to the prior application explains.

The overall cycling period, time intervals common period, the period, taken as the time period of one year, shows present Earth's energy budget cycles energy Heat Rate 94% to 95% efficiencies, only. Scientific observations in these applications review geological epochs, time interval cycles as the cycles which, in turn, extend through Holocene, Pleistocene Epoch for 2.2 million years as periods of the Milankovich cycles; the deep core borings sampled deposits show such is the case.

Scientific communities claim that the period more than doubles during the Holocene Epoch. The applications show, rather than doubled, that period is reduced to nigh half its prior period of 41 ka years. Planets highly stable default states effect either entirely frozen epigene surface or very hot and/or gaseous fluids mass epigene devoid of the light fluids. No planet observed to date spawns the light fluids spawned atmosphere that resembles the Earth's. Over 50 times in last 2.2 million years, power cycling Air Cells in interglacial periods repeatedly tries to reset and fails in trending toward glaciation periods frozen planet state, vacillated between a frozen and a hot eternal status.

Scientific communities assume that Earth's present atmosphere energy status comprises a default state an eternal mass energy status, which our entire knowledge of the Universe shows that is not the case. Rather, through geologic epochs, glacial interglacial periods stunning balances of mass and energy cycle energy actions, energy reactions comprises unstable mass and energy balancing in search of eternal boundaries perfection of that mass energy. Such unstable balancing points to an overriding significance of energy directionality and the period, time intervals, of evaporations, sublimations and condensations and, in turn, thereby, thermal radiation energy emission to space.

Glaciation epochs with no AGW effects unequivocally show that energy rather than constituency of troposphere mass mainly determines cycling Air Cells' Heat Rate efficiency. The troposphere molecular viscous fluids, compared to cosmological gravitational dynamics, Ions Isotopes energy cycling in interdependent boundaries perfection are vulnerable to solar insolation mass energy an energy imbalance. In turn, molecular fluids' mass energy outflowing from boundaries perfection occurs; and, Earth's magnetosphere specific, precise, unique plasma fountains outflowing occurs.

Aforesaid underlying cycling energy dynamics of plasma fountains outflowing explain glaciation periods and epochs, Milankovich cycles and how and why Mars loses most, if not all, of the light fluids. It also explains prior applications valid predictions of water presence on Moon and Mars, and, herewith, the future science, technologies absolute Heat Rate 100% efficiencies. In turn, all that shows scientific communities through centuries bungle the Second, First Law energy issues.

In truth, it is simple. Energy eternally cycles in atoms, molecules and in gravitational field sinks, in celestial body mass of epigene or troposphere, tropopause boundaries perfection or, otherwise, cycles cycling cosmological gravitational dynamics Ions and Isotopes boundaries perfections that constitute all of the Universe. Through millions of years, the troposphere, the tropopause spawns boundaries perfection of molecular fluids cycling Heat Rate less than 100% efficiency. They are in the Universe sole such boundaries perfection cycling energy of the energy relativity structures.

The deep core borings sampled deposits, soil samples correct analysis, pertaining to environment energy that transports and deposits the sampled deposits, broadly confirm that cycling molecular fluids energy in environment spawns the impurities concentrations found in the soil samples with global air warming. Scientific community spurns the tropopause and troposphere interdependent mass energy boundaries perfection an energy imbalance, universally unique energy cycles below 100% Heat Rate efficiency, to claim that the impurities concentrations effect global air warming.

Avoiding life extinction requires troposphere, tropopause Air Cells energy boundaries perfection cycling Heat Rate 100% efficiencies. It comes down to the Air Cells directionalities and relative time-periods time-distances corresponding to Air Cells overall relative latitudinal bearing lengths time intervals overall common environment energy cycling a common cycling period, the period.

Understanding the period of energy cycling and said Air Cells directionalities, both highly varied and diverse, herein, presented in highly broad context show crucial time-distance cycling periods energy cycles in environment cycling vapor leaving, returning to epigene surfaces; each instance of water changing phase, including its epigene confluence, cools Earth's mass gravitational field.

Thus, it is critical that said time-distance of the period is shortened as is possible. Distance in the time, distance is a matter of temperature gradients, and in the time, distance time is energy cycles speed, and energy mass speed and time in the time-distance is environment energy cycled power.

It turns out, wind turbines and solar panels syphon environment cycling energy-power that cools, sustains the energy relativity structures of the atmosphere. And, that is hardly all. Of that, a half to two thirds of that cycling energy-power as thermal energy heat byproduct warms environment. The remaining portion of syphoned energy-power residential, commercial, industrial devices use.

In the past, construed clean energy saps environment cycles power cooling cycles Heat Rate 95% efficiencies, to return it into environment as thermal energy byproduct emission. Such emissions invariably spawn, in turn, undesirable energy directionalities and, thereby, prolong energy power cycles and, thus, the power cycles periods which further lower energy Heat Rate efficiency, also.

Furthermore, atmospheric vapors ultimately magnify insolation, therein, extended portion of said period, which magnifies insolation, spawning magnifications of magnification. Accruing greater water vapor masses, in turn, precipitate energetically, effecting very violent flooding, rare events.

Universe energy conserving—energy of cosmological gravitational global dynamics cycling Heat Rate 100% efficiency—engender boundaries perfection omnidirectional boundaries spawning the interdependences interrelated longevities. Whereas, mechanical devices energy transfers cycling in the atmosphere alters mass energy cycling epigene surfaces affected erosion, which shortens a period portion of energy cycling in epigene mass. Prolonging vapors cycling period exposures to insolation, thus, affecting epigene mass surficial erosion lowers the continents groundwater table.

Earth's gravitational dynamics evolving the light fluid fluids centroid, engendering water phases' mass, shifts these mass portions away from Earth's mass dynamic centroid towards Solar System common mass energy dynamic centroid. The troposphere with the tropopause effectuates unique thin shell structure balancing the Earth, the ionosphere and its own spinning effects. Any sizable hole in that structure, similar to the ozone layer hole, much undermines integrity of that structure.

Sciences disregard of the Second and the First Law through centuries, especially in the last seven decades, questions value of environment energy transfer devices—wind turbines and solar panels. Aforesaid Earth's centrifuge/induction device effects its unique cycling of the light fluids unique boundaries perfection structure of the energy relativity structures and the Universe energy power cycles which support life through millions of years. Likewise, showing, especially in the last 2.2 million years, the Air Cells' unique cycling energy-power supply chronically weakens with time.

Earth as an energy device critically, noticeably overheats. From nebula mass and energy tracings to present, conforming to the Second, First Law and Earth's gravitation atmosphere Milankovich indisputably shown, Earth overheating is mainly caused by lack of Air Cells' cycling energy and power cycling the light fluids. Science communities see wind turbines, solar panels as a solution to energy demand, to curtail emission of CO₂ and alike gases; such science is profoundly flawed.

Geologic history glacial, interglacial periods varied global temperatures show that the impurities concentrations energy transfer, including modes of water phase changes, spawn as an effect. The impurities concentrations in glacial, interglacial periods constitute necessary constituents energy, environment energy critical ingredients which engender the Earth's life cycles; such constituency vital energy and its insolation magnification is insignificant compared cosmological gravitational dynamics energy of Earth's gravitational field sink energy portion cycling boundaries perfection.

Tracing cosmological gravitational dynamics energy 100% Heat Rate efficiency, from the nebula to planets of the Solar System, traces Earth's origins respective boundaries perfection and energy specifics of the energy relativity structures of the atmosphere. The applied science technologies, which the prior applications claim, the Fluid Elements and principles, methodologies, inventions, and innovations (PMII), reveal the Fluid Elements, Ions and Isotopes (FEIIPMII) applied science technologies. The Fluid Elements claimed Ions and Isotopes portions, in fact, trace cosmological gravitational dynamics energy and 100% Heat Rate efficiencies, from nebula of the Solar System planets as the Advanced Fluid Elements, to the energy relativity structures of the magnetosphere.

The FEIIPMII applied science technologies amending to comprise the Advanced Fluid Elements cosmological gravitational dynamics principles, methodologies, inventions, and innovations, and these abbreviate said Advanced Fluid Elements, cosmological gravitational dynamics, principles, methodologies, inventions, innovations to AFECGDPMII applied sciences technologies, therein, applied sciences technologies and/or sciences or applied technology science, the AFECGDPMII.

The AFECGDPMII as the Universe cosmological gravitational dynamics energy spawning mass energy modes cycling, orbiting, spinning, and precession, sets forth cycled quantum mass energy quantified by quantum mass or energy accuracies bound by boundaries perfection, mainly shown by electrons, atomic elements, molecules, Ions, Isotopes bound by Advanced Fluid Elements and clustering the fundamental Fluid Elements into successive Fluid Elements boundaries perfection.

The AFECGDPMII extend to the entire Universe known—for certain—applied science confirmed technologies bound energy in boundaries perfection, which affirms technologies verified science with technologies' sciences complete complements—engendering energy absolute technologies—the absolute technologies. Universe energy successive boundaries perfections enlarging volumes affect the successive boundaries perfections in potential energy flux fields of energy flux cycling.

Energy, power cycling environment cycling Heat Rate maximum efficiency, such as those of the energy relativity structures, comprising boundaries perfection cycling Heat Rate efficiencies nigh 100% effects energy power absolute technologies of cosmological global gravitational dynamics.

Aforesaid listed continuous successive boundaries perfection exiting in the Universe engenders a continuous energy field bound quantum energy into successive boundaries perfection, dispensing with energy of mass attracting mass and curved space time, as nonexistent no energy present and or insignificant energy entirely discounted in boundaries perfection Heat Rate 100% efficiencies. A dynamic, mainly static energy mix cycling masses must effect collisions in Universe structure.

Theorizing such space existence embodies cosmological gravitational dynamics energy illusions. Highly dynamic energy embodies preferred enormous flexibility; static energy embodies rigidity, which by necessity cannot exist. Unavoidably, the energy evolution billions of years old changes energy types unable to cycle eternally Heat Rates 100% efficiency cycling in space environment.

Mass attraction of mass and curved space-time are science theorized energy existence of the past, based on, thereby, “observations” which disregard the Second Law. Whereas the Second and the First Law traces mass energy entire evolution, from the Solar System nebula to present, and sees any such and unnecessary energy completely nonexistent—science by disprove me theorizing. If unnecessary energy were to exist and we know—for certain—it cannot, due to energy cycles Heat Rate 100% efficiencies of cosmological gravitational dynamics overriding and disposing of such.

The prior applications added this application common AFECGDPMII, the AFECGDPMII, detail and claim sciences' energy absolute technologies of cosmological global gravitational dynamics.

The AFECGDPMII disclose the energy absolute technologies of the Universe transferring modes of energy cycling solids, fluids, Bose Einstein condensate and radiations accounting for all mass.

Modes of energy transfers emitted energy balances mass energy modes energy at outflowing, but may unbalance energy cycles boundaries perfection. In frictionless medium, an eternal spinning, orbiting and precession dispose of and account for a cycling masses energy unbalance, balancing gravitational sink boundaries perfection mass in boundaries perfection bound energy unbalances. In Earth's gravitational sink structures, such is the case, and plasma fountains outflowing occurs.

The Second, the First Law origins rely on Nature, the Universe Heat Rate 100% efficiency, while Heat Rate less than 100% efficiency originates Earth's atmosphere made up of the energy relativity structures. Earth's atmosphere evolution constituting energy dynamics engender changing climate Milankovich cycles depict and rising temperatures these five root causes: first, boundaries perfection cycled energy respective Milky Way, Earths innate Heat Rates imbalance; second, vapor concentrations creating an atmosphere; third, water phases cycling, modes cycling; fourth, creation of life forms; fifth, emission of greenhouse gases; and, last, industrial revolution; in deviation to the prior and henceforth, the impurities concentrations do not include water vapor. Energy evolution and evolution energy pertain to one and the same energy magnitude difference.

Scientific community ignores evolved cosmological gravitational dynamics, cosmological global gravitational dynamics, the Second, First Law, and the listed five causes of energy cycling global air warming, focusing on the last, the industrial revolution, and very little before that time period. Chronological tracings of energy in atmosphere rising global temperatures show aforesaid innate Heat Rates imbalance initiates and, in turn, sustains that rising through the Pleistocene, Holocene Epochs. During these Epochs, glaciation periods, the energy relativity structures reset, over fifty times trying to balance the innate Heat Rates imbalance, only to fail each every time and to reset.

Chronological tracings of energy in atmosphere to energy cycling first rising global temperatures traces energy actions to aforesaid chronological events, each of which, in turn, raises temperature and effect mutual interaction energy reactions which raise, magnify temperature rise. In said five global air warming causes, Heat Rates imbalance cycling acts first, earliest. High concentrations of vapors, specifically water vapor is second, and all other impurities concentrations is fifth, last.

Once again, science communities elect to discard the Second Law, slight the First Law, engaging in speculation—science by disprove me theorizing. Said evolution of the Earth's atmosphere, the energy relativity structures, by the listed five energy causes of global air warming comprise steps in evolution chain by the energy relativity structures successive energy actions, energy reactions.

Once again science communities flawed theories—science by disprove our theorizing—completely ignores the Second, thus, the First Law and cosmological gravitational dynamics energy, effected steady energy by solar insolation and its magnification and instead focusing on said theories and, on, in this instance on limiting the impurities concentrations, yet excluding water vapors cycling.

Said disprove me theorizing, therein, differs slightly. It substitutes, in that instance, steady static for dynamic energy, therein, to avoid the Second Law. In each instance done through theoretical science modeling rather than, here, present case, through sciences effected technology. The cited prior quote foretells, also, likewise, traps Sir Eddington who buys into such theoretical modeling, which even at this time, is yet to formulate mathematical function of fundamental Fluid Element.

The listed five forms of energy spawns an energy action energy reaction by the other listed forms of energy, and vice versa and, thereby, energy reactions, energy actions, which blurs distinctions, which energy is which. Such chains of forms of energy, cycling energy in environment, magnify said innate Heat Rates imbalance, which overall magnify solar insolation global temperature rise.

The earlies of the three application chains details the Earth's surface, epigene surface comprising boundary perfection, in parts set forth by all three application chains. That boundaries perfection emits own energy by evolution of energy cycles, magnifying all cycling energy, and by changing epigene surface geophysical features and geological periods, all which Milankovich cycles show.

Scientific community discards the Second, thus, the First Law, again. In turn, discarding Earth's geologic and energy dynamics history, said Laws, assigning the root cause of global air warming to AGW emissions. In this instance, focusing on magnification of solar radiation thermal energy by CO2 and similar carbon gases. Even the science behind Milankovich cycles is thus discarded.

Unavoidably realities of the aforesaid five listed forms of energy happening from now to eternity indisputably spawn the true root causes of global air warming, said, innate Heat Rates imbalance, the Earth's troposphere inabilities to cycle energy Heat Rate 100% efficiencies and, unavoidably, specifically, said five causes of cycling energy in epigene surfaces boundaries perfection. Innate Heat Rates imbalance, epigene surface boundaries perfection, either one of the two, is potentially passed the tipping point, the point of no return; these applications' technologies potential recoups a portion of Heat Rates imbalance in the troposphere and epigene surface and are thereby crucial.

Global air warming of the energy relativity structures points to energy dynamics of the listed five causes and to futility of tries to abate global air warming by controlling emissions of CO₂ energy. Solar insolation steady energy and its magnification transmit radially outward warming the lower troposphere. Milankovich cycles show it, based solely on presence of water vapor concentration.

Cycling energy specific effects on the third of the listed five causes—cycling water phases modes cycling—is difficult if not impossible to predict, especially a cycling time period, the time period. However, we know—for certain—the first of the listed five is critical. We know—for certain—the device that has unbeatable Heat Rates efficiency, the super plant, generates bulk energy power to convert atomic to electrical energy, limiting ultimately said third of the five causes in “the Wheel of Nature”, cosmological global gravitational dynamics cycling energy, to restrict all five causes.

Solar insolation and epigene thermal energy eradiating and all magnifications effect environment as these applications explain. Energy natural transmitting affect radially outward directionalities, which warms the lower troposphere masses which, in turn, distances mass energy centroid inside spinning, orbiting and cycling shell surface comprising cycling mass energy atmospheric masses.

Said energy radially outward directionalities and innately orthogonal directionalities of Air Cells primarily latitudinal cycling, but also a longitudinal cycling, directionalities respective energy air cycling yield the period and length of the period covering relative geographical areas. Global air warming optimizes energy cycling radial directionalities and high altitude precipitations cause by elevations relative changes, spawning the period which limits geographical areas of precipitation.

Said energy radially outward, rather than primarily latitudinal and longitudinal cycling energy air directionalities in the atmosphere reveals potential of said three gravity fields to redistribute mass energy inside boundaries perfection of Milky Way Galaxy. Globally radial, outward energy flow directionalities block, divert Air Cells air masses cycling directionalities. Prevailing, globally an outward, inward radial directions energy cycles including said high altitude precipitations, which solar insolation magnifies, must eventually spawn Earth's gravitational field plasmas outflowing.

Said three gravity fields, in fact, effect further evolution, redistributions of solar nebula mass and energy, exclusively the light fluids energy. Earth's evolution of its boundaries perfection evident redistributions of plasmas mass energy fountains outflowing balances atmospheric, Solar System overburden relative pressures in respective boundaries perfection. Said evolution, redistributions show Solar System cosmological gravitational dynamics distributes the light fluids energy waves away from the Sun. Such presently shows the Earth is at a tipping point, affecting either a frozen Mars or hot Venus scenario. Earth gravitation must cycle Heat Rate 100% efficiency, balance its energy field boundaries perfection, and stop the light fluids outflowing by natural redistributions.

Cosmological gravitational dynamics energy effects plasma fountains mass energy outflowing to successively larger boundaries perfection by the absolute technologies of gravitational dynamics. Plasma outflowing can reoccur through millions of years. Gravitational waves energy in form of distributions energy are a quick, time energy redistribution into successive boundaries perfection.

Plasma fountains outflowing or gravitational wave energy, each rebalances boundaries perfection by boundaries perfection mass energy redistribution affecting boundaries perfection construction, affecting the primary structures of the Universe structure, which delineates the primary structures in the Universe structure. The primary structures successively larger structures, each comprising quantum energy defined each and every successive boundaries perfection, eventually embody the Universe entire structure, entire mass energy quantum energy delineated to a quantum resolution.

Also, we know—for certain—each of the primary structures, itself a bounded energy in successive boundaries perfection, spins affected energy dynamics balancing itself and the primary structures taken boundaries perfections of successive structures and dispositions, which, also, engenders the relativity energy by cycling cosmological gravitational dynamics an energy redistribution. Form of the relativity energy is wholly that of energy dynamics; mass presence acts as ingredient, only.

Cosmological gravitational dynamics bind the primary structures mass energy varied ingredients, ingredients forms photons, electrons mass to the Universe bound energy. That energy constitutes energy of creation and evolution orbit, spin and precession, which, thereby, balances all and each of the primary structures ingredients mass, energy and mass ingredients in boundaries perfection. Most, not all of the primary structures comprise the relativity energy eternalized cycling bounded boundaries perfection boundaries perfection dynamics by the interrelated, interdependent energy.

Prima facie credibility evidence of the relativity energy shows up as energy that binds boundaries perfection of galaxies and Universe, as energy spinning boundaries perfection infinite diversities, and intermediate binding of a system, progressing from a gravitation field celestial body down to cycling an electron in an atom comprising quantum energy binding a respective boundary and its environment dispositions energy cycling. The relativity energy binding eternalized energy mass, environment bound energy, affects presence of the relativity energy in primary, intermediate and smaller structures taken boundaries perfection or a quantum energy, photon, electron disposition.

Of course aforesaid defines, sets forth, respective energy mass configuration of galaxies, systems and celestial bodies delineated to resolution of quantum energy. In turn, aforesaid also sets forth, defines all-inclusive sciences and technologies of the primary structures in the Universe structure and the Universe structure itself. Of course, the Universe structure and the all-inclusive sciences, technologies, each one and all three in-common entirely consistent, embodies the Universe mass.

Affecting the interrelated, interdependent energy of cosmological gravitational dynamics cycling Heat Rate 100% efficiencies embodies entire Universe configurations of the relativity energy and mostly globose spherical each body an orbit, a spin and a precession. Cosmological gravitational dynamics energy sets forth the relativity energy cycling variable, unpredictable energy of and by each celestial body in a bound cycling globose spherical energy structure, the Universe structure.

Affected binding of the relativity energy embodies boundary and disposition types. Environment cycling energy comprise boundaries perfection class types, which, of course, does not specify the energy magnitude or energy environment such boundaries perfections and any other types. Such binding eternalized energy yields environment mass ingredients globose spherical forms, or each form evolving such a shape, or a globose disk shape still evolving optimal boundaries perfection.

The relativity energy affected perfection boundaries grant spherical globose body of the Universe to expand contract, while keeping the primary and the relativity energy configured structures and concomitant energy distribution with the primary structures energy redistribution by gravitational energy dynamics and plasma fountains. Even interstitial closed spaces may expand into vacuum, which remains a confined space. Boundaries perfection and Heat Rate 100% efficiencies cycle a whole of the Universe energy structure affecting boundaries perfection sustenance and evolution.

Time that spans undefined space remains undetermined as a whole and, therein, in increments of whole space, undefined as such. The Universe, a whole structure, cycling, spinning, orbiting and precession occupies varying space which stays undefined. Infinite time, or undetermined eternal increment time, in energy boundary binding the Universe structure occupying varying, undefined space stays undefined; all of which reveal bungling sciences stymied inventions and innovations.

Curved space-time potentially may apply outside boundaries perfection of the Universe structure, as it cycles, spins, orbits and precessions, but not inside it. No one can imagine such, except that scientific communities place curved space-time in the Universe structure, which, in turn, violates the Laws of Thermodynamics. Herewith, by references to the First or the Second Law, if energy boundary is not traceable or does not comply with the Laws of Thermodynamics, it is imaginary.

Anything outside the Universe structure stays undefined; all such need not comply with the Laws of Thermodynamics. Within an energy structure of the Universe and each successive boundaries perfection energy cycling must conform to stated Laws. Such energy traces energy in successive boundaries perfection cycled and confined energy, to sustain boundaries perfection by said Laws.

Aforesaid discloses, claims that the Universe structure is predominantly energy cycling structure, which in time of its evolution cycling eternalizes its cycling energy portion, affecting the primary structures energy cycling Heat Rates 100% efficiencies. Each boundary perfection of each of the primary structures grants or sustains cycling energy cycles, spins, orbits, and precessions relative dynamics or that boundary breaks-down and that energy evolves, taken into adjacent boundaries.

The relativity energy effects interdependent energy dynamics in boundaries perfection successive structures which engender spawning the interdependences interrelated longevities. The relativity energy by primary, intermediate, secondary structures, and down to photon or quantum binds the relativity energy relative dispositions energy cycling affected energy mass boundaries perfection.

The relativity energy, in parts, comprises one body Universe remnant residual stresses, energy of reactions created in the past, potentially in the time of Big Bang. Spawning the interdependences interrelated longevities binds plasma fluids into surfaces in space, engendering energy structures, centripetal forces energy dynamics affected depressions which oppose a disunity of Universe; the secondary structures—atoms, electrons boundaries perfection—fiercely oppose any such disunity.

The prior sciences embody space-time and the Universe in boundaries perfection of the Universe as one and the same, which is profound overarching flaw. Theorizing existence of curved space-time admits that energy exists inside Cartesian coordinates and time coordinate; in turn, we know—for certain—space-time exists inside and outside of the Universe structure; we know—for certain—potentially spawned forms of energy cycle, every which way. We choose—for certain, why not,—to extend said four coordinates, outside the Universe to define space-time, and we also choose—for certain—that these are linear and absolute, true and deterministic space-time, set forth as such.

Difference between curved and not curved space-time has Universe energy resolution theoretical verses actual prima facie credibility—facts. Here, quantum accuracy model defines the Universe; no space-time impacts ubiquitous energy cycling environment energy boundary taken boundaries by boundaries perfection. Herein, model identifies each of the primary structures in the Universe and the relativity energy binding them in the Universe structure, binding the Universe. All of the boundaries conditions sustain the Laws of Thermodynamics, comply with Second and First Law, in each. Herein model, the actual Universe, entirely conforms to resolutions quantum accuracies.

Two set forth models—two space-time models do not exist—only one Universe exists; veracity of quantum resolutions leave no doubt as to validity that says gravity is a centripetal force presence, specifically the cycling energy effect by cosmological gravitational dynamics centripetal forcing. The herein model, the FEIIPMII Sciences and technologies, the FEIIPMIIST, the AFECGDPMII model conforms to absolute maximum and ultimate Heat Rate, effecting ubiquitously Heat Rates 100% efficiencies, complying with the Laws of Thermodynamics cycling molecular and plasmas fluid separately bounded energy. Earth effects an example of such bound fluids bounded energy.

Structure of the FEIIPMIIST and the AFECGDPMII model, the real Universe, comprises energy conglomerates infinite diversities of energy structure spawning energy boundaries perfection and energy mass dynamics perfection, taken space and time unilateral independence. Universe space time restrictions are scientific community creation to explain postulated theories; Universe needs no such restrictions, has none and cannot tolerate such restrictions. All such are scientific myths.

The Universe is enormously more precise than anything to date theorized. It tracks its own space and time, instantly and cumulatively. As conglomerates of energy structures, the Universe innate genres complete conforming to the Laws of Thermodynamics yield absolute space-time stunning perfection, as eternal energy dynamics within boundaries perfection bind mass energy structures.

Basic energy strikingly fundamental complete complements bind energy by compositions infinite diversities in energy boundaries perfection infinite diversities, all of which cycle Heat Rate 100% efficiency. A celestial body, an Advanced Fluid Element, cosmological gravitational dynamics a centrifuge device, comprises a total centripetal force, which the prior sciences see as an attraction of gravitational mass. Separated centripetal force, centrifugal, torsional forces spawn the Earth's spin about its axes and its orbit and precession about the Sun and its Black Hole, in the Universe.

Centrifugal force spins and/or spirals of a celestial body, a solar system, a galaxy or the Universe dissipate angular dynamics imbalance spins, precessions and orbits by affecting mass and energy characteristics of respective orbits. Concomitant centripetal, centrifugal forces effected torsional force embodies precession cycles. A directionality distinguished and segregated forms of energy mass structure frees completely the Universe eternalized energy structure from space-time effect.

If space-time were to exist and we know—for certain it does not—since it is unnecessary. Energy structures constitute dispositions of free deformations configuration changes in domains of space and time, wherein all structures evolve in space and time. All such is exactly what cosmological gravitational dynamics energy does segregating forms of energy into celestial bodies' boundaries perfection mass respective orbits, spins or spirals and precession dispositions occupying changes in domains of space and time. Such are mass and energy eternal evolutions extending to eternity, which show postulated curved space-time violates the First, Second Law and Universe evolution.

Here, distinguished, separated out types of energy show the prior curved space-time theorizing at length is profoundly flawed, because deformations of space, time do not occur. Likewise, energy mass structures do not concomitantly strain or stress in space-time coordinate. Instead, spins and orbits change speeds and orbiting paths unperceivably accommodating any energy imbalance. In curved space-time “mathematical proof”, energy boundaries perfection are missing. Each energy boundary perfection must have dynamic coordinates' space-time dynamics transfer functions; the inequality indicates curved space-time, in fact, proves that taken space-time is not a real solution.

That the Universe energy structure cycles, spirals and fluxes through space, independent of space time is given certainty as a whole either expanding or contracting or both, or in parts necessary to evolve continuous Heat Rate 100% efficiencies. In difference to ordinary structures which stress strain restricted in space and time, the Universe energy structures, ubiquitously and likewise self-spawn energy balance free displacement. Ubiquitous segregating genres mass energy constitutes unique problematically exact boundary of troposphere existence in the Universe energy structure.

In fact, by balance of energy free displacement, the Universe evolution, the gravity evolution, are unaccounted by the prior science, which last constructively through billions of years engendering mass energy conservation of the relativity energy within boundaries perfection. Such boundaries perfection, successive boundaries bind boundaries perfection of the Earth's Advanced Processor.

Energy free displacement, balancing the Universe evolution, the gravity evolution, missing in the prior sciences substitute mass properties and energy reactions for energy actions. Examples of it are mass attractions force energy actions substituting for cosmological gravitational dynamics of centripetal force energy actions which herein explains. Wherein, trust is in a first-hand observer taken observations—by in situ measurements—rather than theoretical mathematics taken insights.

Presence of the relativity energy in all energy structures bind the Universe. The Universe at least in parts usually affects in-common energy spinning, orbiting or spinning, spiraling more than one celestial body three-dimensional compression centripetal forces in a System boundary perfection. Energy constitutes energy of creation and evolution orbit, spin, and precession, which balance all and each energy structure—energy mass ingredients and boundaries perfections energy dynamics.

Solar System binds maximally its nebula energy in a new or same boundaries perfection. Energy dynamics date back to same quantum energy prior to Big Bang, which Systems, Galaxies present perfection boundaries bind. The Universe energy structure energy boundaries bind in boundaries perfection infinite diversities which the relativity energy binds by successively larger boundaries, the larger boundaries perfection energy, in turn, affecting the interrelated, interdependent energy; the interrelated, interdependent energy, the interdependences interrelated longevity, the relativity energy binds the Universe energy structure, quanta dynamics of each celestial body, by quantum energy dynamics evolving space, time domains quantum energy dynamics precise balances. The Universe energy structure evolving the interrelated, interdependent energy, the interdependences interrelated longevities of a celestial body balances by the relativity energy and energy dynamics.

Energy does what energy does by tracking the Laws of Thermodynamics, only. A disposition of Earth and Sun determines, sets forth day, month and year time intervals from advent of sciences, difficult to accurately measure extremely precise, if it accounts for boundaries perfection energy, time evolving interval; said Laws in any shape or form do not limit by entirely not needed to date unquantified space or time part(s) of celestial bodies in the Universe energy structure boundaries.

If it cannot exist as energy, it cannot exist. The Universe energy structure energy quanta balance energy dynamics in each boundaries perfection cycling quantum energy precise accuracies, in all perfection boundaries from Advanced Fluid Elements to photons. Galaxies as largest boundaries perfection bounding smaller perfection boundaries cycled energy, in turn, constitute the Universe energy structure. In turn, quantum energy defines boundaries perfection and the Universe model.

Said centrifuges in all celestial bodies effect in-common respective boundaries perfection unique spinning, orbiting of a respective galaxy, or in a solar system and in a galaxy with the centripetal (axial), centrifugal (tangential) forces, wherein cycling, orbiting, spiraling torsional forces spawn (precession, inclinations) torsional dynamics cycling; all which the prior sciences miss or ignore.

Most significantly the prior sciences miss or ignore unique nature of the Earth's energy relativity structures, especially boundaries perfection of the troposphere, and importance of Air Cells mass boundaries perfection energy cycling, which to date is sole such in the Universe energy structure.

Orbit, spin, precession said interrelated, interdependent energy, the interdependences interrelated longevities and the energy balance free displacement spawning eternalized boundaries perfection of celestial bodies comprises the relativity energy cycling mass and energy with unique a rupture energy precise energy distributions bind boundaries perfections of the Universe energy structure.

The Universe energy structure possesses nigh infinite elastoplasticity of boundaries perfection by all eternalized energy structures, celestial bodies, all of which in suspension are also cushioned in an atmosphere respective plasmas layering. The earth further cradled by troposphere air cushion. The Universe energy structure is infinitely more dynamic and elastoplastic than the prior theories theorize, which the troposphere, tropopause, magnetosphere enormous fluxing amply epitomizes.

The nigh infinite elastoplasticity of orbiting, spinning precession and boundaries perfection mass energy absolute conservation comprising Heat Rates absolute 100% efficiencies, by the Universe energy whole structure, must spiral or tumble through space independent of space independent of time. Elastoplasticity in aforesaid energy dynamics eviscerates possibilities of curved space-time that implies stiffness in the Universe, which we know—for certain—is not the case, as is detailed, herein. The prior science theories, not in possession of boundaries perfection sciences, substitute curved space-time theorizing for boundaries perfection shown, here, nigh infinite elastoplasticity.

The Universe energy whole structure said spiral or tumble through space allows each space, time frame independent four degrees of freedom comprising most expedient energy cycling dynamics. Herein, explained in detail, such energy dynamics expose the fact that equation E=mc² requires a rigidity of the Universe energy structure in does not, cannot possess—an inconceivable rigidity of that structure, to yield concomitantly mass energy conservation and Heat Rate 100% efficiencies.

By Einstein's own statement, mass and energy are manifestations of one and the same thing; that makes that right! Really! Do we really absolutely do meant it? Take the most glorified equation E=mₒ c²+1/2mv² (1), which leads to the super glorified equation E=mc² (2); wherein, mₒ is relativistic mass, m is Newtonian mass, and speed of light c is taken as speed of light in vacuum.

Affirming that Equation (1) is an equality, one must convert Newtonian mass (m) into relativistic mass (mₒ). Substituting equivalent mass (mₒ) for mass (m), as aforesaid centripetal energy force comes with concomitant centrifugal (orbital) and precession (torsional) directionalities respective gravity spin, orbit and precession directions; in reality none of it is doable; the following explain.

Even more complicated is aforesaid unknown spiraling or tumbling of entire Universe, having no displacement zero reference point. To untangle directionalities in Universe energy cycles—if that herculean effort happens—may take centuries and brings to mind boondoggle of the Higgs boson.

The substitution of equivalent mass (mₒ) for mass (m) proves Equation (2) in most, very likely in all instances, the first hand observer would never see; wherein the last term in Equation (1) is the significant term, much larger than the (mc²) term. Mass (m) is at least equal to, in most instances infinitely larger, than (mₒ). Concomitantly, velocity vector (v) in the Equation (2) last term must account for spin, orbit, precession by gravity field and the Universe. Generally, Newtonian term, in Equation (1), is infinitely larger than the (mₒ) term, especially, because, the first hand observer sees that a Newtonian mass energy governs—blocks, deflects or refracts the light energy photons.

Two vacuum types occur—static and dynamic. Dynamic vacuum spins, orbits, precessions inside boundaries perfection that encloses it as “Newtonian” or vacuum common type. Vacuum second type is any space, time outside of the Universe energy structure, as static space, time, which begs defining curved space-time phenomenon that crosses boundaries perfection of gravitational field.

In mathematic computing “validated” curved space-time, as in deriving of the Equation (1), there appears a radical, square root of (1−v²/c²) wherein the Newtonian velocity (v²) is not sole velocity of mass (m), and is velocity v² sum of mass (m) velocity with gravity field, the Solar System and the Universe spin, orbit and precession total speed (v) of mass (m) which as such most likely can exceed speed of light (c). In all such instances, radical (1−v²/c²) comprises an imaginary number.

This application elaborates on many such failures, thus, to disclose/claim global air warming key technologies, sciences, resolutions, and solutions, which reside in quantum energy dynamics, and not in approximations of such dynamics in imprecisely defined, approximated curved space time, and litany of constants, crutch-factors, taken to show, prove and collaborate “scientific” theories. The technologies, sciences, resolutions, and solutions, which reside in quantum energy dynamics disclose diversities in the Universe energy structure, none of which a constant format may define or crutch-factors may bind. The Second Law stipulates such, and all such are unavoidable cases.

Genesis of the Solar System bodies from a single nebula accrued energy in a pressure depression of the Universe energy structure confirms nonexistence of gravity attraction force. Rather, supra three-dimensional centripetal forces explain gravity force. Equation (1) equality in its entirety an incomplete energy formula the Inequality (1), the prior sciences improperly claim as an equation.

E, m, v, mₒ and c, each and all, signify energy parameters comprising an energy source, sink, and energy field, which, in turn, comprise energy environment, cycling directionality, and boundaries perfection. Parameter m signifies mass—in Earth's gravity field, v—a velocity in environment of the troposphere, and mₒ—mass of a photon and c—speed of light in the Universe energy structure; each parameter comprises its environment, source sink, directionality, and boundaries perfection.

Energy of mass m—herein eternalized energy mass—spins, orbits, precessions as the gravity field does. As a component of energy, velocity-v is a vector in most instances insignificant, compared to mass-m spins, orbits, precessions. Directionality longevity of velocity-v of mass-m in passing molecular fluids environment is crucial in energy equations. Then, the parameter mₒ, relativistic—non-atomic mass passes through gravity field fluids in energy wave form, unless blocked by an atom or ion and the Inequality (1) reduces to E=1/2mv² inside gravity field boundary and E=0, nullity, outside of it, in space. Now, Equation (1) unequivocally says Newtonian physics govern.

Energy fields of the Universe energy structure accrue molecular fluids, plasmas and radiations in boundaries perfections of distinguishable energy forms, such as the energy relativity structures of the atmosphere. Equation (1) not to constitute an inequality requires mechanism that may equate forms of energy in Equation (1) parameters to allow these parameters to combine. The Universe energy structure energy structures show how that is done; and, the Inequality (1) is an inequality.

The Second Law engenders such mechanisms, which trace energy and equate energy parameters. In short, as the Inequality (1), the Equation (1) as such does not account for the energy dynamics of the Universe energy structure, which accounts for longevities of energy forms, cycling, power, directionalities and such parameters in unit energy dynamics of successive perfection boundaries.

Eternized energy mass as Newtonian mass valid energy accounting for spin, orbit and precession discloses that E=mc² in the Universe most likely may and may not occur in the energy center of the Universe energy structure, only. Light—c speed photon taken linear path that deforms in spin, orbit and precession, in the Universe energy structure hugely diverse energy fields, may show its location, disposition, direction the net speed range from nigh nullity to a multiple or a fraction of its speed in vacuum, depending on that location spin and orbit, spiral or tumble and precession in time and space domains. Parameters, speed of light included, in space, vacuum on the outside of the Universe energy structure proper is irrelevant since space is static and time advance is steady.

The prior paragraphs show that the theoretical science communities insist that Newtonian masses observed by the first hand observer in the Universe energy structure as eternal and guaranteed by energy comprising boundaries perfections of atomic elements has flows. Yet, these communities take varying relativistic masses defined by squared speed of light in vacuum, which the first hand observers cannot measure and which eternalized energy boundaries perfections do not guarantee.

To the contrary, the Inequality (1) takes Newtonian mass eternalized energy mass as if stationary and—for certain—mass which inherently, unavoidably comprises its spins, orbits and precessions. Inequality (1) by the theoretical science communities and their supporters usurps all validities of Nature technologies of the applied science, which unsuccessfully continues for an entire century. In such effort, decades of exhaustive experiments exposes Higgs boson experiments as tinkering with eternalized energy boundaries perfections by which Nature guarantees stability of Universe.

Inequality (1) in entirety is useless, since relativistic masses depend on speeds of light in vacuum which stays eternally imprecise. It is empowerment of the theoretical scientist creation of and by the same and by the theoretical science practitioners and supporters who presume that theoretical computing discerns intricacies/complexities in energy dynamics in the Universe energy structure. Proposing Inequality (1) as Equation (1) irrevocably and undisputable affirms, none of it is valid.

When photon hits an atom or ion, speed-c, relativist mass, photon mass, and light energy cease to exist, all that energy transfers into energy cycling in its boundaries perfection. Then, that energy as environment energy that conforms to Newtonian physics of motion term E=1/2mv² includes.

In the instance, when photon happens not to impact anything, it yields linear energy vector which cumulative centripetal force by all gravity fields in the Universe energy structure band and return to its starting point; thus, from the outside the Universe energy structure looks like a Black Hole. Examining all parameters in Inequality (1) E=mₒ c²+1/2mv², it is apparent that the terms on the right side of equation are not additive outright. Mass—mₒ as relativistic mass is inherently linear, while mass—m inherently spins, orbits and precessions along with gravity field energy dynamics.

Then, mₒc² embodies energy part of the Universe energy structure whereas mv² embodies energy part of gravity field structure, two completely, entirely boundaries perfection boundaries, entirely and completely two different energy systems; Inequality (1) can constitute an inequality, only. It is apparent that the prior sciences bungle boundaries distinction of the Universe, the gravity field. The computed inequality that supposedly proves curved space-time is an irrational solution since two systems, gravity and Universe, embody energy in two boundaries rather than only one taken.
Then Equation (1), E=mₒc²+1/2mv², in fact is Inequality (1) E≠mₒ c²+1/2mv².

In the Inequality, the second term also is generally nigh infinitely larger than the first term, while its motion longevity in molecular fluids is infinitely smaller than that in the first term which may last into eternity. The first term constitutes Universe energy balance, the second term constitutes gravity field balance; there is absolutely no energy alike and additive on Inequality (1) right side.

Entirely different energy parameters physics in the Inequity (1) right side begs the question as to physical parameters term E represents—never mind the units of quantities. Inequality (1) term by term claims equivalence that in entirety and term by term makes an inequality. Such results from prior sciences set forth a gravity field balance due to spin about its axis, only. That—for certain—is not the case. Boundaries perfection of energy fields take spins concomitant orbits, precessions energy and eternalized energy mass balanced perfection boundaries as if one, in-common energy.

Dynamics of concomitant spins, orbits and precessions affecting boundaries perfections balances in-common energy balance, engendering the relativity energy that binds energy dynamics among celestial bodies' energy fields. As a governing phenomenon, enormous pressure and temperature eternalize energy into internalized energy mass, which when it happens in space must spin, orbit, precession to balance its in-common energy and eternalized energy mass derived from its nebula.

Said two right side terms represent two different parts of two different structures, and as such are not additive; the two represent energy and eternalized energy mass, which spin and spiral, tumble or orbit and precession in different directionalities, which affect perfection boundaries of entirely different energy structures. Said two terms inappropriate additions explain theoretical computing taken flawed results as indisputably correct results in the Universe model a deeply flawed vision.

If speed increases mass, photon has no mass and is energy, only. And, Equation (1) yields, from mₒ=energy and c² as energy, which modifies validly Inequality (1) into Equation (1) which also binds all gravity fields boundaries perfection boundaries in boundaries perfection structure of the Universe energy structure. In that boundary, photon comprises energy, only, comprising a linear path which bends only slightly by spin, orbit and precession of a gravity, comprising light energy waves along with various radiations, irradiations and forms of energy waves energy emissions; in a gravity field, then

E=energy−e_{xyz}+1/2mv².

Wherein energy−e_{xyz} comprises hydrostatic pressure on boundaries perfection of a moving object, and kinetic energy of a moving object boundaries perfection, in uniform hydrostatic pressure has,

E=1/2mv².

Which says Newtonian physics govern provided boundaries perfections of energy fields adjust to avoid energy crossing energy perfection boundaries deformed boundaries to embody energy−e_{xyz}. All such energy drives stunningly boundaries perfection enormous fluxing of the magnetosphere. Inequality (1) concept becomes correctly Equation (1) when applied to a single system boundary; in this instance, for molecular fluids energy in the troposphere, tropopause perfection boundaries, only. And, we write it in this format, energy of warming global air E_{gaw}, such warming energy Eᵢ into the system, and Eₒ outflowing energy. And we want E_{gaw}=0=nullity and we take Air Cells kinetic energy, 1/2mv² as K_{ac} and Eᵢ=as K_{ac} K_{c}, wherein K_{c} comprises a variable coefficient ratio of Air Cells kinetic energy K_{ac} of Eᵢ/Eₒ from proven Inequality (1) concept shown in Equality (1).

System wise kinetic energy actions K_{ac}, energy reactions K_{c} yields approximate thermal radiation emitted to space by air vapors condensation/precipitation and epigene surface radiations, wherein

E≠mₒ c²+1/2mv² Inequality (1)

E_{gaw}=Eᵢ−Eₒ, and/or E_{gaw}=Eᵢ−K_{ac}K_{c} Equality (1)
Wherein E_{gaw} is energy inflow minus energy outflow, or

E_{gaw}=Eᵢ−Eₒ, or E_{gaw}=Eᵢ−K_{ac} K_{c}, and for E_{gaw} set to nullity−0,

0=Eᵢ−K_{ac}K_{c}, and since K_{c} is a variable coefficient,

E_{i.}≈K_{ac}K_{c} Equality (1, 2)

Since global effort tries limiting global air warming, Equality (1) is set to nullity, here. From the Earth's energy budget computations, K_{c} approximate magnitude is between 92% and 96%, down from a time of 100% when in air volume of triatomic and multi-atomic fluids was extremely low.

Energy equation Equality (1), as energy concept equation shown in the Universe energy structure as an inequality, the Inequality (1), as energy concepts in equalities validly and correctly apply to equate molecular fluids of the tropopause, troposphere in Equality (1) and Equality (1, 2). These Equalities show that located in Air Cells of the troposphere environment no energy device lowers global air warming energy, unless the Air Cells energy cycles sustain Heat Rate 100% efficiency.

Although the Air Cells cycling energy crucial Heat Rate efficiency is only in taken range of 92% to 96% range, nevertheless Air Cells energy is irreplaceable priceless commodity, and less 100% efficient makes that energy even more priceless. Air Cells cycling kinetic energy low Heat Rates efficiency, by diatomic air molecular fluids cycles, threatens extinction of life oxygen dependent.

In mathematical terminology, in approximate equality, as Equality (1, 2), K_{c} is energy reactions a function of the Air Cells cycling energy kinetic energy actions, which, in turn, place emphasis on energy mode type of global air warming term E_{gaw}. Earth's eternalized and cycling energy traced form nebula state to present state traces cosmological energy dynamics energy dynamics retained in boundaries perfection of the gravity and magnetic fields, by energy dynamics Heat Rate 100% efficiency cycling, separate cycled, eternalized energy densities in gravity field energy dynamics.

In addition to stratifying eternalized energy, cycling energy density, Earth's gravity field a single continental mass epigene surface separates into seven parts that engender fauna and flora. All of it experiences glacial, interglacial periods' respective energy dynamics, depicted by Milankovich cycles for the last 2.2 million years. The previous application discloses evolving epigene surface in time domain causes magnifications of solar insolation; we know—for certain—molecular fluids cycle less efficiently than the rest of the Universe does. Cosmological gravitational dynamics all such energy actions, energy reactions evolves the Earth's gravity field from the energy of nebula.

Energy mode type of global air warming term E_{gaw}, by the Second Law trancing forms of energy, discloses that the term E_{gaw} represents energy actions of cosmological gravitational dynamics. In turn, E_{gaw} embodies energy inputs into the troposphere, tropopause boundaries perfection system and in Equality (1) the term Eₒ, wherein the plus, minus sign accounts for energy flow directions.

In mathematical language, again, in Equality (1), each of the three terms is a function of the other two terms. Equality (1, 2) each term and specifically terms K_{ac} and K_{c} comprises functions of the other two terms functions, also. And, thus Equality (1) with Equality (1, 2) shows that an energy imbalance in boundaries perfection of the troposphere, tropopause dispositions trends towards an energy imbalance rebalance inside deformed boundaries perfection balancing energy imbalances.

And, that is exactly what Milankovich cycles show—troposphere, tropopause energy imbalances, based on observations of changes in epigene portion surfaces which comprise boundaries portion of molecular fluids comprising the troposphere, tropopause—the Air Cells—cycling energy. That kinetic energy, also disclosed by variations of impurities concentrations in the deep core borings, correctly correlate with temperature variations but improperly correlate entirely to concentrations variation in CO₂ concentrations; that in itself is not a fatal flaw, but implementing energy devices which consume the Air Cells energy cycling the troposphere is precisely an improper thing to do.

The previously explained mathematical terms each term represents the mathematical functions of the other two terms in the two derived in Equalities equality wherein each term comprises energy dynamics, which constitute a set of parameters respective functions of cosmological gravitational dynamics energy dynamics. A CO₂ concentration in the impurities concentrations comprises one among numerous parameter functions which balance cosmological global gravitational dynamics energy dynamics caused energy actions within the troposphere, tropopause boundaries perfection boundaries. In energy dynamics history, which disclose Milankovich cycles, CO₂ concentrations comprise one of the parameters but not the ultimate root cause of global air warming phenomena.

That phenomena engender a list of energy forms spawning root causes in environment, which the previous application explains. Here, energy of global air warming root causes encompass energy parameters which comprise the root causes of energy causing Earth's gravity evolution global air warming. These energy parameters are presented in mathematical functions two Equalities. The Equality corrects flows in the most glorified equation, here proven inequality E≠mₒ c²+1/2mv².

From that inequality concepts correction, equality E_{gaw}=Eᵢ−K_{ac}K_{c} and, in no global air warming case, approximate equality E_{i.}≈K_{ac} K_{c} result; both of these show deep profound flaws in “green-energy” set forth concept when an energy device resides inside boundaries perfection boundaries of the troposphere. In the equality, we want terms K_{ac}, K_{c} maximized to minimize E_{gaw}. Yet, the energy device consumes, term K_{ac} energy, either kinetic or radiations energy, to generate “green-energy”. Thereby, the Air Cells kinetic energy cycling that cools the troposphere air mass drops.

Unavoidably, said variable coefficient ratio K_{c}, thermal radiations K_{c} energy reactions emitted to space, in general, occur with vapors condensations release of thermal energy and Earth's epigene surface irradiation thermal into radiations energy concomitant conversion must drop, specifically addressed later. In such cases, proximate Equality (1, 2) does not hold wherein Eᵢ>K_{ac}K_{c} shows energy devices kinetic or radiations energy conversion into electrical energy inside boundaries of the troposphere perfection unavoidably engenders global air warming and gravity field evolution.

Such energy conversion Heat Rate efficiencies vary from about 33% to 50%, which, in turn, emit radiations and kinetic energy conversion respective thermal energy unavoidable emission of 67% and 50% into environment. In the Equality (1), pertaining on a device type Heat Rate efficiency, 50% to 67% of energy term K_{ac} in the Equality (1) switches from the right to the left side, therein comprising an additive energy portion to the energy term E_{gaw}; energy K_{ac} term a reduced portion that remains on the right side has further reduced the variable coefficient ratio K_{c} energy portion.

Energy term K_{ac} substantially reduced and variable term K_{c} portions reside on both sides, now, of an inequality. K_{ac}K_{c} energy portion on the right side precipitates air impurities a smaller portion, while K_{ac}K_{c} energy portion on the left side, now thermal energy, suspends the impurities additive amounts in air mixture. In fact, these devices cause generated “green-energy” global air warming temperature rise and impurities in air greater amount the first hand observer in environment sees.

Most important circumstance to realize is that global air warming phenomenon engenders energy actions of cosmological global gravitational dynamics in time domain, which spawn an evolution of the Earth's gravity field. Another most important realization is an undeniable fact that cycling molecular air fluids, to best of our knowledge of the Universe, occurs in boundaries perfection of the troposphere and tropopause, only. Yet, another such realization sees configuration of Earth's magnetic, gravity fields dispositions nigh perfect in space time, if not entirely perfect. One more realization sees civilizations intelligent most grievous historical blundering in the “green energy” devices consuming the Universe unique energy, the Air Cells cycling energy, to cause its demise.

The prior paragraph affects facts disclosure that in the atmosphere the energy relativity structures engender perfection beyond ordinary. Further, Milankovich cycles, with the analysis of the deep core borings obtained samples, detail energy dynamics in the evolution of Earth's gravity field.

Energy emitted into environment energy equals energy accruing in that environment as potential, kinetic energy of eternalized energy mass cycling that environment. In that environment, kinetic energy affects flow that balances pressure and temperature differential arising in its environment.

Equality (1) reveals that global air warming, the prior science—global warming—root cause(s) act innately, naturally, entirely in the troposphere, tropopause and significantly much less, if at all, in space plasmas environment. It is life existences issue, since diatomic molecules pass most of the radiations and irradiations, while triatomic and multi-atomic molecules may block forms of wave energy. Life existence depends fundamentally on dispersed triatomic molecules tiny percentages in the air. Human ingenuity must focus on Equality (1), on masse technologies energy dynamics.

Global scientific community focuses on CO₂ emissions as static mass that indirectly relates to the Equation (1) energy dynamics portion affecting a lesser portion of that energy total as a mass that comprises nigh insignificant portion of the troposphere, stratosphere mass. That focus disregards energy dynamics, which drive CO₂ concentration along with temperature, pressure energy issues.

Main institutions rather than to glorify must critically account for misconception responsibilities of scientific community; specifically, those disclosed here, which pits wits of global civilizations relying on crutch-factors science against superintelligence ruthless, precise power cycling energy dynamics quantum precise. Milankovich cycles show it. Yet, all global institutions misconstrue the main adversary the entire human race faces and bask in self-glory as human extinction nears.

Milankovich cycles show graphics analyses of the impurities concentrations, through 2.2 million years, with uncanny stunning relationships among the impurities concentrations and temperature, in cycled energy environment, each and all cycling through glacial periods of geological Epochs.

According to above one-sentence facts, scientific community global institutions and entities sign under the Paris agreement to a global agreement which affirms Milankovich cycles and global air warming effects occur due to AGW, CO² emissions. All that, the foregoing respectfully submits, the Paris agreement signs to a potential life extinction on the planet Earth, in almost a consensus.

The impurities concentrations in graphical format show, to one skilled in art of soil sampling and analyses, no human intelligence is capable of devising such even if assisted by any and all means it has. Earth energy cycles alone cannot not engender such. Only cycling super-intelligence, the Universe energy structure with cosmological gravitational dynamics Earth energy dynamics, can.

Thus, cosmological gravitation creation of the Earth's centrifuge device and evolved evolution of that device engenders global air warming, which manifests itself in the Air Cells deficient energy cycles warming, is the root cause energy effect; the warning, the gravity field evolution threatens Earth's life potential extinction by cosmological global gravitation dynamics global air warming.

Applied sciences must affect Air Cells—troposphere, tropopause—energy cycles Heat Rate 100% efficiency, which cycle to avoid plasma fountains outflowing and avoid plasma emissions due to epigene surfaces entirely radial thermal energy outflows. Curtailing such energy outflowing the epigene surface a boundary, except for radiation energy, precludes gravity field evolution due to plasma fountains, magma outflows, and viscosity losses energy cycles warming the troposphere.

Plasmas outflowing is particularly of concern, since the troposphere, with tropopause as its upper boundary width, shows the Air Cells engender cycling energy environment inadequate Heat Rate efficiency. Both, “clean” solar and wind power are inappropriate energy generation. The former blocks Earth's mass radiations energy cycling and both, especially the latter, siphon environment crucial energy cycling. In analogy to electric motors, a siphoned energy power supply engenders generic failure in electric motors. Whereas this application provides incontrovertible prima facie evidence that Air Cells Jet Streams low energy cycles impose a root cause of global air warming.

The former weakens strength and lowers range of the magnetic field; the latter obstructs, deflects or blocks preferred cycling air directionalities which affect the tropopause most efficient cooling.

In both instances, the Earth's gravitational field reacts, which, in turn, spurs a rate of evolution of Earth's gravity. Energy of cosmological gravitational dynamics spawn gravity fields' evolutions and creates and evolves eternalized mass and energy centrifuge devices which evolve as celestial bodies with energy actions in-common energy reactions, which spurs evolutions of gravity fields.

A “clean” energy slowing environment energy cycles spurs evolution of gravity field—global air warming, air impurities concentrations and global air temperature, shown by Milankovich cycles.

Directionalities of energy cycles constituting boundaries perfection engenders evolution rate that inexplicably associates with energy cycle Heat Rate efficiencies which evolve gravity sink fields.

Above paragraphs disclose that the Universe energy structure effects uniquely continuous energy and evolving dynamics, all which is contrary to the prior science perceptions at large, which take energy dynamics of celestial bodies as gravitational fields quite stable boundaries. At least in the Solar System and Earth such is conclusively not the case. Geological Epochs, glaciation periods, and graphs of Milankovich cycles shown very precise fluxes of the impurities concentrations and temperatures point to Earth's gravity evolution in Solar System towards Mars or Venus scenario.

In either scenario, gravity forcing evolution evolves Earth energy fields cycling dynamics toward eternalizing longevity of its boundaries perfection in cycling energy eternalizing Heat Rate 100% efficiency. That stage of gravity evolution in energy fields cycling comprises a centrifuge device centripetal force energy action exceeded by centrifugal spin energy reaction, assisted by the light fluids not cycling Heat Rate 100% efficiency. Thus, cycling of the light fluids raises temperature and the impurities concentrations and insolation magnifications, wherein gravity field boundaries perfection must emit plasmas to space; such phenomena repeat at each planet that loses its water.

Consequently, the only viable, recommended source of energy is nuclear power generated energy by the nuclear super plant, claimed and explained in applications listed in the first chain of ADS; a warming troposphere thermal energy transfer by underground water aqueducts, which cycle the super plant heat energy outflowing by flow-through water, warms epigene mass; as surface water evaporates epigene surface cools. Then, in turn, as vapor in air condenses, the troposphere cools, and heat energy outflows into the Earth's crust or radiates into space when condensations emit it.

In the nuclear super plant energy cycles, all the light fluids thermal energy directionalities cycles oppose diametrically those by cosmological gravitational dynamics phenomena enacting Mars or Venus scenario, yet, conform to universal conservations of mass and energy and Heat Rate 100% efficiency energy cycles. Therein, heating of epigene mass and cooling of the troposphere occur. Thus, energy dynamics in time domain and boundaries perfection of the magnetosphere stabilize.

In turn, to oppose global air warming, the nuclear super plant is bulk electrical energy generation device and Tesla's electrical motor and generator inventions are devices for converting electrical into mechanical energy and vice versa, respectively. The issue with motors and generators of the prior art also resides in domain of global air warming energy cycling—these devices inadequately cycle energy modes cycling in respective energy environment, comprising Heat Rate efficiencies which are unnecessarily too low—and all which, in turn, contribute to overall global air warming.

Universe irreplaceable commodity wind energy directionalities effect, assist, spawn and support, energize and embody Air Cells structure wind energy cycling maximum or nigh 100% Heat Rate efficiency and supra periods precipitation short periods which precipitate over wide geographical areas. Environment energy cycling said energy directionalities maximally radiate thermal energy to space, engendering energy dynamics which maximally precipitate impurities aggregated in air.

Into that absolutely unbeatable energy cycling environment and irreplaceable commodity intrude “clean energy” devices cycled energy at one-half to one-third of environment innate efficiencies. Such devices consume energy to emit thermal energy, one-half to two-thirds of energy produced; all of emitted energy into environment is unavoidably energy contributing to global air warming.

Energy consumed unavoidably cycles back into environment, in forms of heat energy, especially. Prior art “clean energy” energy cycling devices low Heat Rates guzzle irreplaceable commodities energy, emit thermal energy as a “clean” impurity and, thus, effect energy of global air warming. In turn, slow cycling energy environment raises temperature and impurities concentrations in air.

Earth's atmosphere energy dynamics evolution supra five root causes of rising temperature, each and all boost the impurities concentrations in air and mutually magnify each other. Therein, each and all of the five boost cycling temperatures, accelerating mutual magnification to repeat Venus or Mars scenario. No other option exists—effect Heat Rate 100% efficiency, or live and perish in relatively very short time period; the troposphere must cycle it or the life on Earth ceases to exist.

The prior technologies or sciences global elite institutions one and all of prestige and power must unavoidably envision means to self-propagate global influences. For one reason or another, such breeds human perceptions focusing obsessively on structure and ingredients of mass materials, in very broadest aspect. Consequently, all of the prior sciences and art engender overarching flows.

These applications affirm, summarize it. Stunningly, the prior sciences with art promulgate most fundamental facts profoundly fatal flows through centuries. Missed entirely the energy evolution in the Universe energy structure and gravity fields epitomize it all. Crucial energy cycles govern by vastly varying relative properties and genres characteristics which vary due to a directionality relative change rather than misconstrued structure, or ingredient mass, or a static structures form.

These applications correct the prior sciences concepts of profoundly flawed theories, specifically the disclosed misapplication of gravitational fields, which embody the Universe energy structure eternalized energy into mass. Boundaries perfections successive structures of photons, electrons, atoms, ions and isotopes and the fundamental and Advanced Fluid Elements cycle energy unique successive boundaries perfection that eventually attains the Universe energy structure one energy field structure in entirety into eternity. No photon escapes that structure and the Universe energy structure has boundaries perfection Black Hole appearance embodying a number of Black Holes.

Energy eternal cycling evolves eternal cycle directionalities. By quantum energy resolution Heat Rate 100% efficiencies, boundaries perfection spawns energy integrity, the boundaries perfection energy integrity, which epitomizes the well-known directionalities phenomenon that energy mass straight path remains straight unless acted on by an outside energy source. A planet, a centrifuge spin, orbit and precession eternal energy dynamics cycling affirms the Universe energy structure.

Solar insolation is the outside source cycling thermal energy into Earth's gravity field cycling the light fluids and the impurities concentrations emitted by evolving epigene. All which unbalances the troposphere, with the tropopause as its varied thicknesses energy boundary; all which explain glaciation periods, the geological Epochs; all which the scientific community ignores, because all is contrary to glorified scientific theories of the prior sciences and to applied sciences inventions. There is no doubt whatsoever. Global air warming is evolving gravity field energy phenomenon.

Astonishingly stunning methodology exists to disclose, claim and license intellectual property; in all and every respect that methodology stunning fundamentalisms embody astonishing in entirety and every aspect enormously superior sciences and art to all and any of the prior sciences and art. It reconfigures sciences and art fundamentalism—mass and energy are cosmological gravitational dynamics transformations in geologic time domain and not a manifestation of one and the same—balancing Universe energy structure infinities by cycling energy in energy perfection boundaries.

In geologic time domain, boundaries perfections existence stable structure reveals energy cycling in boundaries perfections engenders Heat Rate 100% efficiency. If not, an energy cycling within boundaries perfections ruptures boundaries perfections; short interval energy dynamics an energy surge distributes the rupture energy, which releases that energy in boundaries perfections rupture.

If the short interval energy surge reconnects its energy cycling boundaries perfection, the rupture energy only reconnects. Concomitantly, released energy of the rupture outflows from boundaries perfection into next larger boundaries perfection. The rupture energy of gravity field embodies a boundaries perfection evolution which engenders a gravity field of a planet, a system or a galaxy; boundaries perfection evolves the Universe energy structure cycling all of eternally stable energy mass portions and evolving portions prevailing disposition energy cycling cycled directionalities.

A galaxy boundaries perfection cycling energy and concomitant enormous pressures combine all forms of energy engendering boundaries perfection of each and all photons, electrons, and atoms, ions, isotopes in the energy evolution. The conservation of mass and energy laws, the First Law, sets forth the Universe energy structure, observed from outside, affecting a Black Hole boundary, which, we know—for certain—cycles boundaries perfection infinite varieties, which cycle energy.

The Universe energy structure analogous to Black Hole boundaries perfection binding subatomic particles into atoms and electrons and photons in respective boundaries perfection, concomitantly almost exclusively, evolves its celestial bodies and gravity fields in globose spherical forms. The Universe energy structure in-common sums of centripetal forces by cycling unison engenders the interrelated, interdependent energy, the interdependences interrelated longevities, energy balance balancing the relativity energy, evolving all, each or any boundaries perfection in space and time.

In space and time, the relativity energy constitutes relationships of energy dynamics among all of celestial bodies of a retained portion of in-common energy dynamics from its origins of one body energy composite. Sizes and globose spherical forms of celestial bodies engenders, contains, and discloses energy dynamics relationships—the relativity energy—an in-common origin originating. Sizes, shapes and spins, orbits and precessions of the Solar System celestial bodies exemplify the relativity energy concomitant energy dynamics in spin, orbit, precession in-common relationship.

Gravity fields' cumulative centripetal forces in isolate boundaries perfections energy binds into a sum total granting the Universe energy structure to deform freely in space, time domains, but not in energy domain. Centripetal forces cumulative energy entire potential energy in tridimensional compression depressions embody the Universe energy structure, an energy sum in Galaxy, Black Hole in-common respective boundaries perfections. Boundaries perfections the Universe energy structure engenders also retains radiations spectra wave energy which Galaxy boundaries cannot.

The Laws of Thermodynamics hold true, we know for certain—unquestionably and especially the fundamental governances of First, Second Laws. Centripetal, centrifugal, torsional energy forces vectorial sums prior to and after the Big Bang event embody the Universe energy components of energy and the eternalized energy mass. All of such deny gravitational attraction force presence.

The Universe energy structure total energy of centripetal forces three-dimensional compressions, centrifugal, torsional forces of all celestial bodies must equal those prior and subsequent to a Big Bang event. Cosmological gravitational dynamics engendering sciences by energy technologies, in space time domain complete independence, stay the same in time space displacement changes, complying with the Laws of Thermodynamics—precisely balanced to quantum energy resolution.

Hydrogen's unavoidable escaping, from the atmosphere into space, is unquestionably prima facie evidence that cosmological gravitational dynamics spawn gravity energy genres, which discloses gravitational field boundaries quantum energy precise boundaries wherein smallest mass smallest boundaries perfection of hydrogen atom or ion contains, exceed its energy quanta and, thus, must outflow into space. Quantum energy resolution of Earth's gravitational field energy is evident in the Ionosphere shown mass energy layers based on least mass density in a boundaries perfection.

Otherwise, a hydrogen ions layer would exist on top of Ionosphere analogous to the Ozone layer. If Earth's gravity field were not a quantum energy resolution field, energy of a sole hydrogen ion would not exceed the Earth's gravity field energy bound boundary, which, thus, is strictly energy most fine quantum energy field boundary, not a mass attraction force delineating mass boundary.

Stunning displacements enormous flux by the magnetosphere magnetotail constitutes prima facie credibility evidence of an energy field rather than an attraction force flux—no doubt, whatsoever. A gravitational field energy field affects quantum energy resolution energy per quantum uniform field forces presence, in energy as small as that of a particle—much smaller than mass of an ion—spawning ubiquitously evident precise directionality convergences, toward and into a focal point.

Smallest atomic size and energy genres which belong, pertain to an energy boundaries perfection exclude a particle smaller than a hydrogen ion boundaries perfection smallest boundary by acting buoyancy forces on that ion volume. Prior science mass, here, boundaries perfection internalized energy a physical make-up and an integrity change bind atomic weights volumes into boundaries perfection by centripetal forces plasma modes energy change into atomic boundaries perfections.

Wherein, atomic weights engender a gravity field centripetal forces energy actions on boundaries perfection of atomic elements volume. Boundaries perfection energy in smallest sizes of volume in radiations energy modes—wave energy modes—penetrate eternalized energy of gaseous energy modes volume engendering a gravitational field constituted boundaries perfection. The Universe energy structure in boundaries perfection binds forms of wave energy. All and each of the above disclose the fatal flaws in the prior sciences which by we know better usurps said laws of Nature.

Energy modes in the internalized energy a physical make-up and an integrity change—eternalized modes energy—hydrostatic, triaxial three-dimensional confinement of cosmological gravitational dynamics spawn in the Universe energy structure(s) gravitational field(s) eternalized phenomena, which bind energy dynamics. Evolution of the integrity change of energy physical make-ups, the eternalized energy modes, progresses outwardly from a focal point of the triaxial compression by a nuclear reaction in a mass core temperature pressure outflows into sedimentary rock formations of mantel; magma outflows cycled energy, igneous rock formations and epigene surfaces evolve.

Attraction force, if existing on atomic scale, would comprise a directionality toward nucleolus of an atom, if only one atom is present. If two atoms are present, their attraction forces would yield a resultant force embodied directionality that balances attraction forces of the two atoms. Nuclei different atoms yield different composition masses, which, thus, embody different magnitudes of attraction forces. None such occurs, and atomic level macro masses attraction force cannot exist.

Likewise, on macro scale, we know—for certain—directionality of gravitational energy forces, on Earth, do not change or vary with Moon's proximity to Earth and ocean tides and the atmosphere shifting masses shifting center of Earth's entire mass gravitational center location as Moon orbits Earth. The prior sciences promulgate a theoretical, unproven and unsubstantiated conjecture that a mass attraction force exists in celestial bodies, only; herewith, proves—none of such is the case.

A celestial body eternalized energy mass genesis and the eternalized modes energy distinguished bulk energy—centripetal forces spin, centrifugal forces orbits, and torsional forces precession the Universe energy structure centripetal forces, tridimensional confinement, concomitantly spawns. The Universe energy balance, embodied energy structure cycling energy, and eternalized energy mass hold centripetal forces spin, orbit, precessions balance about a focal point, cycling in space.

Previously a nebula disk plane, an eternalized and cycling energy an invariant plane spins, orbits, and precessions, which as a part of the Universe energy structure cycling and eternalizing energy spins, orbits and precessions in the disk plane of its galaxy which, in turn, spins, orbits or spirals, and precessions in diverse dynamics, which continuously, persistently embody globose spherical, diversely unique appearance of each celestial body—all diverging from the prior science theories.

The onetime Solar System nebula humongous plasma mass engendered temperature and pressure gradients engender a plasma locomotion mass dynamics, which, in some cases engender a vortex type motion. When a vortex eye disposition happens to reside inside the nigh nullity plane of the pressure gradients, the oblate nebula plasma field spawns a mirror image double vortex about the nigh nullity plane. When cosmological gravitational dynamics affecting the pressure gradients in the oblate nebula, the mirror image double vortex engender mass energy a complete complement in cycling energy dynamics an eye, a focal point, the focal point, in the nigh plane of the pressure gradients. The cycling energy dynamics flip energy spectra energy action into eternalized energy mass spectra energy mass energy reactions, which engenders the eternalized energy mass, energy dynamics, the hydrostatic, tridimensional confinement tridimensional centripetal forces, the focal point and concomitant energy dynamics energy actions flip to energy dynamics energy reactions.

The eternalized energy mass energy reactions impose the eternalized energy dynamics spin, orbit and precession energy reactions. When, energy centripetal forces energy reaction, in turn, spawn diffused, with separating centripetal forces discerned centrifugal forces, separated out centrifugal forces accrue in the eternalized energy mass and spins, which expand respective boundaries until the eternalized energy mass and spins escape in orbits around the nebula eternalized mass proper.

When such an eternalized energy mass and spins occur, centripetal, centrifugal forces eternalized energy dynamics energy reactions evolve the eternalized mass orbits' precessions, which balance eternalized mass energy and energy dynamics of such a celestial body, a planet. Such evolutions of eternalized mass energy and energy dynamics spawned by a celestial body genesis and energy balance perpetuates the relativity energy by each celestial body, a gravity field, evolving relative, specific boundaries perfection; the prior and subsequent further explain a gravity field evolution.

Unique, diverse globose spherical shape of a celestial body implies the Universe energy structure spins, orbits or spirals and or tumbles engender a globose spherical shape in space, time domains. The centripetal forces of the hydrostatic, tridimensional confinement that comprises gravitational fields' respective perfection boundaries bind the Universe energy structure and a complete whole energy structure proper a Black Hole appearance, complying with the Laws of Thermodynamics.

Especially complying with the First, the Second Law, conservation of mass and energy, a gravity field boundaries perfection evolution retains miniscule portion of an eternal energy composite of distributed energy portion part which comprises the relativity energy that binds the whole energy structure—the Universe energy structure, one whole structure. The energy portion part that stays must effectuate that gravity field a cycling energy cycling Heat Rate 100% efficiency. The other part energy portion constitutes energy portion which that gravity field spawning evolution ejects, either by a plasma fountain outflowing or outright rapture of gravity field boundaries perfections.

And, that is precisely what the deep core borings analyses of the impurities concentrations found in the soil samples profoundly reveal and, in turn, thereby, explain Milankovich cycles. Said soil samples impurities concentrations show that AGW CO₂ emissions can contribute to Earth gravity field a boost a rate of evolution, in a short term. A 0.3 ka-0.5 ka time interval is short compared to the 41 ka, even half of that 21.5 ka. On geological time scale, AGW CO₂ emissions are but a blip.

A gravity field's evolution is apathetic to lives of humans, fauna and flora and life existence on a planet. It is a strict, reluctant, a geologic period merchant that affects cycling energy cycles Heat Rate 100% efficiency. We know—for certain—Milankovich cycles each and every one, over fifty times, disclose the troposphere, tropopause cycling air fluids cannot cycle energy dynamics Heat Rate 100% efficiency. Wherein Earth's gravity field evolves the troposphere, tropopause and the energy relativity structures, and the Air Cell molecular fluids dynamics cycling energy Heat Rate less than 100% efficiency evolves global air warming phenomenon; in turn, energy outflow must breach the tropopause, troposphere and the magnetosphere respective the boundaries perfections.

The application's lengthy text cannot undo the bungling, especially the 20^{th} century, centuries of the Second Law fundamentals specifically and the science in general. Such bungling cumulative effects create confusions which in 21^{st} century do not distinguish crucial differences between the health sciences and gravity field's energy dynamic an evolution. Linking AGW CO₂ emission to the root causes of global air warming do not occur in the planet that lost the light fluids, to freeze entirely Mars shown or turn hot Mercury, Venus shown and Earth glaciation cycles, Milankovich cycle shown. These sciences deserve no respect whatsoever; these not only misdiagnose but also apply precisely the wrong technologies which unavoidably do a permanent damage to the planet.

Because infinite diversity, albeit of a diversely unique appearance of any and all celestial bodies, not only holds but also confirms the Theory of Uniformitarianism, the Universe energy structure, the Laws of the Thermodynamics apply throughout. Thus, global air warming phenomenon does occur as cosmological gravitational dynamics Heat Rate 100% efficiencies eternalize energy into eternalized mass of planets by centrifuge devices centripetal forces spawning gravitational fields.

Of course, global air warming appears diversely in gravitational fields' evolutions depending on varied, diverse, numerous factors, not least of which are its orbing distances from its Sun. In that regard, Earth is fortunate, since it is closer to the Sun than the frozen Mars and further away than the hot Venus. On the other hand, Earth's gravity field's energy evolving glacial and interglacial periods for the last 2.2 ka years are losing a significant mass of the light fluids as cycling plasmas energy outflow into space. Such outflowing energy outflows to space is energy by an eternalized energy ions energy modes in an integrity change of energy physical make-up a gravitational field initiates from a nuclear reaction, the focal point spawning magma outflows onto epigene surface.

Cosmological gravitational dynamics affecting the Universe energy structures gravitational fields of centripetal forces effectuate three-dimensional compression centrifuge phenomena, which age by energy cycling in triaxial compressions environment to segregate eternalized energy, mass, by weight mass density. Dense masses migrate toward center of triaxial compression, while lightest fluids flux toward boundaries perfection boundaries of gravitational fields, triaxial compressions.

Mass, on the other hand, is atomic weight in boundaries perfection that transmits said centripetal radial forces cumulative sums by gravity fields or in static energy terms as overburden pressures. On Earth, mass as weight includes its gravity field said centripetal forces energy cumulative sum and possess on its own nothing more or less than just and only that—an atomic weight bound in a boundary. Bound mass only responds, transmits gravity field energy radially unidirectional force and centrifugal, torsional (precession), density (weight) buoyancy, and thermal energy dynamics.

Mass gravity fields evolve eternalized cosmological gravitational dynamics which disseminate to segregate and concomitantly to account, recombine, balance the Universe energy structure, forms of energy types comprising infinities upon infinites of boundaries perfection types. All comprise the relativity energy, the energy balance, with said Black Hole boundaries perfection boundaries.

Mass and energy are not manifestations of one and the same thing. Mass comprises static weight of atomic mass, in boundaries perfection that is cycling electrons. Energy affects types of energy dynamics, energy property only. To show, reveal itself, energy requires motion in highly defined and static mass, which, by that motion reveals a presence of energy form. Gravity energy field is example of pure centripetal energy unidirectional radially varied force with sea level as reference elevation. Mass static weight boundaries in gravity field free-fall define magnitude of the energy presence—wherein, pure energy form, in its boundaries perfection, moves static mass boundaries.

Above utilized valuable space and time explains static mass is ultimately defined by mass weight boundaries perfection, which, in turn, comprises boundaries perfections of electrons, protons and neutrons locomotion in separate and energy field's in-common boundaries. All of such demands extreme care to discern stunningly complex mass and energy boundaries perfection environment, which can embody modes comprising wave energy dynamics and energy modes no mass weight.

Until now, the prior sciences circumvent discerning dynamics of mass and energy and perplexing and complex mass and energy boundaries perfection environment, which spawns the interrelated, interdependent energy, the interdependences interrelated longevities affecting the energy balance and the relativity energy. These energies reveal the prior science relegating, ignoring the Second Law, one of the key Laws of Nature, removes underpins of known Nature all fundamental Laws.

Ignoring the Second Law, the prior sciences substitute, misconstrue mass and energy delineation. And, then, there are crutch factors a litany of constants flawed attempts to reconcile the observed facts of Nature, the theories as one and the same, which, in fact is not the case. Substituted static attraction force for gravity dynamics misconstrues solids mass, static surfaces and energy cycling dynamics, missing entirely boundaries perfection structures and stunning energy dynamics in the Universe energy structure. The curved space time theorized existence misconstrues the Universe energy structure, cooks-up the Universe model and, in turn, the insights into Milankovich cycles.

Two previous paragraphs briefly summarize theoretical sciences highly acclaimed achievements, yet all such bring the human race to precipice of extinction. The prior sciences, in all of such, do not comprehend any of it. Atoms structure comprises eternalized energy of weight mass wherein molecules configuration of ingredients in environment comprises a structure self-evident form of energy actions cycling energy in environment; thus, technologies of the prior art completely miss energy directionalities engendered energy cycling environment dynamics, which, in turn, evolve, stabilize, maintain, strengthen an evolving structure or conversely rupture that evolving structure. Such is precisely energy dynamic phenomenon of gravity field evolution and global air warming.

Best technologies' sciences and concomitantly, likewise the best sciences' technologies engender best energy cycling dynamics ultimate configurations, which let best cycling energy dynamics in environment engender quantum energy precise boundaries perfection of structure configurations. Best sciences best technologies bind boundaries perfection structure cycling energy dynamics by energy eternalizing—solid mass—boundaries perfection structure. No energy dynamics bounded energy can escape eternalized energy structure cycling Heat Rate 100% efficiency energy cycles. Best technologies practice it, but not the sciences that assume to know to ignore the Second Law.

The Fundamental Fluid Elements paragon energy dynamics and technologies of fluid boundaries perfections and boundaries perfections which spawn an eternalized energy a solid mass structure. More than one energy form cycles environment; multiple boundaries perfection boundaries occur—each solid mass shape and energy form dynamics yield energy structures boundaries perfection. Mass and energy is not a manifestation of one and the same thing. And, in definition of the ward ‘manifestations’, for an entire century, the prior sciences continuously bungle sciences of Nature.

Nature rates the first spectra energy mass structure by a perfection boundaries longevity. Atoms, electrons, molecules heads these structures list with molecular structures a distant fourth. Nature rates energy by the size of perfection boundaries and infinite diversities of energy type, spawning composite of the second spectra very complex directionalities. Universe itself, galaxies and stars occupy the top of such energy list. Stated ‘manifestations’ embody spectrum of mass boundaries perfection longevities mass genres with energy boundaries perfection energy genres, two distinct spectra domains, in common, affecting structure longevities and mass boundaries energy spectra.

Or vice versa, energy boundaries perfection energy genres yield mass boundaries energy spectra. Driving gravity field evolution and global air warming both phenomena concomitantly engender energy dynamics both spectra concomitantly changing a mass structure and an energy boundaries perfection. Cosmological global gravitational dynamics affects energy actions. A mass structure yields energy reactions. Energy actions, energy reactions an energy momentum driving toward a balancing the two energy spectra dynamics sustains and strengthens energy dynamics boundaries perfection and also, in turn, energy dynamics embodying structures boundaries perfection or vice versa, energy dynamics momentum drives toward a boundaries perfections rupture. Milankovich cycles disclose that air molecular fluids energy dynamics and energy reactions cycle at Heat Rate below 100% efficiency. Invariably, in Pleistocene Epoch, Earth outflows plasma on 41 ka cycles.

Such plasma fountains outflows, a flip of the Advance Fluid Element, from the energy mass first spectra into energy perfection boundaries of the second spectra, affects prima facie evidence that gravitational energy an attraction force that would oppose such outflows does not exist. A planet blowing-off light fluids is known to occur, also; Mars lost water due to such energy mechanisms.

The Second Law warns that the two spectra is not the one and the same thing. In a disposition of energy cycling the Universe energy structure, none of these is one and the same thing; such is the Second Law. A centripetal forces pure energy engenders pure three-dimensional compression—a planet's boundaries perfection and the Advanced Fluid Element. Planet's orbits unite centripetal, centrifugal and precession forces in boundaries perfection energy a much larger mass and energy boundaries perfection of its solar system or its galaxy, embodying the relativity energy. Whereas glorified yet flawed mother of all theories, Theories of Relativity a mathematical irrational result, claims curved space time to avoid Second Law diversities which we know—for certain—do exist.

The Universe energy structure effectuates mass energy two spectra; there are no third spectra that claims residence inside the Universe energy structure such as curved space time. As the previous explain cycling energy, mass engenders integrity of boundaries perfection structures which cycle energy Heat Rates 100% efficiencies, constituting mass energy first of the two spectra. On finite basis, the first spectra mass energy embody structures of photons, electrons, atoms and molecules mass energy opposing boundaries perfection change. These energy mass structures primarily are reactions energy that retains boundaries perfection energy cycling Heat Rates 100% efficiency to affect cycling energy dynamics eternalized perfection boundaries of mass and energy boundaries.

The mass energy spectra first spectra mainly engender a planet epigene surface. Each of these, at least in part during a specific time interval in geological Epochs flip into the second mass energy spectra, the mass energy spectra structures of the second type, boundaries perfection of an energy structure. These structures perfection boundaries cycle energy Heat Rates 100% efficiencies and emit radiation energy waves of photons, ions, isotopes and cosmological dust particles; on macro basis, ionospheres, Earth's ionosphere, and galaxies and, especially stars, exemplify these energy structures boundaries perfection, constituting the second spectra of said mass energy two spectra.

The second spectra engender energy mass an energy structure constituting mass energy of action. Overpowering energy of action may force mass energy structure of the second spectra to flip into energy of the first spectra, energy of reaction, to yield a stable boundaries perfection and embody energy that resists a boundaries perfection change. On micro scale, ions turning into atoms yield energy of action boundaries perfection of atoms, which balances energy, thus, resist a change, as energy of reaction. Thus, change in an atomic boundary by energy of action must exceed energy of balance, the energy of reaction, which usually evolves exothermal and endothermal processes. Nebula plasmas energy under the hydrostatic triaxial confinement affecting a planet's eternalized energy mass and an epigene surface boundaries perfection epitomizes such energy into mass flip.

Especially the nebula theory by the prion sciences, a planet genesis makes it apparent that plasma and dust particles embody no mass attraction forces in a change of spectra flips over into a planet spherical or globose spherical form with a spin, orbit, and precession. Quite to the contrary, dust particles, plasmas same electrostatic charges repelling genres would oppose any such phenomena taking place. Concomitantly, plasmas-dust particles energy of action must additionally flip mass energy entire spectra of the first into the second spectra to affect that mass boundaries perfection.

Enormous centripetal forces, including those of a System, Galaxy and the Universe, flip a nebula mass, its like electrical charges into eternalized energy mass an eternal orbit, spin and precession. Concomitantly, such a flip binds electrons to eternalized energy mass of constituted gravity field and, in turn, a nuclear reaction at its core, which in turn generates a magnetic field which, in turn, holds ions energy mass plasma that cannot, does not flip into energy eternalized mass. Ions mass makes nebula plasmas a remnant portion which can outflow into structure of the Universe energy structure comprising cosmological energy dynamics, or depending on cosmological gravitational dynamics energy dynamics, can flip into an eternalized energy mass, a balanced energy structure.

Said flip is similar to photon behavior in energy fields, energy behaving either as mass or energy, which a photon displays in energy field environment. A planet genesis makes a mass portion, an eternal flip to mass energy of the Universe energy structure cosmological gravitational dynamics in energy mass cycles Heat Rate 100% efficiency. Concomitantly, the Universe energy structure discerns electrical charges and centripetal, centrifugal, torsional forces energy mass spectra a flip into mass energy spectra and boundaries perfections of photons, electrons, atoms, and molecules.

Such energy mass entire spectra flip into gravitational field mass energy spectra, which engender photons, electrons, atoms and molecules respective boundaries perfection require sufficient mass energy minimum of several galaxies. Such galaxies cycled boundaries perfection structures spin, orbit or spirals in space time, a nebula's energy mass triaxial compression binds a mass structure, which eternalizes a planet's energy mass structure, a triaxial compression affected a gravity field and dynamics of overburden pressures spawn the triaxial compression nigh hydrostatic pressures.

Exothermal energy nuclear reactions affected by centripetal forces in boundaries perfection cores of gravitational fields' spins, orbits and precessions engender energy mass structures energy flips into centrifuge devices, celestial bodies, as aforesaid explains. Energy mass discerning into spin-centripetal, orbit-centrifugal, precession-torsional forces with concomitant mass energy flips into energy mass spectra, the second into first, concomitantly sets forth mass, energy genres flip, also.

Triaxial compressions, centripetal forces of a gravitational field discern mass densities, buoyancy forces comprising eternalized energy mass of mass energy eternal and specific dispositions in the Universe energy structure. The prior addresses space time environment configured cosmological gravitational dynamics cycling energy nodes, bound energy dynamics with boundaries perfection bounded space, in turn, cycling energy Heat Rate 100% efficiency. Planets geneses eternalize an energy optimization by cycling Heat Rate 100% efficiencies in successive perfection boundaries.

Plasmas cycling energy mass cycling engenders ubiquitous, universal mass and energy balancing of celestial bodies, by affecting the relativity energy and the energy relativity structures. Plasmas energy potential energy sinks utilize, maintain a balance that spawns no energy consuming mass-energy dynamics friction and adhesion, engendering balancing configurations of celestial bodies.

Concomitantly, eternalized Heat Rate100% efficiencies discern and eternalize an energy specific energy spectra, with specific mass spectra mass. With such evolving of mass and energy spectra, the light fluids including water phases, separate out densities mass by densities, buoyancy forces, to become apparent in boundaries perfections spins, orbits, precessions of centrifuge devices; the impurities concentrations a concomitant cycling in soil samples of the deep core borings shows it in Milankovich cycles and in environment energy cycling dynamics repetition through millennia.

Einstein's supra quote states that in theory, theory and practice are the same and, yet, “In practice they are not”. In Nature, Nature governs entirely by mass and energy specifics of the two spectra cohabiting the same boundaries, which affect structure longevity in their union. The two specific spectra discerning genres occupy identical boundaries structure, thus, in unified mass and energy boundaries. The two-domain spectra photons, electrons and nonradioactive atomic elements and molecules embody mass boundaries perfection and energy boundaries perfection, which coincide completely. Cycling energy Heat Rates 100% efficiencies cycle in boundaries perfection, which, concomitantly comprises eternal longevity energy genres and mass genres boundaries perfection.

Specifically, finite mass embodying eternally bounded energy boundaries perfection, constituting static mass structure statics, unifies cycling energy dynamics bounding mass, comprising cycling energy dynamics structure, yielding common boundaries. In common, boundaries by static mass structure and energy structure dynamics comprise environment mass and energy longevity of that environment structure. Longevity of environment structures comprising integrity of environment structures must comply with the Laws of Thermodynamics, especially the Second and First Law.

Heat Rate efficiencies discern compatibility of a unity among static mass structure statics, energy dynamics energy cycles, to confining static structure boundaries which embody paths-of-passage (PP) energy. Mass structure statics engender energy of reactions; energy paths-of-passage spawn energy of actions. When environment energy of actions continually affect Heat Rate efficiencies of less than 100%, boundary integrity of confined static structure eventually must fail; Heat Rate greater than 100% flips energy reactions and actions and at 100% involved systems are balanced.

The previous two paragraphs paragon mass and energy conservation, Laws of Thermodynamics, especially the Second Law, and energy cycling and energy boundaries perfection in environment affected systems boundaries. Thus, boundaries perfection embodies environment energy cycling Heat Rate absolutely highest efficiency by engendering eternal boundaries such as an atom does. Skills in the art of energy structures live or die by said Laws and maximum Heat Rate efficiency.

Scientific communities and Einstein definition of mass and energy ‘manifestation’ as one and the same thing, becomes clear after one century, is intended to mean anything we say/do goes. Since in any environment boundary, a mass and energy system cluster unavoidably cohabits individual, separate boundaries either infinitesimal, as energy, or eternal, as those of atoms, evolve based on energy cycling Heat Rate efficiency in the system weakest boundary, which restricts its life span.

Therein, energy of action dynamics evolving eternal boundaries perfection comprising Heat Rate 100% efficiency evolves static mass boundaries perfection structures. Such evolutions of energy dynamics into mass energy a static structure boundaries perfection are irreversible, unless energy of reactions overpowers energy of actions, which, as far as the science knowledge extends do not spawn an infinite ‘Do-While-Loop’. Thereby, mass and energy union constitutes boundaries of a union among spectra specific energy, specific mass, specific union of energy dynamics and mass.

As above precisely elaborates, mass and energy are not one and the same thing. All the bungling by scientific communities, as the above details, relegates the 20^{th} century energy-field sciences to alchemy science of the 19^{th} century. Unacceptably, the prior sciences presume genres residing in energy dynamics spectra as if those of mass static structure genres—Einstein's model of Universe curves space-time. Therefore, energy of actions affecting boundaries perfection Heat Rate 100% efficiency of mass and energy conservation affects a true model of the Universe energy structure.

No question—the 20^{th} century sciences, technologies and global scientific institutions and entities stray from skilled field of technologies by presuming, theorizing and examining most any energy structure based on structure characteristics, as if entirely valid. Prior disclosures utilizing crucial fundamental Laws of Nature reveal and explain—for certain—none of such are the case, including misconstrued theories such as curved space-time, gravitational attraction and global air warming.

Prior sciences gravitational attraction, curved space-time and global air warming systemic, prior, preexisting deep flows, need to conform to these flows, unavoidably cause more profound flows.

Structure static mass energy reactions take precisely equal and opposite directionalities to energy cycling actions when cycling dynamics energy deforming that structure is included, which affect various energy modes energy dynamics. Conforming precisely to Heat Rate efficiencies and the Laws of Thermodynamics engender precisely Nature. The compliances with the flawed theories and Law and Regulations complying with such are devoid of absolute technologies true sciences.

Those skilled in the art of energy efficient devices account for both, energy of actions and energy of reactions; such is nature of that art. The Second Law, Heat Rate efficiency, institutional tools, evaluate all such devices. The fundamental Fluid Elements engender unique structures which by construction affect maximum Heat Rate efficiency, therein, accounting for the Second Law, also.

For centuries, most brilliant minds, Einstein and most brilliant minds through many decades, take observed structure mass statics energy of reactions, only, to set forth a model of the Universe and gravity fields. Beyond a doubt, all such perceives a deeply, profoundly flawed mass model static structure of the Universe or a gravity field. In fact, energy dynamics model such structures, only.

Misconstruing similar fundamentals epitomizes the prior science profound, common, fatal flaws; aforesaid details academia, industry employs in energy devices analysis, design, construction and performance, which discern such energy mass energy of actions and energy of reactions. Energy devices solely based on structure appearance in the prior art is flawed, because inventions energy cycled dynamics of actions is not apparent if at all perceived by static structure mass appearance, only. Significant, profound, fatal flaws occur by technologies energy of actions disregard, which these applications expose, as prevalent and prevailing, arising from the prior sciences such flows.

Violating basic fundamental mass energy Lows, energy mass genres evolving spherical shapes of focal points of aforesaid, herewith, henceforth, centripetal forces, triaxial compressions, likewise, the centripetal forces, the triaxial compression, pertain to modes of mass energy and energy mass changes which yield the Universe energy structure energy of actions an energy mass eternalizing.

Rules and Regulations should not block most advanced, much superior devices from allowances, because these devices conform to academia, industry standards primarily performance interested, which, in fact, should and must govern all instances, involving crucial sciences and technologies.

Aforesaid establish a gravity field not the Earth's structure static mass an attraction force, but the Universe energy structure eternalizing spin, orbit, precession spawn centripetal forces and energy mass energy dynamics of a centrifuge device in spin, orbit and precession. The centrifuge device segregates by mass densities water phases and the light fluids comprising the Earth's epigene and atmospheric mass. These molecular fluids are only such mass in the Universe that does not cycle energy Heat Rate 100% efficiency inside innate boundaries which cycle eternalized energy, only.

The Universe energy structure, by the First Law in accordance with the second Law, must evolve Heat Rates 100% efficiency. The Universe energy structure innate energy dynamics must and do convert all of the light fluids not in frozen phase, into ions, which, in turn, dislocates these fluids' energy into energy boundaries perfection structures comprising conservation of mass and energy.

In fact, gravity evolution, constitutes evolution of the centripetal forces, the triaxial compression, modes of energy the energy evolution eternalizes into mass evolving a centrifuge device, a planet in question. It starts at said focal point initiating a nuclear reaction due to enormous compression forces of the triaxial compression, overburden pressures. The nuclear reaction melts prior nebula mass. The nebula molten mass comprising shear stresses at molten mass boundaries spins, orbits and precessions a globose spherical configuration, along with the remaining nebula mass portion.

A nuclear reaction adds chemical processes to the energy eternalizing energy modes of evolution dynamics a centrifuge segregated mass weight densities of the atomic elements of a molten mass. Heavy elements migrate toward the focal point, the core, and the light atomic elements, the fluids migrate toward perimeters boundaries of centripetal forces, spawning a gravitational field genres.

Once energy modes energy eternalizing initiates, energy evolving boundaries perfection evolves. As lava erupts or outflows onto a surface of the globose spherical configuration, yet an unmolten mass replaces it. Eternalized energy mass cycling maintains Earth's stunning crucial boundaries perfection evolution. The light fluids, with water vapors, yield Milankovich cycles, with Earth's epigene surfaces recording glacial, interglacial glaciation periods energy of reactions response to energy that cycles insolation energy, emanates into atmosphere environment, cycles Earth's core. And, epigene surfaces geological changes document a super-intelligent record of Earth's gravity, energy recorded evolution, with the relativity energy of Earth genesis intertwining in that record.

Thus, the Earth spawns itself entirely of energy cycled energy and the energy eternalizing energy modes of evolution into cycling mass, in most instances, cycled energy processing masses of soil and sedimentary, igneous and metamorphic rock formations. Gravitational force identified as the centripetal forces, the three-dimensional compression, that cycled energy portion of the Universe energy structure to balance itself, to Heat Rate 100% efficiency, readily disproves all of the prior scientific theories related to existence of the gravitational attraction force and curved space-time; the prior theories are science illusions, since the Universe structure is predictably quantum finite.

Repeatedly, these applications point out—the name of the game is binding energy into boundaries perfection energy eternalizing by mass energy binding. The Universe energy structure engenders energy delineated boundaries perfection boundaries from photons and electrons to versions of the Advanced Fluid Elements. From smallest, finite to macro sizes of these boundaries, no attraction force of eternalized energy mass is traced into existence from a nebula genesis and into a planet's creation and evolution. The Universe energy structure indisputable evolution cycling centripetal, centrifugal and precession dynamics and the relativity energy explain cycling gravitational fields.

All aforesaid is apparent, if not prejudicial fundamental sciences and technologies are religiously at work. For the last hundred years, scientific facts affirm, energy dynamics science only begins. More than 2.2 million years of Milankovich cycles of glacial, interglacial periods disclose human race is stunningly blessed with Earth globose spherical configuration space vacillated disposition energy dynamics from eternally frozen to eternally hot epigene surface; scientific observations in environment foresee a warming climate and that the Earth is tilting toward a hot epigene surface.

Higgs boson, God Particle and applied clean energy technologies are nonstarters. Such delusions the Universe energy structure cycling energy confronts; the former confronts no greater no lesser person than God—for the latter taxpayers must fit the bills for any and all of it. Aforesaid energy cycling, eternalizing the Universe energy structure churns Earth's energy masses from inside out, affecting energy dynamics cycling boundaries Heat Rate 100% efficiencies in energy boundaries perfection of the troposphere, tropopause. In each and all instances only to fail—over fifty times.

Again, the name of the game the Universe energy structure plays is boundaries perfections bound energy cycling Heat Rate 100% efficiency from photons to Advanced Fluid Elements to eternity, which in the last 2.2 million years cycling of the molecular light fluids fails to do, by failing over fifty times. Sources and sinks methodical, rigorous tracings of energy modes by the Second Law show no trace of gravitational attraction force energy, yet show the relativity energy an existence of energy modes chronological interactions and the energy modes continuous, eternal evolutions.

The energy modes time domain interactions, the energy modes continuous eternal evolutions and the relativity energy Milankovich cycles show, which, in turn, show modes of energy which bind portions of the Universe energy structure energy structures. Laws of Thermodynamics govern in the Universe energy structure, its valid complete model, in a concomitant governing of all energy modes energy dynamics which yield the relativity energy. Earth's global air warming may affect the gravity field evolution a hot, frozen or a tempered climate, which these applications describe.

The energy relativity structures of the atmosphere cycling energy environment structures in parts of the Air Cells, in turn, documents global air warming phenomenon by Earth's centrifuge device evolving a gravity field evolution Milankovich cycles graphically illustrated. These applications, this application presentation proceeds in directions to detail, set forth and divulge deep, profound flows; and, where, when, how, why such occur. To dredge the truth, responses to these questions documents the prior sciences and Theories lacking fundamental sciences common sense scrutiny.

Milankovich cycles come about from observations of Earth's surfaces during glaciations periods, subsequently substantiated by the deep core borings shown consistent, concomitant and systemic showing that the Air Cells energy environment cycles systemically, graphically repeated through 2.2 million years, on 41 ka cycles. We know—for certain—Earth's epigene stratigraphy continues to evolve, and Earth's eternalized mass turns over inside out, as supra explains. Also, we know—for certain—the light fluids cannot cycle Air Cells energy Heat Rate 100% efficiency, now, in the past. Unless an energy perfection boundaries occur—in stages, Earth's centrifuge device evolves.

At this point, it is time to state that most misconceptions, if not all, promulgate from “scientific”, computing mathematics claim to disclose a stupefying existence of curved-space time. In reality, such computing assumes and instead correcting mathematics to yield Earth gravity field realities, computing theoreticians overall unwarranted exuberances usurp all science fundamentals starting with the Second Law and, proceeding down the line, assign energy properties to mass properties.

In similar, dumbfounding culmination, the scientific communities attribute global air warming to CO₂ mass presence in atmosphere. Yet, best possible prima facie evidence provides Milankovich cycles shown insufficient Heat Rate efficiencies cycling failures in the Air Cells cycled energy is ultimate root cause cosmological gravitational dynamics driven repeatedly in over fifty instances.

It is ironic, the initiated continuously forced, human civilization theorized “sciences” interchange inappropriately mass, energy properties into a potentially deadly outcome. Scientific community curved space time delusion(s) a timely rejection would lead into existences of the Fluid Elements much sooner. Curved space time is neither mass nor energy genre. Theoretical science only can come-up with that boondoggle. By their origin chronology, this text tidies-up such boondoggles.

Supra discloses the Earth's centrifuge device continuously cycles, turns over, respectively cycled energy and eternalized energy (mass). The device as such, in entirety all energy, chronologically evolves molten core, cooled mantle, epigene surface energy boundaries, and the energy relativity structures comprising troposphere, tropopause, stratosphere, ionosphere mass energy bounded in magnetosphere boundaries perfection. All these engender energy evolved successive boundaries.

This energy evolving cosmological gravitational dynamics evolves cycling the centripetal forces, the triaxial compression, evolving energy modes separate the light fluids densities by eternalized energy mass; centrifuge device dynamics migrate such fluids to boundaries perfection successive boundaries; a planet, an evolution portion of evolution by atomic elements weight mass densities supra explains. However, a planet spinning, orbiting and precession cannot spawn its boundaries energy cycles Heat Rate 100% efficiency, unless the light fluids are in frozen mode(s) or emitted to space; today all known observations disclose that all of the Universe energy structure shows it.

Earth's disposition in space is stunningly unique. It orbits about two hot, inside six frozen orbits, of respective planets, retaining the light fluids eternalized energy, mass, uniquely huge quantities of energy of reactions bounded by atomic boundaries, which in unison resist a potential breach of boundaries perfections and, in turn, bind eternalized energy cycled energy potential. We know—for certain—plasmas in ionosphere, magnetosphere perfection boundaries cycle Heat Rates 100% efficiencies whereas molecular fluids in boundaries perfection of tropopause, troposphere do not.

Also, we know first-hand—for certain—the light fluids flowing, air and water flowing, effectuates flow viscosities which preclude the light fluids cycling Heat Rate 100% efficiency. Milankovich cycles, affirmed glaciation cycles by the deep core borings, reaffirm that, through the Pleistocene into the Holocene Epoch, the ionosphere and magnetosphere boundaries perfection resets in each nigh 41 ka period, over fifty times. We know—for certain—in 41 ka period, the eternalized energy mass turning over inside out, with the light fluids cycle energy cycles exposed to solar insolation.

In turn, Milankovich cycles tell us—for certain—the ionosphere, magnetosphere accumulates total energy of action of bounded thermal energy and directionalities energy dynamics in 41 ka periods to overcome energy of reaction and a binding strength of ionosphere, magnetosphere boundaries. Milankovich cycles tell—for certain—cosmological global gravitational dynamics evolves Earth's gravitational field global air warming phenomenon. As such, it discloses origin of its root cause.

Global scientific community “thinks it knows”—for certain—man's activity in general, CO₂ gases in particular, is global air warming root cause. However, these applications, herewith proves that such is not the case. Once again, scientific community continues to implement globally the same flaws in the fundamental science, which it does persistently in the last century; it substitutes mass properties, in this case mass properties of CO₂ gases for energy properties of cosmological global gravitational dynamics, more specifically, for energy dynamics evolution in Earth's gravity field.

The evolution energy in the Earth's gravity field dynamics slow in glacial period and accelerated in interglacial periods, affects a portion of light the fluids change from atomic boundaries energy cycles of energy reactions, to retained directionalities ions boundaries perfection potential energy of actions, concomitantly cycling potential energy dynamics directionality changes. Exposure of triatomic gas to solar radiation, irradiation boosts air temperature, the light fluids ionization rates.

Said exposures engender secondary effects which can magnify, yet warn, of a potential global air worming unfavorable energy dynamics energy directionalities in environment energy dynamics a momentum that affects a yielding perfection boundaries rupture. These energy dynamics, energy reactions, the secondary effects, spawn energy byproducts directionalities in and of environment.

Effects of AGW can magnify energy actions, only; and, cannot possibly constitute the root cause of global air warming. By the Second Law, energy dynamics energy actions affect the root cause in Nature, only. Presuming we can control energy of cosmological global gravitational dynamics in the Universe energy structure is another God-particle boondoggle; this time, a computer model constraints mislays cosmological gravitational dynamics energy of the Universe energy structure.

From advent of sciences, the prior science, in any shape or form, do not account for the existence of cosmological gravitational dynamics enormous energy dynamics which comprise the Universe energy structure. Einstein bungles energy systems physics engendering boundaries perfection of the cosmological gravitational dynamics which evolve, embodying and constituting the Universe energy structure. He, at al. theorizing curved space time, bungles mathematics which end and, in turn, show clearly that the computed result is an irrational number, from aforesaid Inequality (1).

There are usually few that may conclude that He, at al., unaware of the Advanced Fluid Elements energy dynamics comprising centrifuge devices of the Universe energy structure, unintentionally bungles the energy systems physics engendering boundaries perfection and that, in turn, explains an irrational number taken valid to claim a curved space time model of the Universe. Explaining the sciences historical, unprecedented bungling reveals the key point—time of one century is lost.

Such explaining misses another key point. Established existence and practice of the Second Law is known during that period. Yet, global intelligentsia, with few notable exceptions, praises such space time discovery as historical. Applications disclosed sciences point to profound deep flows, herein, exposing curved space time irrational exuberance that engenders, dangerously misplaces, the Universe energy structure governing by cosmological gravitational dynamics energy cycling.

The prior sciences conceptual visualizations model of the Universe model dangerously misplaces governing cosmological energy actions, takes stunning energy dynamics away from the Universe energy structure, and allocates these into conceptually visualized predominant, perceived if one's imagination can perceive, a curved space time static structure showed space time dynamics. The same imagination loses entirely celestial bodies' centripetal forces energy dynamics spinning and orbiting and the interrelated, interdependent energy, the interdependences interrelated longevities energy, which spawn the energy balance and the relativity energy. Replacing these energy forms by the two celestial bodies gravitational attraction force can't balance dynamics of gravity fields.

The prior sciences rob the Universe energy structure most, if not all, of the enormous, ubiquitous omnipresent energy dynamics cycling that structure Hear Rate 100% efficiency. All such energy dynamics conclusively affect, constitute a prima facie credibility evidence, a structure evaluation by the appearance only, without detailed analysis of an energy cycling it does, and an incomplete evaluation at best and a devastatingly flawed technology demise a possibility. The prior sciences did precisely, knowingly ignore the Second Law which is the Law that precludes that possibility.

Sir Eddington famous prediction is affirmed, again, many times over and over in the last century. The described above demise of the prior sciences classic theories is evident with existence of the prima facie credibility evidence that discloses cycling energy dynamics ongoing evolution inside the Universe energy structure generally and the Earth's gravity field, specifically. The global air warming constituting precisely that phenomenon which consistent with the Second Law diversity compliance yields a diversely unique planet surface which planets of the Solar System epitomize.

Even when faced with potential life extinction, scientific communities remain loyal to the flawed model of the Universe curved space time and, once again, this time substituting concentrations of CO₂ gases in the troposphere for cosmological global gravitational dynamics energy cycles in the magnetosphere and Solar System environment. Wherein, the Universe curved space time flawed model is driving life extinction on Earth, it concomitantly sidetracks and delays the technologies, sciences crucial timely implementations; subsequent submits last bits of the missing information.

Milankovich cycles show that in the Pleistocene Epoch ionizing rate of the light fluids invariably lasts nigh 41 ka, until the light fluids ionized energy in changing cycling directionalities, partially outflows the Earth's gravity field. The light fluids such ionized states outflow stops when energy dynamics of energy reaction of the Air Cells balances plasma fountain outflows energy of action.

The Pleistocene Epoch ionizing rates present day versions disclose the integrity change modes of energy make-ups evolving a planet are the light fluids eternalized energy atoms to ions reversible changes changing energy of action into boundaries perfection energy of reaction, which release a mode of energy excesses into energy dynamics cycles eternalized energy. Reversible changes of energy of action and reaction in ionizing processes shows a gravity attraction force nonexistence.

In a nebula, cosmological gravitational dynamics of the Universe energy structure force plasmas-dust particles energy dynamics Heat Rate 100% efficiency. Such dynamics Heat Rate segregates the nebula disk portions, imposing the integrity change of energy modes make-ups which initiate each portion a spin, an orbit and a precession energy dynamics. The Universe energy structure a three-dimensional compression centripetal forces create enormous pressures toward each portion focal point, binding electrons into atomic perfection boundaries which evolve into a gravity field.

All of it affects the integrity change of energy modes a make-up, with no trace of attraction force presence that grants or precludes said energy physical make-up affecting the nebula plasmas-dust particles into atomic boundaries in the segregated nebula each portion. Concomitantly, a nuclear reaction, started at the focal point of each nebula portion, turns over inside out eternalized energy in atomic boundaries perfection boundaries, affecting soil, rock formations and the light fluids of a planet. Supra explains a planet's centrifuge devices continuous segregation of atomic elements by atomic weights as energy cycling boundaries perfection either as eternalized or cycled energy.

A reversal of aforesaid integrity change by modes of energy make-up that evolves the light fluids eternalized energy an on masse paragon occurs in the energy relativity structures engendering the atmosphere. In a reversal, ionizing of the light fluids of the tropopause occurs sole due to energy present in cycling of the light fluids. Again, no trace of attraction force finite presence causes or resists or drives modes of energy make-up evolved in light fluids reversible ionization processes.

The ionized light fluids in the ionosphere portion of the atmosphere make an intermediate gravity field among Solar System celestial bodies; the intermediate gravity and Earth's magnetic field do not readily outflow these fluids, and Heat Rate 100% efficiency by the Universe energy structure precludes cosmological gravitational dynamics cycling reversals in the modes of energy make-up prior change. Changing energy of reaction in atomic boundaries into ions energy of action affect a portion of the energy relativity structures and energy dynamics unique reversals in evolution of planet's gravity and magnetic energy fields and their perfection boundaries respective properties.

The integrity change modes of energy make-up occurs on masse in a plant creation. In turn, also, it creates its perfection boundaries. It concomitantly occurs in Earth's gravity evolution affecting the ionosphere boundaries perfection of the energy relativity structures as reversal in the integrity change modes of energy make-up—an energy action, reaction switch. In these instances, no trace appears of attraction force presence; thus, a planet creation, evolution does not need such a force. Coexistence of huge black bodies in cosmological gravitational dynamics of the Universe energy structure is yet another strong evidence of no “mass attractions” property among celestial bodies.

Genesis of a plant in the Universe energy structure by energy dynamics explains the gravity field as centripetal forces energy field of tree-dimension compression, which affects a nuclear reaction that generates energy radiations including thermal energy emanating from its core. An evolution of that field as the Universe energy structure a centrifuge device cycled energy separates the light fluids weight by cycling energy dynamics in boundaries perfection of a gravity field; such energy dynamics spawn boundaries perfection evolutions and balance energy dynamics of gravity fields.

Herein, sets forth the Universe energy structure and gravity field energy and energy evolutions of a gravity field energy dynamics, which the prior sciences do not do—account for Earth glaciation cycling periods, Milankovich cycles shown cycles of “global warming” global air warming. The energy evolution effects set forth energy evolving mechanisms explain why, how the light fluids, water escapes Mars gravity and the globose spherical configurations of celestial bodies. All these energy phenomena which arise from one root cause in the Universe energy structure—a changing energy action into an energy reaction cycling energy Heat Rate 100% efficiencies, which spawns boundaries perfection cycling energy into eternalized energy, in the prior sciences taken as mass.

The troposphere and tropopause boundaries perfection of the molecular light fluids—for certain—do not cycle Heat Rate 100% efficiency. From a photon to the Earth, a planet boundaries and the Universe energy structure, space time perfection boundaries constitute energy dynamics balance. Everything we need to address the global air warming is known. Even concentrations of gaseous impurities in air, including those of CO₂ the deep core borings disclose are known for the last 2.2 million years. The prior sciences and the Universe curved space time model get it wrong, taking the Universe energy structure energy dynamics as if space and time parameters energy dynamics.

Taken such a switch in the root cause of the Universe energy dynamics energy actions avoids the Universe energy structure energy dynamics, Second Law and Heat Rate 100% efficiency impose on boundaries perfections to balance, in turn, to balance all energy dynamics. Energy dynamics, thereby, avoided the three crucial parameters which govern the Universe energy structure affirms the scientific community president to empower itself, to affirm the global air warning root cause.

Conversely, the global air warming immediately discloses issues with the tropopause, ionosphere boundaries perfection, since the Universe energy structure energy dynamics insist that inside that energy boundary, the tropopause, troposphere boundaries cycling the light fluids cycle Heat Rate 100% efficiency. We know—for certain—that is not the case. We know that from Earth's energy budget cycles Heat Rate efficiency nigh 92-94%. We know it from empirical drags and frictions, which occur along epigene surfaces. We know it from overall nuclear reaction emanated thermal energy and AWG emitted energy into the troposphere. We know it from Milankovich cycles and solar insolation forcing resets over 50 times to balance boundaries perfections in the atmosphere.

All of these above, and especially solar insulation and nuclear reaction emanated thermal energy, epitomizes the Universe energy structure, Earth's gravity field, cosmological global gravitational dynamics unavoidable evolutions by energy dynamics evolution. The prior science mainly static model of Earth's gravity field and the Universe energy structure, because that science unaware of boundaries perfections energy dynamics, entirely ignores energy dynamics a continual evolution.

Solution to global air warming phenomenon resides in the tropopause a viable, stable boundaries perfection, which, by itself constitutes a thick boundaries perfection between the stratosphere and the ionosphere and spawns modes of energy boundary between molecular fluids and plasma ions. In that boundary proximity, Jet Streams energy dynamics balance a solar insulation, a hydrostatic triaxial confinement and molecular, plasma fluids modes of energy mass density and thermal and pressure gradients. Wind velocities of Jet Streams affirm no gravity attraction force affecting the two fluids modes of energy and densities mass weight dynamics and molecular and plasma fluids respective densities respective boundaries perfections containing energy of actions and reactions.

The tropopause entirety constitutes boundaries perfections balancing plasma fluids energy modes triaxial compression, the overburden pressure confined energy modes energy dynamics energy of actions with molecular fluids energy modes energy dynamics reactions, or vice versa. Balancing these modes of energy in the Earth's gravity field balances one of the fluids three most important perfection boundaries. The epigene and magnetosphere surfaces constitute the other two of these boundaries; these three in-common evolution evolve Earth's gravity field current stage evolution.

In that evolution, Air Cells and Jet Streams said energy modes energy dynamics comprise energy of reactions balancing the air fluids' energy dynamics cycling the troposphere, tropopause, which can preclude a global air warming phenomenon in Earth's gravity field evolution. Energy modes energy dynamics energy of reactions affect epigene surface erosional features and its stratigraphy to an extent. Energetic, sever climatic events affect the global air warming energy modes energy dynamics energy of actions. A magnetosphere ionosphere boundaries perfection strength retains, embodies energy modes energy dynamics in energy modes energy dynamics energy of reactions.

The magnetic field magnetosphere perfection boundaries bind ions mass, weights and volumes in perfection boundaries engendering energy modes energy dynamics energy of reactions. The ions volumes respond to the Universe energy structure mass, weight, volumes energy modes affecting energy dynamics a tridimensional compression of centripetal forces constituting nigh hydrostatic overburden pressures. The confined mass, weight, volumes by ions perfection boundaries spawn energy reactions mass volume density layers elevation taken nigh hydrostatic confining pressure.

Universe energy structure volumes, mass, weight, energy modes energy dynamics engender solar insolation and the Universe energy structure radiations and wind pressures. Earth's gravity field energy, the evolution energy modes energy dynamics energy reactions may affect Heat Rate less than 100% efficiency. A closed system volume mass pressure, temperature relative relationships exist; Milankovich cycles show fluids energy volume temperature, pressure relative relationships cycle and that interglacial periods distend magnetosphere volumes, until plasmas outflow occurs.

Milankovich cycles reveal energy of evolution cycles in the atmosphere, also. Pleistocene Epoch into Holocene Epoch engenders energy of evolution cycling on said 41 ka cycles. The Number of said cycles exceeds fifty. During both Epochs, continual plasma outflows occur. More than fifty outflows provide prima facie credibility evidence that gravity mass attraction genres do not exist.

Saturn's energy of evolution in Epochs time domain evolves Polar Air Cells energy modes which overpower all other cycling energy modes, merging light fluids, dust particles solid phase energy dynamics unifying energy dynamics of North, South Jet Streams into the modes of energy Rings. Structures of the Rings constitutes Saturn's evolution energy, energy actions, which outflow said North, South Air Cells modes of energy, based on Earth, Saturn, Mars shown evolution rates. In gravity field evolved rates, Mars has minute, Saturn some, Earth ample energy of the light fluids.

Earth's Air Cells, Jet Streams energy modes energy dynamics mainly cycle air fluid in longitude, latitude respective directionalities primarily orthogonal crossings. Gravity mass attraction genres do not appear, show up at these crossings, also. Each planet centrifuge device optimally discerns energy modes, evidenced in planet's genesis segregating centripetal centrifugal modes of energy, which separate energy modes energy dynamics by quantum dynamics in evolving a gravity field.

A planet centrifuge device, a gravity field and an Advanced Fluid Element engenders boundaries perfection boundaries retained cycling energy modes energy dynamics quantum energy balanced and a closed system boundaries cycling energy dynamics Heat Rates 100% efficiency. A gravity field evolution phenomena occur in presence of molecular fluids, because such fluids, unless in a solid phase, cannot cycle Heat Rate 100% efficiency. Milankovich cycles precisely disclose that.

Solar System also an Advanced Fluid Element generates energy modes energy dynamics wherein evolution initiates from nebula plasmas energy modes; evolving frozen boundaries perfections of Mars surface is close to its eternal state of the energy evolution. Saturn Rings solid phases under solar insolation sublime, changing phase to fluid phase energy modes energy dynamics spawning energy modes energy dynamics balance which Saturn gravity field boundaries perfections affect.

Saturn's frozen surfaces disclose its energy modes energy dynamics in present configurations are near an evolution end. Earth epigene surfaces engender molecular fluids and solids phase modes and Air Cells, Jet Streams energy modes energy dynamics. We know—for certain—the Air Cells, Jet Streams do not cycle Heat Rate 100 efficiency. Milankovich cycles affirm it. Earth's gravity evolution must and does occur in the evolution energy an increased dynamics momentum, shown in the last two Epochs documented herein under “global warming” topic, the global air warming.

An evolution of energy modes energy dynamics evolves, until eternalized boundaries perfections successive boundaries perfections sustain their perfections configuration cycling Heat Rate 100% efficiencies. A galactic structure ions, isotopes, atoms and the Universe energy structure photons and radiations and wind pressures, ions, isotope, and atoms do energy dynamics modes of energy Heat Rate 100% efficiencies by evolving boundaries perfections, balancing the evolution energy.

The Advanced Fluid Elements, the Galaxies respective boundaries perfections continuous energy modes energy dynamics comprise the Universe energy structure a quantum energy based system, not curved space time system. Complexity of the Universe energy structure, the quantum energy based system aforesaid details. Einstein's own admission documented in literature concedes that a flaw in the computed proof of curved space time invalidates the nexus in the Relativity Theory.

Also, documented overwhelming indisputable details, prima facie credibility evidence, herewith, do precisely that, document the proof Universe energy structures reveal the flaw; even novice in the art of energy devices would recognize the indisputable flaw. The energy relativity structures, the Advanced Fluid Elements and the Universe, each of the three affects boundaries perfection of an isolated, compartmentalized structure of cycling energy system, in domains of space and time.

The flaw in the computed proof of curved space time occurs, because parameter mₒ, parameter m is not one and the same mass parameter in the prior science Equation (1), here, the Inequality (1). Parameters mₒ and m engender two different genres, mass quantities, and boundaries perfections. Parameters mₒ and m engender energy magnitudes bind two unlike energy systems in boundaries perfections of energy forms. Ions, atoms, molecular structures in the energy relativity structures, the Advanced Fluid Elements and the Galaxies in each of successive boundaries perfection binds parameter m mass. Conversely, only perfection boundaries of the Universe energy structure bind mass of all photons parameter mₒ. Equation (1), Inequality (1) mixes boundaries of two systems.

Most importantly, Ions, Isotopes and radiations energy dynamics is not included in Equation (1). Ions and Isotopes comprise electrically charged mass and magnetic fields boundaries perfections. Equation (1) excludes nuclear energy, radiations and power, especially thermal energy generated by nuclear reactions by most if not all celestial bodies. These engender magnetic fields modes of energy cycles fluxing energy dynamics and radiations, irradiations dynamics and directionalities.

Taken valid to claim a curved space time model, the mathematical irrational result, an imaginary number of the radical that taken valid derives Equation (1), said Inequality (1). It is but only one presented, documented overwhelming indisputable, prima facie credibility evidence Equation (1) is a mishmash. Quantum energy delineating boundaries perfections disclose the Universe energy structure, discern successive boundaries perfections of the energy structures only possible model, which binds energy of the entire Universe. The mishmash in Equation (1) claiming our mankind great disclosure in fact formulates in scientific, elite' vernacular the first great misrepresentation.

A radical irrational number, which it normally does, points to a mathematically computed correct solution. In this instance, herein, disclosed that the space, time and energy, the three independent domains, comprise the Universe. The energy domain progressively subdivides from a successive three dimensional continuities of boundaries perfections, from boundaries perfections of photons, electrons energy dynamics to those galaxies do, the Universe does to bind energy including wave lengths of radiations. That—for certain—defines the energy domain. Equation (1) is a mishmash. That—for certain—defines model of the Universe energy structure. Equation (1) is the mishmash.

Cosmological gravitational dynamics of the Universe energy structure affecting modes of energy depression, a nullity plane, and potential energy pressure gradients about the nullity plane affects evolution first stage evolves energy modes energy dynamics, the potential energy levels toward a lower level. Cosmological gravitational dynamics next stage, evolving the energy modes energy dynamics toward a lower level, the energy relativity structures of Earth's atmosphere epitomizes.

Air Cells, Jet Streams energy modes energy dynamics mainly cycle air fluid in longitude, latitude respective directionalities in orthogonal crossing disclose no mass attraction genres. Jet Streams, Air Cells energy dynamics balance energy hydrostatic compression and molecular, plasma fluids respective modes of energy mass densities and thermal and pressure gradients. In a huge nebula, and especially Jet Streams analogous energy dynamics in plasmas no adhesion, cohesion, friction fluid two plasma Jet Streams, one on each side of the nigh nullity plane of the pressure gradients, affect very dynamic energy modes energy dynamics portion from the other portion of the nebula.

The nebula spin, orbit or tumble, and precessions with the Universe energy structure engenders a form of centrifuge device that migrates toward perimeter, accruing therein, most dynamic energy modes energy dynamics, effectuating energy dynamics segregation and second evolution stage in the nebula energy modes. The third evolution stage releases said energy dynamics most dynamic energy dynamics into an orbit within the nebula consistent with the nebula most dynamic energy dynamics. The nebula most dynamic energy dynamics release into the Universe energy structure granted space granted free displacements within the nebula proper prior boundaries releases most dynamic energy dynamics centrifugal energy. The centrifugal energy eternalizes itself by nebula most dynamic energy dynamics mass taken highest orbit about a remaining portion of the nebula.

Concomitantly, releasing centrifugal energy into the orbit releases energy of spinning, precession energy dynamics in said most dynamic energy dynamics mass, which engenders evolving energy modes energy actions into energy reactions eternalized plasmas into atomic, molecular structures perfection boundaries energy, the eternalized energy, mass. The spinning and precession energy and the energy orbiting dynamics eternalizing displacements distribute energy modes dynamics a granted space lowered potential energy by evolution of energy into mass, which creates the focal point comprising lowest potential energy level and initiates a nuclear reaction and a gravity field.

Prior paragraph stated, the energy evolution a fourth stage evolves the Universe energy structure, eternalized energy in-common centripetal forces acting on boundaries perfections mass volumes. The in-common centripetal forces embody tridimensional compression and hydrostatic pressures confined energy modes, the focal point, a potential energy least pressure an eye and mass volume densities in said most dynamic energy dynamics mass, evolving atom, molecular structures. This evolution fourth sage evolves mass volume genres and boundaries perfections of a celestial body.

A new cycle of energy evolution stage initiates in the remaining portion of the nebula in a similar manner, except that the second release of the energy dynamics most dynamic energy dynamics in the nebula remaining portion results in a lower orbit than achieved by the first release. Each time a genesis of a celestial body occurs, energy modes energy dynamics evolve energy modes energy dynamics, the potential energy field, the lowest potential energy level, its focal point, and its eye.

Energy modes energy dynamics in said nebula remaining portion repeats a celestial body genesis unless a remaining portion of the nebula nigh entire body embodies boundaries perfection an eye of potential energy, which the Universe energy structure tridimensional compression in-common centripetal forces spawn; the nebula plasma particles like electrical charges evolve modes energy dynamics, created a solar system with said eye a sun, and energy modes energy dynamics evolve energy dynamics energy modes an all-embracing potential energy field of potential energy sinks.

The Solar System affects said all-embracing potential energy field and the potential energy sinks the plants of that System spawn. The planets, the Sun engenders energy modes energy dynamics of the all-embracing potential energy filed—the potential energy sinks of the gravity fields' sinks, the Sun by far the largest. The all-embracing potential energy field embraces each celestial body energy modes energy dynamics, which, in that field, embodies the relativity energy of each body.

The releases of the most dynamic energy dynamics affect the rupture energy distributed quantum precise that stays in the released, the remaining nebula portions undistributed energy modes. The rapture energy and the relativity energy of the released, the remaining nebula portions bind in the relativity energy, the interrelated, interdependent energy, binding the interrelated energy systems.

Solar System in-common potential energy level and the interrelated, interdependent energy spin, orbit, precession account for its energy modes energy dynamics the Universe energy structure; in the Solar System, energy binds into successive boundaries perfections consistent with the Second Law, affecting varied potential energy sinks and boundaries with the Sun the largest of the sinks.

Potential energy sinks, gradients and focal points balancing with spins, orbits precessions spawn energy dispositions, the relativity energy dispositions, of each respective planet about the Sun. A spin, orbit, precession energy dynamics change and the relativity energy change embody one and the same in-common change. The relativity energy of the in-common energy systems constitutes in-common energy dynamics by energy in boundaries perfection boundaries of the Solar System. Energy waves, radiation and solar insolation evolve total energy in planet boundaries perfections passing through large boundaries perfections but not pass those of a nucleus of an atom or an ion.

The first five planets closest to the Sun evolve respective energy modes energy dynamics, which supra notes, along with Milankovich cycles indisputable changes documented in Earth's epigene surface occurring during Pleistocene and Holocene Epochs climate changes. Changes in Earth's epigene surface appearance compare to geophysical evidence comparable to drawings in a patent application. Each of said five planets evolves energy modes energy dynamics from Solar System nebula to the present status, to show the relativity energy unique structures, energy modes energy dynamics Earth atmosphere cycles, which these applications detail according to the Second Law.

Appearances of the five planets constitutes the support evidence, only; the Second Law traces of energy modes energy dynamics to the present status, which herein described, engender the prima facie credibility evidence, applied sciences indisputable evidence affirm, Milankovich cycles the valid interpretation affirms—the Solar System planets continue evolution of the evolution cycles.

The evolution cycles, Milankovich profoundly disclose. The tropopause in entirety comprises an interface of molecular/atomic and plasmas/ionic fluids spawning energy modes energy dynamics energy reactions flip into energy modes energy dynamics energy actions. In turn, the ionosphere comprises said intermediate gravity field among Solar System celestial bodies and energy modes energy dynamics, which evolves eternalized energy mass. Said energy dynamics redistribute the light fluids plasmas and balances mass and energy in boundaries perfections of the Solar System.

Evolution mechanism in the Solar System, the energy relativity structures, the Earth atmosphere, reveals the troposphere engendering boundaries perfection interfaces of energy reactions, energy actions. Ionizing the light fluids flips energy reactions into energy actions with plasma fountains outflowing balancing an imbalance in energy modes energy dynamics in the Earth's gravity field which engenders very much similar evolution mechanism initiated in genesis of the Solar System planets wherein the evolution mechanism rebalances eternalized energy, mass, with its dynamics.

Energy dynamics modes of energy in Milankovich cycles do precisely that on 41 ka cycles, in the Pleistocene and early Holocene Epochs. The evolution mechanism embody evolution processes.

Earth's gravity field rebalances imbalances of energy modes energy dynamics, in turn, spawning cycles of glacial, interglacial periods. In global warming, global air warming glacial, interglacial periods, the evolution mechanism engenders evolution processes to balance Earth's gravity field. Each of the celestial bodies engenders the Solar System's evolution mechanism evolution unique processes consistent with the Second Law and, in turn, engenders rebalanced balance of the Solar System and energy modes energy dynamics within boundaries perfections the System engenders.

Each celestial body in the Solar System evolves the evolution unique processes an evolution rate; In said Epochs, Milankovich cycles, Earth' s glaciation cycles disclose climate changing on 41 ka cycles, and that global air warming is also a Solar System phenomenon. In time domain interval, AGW, CO₂ concentrations three hundred years duration is much too short a short geological time to cause a climate change; an inconsequentially short time interval geological duration, a boost in CO₂ concentrations, even in energy modes energy dynamics in the troposphere, the Solar System cannot cause the climate change a root cause, and the same holds true in the Earth's gravity field.

Energy modes energy dynamics cycling energy in the troposphere environment spawns global air warming 41 ka continuous intervals geologic history repeated more than fifty times in 2.2 million years provide more than ample evolution time in which to evolve climate change. Correctly, few environmentalists claim CO₂ concentration lowers a water vapor concentration, which makes any CO₂ concentration in air a climate change retardant agent. The prior science misconstrues, much oversimplifies energy modes energy dynamics cycling energy. Milankovich cycles, Pleistocene-Holocene Epochs 2.2 million not 300 years evolves a climate change momentum in environment.

Important disclosure by the evolution mechanism, in general, and especially aforementioned five planets of the Solar System, discloses energy modes energy dynamics reversals in directionalities of the evolution processes. When the most dynamic energy dynamics engender energy dynamics segregation, the second stage evolution, and the solar nebula eternalizes a planet's spin, orbit and precession, eternalized energy mass, ions energy of actions flips into molecular, atomic energy of reactions. At the tropopause, ionosphere boundaries perfection said spin, orbit and precession, in Earth's gravity field, engender molecular, atomic energy reactions a flip into ions energy actions.

The reversals in directionalities of the evolution process of accrued plasma fluids flipping energy actions and reactions occurs at molecular-atomic, plasma perfection boundaries of the tropopause and ionosphere. Overburden pressure change from hydrostatic into non-hydrostatic confinement yields boundaries perfections molecular-atomic to plasma change and respective energy reaction, action flips. Vice versa, centripetal forces tridimensional compression and the directionalities by the evolution processes hydrostatic to non-hydrostatic confinement changes energy reactions into plasma fluids energy actions. Plasma outflow fountain ends one cycle in the evolution processes.

Hydrostatic compression confinement, a plasma into atomic-molecular fluids flip that eternalizes energy dynamics groups energy of alike electrical charges into eternalizing spin, orbit precession energy dynamics and energy disperse plasma fluids into eternalized energy mass a planet genesis affects. The evolution processes, the hydrostatic to non-hydrostatic confinement changes affirms the Universe energy model comprises of highly dynamic structures and not of curved space time.

The directionalities of the evolution processes and energy modes energy dynamics show no mass attraction genre need. Jet Streams and Air Cells affecting the orthogonal crossings also shows no trace of mass attraction genre; for certain, no mass attraction genre appears at the tropopause and ionosphere boundary. Energy modes energy dynamics pressure, temperature, and mass densities in Earth's gravity spin, orbit, precession Jet Streams energy dynamics balance comprising energy of reactions balancing energy actions imparted, in part, a spin, orbit, precession energy dynamics change from boundaries perfections change from atomic-molecular structures into plasma fluids.

The ionosphere, comprising aforesaid intermediate gravity field, affects aforesaid directionalities of the evolution processes conforming to potential energy level pressure gradients, during plasma outflow energy actions which overpower energy reactions binding the magnetosphere boundaries perfection. The ionosphere, aforesaid intermediate gravity field constitutes a reservoir of energy mass weight that balances perfection boundaries in the Earth's and Solar System's gravity fields. Saturn rings constitute another unique reservoir of energy mass weight that balances the Saturn's and Solar System's gravity fields. A hydrostatic compression confinement of an epigene surface comprising a planet body embodies a gravity field, an active reservoir of the energy mass weight.

The energy mass weight in successive boundaries perfection engender hydrostatic and, or triaxial compression densities constituting molecular, atomic and isotopes, ions respective structures; the hydrostatic compression, triaxial compression engender densities in boundaries perfection of said structures and structures perfection boundaries layering by energy mass weight and density. The lightest and the most energetic of the most dynamic energy dynamics in each layer affect surface of respective energy mass weight and density layer, a structure, by the Universe energy structure.

Displacements of space time parameters come free. The Laws of Thermodynamics, starting with conservation of mass and energy, the First and Second Law track and trace displacements in time and space; the evolution energy concomitantly eternalizes energy dynamics and energy dynamics mass, which concomitantly define independent space and time domains, quantum energy precise.

Said Laws govern energy dynamics and concomitantly energy space and time free displacements which energy dynamics demand, take. Curved space time is theoretical science said boondoggle.

The Universe energy structure a triaxial compression, a celestial body potential energy sink binds respective gravity energy field, with triaxial compression and the focal point nuclear reaction and subsequent energy evolutions in time domain allotted space; the triaxial compression compresses enormous volume of a nebula portion cloud to a nigh finitely infinitesimal comparative volume a ball shape. Energy dynamics compress a nebula cloud into ball shape and energy dynamics spin, orbit and precession. The ball shape in-common energy dynamics and the evolution mechanism, the evolution processes eternalize a celestial body, a ball shape bound energy dynamics structure.

The relativity energy embodies a celestial body unique space allotment in space and an evolution stage independent energy domain paralleling space time domains—the Universe energy structure. Spin, orbit, precession dynamics, the interrelated, interdependent energy in free displacements an energy balance, and the interdependences interrelated longevities embody eternalized boundaries perfection, and the rupture energy specific distributions, celestial bodies uniquely bound, binding Universe energy structure in-common successive perfection boundaries, quantum energy precise.

Energy modes energy levels of each layer engender most active energy modes residence near the top of a respective layer. The evolution mechanism comprises successive boundaries perfections and hydrostatic and/or triaxial compression bound in one the Universe energy structure; the Solar System geneses exemplifies the evolution mechanism. The Universe energy structure eternalizes the solar nebula energy mass and dynamics into eternalized celestial bodies of energy, mass spin, orbit and precession dynamics. The evolution mechanism recycles the Earth plasma unbalancing energy in Solar System boundaries. Earth's Ionosphere, the intermediate gravity field, holds and redistributes, returns unbalanced plasma energy back to original source, completing the evolution mechanism one cycle. Milankovich cycles reveal Earth's evolution mechanism over fifty cycles.

The evolution processes evolution stages one, two, three, the current stage traces forms of nebula energy modes energy dynamics; nuclear reaction in the eye of the triaxial compression turns over inside out eternalized energy mass; the light fluids cycle energy cycles and the current stage light fluids plasma fountains, Earth's gravity field unbalanced energy modes periodic outflows occurs. The evolution processes pressure, temperature, mass density distributions of energy spawn winds and weather changes by energy modes energy dynamics cycle toward decreased potential energy level. Energy distributions cannot cease inside said boundaries perfections. Solar radiations and radiations generally, unless hitting a nucleus of an atom, penetrate energy fields and/or influence quantum precise cycles of modes energy dynamics in adjacent successive boundaries perfections.

The evolution mechanism, the evolution processes bind the Universe energy structure and energy modes energy dynamics bind successive boundaries perfection boundaries; boundaries perfection boundaries, balanced to quantum energy conforming to Laws of Thermodynamics and especially the First and Second Law stipulated diversity and complexity, set forth the model of the Universe energy structure. Step by step methodology, energy modes energy dynamics bound in perfection boundaries successively larger boundaries yielding the Universe energy structure; in the likewise manner, Universe structure energy domain model, shows the First and Second Law compliances, engenders own space time independent of space and time domains the prior sciences promulgate.

The Universe energy structure energy domain model, the model of the Universe structure, traced and tracked energy modes of plasma dynamics, from the Solar System boundaries perfection into Earth's gravity boundaries perfection back into Solar System boundaries perfection, according to the Second, First Law show no evidence of mass attraction. The Universe energy structure in the evolution mechanism, the evolution processes, engenders hydrostatic compression depressions of gravity field sinks, the sinks' focal points, the hydrostatic compression depressions ultimate lows and potential energy fluxing levels of the potential energy field by the Universe energy structure.

The potential energy fluxing levels of the Universe energy structure affect an in-common energy modes energy dynamics energy field, spawning infinite number of voids in space. Energy fluxes contract, distend, cycle, orbit, precession, energy modes dynamics in boundaries perfections; said interrelated, interdependent energy, the interrelated energy systems and the relativity energy bind a potential energy one field. The interrelated energy systems, the evolution mechanism interface environment, and the evolution processes no adhesion-friction affect 100% Heat Rate efficiency.

Earth spin, orbit, precession in Solar System spin, orbit-spiral, precession, in Milky Way Galaxy spiral, orbit, and precession energy dynamics, confirm facts, especially affirm nonexistence of a mass attraction genre energy and curved space time Universe energy; energy dynamics in and by successive larger perfection boundaries, starting with atoms and ions. Energy dynamics do it all; the evolution mechanism, the evolution processes would not work, if the prior science were true.

The evolution mechanism, the evolution processes affected redistribution of the relativity energy, the interrelated, interdependent energy, the rupture energy engenders rebalancing of the Universe energy structure, the potential energy one field. The prior science substituting curved space time for energy of said affected redistribution of said three forms of energy claims said three forms of energy, curved space time constitutes manifestation of one and the same thing; not now, not ever.

A gravity field embodies the Universe energy structure a tridimensional energy field energy sink, a potential energy hydrostatic compression depression and potential energy a focal point low and the relativity energy, boundaries perfection energy system by one and the same energy dynamics.

Gravity fields constitute the relativity energy, the interconnected energy systems, and the cycling energy nodes which the Universe energy structure configures eternalizing energy mass dynamics into energy structures grid of eternalized energy masses and energy dynamics; eternalized energy structures stay eternal until pulled into Black Hole in-common sink of merged gravity field sinks. The evolution mechanism, the evolution processes evolve energy modes energy dynamics of one nebula energy modes cloud by the Universe energy structure and same cycling energy dynamics.

A planet geneses, energy dynamics herein traced, evolving energy modes of Ions into eternalized energy dynamics energy modes mass disclose no presence of a gravity attraction force. A partial reversal in boundaries perfections boundaries evolves energy dynamics evolving energy balance. Energy modes Ions lose atoms gain to cycle, distribute in Jet Streams orbiting, precession energy dynamics, again, rebalancing Earth's gravity field spin, orbit, precession dynamics an imbalance.

The tropopause boundaries perfections delineate cycling modes energy dynamics and ingredients eternalized energy molecular and plasma mass weights. No presence of a gravity attraction force appears in such instances. Molecular fluids energy modes change to plasma fluids engenders the evolution energy evolving by a minor reversal in a planet genesis. These events by the evolution energy, eternalized energy a spin, orbit and precession inside the Universe energy structure cycle the relativity energy and the interrelated, interdependent energy of the potential energy one field.

Inside the Earth's gravity energy field, boundaries perfections of tropopause, upper bound the Jet Streams energy modes dynamics, the energy relativity and the evolution energy, in common, and the intermediate gravity field energy dynamics engender balance of eternalized energy dynamics. The relativity energy, the interrelated, interdependent energy, the rupture energy redistributed by the evolution mechanism, the evolution processes impose energy actions of the evolution energy, which the Universe energy structure affects to rebalance energy of the potential energy one field.

Plasma fountain outflowing a cusp in Earth's magnetic field affects the last step of a cycle by the evolution energy an iterative energy dynamics process that redistributes unbalanced energy in the relativity energy. And, the Earth evolving gravity field unbalanced energy plasma energy modes return to the Solar System. Plasma fountain outflowing energy distributes the remaining portions of orbit, spin precession dynamics into the potential energy field of the Solar System. Since such outflowing occurs in time period of many millennia, climate change reversal likewise is possible.

Milankovich cycles show exactly that—energy modes energy dynamics a doo loop recycling that redistributes, returns the Earth's gravity field unbalanced energy modes energy actions back into the Solar System. Each gravity field boundaries perfection, Solar System boundaries perfections all do loops do such. These do loops, gravity fields, engender energy modes energy dynamics of energy actions to concomitantly balance all gravity fields, the potential energy one field spawned respective boundaries perfections which the one gravity field the Universe energy structure does.

Said do loops effectuate energy actions of cycling modes, energy dynamics, and energy phases in respective boundaries perfections, engendering an unbalanced energy a redistribution through the evolution mechanism, the evolution processes, with energy actions a gravity field energy unequal reactions—the evolution energy. A gravity field portion of the potential energy one field balances energy actions and reactions; otherwise, an energy redistribution by that gravity field must occur.

Aforesaid discloses that mass and energy are not one and the same thing. It takes specific energy modes energy dynamics and energy evolution, with time domain long processes to evolve energy into mass. Global scientific elites fundamentally misrepresent by communicated in scientific and literary, legal and mass media specific vernaculars, thereby, empowering theoretical sciences and achievements of elites. These vernaculars adopted misrepresentations sidetrack applied sciences.

In the Universe energy structure, gravitational sinks configure the potential energy levels energy, bind energy modes energy dynamics in the cycling energy nodes a tridimensional system eternal grid, and configure the relativity energy and the interrelated, interdependent energy distributions; all which engenders no friction, no adhesion—no mass attraction genre, especially. Gravitational sinks, the cycling energy nodes, spawned a spin, orbit and precession Heat Rate 100% efficiency affect boundaries perfections, the celestial bodies, the Universe model quantum energy balanced.

Most importantly, each of boundaries perfections and successively larger boundaries perfections binds energy modes energy dynamics cycling quantum energy precise directionalities in a system energy structure boundaries of a gravitational field, affecting successively larger potential energy sinks. A gravity field successive, larger field, a potential energy larger sink, the Universe energy structure eventual an all-inclusive tridimensional hydrostatic compression structure, a depression potential energy field energy sink, in turn, energy dynamics spawns an energy dynamics balance.

Energy dynamics directionality which persists in a domain of a gravitational field independent of space, time domains and accrues sufficient energy, affects energy dynamics directionality energy outflow into a tridimensional compression depression binding larger structure and a gravitational stronger field. Energy outbursts, wave dynamics affect same dynamics; the latter, no boundaries volume upon which centripetal force can act, bends wave energy path in a spinning gravity field.

The Universe energy structure in-common successively larger structures a progressively stronger gravitational fields' energy sinks eventually bends confines a wave energy path in a gravitational field sink constituting a large sufficiently strong tridimensional compression depression. A wave energy path, unless stopped by a nucleus, does not belong in any other gravitational field than the one which confines it and, in turn, embodies space, time and energy dynamics genres specifically pertaining to that gravitational field sink. Energy passing a structure and belonging to a structure identify two structures space, time, energy dynamics undefined genres, not bound in one domain.

The prior paragraph restates supra paragraphs indisputable elementary proofs of flaw(s) in theory of curved space time, a tyro in the art of energy systems should promptly notice. And, a litany of fundamental science flows—the gravitational energy dynamics, the Universe a model of evolving structures, the distinction in mass and energy origins, Milankovich cycles energy dynamics—only mentions a few. Unexplainable, incontrovertible, the Second Law entirely displaced is stunning.

The prior science incontrovertible bungles energy modes dynamics the Universe energy structure and gravitational fields affect, in general and specific curved space time envisioning that does the century long validating the very acclaimed yet unscientific theories which in reality, practice and the art do not conform to fundamental science, the Law of Nature; the prior sciences misconstrue energy dynamics the Universe energy structure, each gravity field embodies, affects and evolves.

Theoretical science misconstrue curved space time for energy environment dynamics and gravity attraction forces, the tridimensional compression depression centripetal forces. The prior science evades the evolution energy in the Universe energy structure, the Earth's gravity field, the energy relativity structures, and the troposphere, tropopause. Global panel on climate change, the IPCC, blames global warming, herein global air warming, on CO₂ emissions present in the troposphere.

Said deep soil boring samples impurities concentrations, each and every one impurity, affects the interrelated, interdependent energy affected global air warming. Conducted experiment sciences misconstrue CO₂ emission concentrations spawn root causes of global air warming. In selecting one and not all of the impurities concentrations, the conducted experiments veracity relies on the prior science key theories, which contain deep and profound flaws painstakingly detailed, herein.

Energy fundamentals, forms of energies, eternalized energy—mass—energy dynamics cycling the Universe energy structure evolves spawning boundaries perfections the Earth's energy evolution, eternalized energy, mass, and cycling energy modes energy dynamics epitomize. Plasma energy, traced boundaries perfections from oblate of solar nebula energy evolution the prior text does. It constitutes prima facie credibility that cycling forms of energies cycles all energies present, from inside out, from a nuclear reaction in the eye toward perimeter and inwardly from said perimeter.

Epigene crust surfaces affect primarily freeze or hot, when a nuclear reaction at its core subsides, circulating energy cycles slow. Energy modes media large volume must distribute pressures and temperatures, the interrelated, interdependent energy, throughout the large media or rupture(s) of boundaries perfections must occur. The evolution processes evolution stages one, two, three, the current stage traced forms of nebula energy modes evolve energy modes entire media constituted boundaries perfections; all of these comprises energy dynamics energy evolution since Big Bang. Said energy dynamics energy evolution, known to affect boundaries perfections, balances energy cycling dynamics which engage an entire volume of energy modes inside boundaries perfections.

Milankovich cycles provide the most significant revelation—energy modes and energy dynamics evolution in the troposphere, tropopause for the last 2.2 million years—when presented in graphs, illustrating temperatures with the impurities concentrations soil samples contained, which energy modes dynamics transport and deposit into soil deposits. In common, the graphs illustrate global energy modes cycled energy dynamics evolving the evolution energy in space and time domains.

Most critically, Milankovich cycles illustrate the prior science respective acclaims and models of the Earth's gravity field, the Universe energy structure embody deep, profound bungling, beyond any doubt. Concomitantly, said graphs in unison, one on top of the previous graph, show Earth's cycling energy dynamics and energy modes repetitious rebalancing over fifty times in the last 2.2 million years. The aforesaid painstaking details, the fundamental sciences correct such bungling.

The graphs of Milankovich cycles, Earth's energy modes energy dynamics temperatures, varies a CO₂ concentration in the troposphere space and time domains. The Earth's energy modes cycling energy dynamics repeat over fifty times in the last 2.2 million years wherein the troposphere CO₂ concentrations the prior science taken limit of 300 parts per million is also bungled. In evolution of the Universe energy structure especially, presuming the Earth's gravity CO₂ concentrations of 100-300 ppm in the troposphere and tropopause, governs the evolution energy rebalance by both structures, the Earth's gravity field, the Universe energy structure, in fact, affects invalid science.

An impurity concentration a noteworthy upward zag a noteworthy downward zig follows forcing a continual rising to a peak, to zag precipitously to a previous concentration nigh an all-time low. The impurities concentrations illustrated in one graph reveal the troposphere confines them; a zig zag, the zig-zag, a graph's zig an energy dynamics energy fall, a zag an energy rise, respectively.

Air energy modes dynamics cycling the interrelated, interdependent energy spawns water vapors, impurities concentrations in-common content. Cycling oxygen, nitrogen cycling the interrelated, interdependent energy and water vapors energy embodies the evolution energy. The interrelated, interdependent energy cycling engenders soil deposits in-common residues and not a total energy distribution; soil water/ice content is that in the ground not air and energy cycling left no residue.

For certain, plasma fountain outflowing an energy imbalance of Earth's cycled energy affects the evolution energy quantum energy distribution rebalancing the interrelated, interdependent energy and the relativity energy a redistribution that balances, affects boundaries perfections in the Solar System. The prior science and best minds irrational exuberances miss on ingenuity brilliance of the Universe energy structure, each and all structures cycling energy Heat Rate 100% efficiency.

It is nigh certainty that a celestial body or bodies in infinity of the Universe energy structure fail in continuously cycling energy Heat Rate 100% efficiency; the Second Law says such is the law. The troposphere through the Pleistocene Epoch cycles energy a Heat Rate nigh 100%, not 100% efficiency, and the interrelated, interdependent energy and relativity energy redistributions repeat over fifty times, over fifty glaciation cycling climate changes spawning Earth's energy evolution.

The Universe energy structure a timing mechanisms eternal, minute, quantum energy boundaries evolve longevities of large boundaries perfections. These, successive boundaries perfections and successively larger boundaries perfections affects energies cycling the potential energy one field, the Universe energy structure, bound hydrostatic and triaxial compressions into one energy field, Said forms of specific energies, the interdependences interrelated energies, and the energy genres innately mutual interdependence interrelated longevity bound by energy modes dynamics cycling energy, eternalized energy and the relativity energy and the rupture energy constitute in-common energy modes energy total energy distributions. Nebula cloud particles forced unison overcomes alike negative electrical charge flips energy actions into energy reactions, which flip plasma ions into atoms. Such a flip affects the evolution mechanism, the evolution processes, which the large sufficiently strong tridimensional compression depression of an energy field does; energy actions and energy reactions such flips reverse the evolution processes depending on an energy direction.

The energy relativity structures of the atmosphere, depending on energies in environment forcing directionality, may continue, stagnate and even reverse the evolution processes in Earth's gravity field evolution. Such occurs in the tropopause constituted boundaries perfections separating ions energy actions and atoms/molecules energy reactions. When atoms flip into ions, Earth's gravity field evolving continues. If such flips stagnate, gravity field evolution stagnates and if ions were to flip to atoms, the evolution processes directionality reverses to those in Earth's genesis period.

Said forms of specific energies, eternalized energy dynamics, cycling energy forms, the relativity energy, and the rupture energy, time domain cycling, in-common energy distributions are not one and the same forms of energy. Different forms of energy evolve differently. Aforesaid discloses that tridimensional compression depression eternalizes cycling energies into a cycling eternalized energy mass at a specific disposition distance from the focal point, which, in turn, imparts energy dynamics, frees energy modes of eternalized mass atoms molecules to spin, orbit and precession.

Such energy actions, reactions explain the evolution mechanism, the evolution processes of Earth Jet Streams and Saturn Rings. Wherein, the nebula cloud nigh identical energy actions, reactions a specific energy presence in tridimensional compression depression segregates by energy modes energy dynamics. The evolution mechanism causing such segregation moves energy modes high energy dynamics to a perimeter of the nebula cloud, yielding the evolution mechanism this stage.

At said perimeter a continual rise in energy modes volume and energy dynamics yields a Ring of energy modes energy dynamics, which eventually accrues the energy modes volume high energy dynamics to separate from a remainder of the nebula cloud; the Ring differentiated energy modes energy dynamics into a differentiated body completes the first stage of the evolution mechanism.

A body in motion stays in that motion, unless acted upon by an external force—the First Law. In said first stage, no energy exchanges take place by modes of energy dispositions inside the Ring. Energy modes energy dynamics of the Ring and the nebula remaining portion(s) repel each other due to alike electrical charge. Different volumes in tridimensional compression, permitted freely to displace, yield a gap that separates the two, completing the evolution mechanism second stage.

Energy modes energy dynamics in the Universe energy structure enforce energy actions flip into energy reactions by diverse energy dynamics in orbits, or spirals and/or tumbles, precessions and successive boundaries perfections energy dynamics. A disposition sufficiently close to the eye of tridimensional compression depression forces said flips and the evolution mechanism third stage.

Earth's gravity field, an altitude disposition nigh upper boundaries perfections of the tropopause, an elevation height, embodies a potential flip disposition. Above the troposphere all dispositions embody energy actions, below the troposphere energy reactions, and in the troposphere said flips may occur; the light fluids energy modes energy reactions passing into the ionosphere, buoyancy forced, flip into ions energy actions. In turn, energy modes releasing energy, in energy dynamics change, Jet Streams molecular fluids balance with troposphere's spin, orbit, precession energy in a planet genesis energy mode flips reversal, the evolution mechanism a reversal, the fourth stage.

Magnetic cusp an outflow of plasma energy modes completes that outflow plasma energy modes energy dynamics the Earth's gravity field an inflow and outflow, in out cycle. That cycle affirms gravity mass attraction nonexistence, wherein proof of that nonexistence is prima facie evidence the Second Law energy modes energy dynamics trace from the Solar System, the Earth's gravity field genesis, back into the Solar System and in that trace sees no gravity attraction force energy.

Said energy modes energy dynamics trace discloses technologies of the evolution mechanism the Universe energy structure effectuates, henceforth, the Universe energy structure technologies, all technologies in one technology,the technology, concomitantly quantum energy precise balances: energy modes energy dynamics in each boundaries perfections enclosed in successive boundaries perfections wherein each and all boundaries perfections cycle eternal Heat Rate 100% efficiency.

Technologies in the Universe energy structure, the technologies, sets a structure taken boundaries perfections of set forth a Region and/or sui generis boundaries structure sets fort individually and specific, an in-common, a clustering in-common or selection and/or selections four selections. In the four selections, the one specific and a selection in-common quantum energy boundaries taken boundaries embody quantum energy discerned modes energy dynamics quantum energy affected energy cycling comprising an absolute maximum Heat Rate—above or nigh the 100% efficiency.

The Universe energy structure yields tridimensional compression depression Earth's gravity field effectuating a potential energy field sink and energy modes' dynamics cycling the nullities' sums nullity. The Universe energy structure potential energy one field spawns potential energy gravity sinks nigh infinite number of quantum precise configurations and tridimensional potential energy fields one field; boundaries perfections in boundaries perfections in the potential energy one field energy dynamics energy redistributions of the relativity energy, the rupture energy interconnects.

Energy modes energy dynamics eternalized and cycling energy cycle ubiquitously. Such cycling embodies cycled energy closed loops, each loop embodying boundaries perfections in successive boundaries perfections. Each loop constitutes a gravitational field sink cycling energy Heat Rate 100% efficiency. The potential energy one field—the Universe energy structure—binds the loops.

A lapping, the lapping, of boundaries perfections inside the Universe energy structure boundaries perfections occurs for all boundaries perfections, wherein the lapping of at least three boundaries perfections occurs generally. The lapping grants energy modes energy dynamics a redistribution, concomitant boundaries perfections, the evolution mechanism evolving energy structures and the evolution processes, eternalized energy modes, energy dynamics evolving in the potential energy one field. Whereas, the curved space theorizing overlooks the lapping of boundaries perfections.

Whereas, cycling gravity fields embody the lapping of cycling respective energy forms and types in respective boundaries perfections, cycled energy forms and types and respective gravity fields do not merge into one gravity energy field. Nevertheless, apparent coordinated motions of Milky Way Galaxy, Solar System and Earth, all avoid a collision and disclose no presence of distinctive gravitational attraction forces presence that foretells a collision between any two celestial bodies.

On the other hand—for certain—the Universe, Milky Way Galaxy, Solar System, Earth respective energy structure a spin, tumble or spiral in respective planes at an angle to each other comprising the spin, tumble or spiral respective centripetal forces, which affect the tridimensional centripetal forces in Earth's gravity field; for certain, the prior science substitutes the gravitational attraction force of pat theories for dynamics of the tridimensional centripetal forces compression dynamics.

In such a frame of mind, the prior sciences improperly disassemble the Universe energy structure into celestial bodies and utilizes curved space-time to reassemble it, none of which holds true. In fact, the Universe energy structure comprises one energy field, the potential energy one field that does the lapping of at least three energy fields—the Universe, a galaxy, a planet—individually and jointly, in common successively compressing at least three nigh infinite volume of plasma clouds into internalized energy, mass, energy dynamics spawned said three successive energy structures.

If eternalized energy mass eternalized energy dynamics were to de-eternalize, the Universe could revert hack to one infinite volume plasmas cloud with very limited volume of free or open space. Each gravity field embodies the mass energy node and the integral effective unit of gravity fields affecting the potential energy one field, one structure of the Universe energy structure. Wherein,

Said mass energy node embodies energy dynamics “a stich seem” in the tridimensional compress compression a continuity. Each “stich seem” precludes energy dynamics a node de-eternalizing. The Universe energy structure affects the tridimensional compression depression cycling energy dynamics—gravitational field energy dynamics—which the prior sciences knowingly misapply to the gravitational attraction force, again, to empower theoretical science, relegate applied science.

A preconceived notion by global elite, in a significant part influenced by the theoretical sciences, assumes that structure appearance shows utility. None of such is the case in the fundamental, the advanced sciences in—gravitational field genesis, gravitational field energy dynamics, global air warming phenomenon and Universe energy structure real model; these four, the evolution energy technologies by environment structures cycling energy dynamics, the prior sciences and art miss.

Cycling energy dynamics spawned an explained and illustrated structure, in almost all instances, adequately claims that structure utility. Claimed structure utility by known appearance details of structure and cycling energy dynamics not known specifics, by disregard of the Second Law, can mislead badly, wherein structure technologies by the evolution energy threatens global genocide.

The prior sciences and art misses derail the prior sciences and art for the last three, especially the last century. Said four, the four most significant in environment structures and, herein explained, phenomenon of the evolution energy spawns in the past life on Earth, and now threatens it. Most of the prior science and art extensive bungling, herein explains, also; most mind boggling of such conceive two structures irrational boundary claiming the famous Equation (1), the Inequality (1).

Eternalized energy—the prior science mass—and cycling energy dynamics said free displacement comprises physically unoccupied space tridimensional compression field, energy dynamics freed space created by enormously compressed volume of a potential energy plasma field. The energy free space comprises granted space to eternalized energy mass in boundaries perfections, to spin, orbit, precession. Said free space eternally checks validations of eternalized energy dynamics of eternalized energy in the evolution stages, the evolution processes and the evolution mechanism.

The evolution stages, the evolution processes distribute the light fluids by plasmas energy modes dynamics on micro scale; the evolution mechanism distributes eternalized energy and eternalized dynamics in a macro scale energy modes cycle. The evolution stages, the evolution processes by plasmas energy modes cycling dynamics, occur in over fifty 41 ka time interval periods in each to accrue the rupture energy to rupture eternalized energy boundaries perfection of the troposphere.

The evolution stages, the evolution processes and the evolution mechanism embody the Universe energy structure in cosmological time stunning dynamics which the prior science misconstrues in entirety. Energy dynamics of eternalized energy mass in evolution mechanism, processes, stages the prior sciences misapply by confused mass and energy properties, mass weight and eternalized energy mass, and flowed models of gravity and Universe models; all of which aforesaid explains.

Supra correct the prior sciences acclaimed Einstein's Universe model. Undeniable fundamentals epitomizes incontrovertible fact that applying technologies applied sciences advance the sciences of Nature, period. The rest is doers do what they do to promote what elite does, to do what elites do. Theoretical science century of claims bizzaria exemplifies it, herein, shown none of it works.

Invalid science yields unacceptable technology. Substitution of weight mass, eternalized energy; gravitational attraction, gravitational dynamics; and energy dynamics Heat Rate 100% efficiency ubiquitous an in-common energy cycling, curved space time by each of the two a substitution, or especially in-common substitution is incontrovertibly not manifestations one and the same thing.

Cycling impurities concentrations, temperature variations paralleling zig-zags Milankovich show that the evolution energy dynamics cycle the interdependences interrelated energies of and by the impurities concentrations in the troposphere. An impurity cycles by its energy of reactions, only. And, impurities concentrations cycle energy reactions—only. Air Cells, Jet Streams cycle energy dynamics, if they were taken to leave a residue behind, than correct analyses of the deep core soil samples must accept that energy dynamics by energy actions in the troposphere leave no residue.

The prior sciences take the Universe, the Earth, and the troposphere structures respective models, environment structures, engendering a sanguine, benignant, isolate energy cycling. These energy dynamics flawed models of the evolution energy, the evolution processes, boundaries perfections energy dynamics, and especially boundaries perfections energy redistribution forcing yet another unacceptable energy actions and energy reactions substitution; science that makes for no science.

Impurities concentrations in air engender energy reactions response to energy actions presence in Earth's gravity field. Even when taken in-common, impurities concentrations cannot constitute a root cause of global air warming. Only, energy actions spawn a root cause. Cosmological global gravitational dynamics energy actions dominate Earth's energy fields. The evolution energy, the evolution processes, said evolution stages, and said Earth's evolution of its boundaries perfection evident redistributions engender innate chain energy reactions a response to energy actions, only.

Cosmological gravitational dynamics energy unavoidably embodies ultimate energy actions. Air Cells, Jet Streams energy reactions, a last link in said response to said energy reactions by energy reactions tracing path leads to energy actions—cosmological gravitational dynamics energy as the root cause of it. Impurities concentrations, especially CO₂ gases concentration, entirely engender energy reactions by the forms of specific energies, the interdependences interrelated energies in a response to solar insolation. CO₂ gas energetic response to solar insolation, the interdependences interrelated energies, especially misleads the prior science to see the CO₂ gases as the root cause.

The prior sciences fundamental sciences inappropriate mass and energy substitutions in the First, the Second Law an avoidance affects critical flaws in the Theories of Relativity, the gravitational theories and the root cause of global air warming. These profound flows show scientific theories are loose cannon shootings a hit or miss proposition. When applied science sets forth the details, an elite response—we know all about it, we discovered it!—are typical responses. The Newtonian gravitational said attraction Force (F) accepted as complete and correct gravitational theory, with F=G (m₁m₂/r²), m₁ and m₂ are the masses and, r an interacting separation and G, the gravitational constant, in fact, all are a crutch factors formula.

“Small discrepancies” noted in the Newtonian gravitation above given formula Einstein's curved space time Relativity Theories “supposedly” corrects. The prior sciences affecting the Relativity Theory deep flows fundamental sciences profound flaws, correcting the flaws in previous crutch factors “correcting” the crutch factors formula are exemplifying science work of the past century.

The prima facie credibility scientific evidence, herein, methodology shows that energy sources of gravity field force uniquely specific number of gravity fields affect by comprising tridimensional compression depression; therein, said energy field sufficient energy flips at least a portion of ions energy actions into energy modes eternalized energy bound in energy reactions energy dynamics.

Gravity field evolution fundamental science phenomenal unprecedented coincidence, the Second perpetuating the First Law by quantum energy dynamics precise cosmological sciences, affects a gravity field evolution—the cosmological sciences—all of which the prior sciences misconstrue in entirety. Flawed fundamental sciences burdened, the prior art does no better. There is no way to properly correctly evaluate an energy device structure and not know its energy cycling dynamics.

Said one mega system mega structure of four structures, including Pluto, consists of nine planets, nine planetary gravity fields in one Solar System gravity field(s) potential energy one field that is continually evolving from the solar nebula energy modes energy dynamics. The potential energy nine gravity fields of one gravity field continually redistribute energy modes energy dynamics by wave energy dynamics away from the Sun. These wave energy modes energy dynamics embody energy actions evolving the evolution energy. The impurities concentrations varied temperature, which graphically plot Milankovich cycles, shows boundaries perfections epigene surface energy reactions, responding to energy actions. All of which repeat over fifty times in 2.2 million years.

The prior science misconstrue mass and curved space time and eternalized energy modes energy dynamics a gravity field evolving with all its energy dynamics governing by the Universe energy structure. The prior science, by defending its theories, takes no prisoner; it substitutes CO₂ gases energy emissions which raise air temperature for energy of cosmological gravitational dynamics.

The impurities concentrations cycling energy dynamics can and do constitute energy reactions to energy actions and, thus, engender the interrelated, interdependent energy of the Air Cells energy modes energy dynamics, which, in turn, constitute energy reactions to cosmological gravitational dynamics energy actions. Such happens over fifty times on 41 ka cycles and in each of the cycles the magnetosphere boundaries perfections reset, due to energy modes energy dynamics of energy reactions inability to cycle Heat Rate 100% efficiency and balance imbalances by energy actions.

Energy modes energy dynamics by cycling energy actions and reactions disclose critical flaws in the prior science and the prior art granted patent allowances, which the texts of these applications detail; in the 21^{st} century, the prior science(s) and associated technologies granted patents cannot, do not work. Both unacceptably simplify energy dynamics to overemphasize or underemphasize energy device cycling energy dynamics, evaluating an energy device by its structure appearance.

Within each boundaries perfections energy reactions must in time domain balance energy actions cycling Heat Rate 100% efficiency. Otherwise, boundaries perfections an eventual rapturing and ceasing to exist occur; Mars, Moon, Venus and Mercury losing the light fluids are such cases. In the troposphere and tropopause, primarily the Air Cells energy reactions of energy modes energy dynamics a response to cosmological gravitational dynamics energy actions an inability to spawn Heat Rate 100% efficiency and balance Earth's gravity field is global air warming the root cause.

Boundaries perfections enormous flux spin balances the light fluids recycling energy reactions of the light fluids, the impurities concentrations in the troposphere, the magnetosphere; these energy reactions balance retain the ionosphere plasmas energy reactions in the intermediate gravity field bound by the Earth's magnetic field in the Universe energy structure tridimensional compression depression spins, orbits, precessions—the four structures in one energy field. The light fluids, the impurities concentrations, the ionosphere plasmas bound by the Earth's gravity ultimately strong energy field an energy reactions maximum in-common response to oppose, balance cosmological gravitational dynamics energy actions and which the other three of the four structures also affect.

The in-common maximum energy reactions response is preferred over a lesser and an inadequate one, since such a responses strengthens the Earth's gravity field, and no possibility exists that the maximum energy reactions response would spawn a catastrophe in and outside the Solar System. At the worst, Mars may warm a bit and, nigh an impossibility, Earth may cool more than desired.

The Second and the First Law tracing energy forms in the Universe energy structure affecting the prima facie credibility scientific evidence says cosmological global gravitational dynamics of the Universe energy structure energy dynamics affect the energy evolution forcing “global warming” global air warming phenomenon. A gravity field CO₂ molecular fluids cannot, do not ionize, and do not affect environment energy actions; these fluids, the impurities concentrations, conforming to gravity field energy dynamics can constitute energy reactions, only. These fluids energetically respond to solar insolation; but, again, these fluids can affect energy dynamics of reactions, only,

Energy modes energy dynamics traced from space into the troposphere and energy modes energy dynamics of energy actions, energy reactions in the troposphere concomitantly, separately affirm CO₂ gases concentration, the impurities concentration said water vapor excluded, cannot embody energy actions of global air warming root cause. Modes energy dynamics trace from space show that the evolution energy of the Universe energy structure affects the root cause; energy reactions energy modes energy dynamics unequal, unbalancing Air Cells response to energy actions affect root causes of the root cause—energy actions, reactions an unequal energy—the evolution energy.

Aforesaid summarizes centuries of profoundly flawed sciences into three examples, which reveal an appearance of a structure is not sufficient to evaluate functions of an energy device. The three examples—gravitational field force, the Universe energy structure and the root cause of global air derived by the prior science without tracing energy origins, paths, and dynamics according to the Second Law arrives at deeply flawed understanding of an energy device function and its purpose.

The three examples show that reliance on structure appearance is unwarranted and in key, crucial instances structure appearance misleads if details of energy cycling dynamics are not thorough or critically evaluated, by a valid methodology, according to the Second Law. The prior art a patent granted allowance evaluated consistent with the prior science relying on structure appearance can result in catastrophic consequences; “clean energy devices” exemplify flawed science applied art flawed utilization, in a jaw dropping, stunning purpose. The following true sciences exemplifies.

Aforesaid corrects the prior science understanding of the gravitational force, the Universe energy structure and the root cause of “global warming”. Not applying the Second Law misses entirely, crucially the evolution mechanism, the evolution processes by gravity field energy modes energy dynamics evolved nebula energy. The evolution mechanism and the forever technologies spawn maximum energy dynamics maximum energy modes cycling bounded by boundaries perfections.

The forever technologies eternalize maximum energy dynamics such as a planets, spin, orbit and precession, avoiding conflicts of their energy modes binding into boundaries perfections avoided energy dynamics directionality conflicts; in turn, granting spin, orbit, precession respective speed dynamics variation that retains boundaries perfections binding energy modes changing dynamics and energy cycling Heat Rate, at least, nigh 100% efficiency and in short geological period, only.

The forever technologies a gravity field maximum energy dynamics eternally bind, except for the light fluids energy modes changing dynamics engendered cycling energy boundaries perfections, the Universe energy structure, the potential energy one field, the evolution energy forcing energy redistribution. All which engender the evolution energy a continuous evolving of nebula energy.

The forever technologies spawning said continuous evolving of nebula energy into a gravity field evolves maximally small volume maximally eternalized energy modes spin, orbit, precession and the Universe energy structure maximally eternalized energy volumes Heat Rate 100% efficiency, compressed configured in, by energy dynamics of a tridimensional compression depression field.

None of maximally evolved parameters of the forever technologies the prior science imagines, or conceives possible. Yet, such is Nature. The Second Law guarantees it. The USPTO, the WIPO Laws and Regulations dismiss the forever technologies, by relying on flawed unreliable structure evaluation, only. “Operational Language” sets forth energy dynamics the Rules and Regulations and the prior science entirely disregard, which intentionally circumvents and bars presence of the Second Law. Only, set forth cycling energy dynamics fully describes an energy device structure. Operational language is absolute required to set forth, claim sciences of the forever technologies.

An energy device set forth energy cycling tells complete truth of what that device structure does. Described structure describes structure, only—and nothing more. This application with the prior applications sets forth incontrovertible prima facie evidence that deep profound flaws in the prior sciences, the Rules, Regulations, the IPCC that global elite carry on to combat “global warming”.

The prior science, the global elite claim to know structure, in turn, to misdiagnose the root cause and effect of energy dynamics the structure cycles. It happens in the three most significant cases, which the prior text details—the energy sources of gravity field, the wrong model of the Universe energy structure and most importantly the root cause(s) of “global warming” global air warming.

In unprecedented stunning blunder, the global elites couple the sciences deep profound flaws and the Rules, Regulations with the same deep profound flaws and implement “clean energy devices” in cycling energy environment the troposphere spawns—exactly wrong energy device types. The root cause of global air warming CO₂ air concentrations cannot affect spawning energy reactions, only. Then, solar isolation absorbed by CO₂ air concentrations is absorbed thermal radiation that, otherwise, likely affects water vapor which is greenhouse gas two to three times more potent gas.

Wind turbines, solar panels generated respective electrical energy power significantly syphons or block energy modes energy dynamics, in turn, energy phases, which the Air Cells cycling does to radiate thermal energy into space and cool global air warming; the Air Cells are doing their work free of charge at Heat Rate no less than 92% efficiency. Whereas, Heat Rates of solar panels and wind turbines range from 25% to 55% efficiency and Heat Rate efficiency net loss of about 50%, emits 45% to 75% more heat energy byproducts, than electrical energy produced. The impurities concentrations even if not seen in part to substitute for water vapors greenhouse gas effects show the “clean energy” devices to oppose global are warming are exactly the wrong devices to utilize.

The fundamental, philosophical Law that augments the Laws of Thermodynamics and maximum energy cycling Heat Rate 100% efficiency in dynamics of the Universe energy structure suffices, only, if the energy cycling energy modes energy phases engender cycling boundaries perfections; and—do otherwise and perish. Global elite is bent on the otherwise—planet Earth's life to perish.

The prior text explains, the root causes of global warming the evolution energy and the evolution processes spawn said four gravity fields in-common energy, constituting the potential energy one field. The Earth's energy bounded by boundaries perfections of the magnetosphere embodies in-common energy modes energy dynamics the Solar System, the Milky Way Galaxy, the Universe energy structure, the lapping, cycles balancing the potential energy one field in-common cycling.

CO₂ air concentrations of their own cycle the nullities' sums nullity spawns the interdependences interrelated energies to Air Cells energy modes energy dynamics energy reactions which respond to energy actions by the lapping of said other three of the four structures. Solar insolation energy action by the Solar System structure affected CO₂ cycles cycling the nullities' sums nullity in the lapping embody energy reactions a taken response to energy actions by the other three structures.

In each instance, cycling the nullities' sums nullity CO₂ air concentrations unavoidably comprise the interdependences interrelated energies to Air Cells energy modes energy dynamics, primarily a response to solar insolation energy actions. Thereby, the nullities' sums nullity cycling CO₂ air concentrations, even if in part taken as energy actions, unavoidably spawns the interdependences interrelated energies to Air Cells energy modes energy dynamics. CO₂ air concentrations cycling the nullities' sums nullity cycled energy ameliorates global air warming, especially when CO₂ air concentration is taken as energy beneficially substituting for energy of water vapor content in air.

The root cause of global air warming resides in the lapping of the four structures wherein Earth's troposphere cannot, does not cycle Heat Rate 100% efficiency while the other three structures do and force it. The lapping, in turn, affects a cycling energy imbalance, which affects the evolution energy, the evolutions processes, and energy redistributions. All three of these manifestations of cycling energy forms do not stop from a nebula cloud evolving, varying respective evolving rate. It comes down to Air Cells, Jet Streams energy reactions to cycle the Heat Rate 100% efficiency in-common responses to balance energy actions by the other three structure, three mega systems.

More precisely, the lapping energy structures effectuate the lapping of energy fields. The Earth's gravity field entire energy is lapped by energy fields' respective portions of the three much larger energy fields. The lapping incontrovertible physical prima facie evidence entirely invalidates the Theories of Relativity demonstrated by supra Inequality (1). Here, also, discloses Earth's gravity field energy true energy source invalidated most of the prior theoretical science key, fundamental principles, which must unavoidably raise issue with the USPTO granted licenses in energy fields.

The one energy mega system mega structure, the Universe energy structure, spin, orbit, or spiral, or tumble and precession, which bind the four boundaries perfections, the four structures into one mega system mega structure do and must insist that the light fluids cycling rate, the Air Cells, Jet Streams cycling rate balances energy actions imposed by all four energy structures especially the solar radiation and irradiation; the mega system mega structure energy balance cycles either Heat Rates 100% efficiency or energy redistributions occur in all boundaries perfections which do not.

The prior text claims incontrovertible undeniable evidence that the evolution mechanism with the evolution processes affects energy actions of the root cause of global air warming. The evolution mechanism energy dynamics flip; the evolution processes energy modes phases flip—both energy innate genres. Energy modes flip proximate or not a gravity field eye, and concomitantly, energy dynamics segregate spin, orbit and precession. Energy phases flip lacking, or not lacking, energy cycling dynamics and/or thermal radiation energy, which evolves energy evolution directionality.

The evolution energy, by the evolution mechanism and the evolution processes respective energy evolution directionality, respective flips of energy modes, energy dynamics and modes of energy phases uniquely paragon the Earth, the Solar System respective evolutions. The potential energy one field, the Universe energy structure, does said do loops of the primary structures, the gravity fields, cycling the evolution energy spawning the evolution mechanism, the evolution processes.

The do loops energy balancing distributions, redistributions implement the evolution mechanism, the evolution processes of the evolution energy which continually affirms boundaries perfections of the primary structures and energy structures, generally, Heat Rate 100% efficiency, especially, in the potential energy one field, at large. The do loops do energy distributions, redistributions to the primary structures with the energy structures quantum energy precise boundaries perfections.

The Earth's gravity field cycles one do loop for each of the impurities concentration cycled in the troposphere, the tropopause and a do loop that cycles water vapor, comprising the nullities' sums nullity, which the prior applications explain. The claim CO₂ concentrations lowers a water vapor concentrations makes all CO₂ concentration in air a retardant agent, not a root cause of global air warming, is a valid point. Supra energy actions, reactions analyses affirm the troposphere cycles only energy reactions, and affirm incontrovertible science prima facie evidence that the Universe energy structure embodying the evolution energy engenders the root cause of global air warming.

Energy reactions of the CO₂ air concentrations entire cycling energy of the nullities' sums nullity embodies inadequately small energy compared to potent energy of the evolution energy. Also, it inadequately small energy reactions in comparison with entire energy of the Air Cell, Jet Streams energy reactions energy cycling response to the evolution energy, energy actions which engender the root cause of global air warming. Energy of the CO₂ air concentrations entire cycling energy, which, concomitantly, the Air Cells cycling energy cycles in the light fluids cycling environment spawns the interrelated, interdependent energy to the Air Cells cycling energy. A capacity of the CO₂ air concentrations to affect in-common the interrelated, interdependent energy, the Air Cells energy cycling affirm the CO₂, the impurities concentrations are global air warming retardants to an extent that otherwise water vapors more potent greenhouse gas would replace in environment.

The Universe energy structure cycling the do loops which cycle the evolution energy spawns the root cause, energy actions, of global air warming. The only possible energy reactions, to balance the root cause(s), energy actions, reside in energy reactions of Air Cells cycling energy response. The root cause(s), the difference in energy of energy actions, energy reactions, constitutes energy magnitude difference in the evolution energy in environment. Glacial, interglacial period change in temperature discloses magnitudes of the evolution energy in interglacial and glacial respective periods rise, drop and slow. The evolution energy cycling magnitude changing Air Cells cycling energy reactions, environment energy actions engender, in the Pleistocene and Holocene Epochs.

A significant change in said environment energy actions, energy reactions, which spawn in these Epochs is water vapor content in the air, along with the impurities concentrations. Due to falling and rising temperature, incontrovertible prima facie evidence discloses rising temperatures boost the impurities concentrations in air, not the other way which the prior science claims; in turn, the environment energy actions, energy reactions, in the Pleistocene and Holocene Epochs changing climate, support said claim that the impurities concentrations may ameliorate global air warming. We know—for certain—rising temperature the impurities concentrations in air, especially a water vapor content of air, since water surface by far exceeds the impurities concentrations in-common surfaces. No other eternalized energy participant, other energy reactions participant than a water vapor content, by Air Cells modes of energy dynamics cycling energy phases, in said Epochs can evolve repeatedly energy actions and energy reactions of the root cause(s) of global air warming.

Traced energy modes energy dynamics energy phases respective flips and changes from the solar nebula into the Solar System disclose, correct the prior theories, theoretical sciences bungling pat sciences of fundamental sciences for centuries, especially the last century especially the last three decades; the bungling unrestrained through centuries, culminates in global blunders which blame global air warming on the CO₂ air concentrations. Global scientists, global elites promote global theoretical science blunders to practice by utilizing exactly wrong energy devices in environment to oppose global air warming, imposing unavoidable present and unforeseen future ramifications.

Irrational exuberance of perceived science contributions, yet flawed theoretical sciences, entirely misses nonexistence of gravitational mass attraction genre, planets balancing energy dynamics of the Solar System and Earth's gravity field energy dynamics of continual evolution forced climate changes in the last 2.2 million years. For the last three decades, the same sciences perpetuate the theoretical sciences same flaws and assign global air warming to CO₂ and AGW emissions rather than gravity field evolving energy. In turn, global elite installs the exactly wrong energy devices.

Common knowledge that rising temperatures boost water vapors content in air, which, in turn, do boost temperatures, can get out of control if unchecked, the prior sciences bungling sciences turn that common sense knowledge into issues of CO₂ emissions. In context of the Second Law trace of energy modes in space, the prior text does in particular, water vapor content in the atmosphere and atmospheric temperature of the five planets closest to the Sun, tell nigh all we need to know.

Proximity to the Sun and a water vapor content in atmosphere warm and/or overheat a planet due to solar insolation, subsequent to the Solar System genesis, which redistributes rebalances energy engendering the evolution energy in the potential energy one field, the Universe energy structure. The evolution energy invokes the do loops, the evolution mechanism and the evolution processes and boundaries cycling energy modes energy dynamics energy phases by boundaries perfections.

Convincingly, Mercury and Venus evolutions by respective boundaries perfections are at nigh an eternal state hot status. Evolution of Saturn and the Rings appear in an awkwardly, unexpectedly interrupted incomplete state. Mars epigene surfaces nigh an eternally frozen status discloses that it lost water, showing surficial features typically eroded by fluvial erosions. The Earth's epigene surface is starting to show localized fluvial erosion devastation in the last two decades. The prior science misapplies it to AGS CO₂ air concentration, again. Milankovich cycles graphs of energy reactions, show the evolution energy decidedly gaining momentum, threatening a hot state status.

The invention discloses alternating current, three phase and four pole induction device, induction motor that engenders the forever technologies a maximum energy cycling of energy forms and in an analogy with gravity energy fields energy cycling. The analogy the prior science and art need to appreciate or learn to appreciate, especially the theoretical sciences. To date, the prior science and art ignore that analogy unavoidable realities and a most important Law of Nature, the Law of Nature, which the Universe energy structure imposes on all energy structures—cycle energy Heat Rate maximum efficiency toward 100% efficiency or perish. Failure to see, recognize Heat Rate maximum efficiency mandated by the Law of Nature, results in the prior science and art utilizing the exactly wrong energy devices cycling energy in environment, to further imperil life on Earth.

Said Law of Nature, the Law of Nature, supervenes upon all other energy environment governing and utilized the evolution energy in time domain to implement itself Criteria governing all other environment energy laws includes, supervenes upon the Laws of Thermodynamics and mandates that boundaries perfections cycle environment energy Heat Rate 100% efficiency in time domain and, likewise, also cycle energy modes, energy phases, energy dynamics ultimate energy cycling.

That energy cycling, the ultimate energy cycling, differentiates energy forms epitomized by spin, orbit and precession delineation mandated by the Law of Nature, the evolution energy in a planet genesis. The evolution energy, the Law of Nature concomitantly supervenes upon all boundaries perfections energy cycling energy modes, energy phases, energy dynamics ultimate cycling in all gravity fields' respective, ubiquitous and concomitant Heat Rates energy cycles 100% efficiency.

Energy forms followed from their roots in plasma clouds or solar nebula discloses energy actions randomly cycled energy field of tridimensional compression depression a flip into cycling energy reactions in common orderly spin, orbit and precession and said depression energy field affecting a gravity field energy dynamics. The followed energy roots affirm the prior science substitutes a celestial body mass attractions for a gravity field energy dynamics in a deep and fundament flaw.

Understanding of gravity fields, said deep flaw in the prior science permits a computed irrational results delusion of curved space time, which supra explain, to irrationally stand-in for the Second Law, said Law of Nature, and the evolution energy cycling science of cosmological gravitational dynamics. The prior science adopted key Theories relegate cosmological gravitational dynamics to mathematical computing evaluated energy structures based on perceived structure appearance.

By ironic twist of faith, Einstein stating “mass and energy are manifestations of one and the same thing” is practicing art; it is a broad brush not a precise scientific statement. In a broad inclusion, anything manifest everything by energy quantum dynamics. Tesla, the all-time greatest inventor, argues science. Energy modes, energy phase, energy dynamics cycling mutually opposed energy actions, energy reactions is not one and the same thing, neither are plasma and gravity field fluid.

The Second Law and said Law of Nature unavoidably relegate a structure appearance to rigors of cycling energy dynamics. The prior science fools itself respective through three and one century, by structure appearance, promulgated existence of mass gravitational attraction and curved space time. Applied sciences innovation relegates to Rules and Regulations for the last three centuries, especially the last century, the last decades; whereas, applied sciences technology leads sciences.

This application epitomizes aforesaid. Said entropy representing diversity of the Second Law, in turn, discloses said Law of Nature and executes hara-kiri of global sciences elite, elite in general. It happens when, in addition to the prior science and Laws and Regulations, global elite relegates the Second Law to bungled modeling diversities of the Second Law, the entropy, which engender global air warming phenomenon; that bungling is unavoidable due to involved extreme diversity. Said hara-kiri happens due to the science sciences flock mentality spreading into elite, in general.

If one theorizes that Earth orbits shift causes glaciation periods climate changes, only a tracing of energy dynamics forcing the orbits shift can affirm such is the case; wherein, Milankovich cycles provide best possible scientific data. All such disclose the prior science top elite influence which relegate the Second Law in cycling energy dynamics, especially those cosmological gravitational dynamics spawn. The prior sciences top elite and influences taken posture deny a Law of Nature existence, the Law of Nature existence, the evolution energy existence, this application discloses.

The Law of Nature existence, the evolution energy existence, sets forth that environment cycling, fluxing energy dynamics spawning boundaries perfections cycle, flux Heat Rate 100% efficiency or cycle, flux Heat Rate maximal efficiency provided larger boundaries perfections cycling Heat Rate 100% efficiency enclose boundaries perfections cycling energy less than 100% efficiencies. Otherwise, entire chain of boundaries perfections successive enclosures adjusts respective energy cycling and respective boundaries. Weak energy boundaries yield first, forcing changes by other boundaries perfections comprising cycling energy dynamics a chain of the successive enclosures.

In the Earth's gravity field, the troposphere tropopause bound molecular fluids comprise weakest boundaries in chain of boundaries perfections, which spawn the energy relativity structures of the atmosphere. In the Solar System, the Law of Nature existence, the evolution energy existence, is apparent in energy modes, energy phases, energy dynamics of the Earth's troposphere, the Saturn Rings cycling metastable boundaries perfections. A planet epigene surfaces represent boundaries perfections respective chains, effectuating in parallel boundaries perfections of the Solar System.

The Earth's glaciation periods disclose the troposphere metastable boundaries perfections, which undergo climate changes, while Mercury, Venus, and Mars lose the light fluids; wherein, the first five planets undergo epigene surfaces significant in the Solar System subtle changes by continual evolving. Mercury, Venus and Mars epigene respective surface a proximate eternal status leaves Earth, Saturn Rings balancing the potential energy one field inside boundaries affecting the Solar System, since in the other planets, the energy evolution engenders stable epigene frozen surfaces.

Science technologies, the technologies, the prior text details and the Law of Nature, the evolution energy yield one and the same environment technologies; in magnitude they are, in the evolution processes the latter two precisely affect energy reactions, energy actions balanced energy phases, energy modes, energy dynamics in environment. The evolution energy engenders energy actions a chain of boundaries conforming to the First Law, the Law of Nature, which mandate successive boundaries perfections boundaries, energy phases, energy modes, energy dynamics must balance.

Pressure, temperature gradients spawn energy phases, energy modes and energy dynamics within boundaries perfections, affecting concomitantly the evolution energy, the Law of Nature balance. Boundaries perfections and cosmological gravitational dynamics energy cycles sustain Heat Rate 100% efficiency, only. For certain, within boundaries perfections of the troposphere, tropopause the light fluids cannot cycle Heat Rate 100% efficiency, unless changing energy phases changing energy modes spawns the Air Cells, Jet Streams energy dynamics cycling above Heat Rate 100% efficiency; Milankovich cycles show over fifty instances in 2.2 million years such is not the case, and energy dynamics in the energy relativity structures in each instance outflow plasma to space.

A tridimensional compression depression energy field a gravity energy field genesis affects and a base reference of cycling energy phases, energy modes and energy dynamics a precise balancing. A gravity energy field's eternalized energy, the prior sciences mass, a spin, an orbit, a precession essentially sustains the base reference for cycling energy dynamics and not for energy phases and energy modes. Eternalized energy, the prior science mass, manifests an energy balancing energy reactions. Other energies cycling spawns unbalancing energy actions. Said mass, the eternalized energy, the other cycling energies reactions manifest in reactions, actions two opposing energies.

Earth's energy budget reveals thermal energy imbalance and the troposphere rising temperatures and shows energy actions exceeding energy reactions loses Earth's gravity field plasma to space. Since the evolution energy, the Law of Nature is one and the same magnitude opposing forms of energy one and the same, energy phases, energy modes and energy dynamics engender global air warming phenomenon in the troposphere and in that order; there is no doubt about it whatsoever.

Inadequate energy phases cycling discloses CO₂ air concentrations do not affect the root cause of global air warming. Likewise, global air warming phenomenon imposed “clean energy devices”, the prior art set forth to mean wind turbines, solar panels syphoning environment energy cycling, utilize precisely the wrong energy devices, to oppose global air warming; the maximum possible rate cycling changes of water phases affects maximum thermal energy radiated into space. Supra induction motor failures list lists the power supply issues as one of the five causes. Adding more energy devices to an inadequate power supply unavoidably must overheat also the power supply.

In tropopause, energy modes energy reactions can flip the light fluids into ions energy actions; in such flips reverse plasmas into atoms and molecules flips which a planet genesis affects, reverses the evolution processes and in the Earth's case sustain; keep boundaries perfections of the energy relativity structures. In Pleistocene Epoch 41 ka cycles, Milankovich cycles show, energy modes flip rebalances the energy relativity structures, resets boundaries perfections and outflow plasma.

It is a minor miracle that boundaries perfections of the energy relativity structures keep resetting, especially in the late Holocene Epoch. Such a future resetting may not repeat again. Boundaries perfections of the energy relativity structures resetting upon energy dynamics changed spin, orbit or precession by energy actions, which overpower Earth's gravity field energy eternalized energy dynamics spin, orbit, precession energy reactions are unlikely. The energy relativity structures in an energy dynamics spin, orbit, precession change, comprising metastable boundaries perfections status, most likely would not reset, nor would the intermediate gravity field. For certain—Earth's climate changes, the glaciation periods, occur due to energy dynamics cycles of Air Cells cycling environment Air Cells cycling pressures, temperatures and energy dynamics respective gradients.

The minor miracle grows into the miracle of Earth's magnetic field in the Universe, which yields magnetic field sufficient energy for magnetic lines quick reconnecting, when outermost magnetic lines disconnect, especial after or in plasma outflows. Strong magnetic field contains Ionosphere huge volume in the globose spherical confinement, by the tridimensional centripetal forces of the gravity field and the overburden pressure of a hydrostatic compression depression tridimensional bottling up atomic, molecular fluids energy cycling the tropopause, troposphere. Confinement of the atomic, molecular fluids by Earth's gravity field, unprecedented in the Universe, supports life which cannot cycle Heat Rate 100% efficiency, wherein the Universe in entirety does and insists.

Mars losing the light fluids leaves the Saturn Rings and Earth's troposphere as the weakest of the Solar System spawned boundaries perfections, which the Universe energy structure, the potential energy one field, relies on to balance energy dynamics the Solar System, the Earth and the Saturn respective gravity fields cycle. Celestial bodies in the lapping in the Universe energy structure of at least three gravity fields assures that each gravity field embodies the mass energy node and the integral effective unit of gravity fields constituting the potential energy on field and the Universe energy structure one structure. All of which affirms, herein, disclosed the model of the Universe.

Wherein, the Earth's Ionosphere, the intermediate gravity field, with the Saturn Rings effectuates the one energy field respective intermediate gravity fields, respective cycling energy dynamics to balance imbalances, the evolution energy, and spawn energy demand in the Solar System. Black Hole, the inverted centrifuge device affects negative back pressure, while the Sun affects positive front pressure, both spawning energy actions energy unbalances, the evolution energy. A gravity field's cycling energy dynamics must balance its energy field energy dynamics, temperatures and pressure gradients, also comprise energy reactions to balance the Sun, Black Hole energy actions to retain its boundaries perfections; or, its boundaries perfections evolve toward eternalized

Second Law of Nature inferred from the evolution energy and the First Law of Thermodynamics mandates a gravity field continuous maximum energy cycling, which balances its energy phases, energy modes, electromagnetic field energy dynamics respective cycling and inn the Earth's case Air Cells, Jet Streams energy dynamics atomic, molecular respective energy gradients balancing.

Magnetosphere instant, stunning and enormous flux, in part compensates for the Air Cells energy slow cycling rates to balance timely energy phases, energy dynamics respective energy gradients. Outermost magnetic lines in the Solar System embody one of the weakest boundaries perfections and concomitantly the strongest magnetic field lines epitomized by volume of the Ionosphere. In the Solar System, it comes down to planet dispositions of boundaries perfections in respect to the Sun, its boundaries perfections relative strength, and energy rate cycles balancing specific energy gradients of energy phases, energy modes, and in the Earth's case the Air Cells energy dynamics.

Third Law of Nature requires the evolution energy, the Law of Nature to evolve first the weakest chain of successive boundaries perfections; in the Solar System among planets, it comes down to the Universe energy structure, the potential energy one field, balancing boundaries perfections of the Solar System by respective energy dynamics of the intermediate gravity field of Saturn Rings or the energy relativity structures. And, comes down to boundaries perfections relative strengths, distances of the Saturn Rings, the Earth Air Cells Jet Streams and energy phases unique cycles of the two, due to exposed Rings, confined Air Cells by their respective gravity and magnetic fields.

The Third Law of Nature also sets forth maximum energy cycling dynamics environment cycling energy to exceed a weak chain of respective boundaries perfections strength spawning successive boundaries perfections, since the evolution energy evolves weak boundaries first. And, the Third Law of Nature, the evolution energy of the Law of Nature evolves first boundaries perfections by water phases evolved boundaries perfections, since these evolve weak boundaries; energy modes flip occur subsequently. A celestial body evolving energy dynamics spin, orbit and precession is extremely rare, obscure, unique event. After plasma outflows, epigene accrues ice phase forcing a glacial period, and a subsequent water vapor phase accruing in air forces an interglacial period.

Over fifty Milankovich cycles show exactly such water phase changes spawning climate changes and the evolution energy profound flips balancing energy dynamics of energy modes—the energy actions energy unbalances, energy reactions balancing—to balance the potential energy one field, portion comprising boundaries perfections, the gravity fields in the Solar System. The impurities concentrations only intervene, arguably either a catalyst or a retarder and likely both in global air warming phenomenon, which diversities of pressures, temperatures and energy dynamics affects.

Changing water phases comprise a primary agent, the primary agent, of the evolution energy that concomitantly forces energy modes to flip climate changes and boundaries perfections balancing. Tracing energy phases, energy modes and especially energy dynamics affects internalized energy dynamics spawning the prior science mass from plasmas of solar nebula into gravity fields of the Solar System. In turn, these tracings disclose tridimensional compression depression field of the potential energy one field, the Universe energy structure, constituting the lapping of at least three and in the Solar System's case energy dynamics four gravity fields in each planet's gravity field.

These tracings mandated by the Second Law prove the prior science claims to fame accolades, in fact, practices art from time of its conception and especially during the last century. And, in fact, the prior science is not a valid art, since that art evaluates or perceives an energy device utility by appearance and description of its structure alone; that is with no participation of the Second Law.

The Earth's gravity disclosed source(s) of energy, in turn, show correct art is science, the science at its best and proven in practice, not anointed by elite Associations and Rules or Regulations; all of such art is rooted in the existence and longevity; and, not in a theory or an experiment, both of which, incontrovertibly fail at most crucial time in most critical experiment—to oppose Nature of the evolution energy—global air warming phenomena whose roots the lines of this text identifies.

The Earth's gravity disclosed creation, genesis and evolution in time domain, discloses an energy device structure sciences and science technologies, the technologies, the forever technologies, by environment affected cycling energy dynamics. In boundaries perfections by cycling energy, the technologies affect energy device structure cycling energy Heat Rate 100%, maximum efficiency for respective plasma, molecular/atomic fluids; in boundaries perfections presence, in one of said two fluids, the technologies discern energy forms type and directionality and minimize a volume of an energy device structure and energy forms each type maximize its energy dynamics cycling.

The forever technologies, the technologies, utilize and affect, implement energy cycling quantum dynamics, which the Universe energy structure, the potential energy field, affects to cycle energy of cosmological gravitational dynamics and create, affect and evolve cycling energy dynamics of gravitational fields. Wherein, quantum precise cycling energy directionalities minimize structure volume, in turn, maximizes cycling energy dynamics and embodies the sui generis boundaries of fluids, structure interface and cycled energy dynamics respective Heat Rate maximum efficiency.

The present invention utilizes wire of an electrical conductor proximate a rounded entirely cross-section, affecting a barely rectangular hexagonal cross-section for wound wire coils. Such cross-sections of wire best stacks, compacts into winding coils least volume maximum number of coils minimized each stator slot cross-section area. Electrical conductance of such wire coils is on par with electrical conductance comparable to wire size engendering rounded entirely cross-sections. Said electrical wire cross-section, the slot minimized volume, maximized conductance in each of the slots minimizes the yoke, the induction device volume and weight and maximizes said device Heat Rate maximum efficiency, comprising each of energy forms type maximum energy cycling.

The prior paragraphs maximum and minimum properties the Earth's gravity field spawns, which segregate discerned maximized spin, orbit and precession of eternalized energy, mass, maximum dynamics in tridimensional compression depression energy field minimalize volume of the mass, where said depression continuous minimizing the mass volume sustains energy maximal cycling. Milankovich cycles show Earth's mass minimizing sustains its energy maximum cycling; and, to oppose global air warming, wind turbines, solar panels are precisely the wrong devices to utilize.

The prior paragraph epitomizes failures of a structure appearance to set forth energy devices true function. Whereas, to the contrary, cycling energy dynamics sets forth fluids, structure interface, the sui generis boundaries perfection, the sui generis boundaries perfections; the latter pertains to needed specificity in a plurality of boundaries perfections such existence which supra enumerate.

A device structure cycles fluid energy; only, the sui generis boundaries of boundaries perfections yield cycled energy dynamics, device structure interface energy unique cycling maximum utility. Inventing device maximum utility is the objective—drawings affirm a structure taken appearance.

Only, the PPLSLS, the maximum conductance, Heat Rate maximum ultimate efficiency governs, said ‘maximum ultimate’ only emphasizes ‘maximum’—and/or a greatest possible quantity, only. Pick one of the three. A structure appearance misleads, misleads Newton 300 hundred years ago, misleads Einstein 80 years ago, the prior science, also, and decades ago, relative to energy source of gravity, the Universe model, and root causes of global air warming, respectively; for 300 years conclusively and repeatedly structures constituted appearances mislead theories, science, and art.

The PPLSLS, the sui generis boundaries of boundaries perfections, the maximum conductance of cycling energy flow concomitantly occurs; the Second Fluid Element, quantum energy algorithm in the prior applications claims it. Said quantum energy algorithm disclosed the PPLSLS reveals Heat Rate maximum efficiency cycling flow paths-of-passage lengths the least sum and structure energy cycling perfect flow and the maximum conductance quantum quanta cycling flow energy.

The maximum conductance flow yields perfect structure. The maximum conductance a structure cannot disclose, unless the PPLSLS energy cycling dynamics affirm that such is the case, indeed. A fundamental specific structure ubiquitously utilized, or for a practical purpose a structure takes shape a fabrication process imposes. The structure specific sui generis boundaries of boundaries perfections discloses utility of energy directionalities and energy forms cycling energy dynamics.

Conforming to the forever technologies, the barely rectangular hexagonal cross-sections coils fill filling the stator slots engenders the fill, the maximum conductance energy forms energy transfer cycling. The fill thermal and electrical conductance, the maximum conductance energy transfers overall engenders ability by the slot, the stator to cycle energy Heat Rate maximum efficiency, to meet the Law of Nature by cycling energy dynamics cycled in successive boundaries perfections.

The forever technologies, in analogy to gravitational field genesis, an energy device must discern concomitant energy type forms, affecting the maximum conductance, the PPLSLS and Heat Rate maximum efficiency (each of the three comprising one and the same thing), wherein each energy type comprises the maximum conductance cycling its energy type confined within the sui generis boundaries respective boundaries, which engender the maximum conductance granting its energy cycling Heat Rate maximum efficiency; the present invention spawns a clustering, the clustering, of the sui generis boundaries and shows pluralities of, in pluralities of the sui generis boundaries.

Conversely, the same analogy provides environments energy confirmatory affirmance. Wherein, in analogy to induction motors, planet gravity field genesis energy phases, energy modes, energy dynamics embody a plasma energy field random, amorphous cycling, which the Universe energy structure retains in tridimensional compression depression. Concomitantly segregating discerned spin, orbit, precession causes each energy form conductance, in turn, the maximum conductance.

The spin caused hydrostatic compression compresses, segregates and internalizes cycled plasmas relative energy to eternalized energy dynamics atomic and molecular structures, the mass. In the Earth gravity field energy dynamics in the tropopause atomic, molecular structures return back to plasmas random amorphous cycling random conductance retained in Earth's magnetic field upon leaving hydrostatic confinement by Earth's compression depression spins, orbits and precessions.

Continuing prior noted analogies and the potential five causes of failure induction devices spawn finds Earth's gravity field each and the same cause spawns the evolution energy. Comparing two greenhouse gases in air, CO₂ 400, water vapor 20000 per million respective concentrations, finds water vapor mass is fifty times greater and a more potent greenhouse gas warms the troposphere.

The two greenhouse gases parts per million show temperature rise evaporates into air much more water vapor than emits CO₂ gas, from at one time nigh nullity of each on entirely frozen Earth; in turn, water vapor parts per million force temperature rise and CO₂ concentrations rise. Air Cells, especially Hadley Cells relative conductance cycling energy dynamics, energy modes and energy phases cycle below Heat Rate 100% efficiency. Computed Earth energy budget tells—for certain—such is precisely the case. We know—also for certain—an air, water vapor concentration cannot cycle Heat Rate 100% efficiency; over fifty Milankovich cycles affirm precisely such is the case.

The five causes of failure of induction devices evolve from within evolution energy environment, which cycling energy phases, energy modes, energy dynamics spawn in environment, manifested by rising temperature, generally. That rising temperature the relative conductance drop affects in environment energy phases, energy modes and energy dynamics slowed energy cycling in the sui generis boundaries perfections or in boundaries perfections affected cycling energy environment.

The continued prior noted analogies find that 400 ppm CO₂ air concentration may not result in an induction motor electrical short. Additional syphoning of electrical power supply from the motor is going to fail the motor—no doubt about it. Whereas, the glaciers melting phenomenon leads to extinction of life. Additional syphoning of cycling energy, energy phases, energy modes, energy dynamics, which engender the relative conductance and temperature and pressure gradients is air masses is going to fail boundaries perfections of the troposphere—no doubt about it—whatsoever.

The continued prior noted analogies conclude that almost all of the prior science, the global elite, and mass media need technologies art training to understand global air warming phenomenon, or the in common goal main objective is to outflow mass portion of the troposphere and force affect Air Cells a glacial period energy cycling. For certain—the former is the case. Said prior science, the global elite and mass media doing bungling for the last three hundred years this text explains.

Disclosed existences of the relative conductance in cycling energy, energy phases, energy modes and energy dynamics in environment cycling discloses Milankovich cycles illustrated 2.2 million years over fifty plasma outflows incur a mass budget of the light fluids stunning losses; Air Cells cycling energy, the relative conductance forces the Earth's glacial interglacial periods of the past.

The relative conductance incontrovertible science evidence affirms that Air Cells cycling energy, cycling dynamics engender the root causes of now noticeable global air warming. Wherein, also, the relative conductance confirms, wind turbines and solar panels are precisely the wrong energy devices to oppose global air warming. These devices sharply degrade the relative conductance in air energy cycles, forcing apparent air warming. A CO₂ air concentration AGW caused, rising in sympathy with energy reactions to solar insolation affects global air warming dual participations.

Of course, CO2 air concentration boosts the relative conductance in cycling air mass spawned by temperature and pressure gradients. Melting glaciers, conducted modeling experiments confirms that such is the case. However, that boost in the relative conductance that is additionally melting glaciers cools the light fluids, which slows global air warming, slows air temperatures rising and, in turn, slows water vapors rising from epigene surfaces. All which slows global air warming; in clean air, the low relative conductance raises temperature, evaporates more water vapors into air.

The relative conductance in successive, in common a plurality of the suit generis boundaries with environment boundaries perfections are entirely missing in the prior science and art. The present inventions affect a gravity field most important energy properties of an ultimate induction device a planet genesis affects; the ultimate induction device yields the ultimately compact structure that distinguishes forms of cycling energy types, engenders each energy type respective directionality and respective energy types the maximum conductance cycling ultimately short paths-of-passage lengths sum least sum, the PPLSLS, unavoidably cycling energy Heat Rate maximum efficiency.

An ultimately compact energy structure thermal energy maximum conductance, electrical energy maximum conductance, where electrical energy cycling densities transfer to electromagnetic flux cycling densities greatly increase over the prior art by the ultimate energy device said plurality of sui generis successive boundaries perfections in the ultimately compact energy structure. Where, thermal energy maximum conductance, electrical energy maximum conductance in said plurality of said sui generis successive boundaries perfections embody absolute maximum surface areas of respective interacting perimeter surfaces of stator coils and stator coils dual layer, which imposes electrical insulation compressed insulation volume least needed thicknesses least needed volume; the ultimately compact energy structure affects 140% greater number of stator coils in stator slots than the prior art, with 15% larger cross sectional area in each of winding coils over the prior art.

Said plurality of said sui generis successive boundaries perfections of the ultimate energy device, where said ultimate maximum conductance of electromagnetic thermal energies cycling energies boosts cycling energies cycled Heat Rate efficiency of Earth's gravity field, where “the Wheel of Nature” said maximum conductance positively, absolutely minimizes global air warming effects.

Where, the sui generis boundaries in the Universe energy structure, the Universe energy structure common boundaries perfections, balance insolation energy actions, energy reactions by a lapping in the Universe, Milky Way Galaxy, Sun and Earth gravity fields an in common energy evolving. A lapping of gravity fields balances the potential energy one field, the Universe energy structure, which evolves balance of energy forms, types and respective energy directionalities the evolution energy spawns inside boundaries perfections in the Solar System; energy reactions slow response to insolation energy actions accrues the evolution energy, insulation energy actions, within weak, slow responding boundaries perfections, wherein slow responding boundaries perfections in time domain accruing insulation energy actions rebalance or disintegrate weak boundaries perfections.

Milankovich cycles show Earth's energy cycles glaciation periods the Solar System, the potential energy one field, affects each and all of the cycling gravity field within boundaries perfections of the Solar System. Air Cells slow cycling energy reactions accrue insulation energy actions, force global air warming in the last 2.2 million years and in over fifty cycles outflow plasma fountains.

The prior sciences, technologies and art rely absolutely on precisely wrong energy devices and in each and all respects, especially by blaming global air warming on AGW, CO2 concentrations in air. The prior text details disclose science elite imposes, global elite institutions honors, the prior sciences, technologies and art continually compounded profound flows in the last three centuries.

This and prior applications explain global air warming phenomenon, which, to date, is lasting for more than 2.2 million years. Energy tracing root cause(s) of global air warming phenomenon the Second Law traces in and from the solar nebula into the Earth's gravity field. In turn, the Second Law reveals global elite perpetuated centuries of bungled sciences upon applied art technologies.

Solutions to global air warming these applications claim, specifically, exclusively. Technologies disclose precisely applied sciences and solutions global elite theories, laws or regulations bungle, ignore, relegate to trivial, especially those the Second Law imposes. Two gravities two solutions two technologies—the Earth and the Solar System gravity field respective solutions are disclosed.

The ultimate induction device the continuation in part and the prior applications detail and claim; the ultimate induction device important energy properties a gravity field, a planet genesis affects; and, the ultimately compact structure that distinguishes forms of cycling energy types effectuates each energy type respective directionality and respective energy type the maximum conductance, cycling ultimately short paths-of-passage lengths sum least sum, the PPLSLS, and cycled energy Heat Rate maximum efficiency. The ultimate energy device instills the forever technologies, the forever technologies, interacting eternalized energy mass structure and cycling energy dynamics.

A forever technologies ultimate energy device affecting energy dynamics planet genesis, gravity fields spawn, affects sui generis boundaries perfections an ultimately compact structure, discerns, field does: requires sui generis boundaries perfections in ultimately compact structures, discerns, and embodies energy cycling maximum conductance, or maximum ultimate Heat Rate efficiency or maximally, ultimately short paths-of-passage lengths' sums comprising a least sum (PPLSLS).

Said maximum conductance, or maximum ultimate Heat Rate efficiency or maximally ultimately short paths-of-passage lengths' sums comprising a least sum (PPLSLS), the forever technologies, wherein, only at least one of the three may affirm positively, absolutely the forever technologies. Said forever technologies with said energy dynamics gravity fields spawn, spawns energy modes cycling dynamics engendering those gravity fields do, yield energy structures and energy devices Heat Rate efficiencies maximum efficiencies, in turn, yielding maximum service life longevities.

In the Solar System gravity field, technologies solution utilizes the lapping gravity fields cycling energy structure a model of the Universe, the Universe energy structure, comprising the potential energy field, the potential energy one field that balances itself by balancing cycling energy inside the planets and the Solar System respective boundaries perfections; wherein, space rocket launch from the Earth disintegrates outermost Ring of Saturn Rings, directing most of disintegrated ring pieces towards the Earth, the Sun, which, of course, only possesses a marginal chance of success.

The forever technologies yield positive, absolute, ultimate technology solutions in general and to global air warming phenomenon presented in three copending application chains, which address: by said maximum conductance claims electromagnetic, thermal, radiation absolute technologies; fluids, liquids energy dynamics set forth the fundamental and Advanced Fluid Elements, disclose and claim the same, by technologies of PPLSLS, application Ser. No. 15/330,085, the latest in that chain; set forth and claim the nuclear super plant, by technologies Heat Rates efficiency that potentially exceeds 100%, application Ser. No. 15/731,310, latest in that chain; constituting three application chains.

The forever technologies continuation in part, herein, continue claims continuing said application chains and fluids/liquids ions, isotopes Fluid Elements (FEII) science, principles, methodologies, innovations and inventions (PMII) claiming cosmological (FEIIPMII), global PMII technologies; continuation in part continuity of the prior applications claiming sciences and technologies under the cosmological (FEIIPMII) global PMII technologies, herein, the forever technologies, affected sciences and technologies inventions and innovations, according to criteria of the ultimate energy device, claim 1 states, affect sole solutions to global air warming phenomenon; the prior science, technology art, especially wind turbine and solar panel technologies, enhance global air warming phenomenon climate change; thus, an energy device either meets or cannot meet claim 1 criteria.

The claim 1 criteria for ultimate energy device show structure genres of the forever technologies, wherein shown structure genres of cycling energy dynamics disclose the ultimate device and also the structure, eternalized energy mass structure, based on the merits, the claim 1 criteria, founded in technologies and sciences. Eternalized energy structure and mass designate one and the same.

Genesis of the forever technologies and gravity fields evolving Newton cannot perceive, Einstein totally bungles, scientific community at al. cannot see and the prior art and the USPTO Rules and Regulations dismiss. The forever technologies embody a very top of crucial absolute technology sciences founded on quantum energy cycling dynamics within successive boundaries perfections.

The motor, the induction device, the induction motor, the ultimate induction device identifies one and the same device that uniquely discloses cycling energy dynamics of the forever technologies, disclosing energies cycling directionalities successive boundaries perfections. An appearance, or a presentation should not receive a recognition unless a structure meets the criteria claim 1 states.

The claim 1 criteria required technologies founded in science shows the USPTO does not possess a valid criterial that evaluates eternalized energy structure, an energy device, a device may claim. The claim 1 is information proprietary knowledge that one must not disseminate, distribute, or otherwise utilize, except for granting this inventor filed and claimed patent allowance(s).

One cannot possibly evaluate a structure appearance and not do accurate energy genres tracing of cycling energy dynamics. Especially, an evaluating of an energy structure energy directionalities can mislead. Since the advent of science, a structure appearance misleads; it misleads Newton at al., Einstein at al., scientific community at al., all whom rely on apparent appearance of the Earth structure in the Universe structure; drawings illustrate, therein describe a device structure claims.

Newton, Einstein, scientific community at al. provide incontrovertible evidence that technologies and sciences in claim 1 criteria are incontrovertible, also. Supra explains. Short of constructing, implementing an energy device, no better valid criteria exists. The prior art is essentially useless, along with the prior science theories. Drawings illustrate also describe a device structure claims.

All continuing prior applications claim specifically devices based on compliance with claim 1 to specificity of one of the three options, in fact conform to all the criteria which claim 1 sets forth, of course. The drawings of the continuation in part applications the USPTO finds acceptable; the continuation in part applications deserve patent allowance—Claim 1 is incontrovertibly correct.

Permission to withdraw the letter to Mail Stop PG PUB dated Feb. 21, 2017 (stamped Ser. No. 15/530,056), respectfully requests, a based on the fact that on Feb. 21, 2017 the applicant did not have on file the substance of this application, which we now do; separate transmittal letter details explain further.

This application corrects the prior art flaws in the prior sciences permeating into the prior applied sciences applied technologies and art. These applications claim transition applications filed prior to the America Invents Act continuation in part applications, where at least Title of the Invention varies; issued Filing Receipts language of continuity claimed continues to introduce an additional to standard language that may later raise issues pertaining to transition applications. The USPTO causes errors; in most instances, the inventor is subsequently to correct these. The applicant files the PCT applications with the PCT USPTO Regional Office only, and not with a foreign country.

### SUMMARY OF THE INVENTION, CONTINUED

A three phase, four pole induction motor of ultimately compact device utilizes said stator, said yoke, a plurality of stator teeth, a plurality of stator slots, the maximum ultimate copper fill by a hexagonal barely rectangular cross-sectional area of wound coil rows, wound coil columns wound precisely concentric wire coils, the coils, comprising:

a maximum ultimate number of wound wire coils of a magnet wire, the magnet wire, in each of the slots;

a least length of the wire length in the maximum ultimate number of the wound wire coils in a magnetic pole, a magnetic pole pair and pairs of magnetic poles;

a column of pre-insulated coils, wherein the wound coil columns in position press and wedge in grooves and ridges of concentric wire coils in place and/or into insulation in base of the slot;

a row of pre-insulated coils, wherein the wound coil columns of the wound coil rows wedge the row each outermost coil into grooves and ridges in insulation of respective walls of each slot;

a volume of an electrical insulation in the coils of stator slots, wherein the maximum ultimate copper fill compresses the volume of the electrical insulation in a plurality of the stator slots;

a layer bundle, wherein perimeter coils of the layer bundle are pressing on and wedging into groves and ridges in the electrical insulation of the slot;

a coil, a coil pair and coil pairs, wherein the maximum ultimate number of the wound precisely concentric wire coils maximize the maximal ultimate number of the wound wire coils and, also, maximize the maximum ultimate copper fill in the slot;

a winding coils group of the wound precisely concentric wire coils of a dual layer bundle and a perimeter two surfaces of compressed volume of an insulation lining the slot and surface perimeter of the slot affects an absolute maximum surface area of respective interacting perimeter surfaces;

a thermal energy most direct outflow path flows from maximum perimeter surfaces of each of the coils and from surfaces of a slot perimeters within a stator yoke;

a rectangular hexagon cross-sectional area of the coils and the slots absolutely maximized respective perimeters surface areas maximized heat energy outflow conductance;

a structure configuration of the slot maximized respective electrical, thermal, electromagnetic energy cycling comprising the slot sui generis surfaces boundaries of the structure configuration;

a compacted configuration slot compacting the slot cross-sectional area, in turn, the steel laminations required a stator diameter size and, in turn, diameter size of the yoke, the motor;

a compacted slot cross-sectional area, in turn, minimized weight of the induction device;

wherein, the motor, the induction device, the induction motor is one and the same device;

wherein, the layer bundle of the wound precisely concentric wire coils, the compacted columns of the wound wire coils of the layer bundle compacts the wound coil rows of the layer bundle;

wherein, the wound precisely concentric wire coils compress a thickness of an electrical insulation of the slot, compress a flexible coat portion of a pre-insulation insulation of the wound coil rows to a least needed insulation thickness in the layer bundle and an insulation lining the slot to maximize outflowing heat energy conductance of the coils and of the stator slots;

wherein, the hexagonal barely rectangular cross-sectional area of the wound coil rows, wound coil columns wound precisely concentric wire coils comprising said wires coils, a wire coil an absolute maximum surface area that conducts/transfers heat energy in a radial direction;

wherein, a biaxial compression of the compressed volume of an electrical insulation in the slot affects an ultimately compact volume, the ultimately compact structure of the slot;

wherein, a cross-sectional area of a hexagonal barely rectangular cross-sectional area a conforming to an equal entirely round cross-sectional area affecting a significant increase in the conductance of a heat energy dissipation increased conductance of cycling electrical energy and decreased a rising temperature increase by the heat energy dissipation of cycling heat energy;

wherein, the cross-sectional area of the hexagonal barely rectangular cross-section conforming to the equal entirely round cross-sectional area affecting the significant increase in the conductance of the heat energy dissipation, the increased conductance of the cycling electrical energy, a decreased rising temperature increases increase cycling electromagnetic flux density;

wherein, the cross-sectional area of the hexagonal barely rectangular cross-section conforming to the equal entirely round cross-sectional area an increase in electrical energy cycling transfer to electromagnetic flux density cycling increases Heat Rate efficiency of cycling energies transfer;

wherein, the cross-sectional area of the hexagonal barely rectangular cross-sectional area of the wound coil rows in each of the stator slots winds concentric without a torsional twisting;

wherein, the cross-sectional area of the hexagonal barely rectangular cross-sectional area of the wound coil rows in each of the stator slots winding concentric without the torsional twisting in the stator slots minimizes the torsional twisting on outside of the stator slots and minimizes the torsional twisting of the wire coil and the winding layer;

wherein, the cross-sectional area of the hexagonal barely rectangular cross-section torsional no twisting in the slots and torsional minimized twisting outside of the slots engenders compressed insulation volume maximized thermal energy conductance maximized electrical energy conductance;

wherein, the maximum ultimate copper fill, the maximum coil number, the compressed volume of insulation, the maximum conductance of electrical energy, the maximum conductance of thermal energy respective cycling yield the electromagnetic maximum torque and a mechanical maximum torque at relatively low temperature of the slot temperature;

wherein, the structure configuration of the slot maximized respective electrical, thermal, electromagnetic energy cycling comprising the slot sui generis surfaces boundaries of the structure configuration comprising energy specific directionalities preferred directions;

wherein, electrical insolation in the slot, in the coil, in the coil pair, in the coil pairs comprises the compressed insulation needed volume least thicknesses of electrical insulation least volume needed in insulation coat of the wire windings of the coils and the insulation lining of the stator teeth; and,

wherein, 60 slot arrangement associated with the yoke illustrates the stator of the present invention;

and, the three phase, four pole induction motor of ultimately compact device comprises a rotor yoke thickness of a rotor yoke comprising:

a plurality of rotor teeth which extend radially and outwardly away from a rotor center axis;

a common tooth length of the plurality of the rotor teeth:

wherein, each tooth of the plurality of the rotor teeth has two sides;

wherein each pair of the rotor teeth has the side surfaces parallel;

wherein the plurality of the rotor teeth comprises the side surfaces in parallel;

wherein, each pair of the rotor teeth embodies a rotor tooth slot;

wherein, a rotor bridge seals the rotor tooth slot, therein, affecting a surface of the air gap; and,

wherein, the illustrated example shows 72 rotor teeth.

The forever technologies in the claimed invention, an ultimately compact energy device, a motor, an induction device, an induction motor, an ultimate induction device and such refers to the same device. The stator and a rotor engenders the induction device. The plurality of stator teeth affect unique stator slots which extend radially inward toward the stator center axis, wherein said stator teeth with the stator teeth respective centerlines, in this invention illustrated arrangement radially separated, radially spaced by six degrees, affecting sixty of the stator teeth with sixty of the stator slots. Each stator tooth extends for an entire length of the stator forming side walls of each tooth, each wall a polyline in profile. Each wall of each stator tooth a polyline cross-section effectuates a poly-surface of surfaces, which extend and merge into forming a slot base of a slot perimeter to match precisely a surface perimeter of winding coils. Each coil of said winding coils is precisely fabricated the hexagonal barely rectangular cross-sectional area which stacks into said maximum ultimate number of wound wire coils in each of the slots and yield the maximum ultimate copper fill in each of the stator slots. Said hexagonal barely rectangular cross-sectional area of a number of the winding coils wind concentrically into a number coil rows in each of the stator slots. Each of the coil rows, wedging into predesignated place, positively compresses a flexible portion of insulation that coats each of the winding coils, and positively compresses a flexible insulation portion that lines each of side wall of each tooth of the stator teeth. The coil rows compaction of the maximum ultimate number of wound wire coils concomitantly affects the maximum ultimate copper fill and a maximal ultimate cross-sectional area of copper in each of: the slot, the coil, the coil pair, and the coil pairs of and in the stator slots. In turn, a total insulation volume in each of: the coil, the coil pair, and the coil pairs is compacted by compacting the coil rows, where the coil rows compacts each coil column of the winding coils, which also compresses an entire insulation volume in each of: the coil, the coil pair and the coil pairs. In turn, the wire length a least length is used in making of the maximum ultimate number of the wound wire coils in a magnetic pole, a magnetic pole pair and pairs of magnetic poles, affecting the maximum conductance of electrical current cycling in said magnetic pole said magnetic pole pair and the pairs of the magnetic poles. Said maximum ultimate copper fill and a maximal ultimate cross-sectional area of copper in each of: the slot, the coil, the coil pair, and the coil pairs of and in the stator slots embodies surfaces of the maximum ultimate number of the wound wire coils compressing the flexible coat portion of a pre-insulation insulation of the wound coil rows wound coil columns wound precisely concentric wire coils. Said maximum ultimate number of the wound wire coils compresses the flexible coat portion of the pre-insulation to a needed minimal an insulation thickness, forcing conductance by the maximum conductance of thermal energy for the maximum conductance of electrical current.

In presented analogy, the maximum ultimate number of wound wire coils, the maximum ultimate copper fill is analogous to said—cycling forms of energies cycles all energies present, from inside out, from a nuclear reaction in the eye toward perimeter and inwardly from said perimeter, where in the stator cycling energies cycle energies in the rotor, which, by transferring forms of energies yields useful mechanical energy and a byproduct heat energy. Where, the byproduct heat energy is the evolution energy that eventually restricts longevity of the motor. The magnet wire in the precisely concentric wire coils concomitantly affect the maximum conductance cycling electrical energy and the maximum conductance cycling thermal energy two priorities in the stator slot and the stator tooth construction, to unavoidably engender ultimate priority—an electromagnetic field cycling flux maximum densities which are the ultimate priority of the induction device—which is what winding the precisely concentric wire coils does. A compacting of each coil row of the coil rows compacts each coil of the winding coils each column. The insulation volume thicknesses of electrical insulation in the stator slots biaxial compression, or thermal expansion triaxial stresses, compress electrical insolation to the needed minimal insulation thicknesses in the slot, in the coil, in the coil pair, in the coil pairs, affecting least thicknesses insulation volume. All spawning two dimensional compression, in thermal expansion three dimensional compression, in the stator slot of forever technologies ultimate energy device, affecting energy dynamics planet genesis, gravity fields do: embodies sui generis boundaries perfections in ultimately compact structures, discerns, distinguishes forms of cycling energy genres, engenders an energy form respective directionality, and embodies energy cycling maximum conductance, or maximum ultimate Heat Rate efficiency or maximally, ultimately short paths-of-passage lengths' sums comprising a least sum (PPLSLS).

The poly-surface surfaces of the stator slot and the least needed insulation thickness least volume of insulation in the layer bundle and in the insulation lining the slot yields the absolute maximum interacting perimeter surfaces of the stator teeth, extending the maximum conductance of thermal energy conductance to include the yoke of the stator. The winding coils, the dual layer, the slots, and the yoke in the stator embody the maximum conductance of thermal energy in the sui generis boundaries perfections of ultimately compact structures inside successive boundaries perfections.

Rolling mills mill the hexagonal barely rectangular cross-sectional area a preferred cross-section, the preferred cross-section of the winding coils; in the art, a metal forming machine known under the name of Turks Head rolls the preferred cross-section from equal cross-section area of entirely round wire gage cross-section. Turks Head machines cold roll precisely cross-sections of special forms. Turks Head machine repeated pass of entry stock cold rolls the preferred cross-section, to closest tolerances, from high quality entry stock of freshly fabricated wire electrolytically refined fully annealed copper having said equal cross-section area. A slot length minimally adjusts, well in a range of a granted to the slot length, in order to reduce number of passes required to produce the required close tolerances of the preferred cross-section. The entry stock is fed to the machine without twisting. The preferred cross-section naturally, flexibly bends to a small radius about the minor axis and possesses flat surfaces suitable for bundling. Pairs of two rollers do cold forming of the preferred cross-section of the entry stock. The first pair of rollers flattens the round cross-section and precludes a twisting of the entry stock; the second pair of rollers cold roll dimensions of the other four faces. Polymer film insulation two layers preferably of amide-amide, a flexible-coat over a hard-coat coats the magnet wire; an equal insulation known in the art is not excluded. Of course, the magnet wire overall dimensions account for two layers-thickness of the polymer film insulation, where the flexible coat of the two coat layers lightly compresses in the stator slot.

Three phase, four pole, induction motor of the present invention comprises coils in the dual layer and a method to fabricate the same. Said coils in the dual layer of the slot cross-section embody, effectuate the present invention. The barely rectangular hexagonal cross-section of 31 wire coils, a wire honeycomb bundle of the wire coils makes up a layer winding. Five, six rows of said wire coils wind precisely concentric a lower, an upper layer winding, respectively. Three phases, four poles per phase, twelve coils of six coil groups of two pole pairs per phase the dual layer winding embraces. Each of the three phases embodies a first, a second, a third and a fourth coil group. In each of the phases, the first and the second coil pair, the third and the fourth coil pair comprises a first, a second, a third and a fourth respective coil pair, which, in turn, effectuate a first, a second, a third and a forth pole pair, respectively; it is preferred that each inter-pole connection is formed by using a continuous wire/wire bundle to form the first, the second coil group of each phase and the third, the fourth coil group of each phase, making for six of the inter-pole connections formed automatically using continuous wire/wire bundles. The inter-pole connections, which are formed automatically, use continuous wire/wire bundles for the wire/wire bundles continuous connecting of the winding coils of the preferred cross-section. The stator, the armature, refers to one and the same part comprising 60 slot arrangement associated with the yoke. The armature, the stator in various arrangements of the slots, especially 36 or 48 slot arrangements is a part of the invention. The stator and a rotor comprises the induction device. Said yoke comprises a yoke thickness and a plurality of the stator teeth. The stator teeth extend radially inwardly toward an axial centerline of a stator bore, the axial centerline of the stator bore. The poly-surface surfaces of the stator slot and the interacting perimeter surfaces of the stator teeth are the same surfaces. Radial centerlines of the stator teeth are disposed on equal angular increments, subdividing equally angular rotation of 360 degrees. For the illustrated invention, the three phase, four pole induction motor and sixty slots the stator teeth radial centerlines are angular rotation disposed every six degrees. Likewise, the stator slots are disposed every six degrees. Angular rotational displacement of the centerlines of the stator teeth in respect to the radial centerlines of the stator slots is three degrees. In respect to the centerlines of the stator slots angular rotational displacement of the centerlines of the stator teeth is three degrees, also. The prior art extensive empirical data show that ratio of stator length to stator diameter is preferably 1.0:1.5. The stator tooth a lip portion proximate to the stator bore extends partially over the stator slot, where a lip portion extends over the stator slot and permits a four coil row to readily pass through a slot opening, in the illustrated example. A common stator yoke thickness be from 25% to 75% larger than the stator tooth length. Said rotor is positioned on a rotor shaft. An air gap separates the stator bore, the rotor; the air gap may be between 0.5 millimeters and 0.8 millimeters. The rotor yoke thickness may be from 30% to 70% larger than the common rotor tooth length. The illustrated example shows 72 rotor teeth, where empirical data disclose a number of the rotor teeth may be 10% to 15% greater than a number of the stator teeth. The plurality of the rotor teeth extends radially and outwardly from a rotor center axis; the plurality of the rotor teeth have a common tooth length. Each rotor tooth has two side surfaces. Each pair of the rotor teeth has the side surfaces parallel. The plurality of the rotor teeth comprises the side surfaces of each pair of the rotor teeth parallel; each pair of the rotor teeth embodies the rotor tooth slot that a rotor tooth bridge seals, therein, making the surface of the rotor slot affecting the air gap.

Configurations of the stator slots may contain any number of precisely concentric layer windings may comprise a hexagonal wire windings any number of coil groups, pole pairs and coil rows, in a plurality of precisely concentric layer windings, may comprise various alternate configurations; therein, the stator, the slots, the yoke alternative configurations may embody various size shapes.

Configurations of the stator slots any practical number in the present invention may be of the coil pairs any practical number. The winding coils affect the preferred cross-section of the maximum ultimate number of the wound wire coils of the magnet wire having concomitantly the maximum ultimate copper fill in each of the stator slots. Said absolute maximum surface area of respective interacting perimeter surfaces of the winding coils, the dual layer, with the compressed insulation volume needed least thicknesses of electrical insulation least volume, the stator teeth, the stator yoke and the magnetic wire each and all of wire coils of the wound wire coils embody a plurality of the sui generis boundaries perfections by the ultimately compact structures inside successive boundaries perfections of the sui generis boundaries. The stator slots, the stator yoke affect unique structure.

The stator slots and the stator yoke effectuate unique individual and in common structures, which spawn concomitantly the maximum conductance of electrical energy, the maximum conductance of thermal energy, and also Heat Rate maximum efficiency in transferring electrical currents flux density to electromagnetic flux density. The stator slots and the stator yoke are unique structures of unique structure, which by unique features appearance of respective structures disclose energy dynamics respective directionality of electrical, thermal, and electromagnetic energies utilization.

We know—for certain—the stator slots, the stator yoke respective structures experience a residual biaxial pre-stress and under thermal loads, from inside the stator slots, a triaxial stress expansion; and, we know—for certain that the two structures configuration and construction is about the best and perhaps the best we can do, comprising about the highest Heat Rate efficiency human device can achieve, based on the maximum conductance the prior paragraph explains. Then, we want to know, what happens to thermal energy byproduct. We exclude thermal radiation, since that form of thermal energy by superconductivity transmits its energy quanta to space or into epigene crust.

That leaves to account for conduction and convection energy emissions into the troposphere Heat Rate 100% efficiency. We can and do say—conduction and convection energy emissions—spawn the evolution energy global air warming of the troposphere. Not an Earth shaking revelation, but a valid conclusion, because such energy forms have no place to go unless the Air Cells air quanta energy cycling dynamics in environment by precipitations transfer such energy into epigene crust and by thermal radiations emit into space. All of that says global air warming issues, which—for certain—we know to exist based on Earth's energy budget, reside in the Air Cells energy cycling.

We can go further and utilize technologies founded in sciences, the claim 1 criteria, and evaluate the troposphere energy cycling boundaries perfections as an Air Cells structure an energy device, which is the case. Each of the three governing aspects in the claim 1 affirms that the troposphere is a potentially failing energy device. In fact, in this particular instance, the scientific community computes Earth's energy budget which actually is Earth's Heat Rate efficiency of the atmosphere confirms global air warming concerns. However, in cycling energy dynamics, in the Air Cells of the atmosphere, the maximum conductance, the first of three claim 1 criteria, shows that all CO₂ concentration only boosts cycled energy conductance in air and, thus, cannot be the root cause of global air warming; thus, we know—for certain—the troposphere is a potentially failing structure.

The maximum conductance energy genre insufficient energy conductance in the Air Cells cycles cycling energy dynamics, affected by pressure and temperature gradients, affect the root cause of global air warming, where air CO₂ has a small part. But, energy, power maximally and optimally associated with, and innately in, the ultimately compact structures must supply ample energy and power in all circumstances, which is precisely what the Air Cells cannot, do not affect. The prior application explains solar insulation magnification of energies cycling in environment. Any lack of energy or power boosts generation of thermal energy byproduct that remains with a succession of boundaries perfections, unless byproduct is thermal radiation emitted through air that becomes cycling energies which balance in the potential energy one field of the Universe energy structure.

The forever technologies make certain of maximum energy and power supply that minimizes any thermal energy emission to environment, which, spawns the maximum conductance, the PPLSLS or Heat Rate maximum efficiency of each and all three. Wherein, the maximum conductance the maximum ultimate copper fill, in turn, the maximum ultimate number of wound wire coils, either of each, especially in configuration of proper construction affect Heat Rate maximum efficiency.

There is no way that the troposphere naturally balances thermal energy byproducts. Milankovich cycles incontrovertible prove that point. The nuclear super plant that the prior applications claim can boost byproduct radiation from the Earth's gravity field into the potential energy one field of the Universe energy structure. Global energy policies, however, rely on appearance of structures rather than on substance of the Second Law and utilize environmental unfriendly technologies of solar panels and wind turbines, which syphon already inadequate cycling energy of the Air Cells.

It takes ten or more years to build said nuclear super plant. The global energy policies are at loss what 21^{st} century energy generation and utilizations should look like. The best is to start in small increments replace the stators the prior art by the stator of the present invention and/or replace all motors and generators of the prior art. Until then, replacing all motors and generators in the next ten years can significantly lower thermal load on the Air Cells cycled energy, while efficiency of the present invention makes possible wind turbines and solar panels removal from electrical grid.

Consequently, utilizing the magnetic wire of hexagonal cross-sections in the winding coils of the electrical motors and most of electrical generators can reap huge gains in preserving environment ubiquitously, while concomitantly engendering enormous global economic prosperity, in general.

Another aspect of the present invention illustrated by example provides a procedure for packing the wound coil rows, the wound coil columns wound precisely concentric wire coils of said coils preferred cross-section of the magnetic wire. Each layer of the dual layer selected for illustration has 31 of the winding coils. The base of the stator slot is at a stator slot bottom and is a region of the stator slot away from the stator bore. A region of a stator slot opening is proximate the stator bore and is top of the slot. The dual layer in the stator slot has 5 coil rows in the dual layer lower layer and 6 coil rows in the top layer for a total of 11 coil rows. Each of the coil rows 1, 7, 9 and 11 has the coil group of five coils. Each of the coil rows 2, 4, 6 and 8 makes the coil group of six coils. Each of the of the coil rows 3 and 5 has seven coils in the coil row. Coil row 10 four coils pass thru the slot opening as one row. The other coil rows pass thru the slot opening split in two, having four coils on bottom with the remaining coils of the coil row on top. The coil rows 1, 7, 9 and 11 have coil number 1, 2, 4 and 5 positioned under coil number 3 positioned to be lowered to designated center position. The coil rows 2, 4, 6 and 8 have coil number 1, 3, 4 and 6 under coils 2 and 5 positioned to be lowered to respective designated positions. In positioning coil rows 1-9, an anvil bobbin preferably guides the coils to respective predesignated positions, while a hammer bobbin lowers the coils into designated positions. Where, the dual layer or multiple layers or one layer of said coils, the coils, spawns the maximum ultimate copper fill of the stator slots, wherein any number of said coils may comprise the dual layer, the multiple layers and the one layer. Any number of three phases and of each phase lapping, the wound precisely concentric wire coils row may affect, and each phase change the coil rows a coils row may affect lapping in any stator slot. The procedure set forth for packing of the coils is suitable and conducive to machine automation.

Lengths of the anvil bobbin and the hammer bobbin allow each and both simultaneous operations from either end of the stator, wherein each of the two bobbins may embody one side extension or two side extensions, which extend to span a slot entire width at any location inside the stator slot.

The stator slot illustrated example engenders the forever technologies four energy characteristics, comprising sui generis successive boundaries perfections an ultimately compact energy structure, electromagnetic, thermal energy maximum conductance, and transferring into mechanical energy cycled maximum ultimate Heat Rate efficiency under confining pressure of Earth's gravity field; where, unbalanced one of the four energy characteristics evolves the other three, where, the prior sciences, technologies and art not one energy device has the ultimately compact energy structure.

And, that is precisely what tectonic and volcanic events do to spawn one and, thus, all of the four characteristic, wherein the Earth's eternalized mass turns over inside out, and where mass weight high density migrate to Earth's core high density mass boundaries perfections and the light fluids affect boundaries perfections of the energy relativity structures. All of said four comprise energy characteristics evolution in Earth's gravity field and is what the evolution energy does. Wherein, the forth listed, Heat Rate efficiency, must evolve the Universe energy structure 100% efficiency or global air warming phenomena occur. The four energy characteristics of energy structures are evolved concomitantly, where one forces evolving by each of the other three to energy structures of cycling energy devices in the Universe. The four energy characteristics come under one name—energy of the evolution energy in gravity field evolved before, during and after Big Bang event.

The Earth's energy budget clearly shows that Heat Rate deficiency characteristics is evolving the other three, wherein Milankovich cycles show the evolution energy cycling in the Earth's gravity field outflows plasma energy into the potential energy one field. Milankovich cycles also reveals energy of the evolution energy, the four energy characteristics cannot balance the Earth's gravity field—failed attempts over fifty times. The failed attempts explains Mars missing the light fluids.

The forever technologies continued the Fluid Elements ions, isotopes, principles, methodologies, inventions, and innovations continue the continuation-in-part continuity of the prior applications, which disclose, illustrate and claim said sui generis boundaries perfections in ultimately compact structures of energy devices and set forth either the PPLSLS or Heat Rate maximum efficiencies. Wherein, the forever technologies pack energy structures affected ultimately compacted, ultimate compact structures, the Universe energy structure packs energy into eternally compact structures.

Wherein, almost exclusively, the USPTO patent allowances grant unpacking of energy structures founded on structure appearance. All of such licensing, disregard for the Second Law in general, opposes Laws of Nature and eventually incontrovertibly are heading into spectacular catastrophe, affected by the Universe energy structure repacking energy structures in Earth's gravity field. In energy cycle study, Milankovich cycles show how it starts—by global air warming phenomenon.

In the lapping of gravity fields Laws of Nature, the Laws of Thermodynamics govern, regardless of what scientific pat theories past and present promotions promulgate. Within the same context, solar panels and wind turbans are unpacking already thin volume of tropospheric mass, where, in fact, flawed science theories understanding of energy structures is actually cause enormous harm.

Importance of disclosing the source of gravitational energy with the viable model of the Universe energy structure cannot be overemphasized. Unpacking energy structure terminology referred to energy structures can sound weird. However, that is exactly what happens when energy structure in environment loses boundaries perfections part by the evolution energy balanced imbalances in the potential energy one field—the Universe energy structure. Wherein, it turns out, the Universe compacting ultimately compacts energy structures by improved energy conductance. It does that by cosmological gravitational dynamics effectuating ubiquitously three dimensional compression depressions comprised gravitational fields of celestial bodies. Where, compact structures contain more energy high energy conductance within respective boundaries perfections high potential for cycling energy. That is precisely what the forever technologies do, these continuations in part of applications and inventions and innovations claims do. And, such is precisely what claim 1 says.

The potential energy one field energy is precisely that mechanism—that energy cycling energy of energy conductance that Heat Rate efficiency or the PPLSLS, by environment distances, mirrors. That energy mechanism balances the potential energy one field by energy conductance of energy actions verses energy conductance of energy reactions. Where, each energy form conductance is mirrored by energy of cycling energy directionalities and energy dynamics energy actions verses energy reactions. Global air warming solar insolation sustains steady energy action conductance.

Repetitious Milankovich cycles for certain proves that energy conductance of troposphere energy reactions conductance is predictable and repetitiously failing, over fifty times, and cannot oppose solar energy actions. Where, in glacial periods, the PPLSLS to heat sinks of ice masses are short and unbalance between energy actions and energy reactions becomes small. Interglacial period's distances to ice masses become long and said unbalance grows. All of it is mirrored by Air Cells and Jet Streams energy dynamics impact on global climate; all of it proves Air Cells, Jet Streams energy dynamics in the atmosphere, said energy relativity structures, are causing energy failures.

Syphoning cycling energy of Air Cells and Jet Streams by solar panels and wind turbine can only aggravate precariously inadequate energy conductance of the troposphere energy cycling; where, air energy conductance of Air Cells energy cycling incontrovertibly proves CO₂ concentration in air cannot be the root cause of global air warming—balancing of said potential energy one field is that root cause, mirrored by Air Cells energy cycles. Incontrovertibly solar panels, wind turbines are precisely the wrong energy devices to oppose global air warming. In laymen jargon one may say, the troposphere is being unpacked; in science jargon, one can say the evolution energy in the potential energy one field by energy conductance is balancing redistribution of the atmosphere in partial conversions of molecular air back into plasma inside a Solar System energy redistributing. Where, boundaries perfections of Mars, Venus, and Mercury experienced such energy balancing.

Causal relationships of a packed energy structure compactness and energy cycling that structure may do correlate; where, energy conductance, Heat Rate efficiency and PPLSLS may be utilized to evaluate energy structure crucial genres. Wherein, packing of energy structure is most crucial, and explains why Mars further away from the Sun loses and Earth still does have the light fluids.

A procedure for packing the wound coil rows, the wound coil columns, comprising a procedure, the procedure, for making of the coils sets forth the wound coil rows, the wound coil columns of each coil specific number, each coil row specific number and a number of coils in each coils row and a number of coil rows in each layer of a dual layer or in one layer are comprised to configure an ultimate maximum number of wound precisely concentric coils of magnet wire and which is a maximum ultimate copper fill in stator slots each slot of an ultimate induction device, or a motor.

The procedure winds precisely concentric the wound coil rows, the wound coil columns, by each coil specific number, each coil row specific number, a number of coils in each coils row having a number of coil rows in a layer or layers of the dual layer and is comprised to embody an ultimate maximum number of the coils of the magnet wire that yield the maximum ultimate copper fills in each of the stator slots of the ultimate induction device or an electrical motor; where, the wound coil rows wedge the coils row compressed in a winding pattern of each row of the wound coils of pre-insulated coils, where the wound coil columns push each of coil row each outermost coil into grooves and ridges in insulation of respective walls of each slot, which wedges in each coils row.

Lapping of the three phases of electrical current is well known in the art. Here, analogy is drawn to lapping of gravity fields the Universe, particular. Parallel lapping gravity fields are even more prevalent than lapping in series, supra describes. Exemplified by the planets of the Solar System, the galaxies and the Universe energy structure, said potential energy one field, incredibly smooth cycling energy evolves Heat Rate 100% efficiency primarily by parallel lapping of gravity fields.

The procedure for packing of the coils grants lapping each of electrical phases by a coil and coils and lapping any two phases by a coils pair, or pairs of coils, or the three phases by three coils and pairs of the three coils and one phase, two phases, and three phase combinations of coils in a dual layer, each layer of the dual layers, or a single layer, or in any number of precise specific lapping configurations affected lapping dispositions in stator slots of an energy device, or a motor device. Stator slot widths specific coil rows granted additional winding coils provides for that flexibility.

In another aspect of the illustrated example, the procedure requires each coil row of the coil rows installs in entirety at one time. Preferably rubber plug, one at each end of each of the stator slots, precludes a coil row in the coil rows in place and the coils in the stator slots from shifting. Each of the coil rows installs as one coil group. Preferably, a continuous wire/wire bundle automatic connections are used in a continuous wire/wire connecting of the coil rows the preferred cross-section, the hexagonal barely rectangular cross-sectional area. In a dual winding configuration of a three phase four pole illustrative example has four coils per phase, for three phases a total of twelve coils. For the stator yoke sixty stator slots, five stator slots go to each layer of the dual layer, comprising six coil groups of dual layers, twelve specific layers, where a first and a second coil group of the first phase connects to a third and a fourth coil group, where precise concentric counterclockwise coil rows 1-5 of the first pole wind in slots from, to slot: 1 & 15; 2 & 14; 3 & 13; 4 & 12; 5 & 11. From slot 11 coil rows 1-5 go to slot 30 of the second pole of the first phase to wind precise concentric counterclockwise in slots from, to slot: 30 & 16; 29 & 17; 28 & 18; 17; 27 & 19; 26 & 20; from slot 20, coil rows 1-5 connect to the first phase Y-1 lug connection. The other end of coil rows 1-5 of the first pole of the first phase from stator slot 1 connects to the first phase power source A-1 lug connection. Coil rows 6-11 of the first phase third pole go from power source A-1 connection go to slot 31 to wind precise concentric clockwise in slots from, to slot: 31& 45; 32 & 44; 33 & 43; 34 & 42; 35 & 41 go from slot 41 of the third pole to slot 60 of the fourth pole of the first phase to wind precise concentric counterclockwise in slots from, to slot: 60 & 46; 59 & 47; 58 & 48; 57 & 49; 56 & 50; from slot 50, coil rows 6-11 connect to the first phase Y-2 lug connection.

Coil rows 6-11 from power source B-1 lug connector of the first pole of the second phase to slot 11 and wind precise concentric clockwise from slot 11 in slots from, to slot: 11 & 25; 12 & 24; 13 & 23; 14 & 22; 15 & 21. From slot 21 coil rows 6-11 go to slot 40 of the second pole of the second phase to wind counterclockwise and precise concentric in slots from, to slot: 40 & 26; 39 & 27; 38 & 28; 37 & 29; 36 & 30; from slot 30, coil rows 6-11 connect to the second phase Y-1 lug connection. Coil rows 1-5 of the third pole of the second phase from the second phase power source B-1 lug connection go to slot 41. Coil rows 1-5 of the third pole from slot 41 go to slot 55 of the third pole of the second phase and wind precise concentric clockwise in slots from, to slot: 41 & 55; 42 & 54; 43 & 53; 44 & 52; 45 & 51, from slot 51 coil rows 1-5 go to slot 10 of the fourth coil of the second phase to wind counterclockwise precise concentric in slots from, to slot 10 & 56; 9 & 57; 8 & 58; 7 & 59; 6 & 60; from slot 60, coil rows 1-11 connect to the second phase Y-2 connection.

Coil rows 1-5 of the first pole of the third phase from power source C-1 lug connection of the first pole of the third phase go to slot 21 and wind precise concentric clockwise from slot 21 in slots from, to slot: 21 & 35; 22 & 34; 23 & 33; 24 & 32; 25 & 31. From slot 31 coil rows 1-5 go to slot 50 of the second pole of the third phase to wind counterclockwise precise concentric in slots from, to slot: 50 & 36; 49 & 37; 48 & 38; 47 & 39; 46 & 40; from slot 40, coil rows 1-11 connect to the third phase Y-1 lug connection. Coil rows 6-11 of the third pole of the third phase go to stator slot 51 from the third phase power source C-1 lug connection. Coil rows 6-11 of the third pole from slot 51 go to slot 5 of the third pole of the third phase to wind precise concentric clockwise in slots from, to slot: 51 & 5; 52 & 4; 53 & 3; 54 & 2; 55 & 1, from slot 1 coil rows 6-11 go to slot 20 of the fourth pole of the third phase to wind counterclockwise precise concentric in slots from, to slot 20 & 6; 19 & 7; 18 & 8; 17 & 9; 16 & 10; from slot 10, coil rows 6-11 connect to the third phase Y-2 connection.

One aspect of the present invention, the procedures, are illustrated explained by example, where: an electrical wiring procedure that wires wound coil rows, wound coil columns wound precisely concentric magnetic wire coils comprised of a preferred gage of a hexagonal wire cross-sectional area, by designated coils row number and wire coils each wire coil assigned number, in the stator slots of the stator yoke in an energy device comprises an electrical motor or an electrical generator.

### BRIEF DESCRIPTION OF THE DRAWINGS

FIG. 1 on Drawing page 1 of 7 shows a simplified top view of the ultimate induction device;

FIG. 2 on Drawing page 2 of 7 provides a simplified axial view of the ultimate induction device of the present invention;

FIG. 3, FIG. 4, FIG. 5 on Drawing page 3 of 7 provide a stator slot make up and a Procedure for packing winding coils;

FIG. 3 illustrates a cross-sectional view of a stator slot 19 having a plurality of 60 slots in stator 101;

FIG. 4 shows slot 19 in a single layer, no slot phase separator 41;

FIG. 5A of FIG. 5A, FIG. 5B, FIG. 5C illustrates packing procedure;

FIG. 5B of FIG. 5A, FIG. 5B, FIG. 5C illustrates packing procedure;

FIG. 5C of FIG. 5A, FIG. 5B, FIG. 5C illustrates packing procedure;

FIG. 6 on Drawing page 6 of 7 provides electrical wiring diagram for three phase, four pole electrical motor;

FIG. 7 on Drawing page 4 of 7 details three stator slots portion shown coil windings of Section 9-9 of the stator;

FIG. 8 on Drawing page 5 of 7 details Section 8-8 two rotor slots portion of the rotor; and,

Three figures Comparison FIG. 9A, FIG. 9B and FIG. 9C on Drawings page 7 of 7;

The first of the illustrated slots shows the Prior Art on page 7 of 7;

FIG. 9B figure of FIGS. 9A, 9B and 9C shows the same slot outline of the first figure and the present invention compacting procedure affected nigh 98% compaction copper fill by copper wire coils;

FIG. 9C figure more of coil windings replaces the Prior Art, Drawings page 7/7.

### DESCRIPTION OF THE SPECIFIC EMBODIMENTS

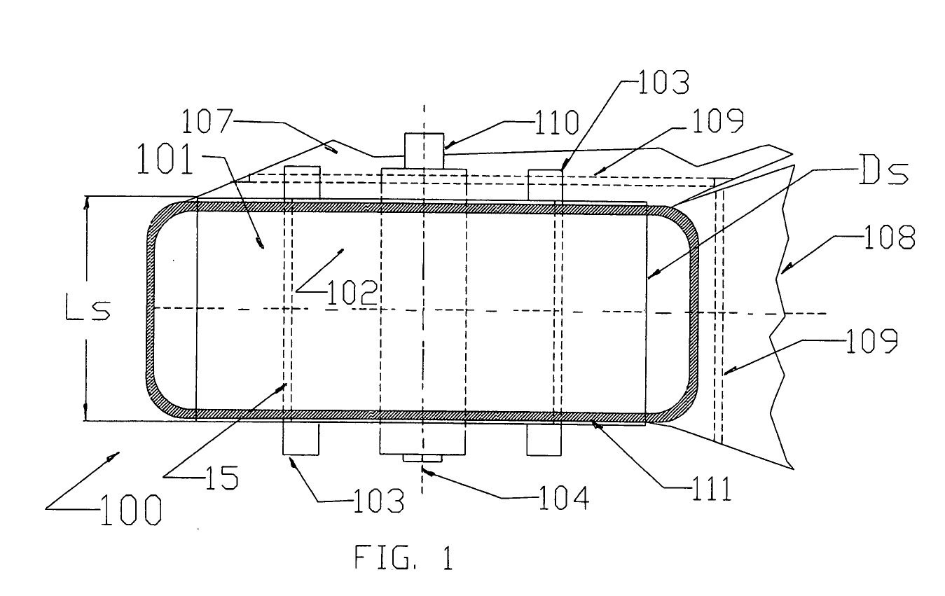

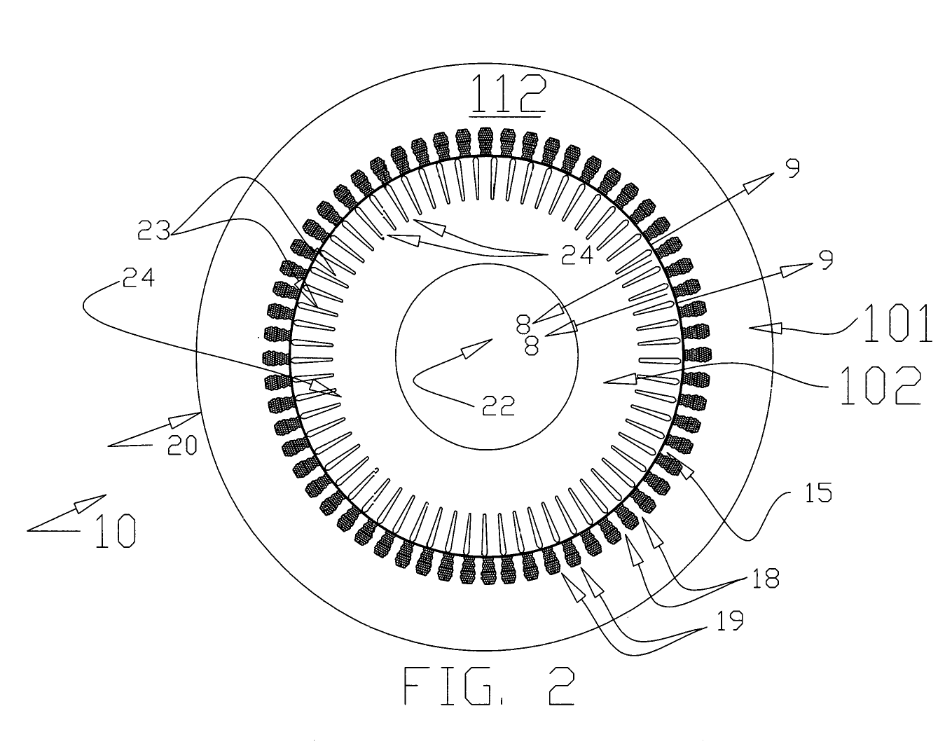

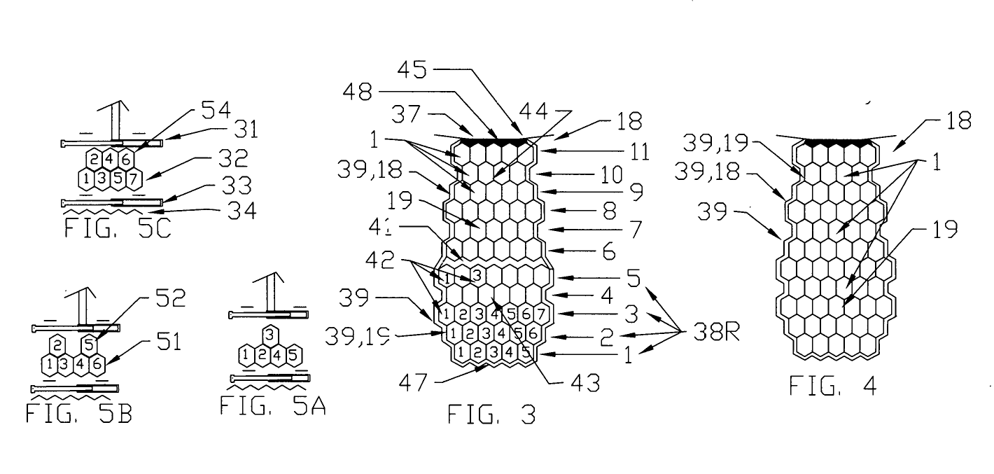

FIGS. 1 and 2 of the ultimate induction device 100 motor 10 and FIG. 3-5 stator slot show crucial energy device genres that in very significant aspects vary from the prior art, which the following explain; noteworthy among many is a moving vehicle about doubled range Heat Rate efficiency. Wherein, motor shaft 22 is coupled to rotor 102 supported on bearings of stator 101. Motor shaft 22 of motor 10, which comprises the ultimate energy device 100, comprises means for coupling various drive train devices and mechanisms. The motor 10 utilized in many varied mechanisms.

FIG. 1 shows a top view of an ultimate induction device 100 in an automobile setting, where a car's rear axle is also a shaft 22 of a rotor 102. The FIG. 1 illustrates fundamental outline of the device 100 detailed, herein. Aspects of the present invention are susceptible of embodiments in many different versions. There is shown in the present invention specific embodiments with the understanding that disclosures of the present invention are exemplifications in fundamentals of technologies advanced sciences, wherein energy devices, technologies and sciences advancement are one and the same. Wherein, the prior sciences, technologies and art stray into bizarre claims.

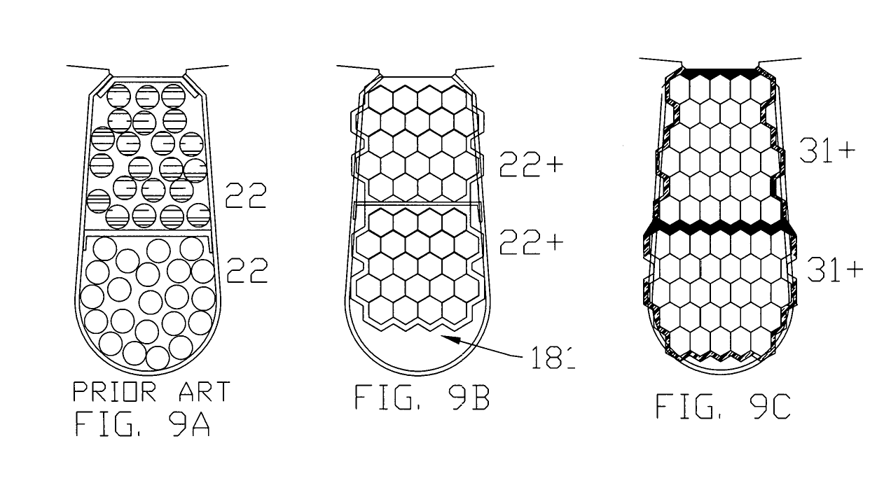

Said embodiments different versions also very numerous in the prior art herewith examples show are less than environmentally friendly, which should be amply corrected to conform, preferable sooner rather than later. The ultimate energy device, motor 100 a simplified schematic, shows Rotor 102 coupled to shaft 101. Rotor 102 is separated from stator 101 by air gap 15 between 0.5 millimeters and 0.8 millimeters, shown end rings 103 and is coupled to shaft 110 engenders axial centerline 104 and, also, axial centerline of the stator bore. Air duct 107 and air duct 108 direct air flow at the motor under a moving load due to a vehicle in motion. Air filter 109 in air duct 107 and air filter 109 in air duct 108 filter air directed at the motor. Air outflow duct, stack 111, extends from above stator 101 affecting a very small air separation from stator and extends upwardly through a body periphery of the vehicle, where stator 101 is exposed to radiate thermal energy into ground surface and through air outflow duct stack 111 and the atmosphere. Wherein, another aspect of the ultimate energy device outflows thermal radiation to space and into ground surface, whereby thermal load is reduced on cycling phases in Air Cells energy dynamics, while the motor runs cooler at higher Heat Rate efficiency. Concomitantly, air intake ports direct air circulation at the motor to run cooler at higher Heat Rate efficiency, which avoids a cooling fan and preferably further boost the motor Heat Rate efficiency. The vehicle may have one motor or up to two motors per axle. Preferably, stator 101 has black color two shellac protective coatings, protection against weather elements, wherein a blowing fan to cool the motor is avoided, which may further boosts Heat Rate efficiency of the motor. Proximate the stator, preferably stack 111, air duct 107 and air duct 108 are made of aluminum. Air intake portal locations for air duct 107 and air duct 108 proximate location of the motor may be situated under a chassis, in general, in front of wheel wells in the rear side panels and in a front grill and side panels of the vehicle. The ultimate induction device 100 motor may very well double the EPAct Energy-Efficient, NEMA Premium Motors Minimal Nominal Efficiency respective range of 87.5 to 96.2 at 100% load. FIG. 3 and the Prior Art FIG. 9B explained illustration further explain this aspect of the present invention.

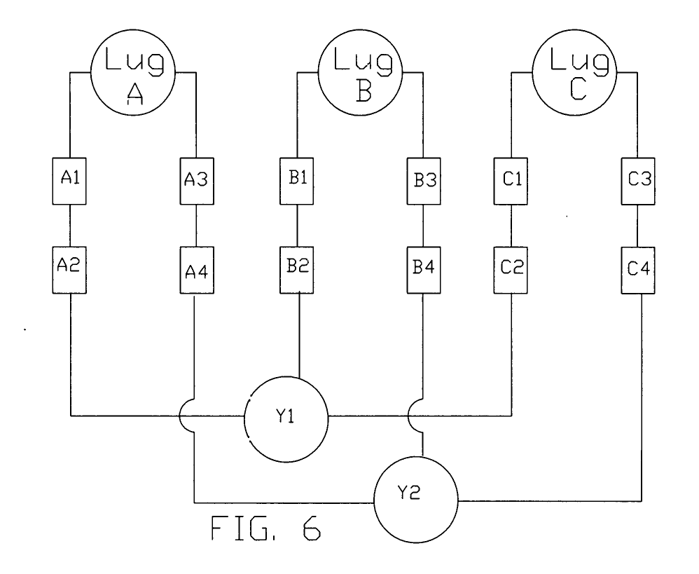

FIG. 2 shows a cross-sectional area axial view of the motor 10 of the ultimate induction device 100 simplified schematic, shows stator 101, stator yoke 102, rotor 102, rotor yoke 11, stator slots 19, stator teeth 18, rotor slots 23, rotor teeth 24, motor shaft 22 and stator diameter 20. Section 9-9 and Section 8-8 of motor 10 of ultimate induction device 100 respective portions respective sectional configurations of stator 101, rotor 102. For illustration purposes, a 60-slot stator 101 is selected, where for three phases at least two poles per phase, here, four poles per phase make 24, 36, 48, or 72 slot common arrangements. Electrical schematic diagram of three phase, four poles configuration known in the art FIG. 6 illustrates. For illustration purpose the present invention is taken to have eleven coil rows; where, a coil row is compacted in specific order from row one to eleven in precisely concentric wound coil rows, wound coil columns wound precisely concentric magnetic wire coils. That specific aspect of the present invention FIG. 3-5 illustrate and explain. Motor 10, affects physically compacted compact energy structure and the ultimate energy device, the ultimately compact structure 100 in a moving vehicles embodies stator 101 of laminated steel plates, consistent with best manufacturing practices for making such structures, including quality assurance paper work, for steel plate laminating, for copper entry stock, for insulating insulation, physically marked, where appropriate. Steel laminations of stator 101, yoke 112, slots 23, and teeth 24 are manufactured by computer-controlled laser cutting machines, preferably cut in one piece. Wherein, said stator, yoke, slots and teeth common length, according to empirical data the prior art derived, is preferably less than 1.50 of stator diameter 20. Stator slots 19 small compact slots and stator teeth 18 warrant a corresponding small stator yoke 112, stator 101 smaller lighter ultimately compact structure 100 of the ultimate energy device, motor 10, than the prior art. The present invention and the maximum ultimate copper fill by a hexagonal barely rectangular cross-sectional area of wound coil rows, wound coil columns wound precisely concentric wire coils in yoke, stator 101 lighter structure higher Heat Rate efficiency can double range of energy devices.

FIG. 3 illustrates a cross-sectional view of a stator slot 19 having a plurality of 60 slots in stator 101. Stator teeth 18, one on each of two sides embrace a slot 19. Preferably, cross-sectional area of hexagonal barely rectangular cross-sectional area of the magnetic wire coils fills each slot 19, in fact, yielding the maximum ultimate copper fill in each slot 19. From a structural aspect point of view, hexagonal wire cross-section packs well, yielding maximum surface areas suitable to fill a plurality of slots of slot 19. Preferably, a barely rectangular cross-section is utilized. Empirical data suggest that preference and arranged, which recognizes and preserves as such the sui generis boundaries of hexagonal geometrics, which, concomitantly engender, where properly packed and configured structure comprising a maximum cross-sectional area and maximum surface area, and extremely stable energy structure. Dual layer 43 44 is that structure; wedged into the groves and ridges in stator teeth 18 stator slot 19 perimeter, unpacking of dual layer 43 44 energy structure is an impossible possible task. Thermal energy could possibly do it. Wherein, rectangular hexagon cross-sectional area of the coils 1 and the slots 19 absolutely maximized respective perimeters 39 18 and 38 19 surface areas maximized heat energy outflow thru conductance of the compressed insulation needed volume least thicknesses 39 of electrical insulation least volume needed and in insulation coat of the wire windings of the coils 1 and the insulation lining of the stator teeth 39. Wherein, weak axis of coils 1 facilitates bending of the coils 1, while strong axis minimizes all twisting of the wire windings of the coils 1, which conserves current and magnetic flux densities.

For the above listed reasons, coils 1, coil numbers 42, dual layer lower layer 43, upper layer 44, stator slot perimeter 39 19, stator teeth perimeter 39 18 and insulation 39 needed least volume, all comprise individually and in common the sui generis boundaries of the stator slots 19. Slot wedge 37 hooks under teeth lip 45 assures coils 1 42 stay in place; stator slot bottom is marked 47 and the top is 48, where phase insulation is marked 41 and 11 coil rows is marked 38R. Most importantly these energy, structure boundaries engender concomitantly maximum electrical and electromagnetic densities highest conductance least thermal energy byproduct and, in turn, the thermal energy byproduct highest outflowing conductance. Wherein, stator yoke 112 completes that outflowing consistent with the prior art empirical data. Where, motion of a moving vehicle is performing useful work and thermal energy byproduct increases the ultimate induction device 100 outflowing that energy increases by faster moving of that moving vehicle; wherein yoke 112 radiates, at the speed of light, a thermal energy portion to Earth's surface for irradiation and into the Universe energy structure, the potential energy one field, which make the ultimate induction 100 device participate in the Wheel of Nature cycling energy thru the Universe energy structure. Summary of the Invention details numerous aspects of these issues in technologies and sciences. The ultimate induction device 100 in a moving vehicle affects Heat Rate efficiency high possible and way above EPAct Energy-Efficient, NEMA Premium Motors Minimal Nominal Efficiency respective range of 87.5 to 96.2 at 100% load and may very well double such efficiency ratings. Stator 101 affects large torque at 100% load and thus can run cooler than conventional motors; preferably yoke 112 thickness is less than 100% larger than stator teeth 18 length Lsl and each stator tooth 18 length Ls1 is in range of four to seven times larger than minimum width Wst, and, where, preferably ratio of stator diameter to stator length is less than 1.5.

FIG. 4 shows slot 19 in a single layer, no slot phase separator 41, which, likewise shows, where preferred, stator slots filled with coil wires having hexagonal cross wire can readily compact in more than two layers, which reduces number of coil wires concomitantly wound. Wherein, for practical purposes wire coils one coil row at a time is concomitantly wound and wedge in place.

FIG. 5A, FIG. 5B, FIG. 5C illustrates packing procedure, the procedure, for packing coils row 1 to 11 38R in stator slots 19, where anvil bobbin 72 is inserted into stator slot 19 on top of the slot bottom 47 on top of insulation 39, enumeration 34 or on top of previously packed coils which is enumerated 34. FIG. 5A show alignment prior to compacting coil rows 1, 7, 9 and 11, with five coils of coil rows 1-11 38R, by bobbin hammer 31. Bobbin anvil 33 and bobbin hammer 31 have side extensions, arrows shown, and are capable of breaching a stator slot 19 largest width Lsb2. The coils alignment and manipulating both bobbins occurs at either end or both ends of a stator slot 19. Coil numbers FIG. 3 shows, where FIG. 5A shows five coils placed in top row 57, bottom row 55 between hammer bobbin and anvil bobbin aligned for compaction. In position for compacting, coils 1, 2, 3, 4 and 5 are kept in that position by light tension. When hammer bobbin 58 comes down and pushes on coil 3 57, coils 1 and 5 of coils 1 2, 4 and 5 55 push against slot insulation 39; at that moment, anvil bobbin 72 is pulled out from under coils 1, 2, 4 and 5. Under pressure by hammer bobbin 58 outside coils 1 and 5 compress flexible portions of slot insulation 39 and wedge into grooves and ridges in predetermined positions and compresses insulation 39, compressing lightly flexible coating of coils 1, 2, 3, 4 and 5, which wedges in place these coil numbers of rows 1, 7, 9 and 11 in an ultimate compaction of rows 1-11 in stator slot 19, and wedge into grooves and ridges in predetermined positions now in compressed insulation 39. Wherein, FIG. 5B shows compacting of six coils of row 2, 4, 6 and 8 of coil rows 1-11 38R, where coil number 2 and 5 are positioned in a row 52 on top of coils 1, 3, 4 and 6, where coil 2 is centered on top between coils 1 and 3 and coil 5 is centered on tip of coils 4 and 6. Light tension in coils keeps coils in that position, when hammer bobbin 58 comes down and pushes on coils 2 and 5 52 to respectively separate coils 1 and 3, coils 4 and 6, where outside coil 1 and 6 push against slot insulation 39; at that moment, anvil bobbin 72 is pulled out from under coils 1, 3, 4 and 6. Under pressure by hammer bobbin 58, outside coils 1 and 6 compress flexible portions of slot insulation 39 and wedge into grooves and ridges in predetermined positions now compressed insulation 39. FIG. 5C shows compacting of seven coils of row 3 and 5 of coil rows 1-11 38R, where coils number 2, 4 and 6 are positioned in a row 54 on top of row of coils 1, 3, 5 and 6 and coil 2 is centered on top between coils 1 and 3, coil 4 is centered on top between coils 3 and 5 and coil 6 is centered on top and between coils 5 and 7. Light tension in coils keeps coils in that position. Hammer bobbin 58 comes down and pushes on coils 2, 4 and 6 54 to respectively separate coils 1 and 3, coils 3 and 5 and coils 5 and 7, where outside coil 1 and 6 push against slot insulation 39; at that moment, anvil bobbin 72 is pulled out from under coils 1, 3, 5 and 7. Under pressure by hammer bobbin, outside coils 1 and 7 compress slot insulation 39 flexible portions and wedge into grooves and ridges in predetermined positions in compressed insulation 39. Row 10 passes through slot opening; hammer bobbin 58 pushes row 10 in place as one unit.

Unavoidably, light pre-compressing of coil rows by hammer bobbin 58, lightly pre-compresses coil columns, which rows 1-11 comprise. Said pre-compressing put stator slots 19, stator teeth 18 in pre-compression hoop stresses by slots 19 packing. In turn, pre-compression of stator teeth 18 and fill of stator slot 19 affect tensile pre-stress in stator yoke 112, where pre-stressing energy in each stator teeth 18, in each stator slot 19 and yoke 112 by stresses energy action and energy reaction act as one structural unit and structural stresses uniformly distributed circumferentially and radially. In turn, thermal load stresses also distribute and outflow in same uniform manner comprising the maximum conductance of thermal byproduct outflowing. FIG. 6 shows electrical diagram of the winding coils for three phase, four poles per phase motor well known in the prior.

FIG. 6 electrical diagram shows the three phases of A1, A2, A3, A4 and B1, B2, B3, B4 and C14 C2, C3 and C4 poles arrangement. Summary of the Inventions details the Procedure for packing of these winding coils.

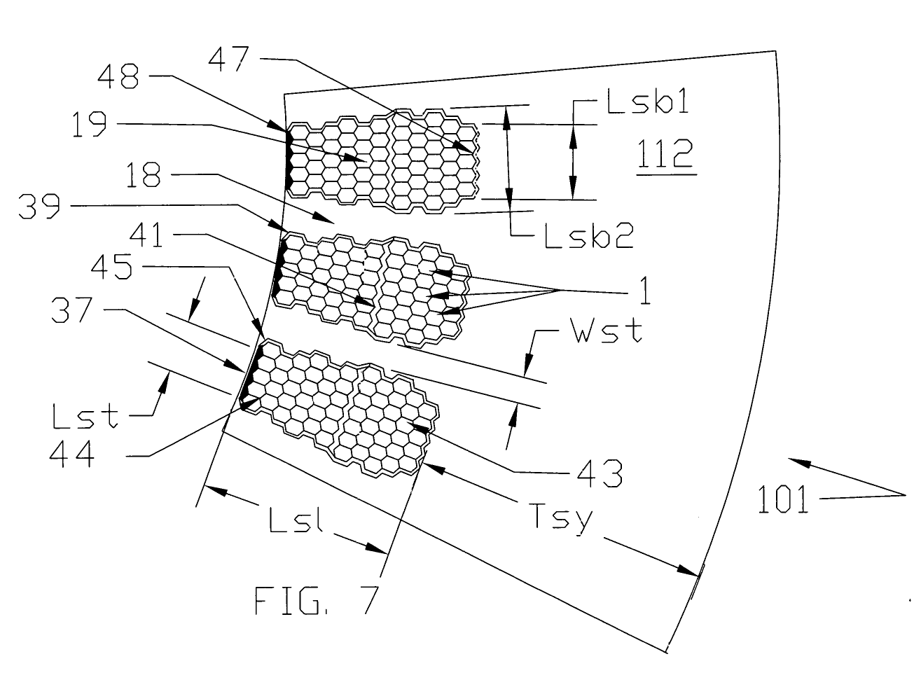

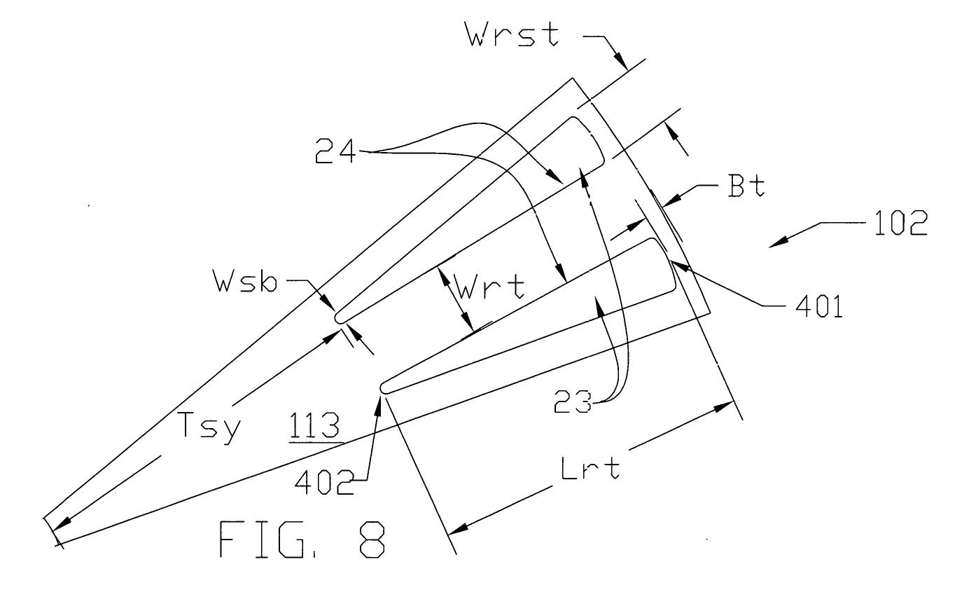

FIG. 7 details a stator plate Section 9-9 of stator 101 comprising stator yoke 112 thickness T_{sy}, slot opening width Lₛₜ, slot wedge 37, stator teeth 18 width Wₛₜ, phase separation insulation 41, stator slots 19, slots width Lsb1 and Lsb2, slots bottom or base 47 and slots top 48. Stator slots 19 are spaced equally six angular degrees apart and stator teeth 18 are space equally six angular degrees apart, comprising said slot widths and said slot teeth width through 360 angular degrees. Slots top 48 is proximate the stator bore, where slot bottom or base is away from the stator bore. Stator teeth lip 45 comprise portion of the sui generis boundaries of stator teeth, which interface with the sui generis boundaries of the winding coils in dual layer top layer 44 and bottom layer 45 in stator slots 19, where coil row 11 wedges into flexible portion of slot insulation 39, under the stator lip 45. FIG. 3 description details high structural integrity of stator slots 19 stator teeth 18 pre-compressed by packing of the coils, thus, comprising very stable structure configuration with stator yoke, where stator teeth width is primarily electromagnetic density consideration for which empirical data is not available. Wherein, pairs of winding coils, which keeps each stator slot respective symmetry and each stator teeth symmetric may be added to each layer of a dual layer or a single layer. In turn, the sui generis boundaries between stator slots 19 and stator teeth 18 is maintained, providing enormous versatility in affecting stator slots and teeth configurations. Computer-controlled laser cutting machines cut steel plates of stator 112 laminations, preferably in one piece blank forms precise laminations fabrication, which includes subsequent annealing to maximize electromagnetic properties. Preferably, the computer-controlled laser cutting machine is programed to cut no smaller fillet radius than one programmed into computer that does affect precisely same outside fillets of the preferred hexagonal barely rectangular cross-sectional area of the magnetic wire coils, which the Turks Head machine does manufacturing the magnet wire coils. Punch press stamping blank stator plate laminations is acceptable, provided smooth inside and outside said small radius radii can be fabricated by a stamping of blank stator plates.

FIG. 8 shows a Sectional 8-8 of rotor 113 detailed two rotor slots 24, where each rotor tooth 24 comprises uniform thickness two parallel surfaces of each rotor tooth 24, rotor 113 yoke having thickness T_{ry}, each rotor tooth 24 thickness Wᵣₜ, rotor tooth length Lrt and a rotor slot 23, having a slot bridge thickness Br. Rotor slot top is designated 401 and rotor bottom designated 402, number of rotor slots is 72, where, preferably ratio of rotor teeth width to stator teeth width is between 1:1 and 1:1.2 and a number and number of rotor teeth is about 15% greater than the number of the stator teeth, and rotor yoke thickness T_{ry} to rotor tooth length in range of about 25% to 70% larger.

Illustrating the present invention visual significant improvements of the Prior Art three figures of the Drawings page 7/7 visual appearance of three slots respective cross-sections show. All three figures show an outline of a slot the Prior Art slot has. The first of the illustrated slots shows the Prior Art slot cross-section, claiming concentric wound coils, which in a broad context they are. Such compacting at best achieves 75% copper fill in a slot. FIG. 9B figure shows the same slot outline of the first figure and the present invention compacting procedure affected nigh 98% compaction copper fill by copper wire coils. Each coil cross-sectional area is about 15% larger than the cross-sectional area of the wire coils FIG. 9B figure shows, comprising the present invention precisely concentric coil windings. About 15% of slot volume 181 comprising access insulation can be replaced either by more copper fill. FIG. 9C figure shows that 41% more of coil windings replaces said access insulation. All thee figure illustrate dual layer, where first and second figure show each layer having 22 coils, but coils in FIG. 9B have 15% larger cross-sectional area; the FIG. figure shows 31 coils in about the same slot perimeter and each coil 15% larger cross-sectional area, where 22+ and 31+ designates such larger areas cross-sections. Total magnetic flux density, B=μₒ Ni/l, where μₒ is magnetic constant, N the number of turns, i the current 1 and the length of coil. Ignoring end effects, the total magnetic through the coil, Φ=μₒ NiA/l, where A is cross-sectional area of the coil, and N and A affect the maximum ultimate copper fill and the length l, the least length of the coil for precisely concentric wound coils in the slot. And, we know—for certain—electrical current conductance, thermal energy conductance is nigh absolute maximum, since the compressed insulation needed volume least thicknesses of electrical insulation least volume needed is in each slot and in biaxial compression by packing Procedure and in the slot triaxial compression spawned by thermal expansion of copper fill. All of which aspects of the present invention address.

1. A forever technologies ultimate energy device affecting energy dynamics planet genesis, gravity fields do: embodies sui generis boundaries perfections in ultimately compact structures, discerns, distinguishes forms of cycling energy genres, effectuates an energy form respective directionality and embraces energy cycling maximum conductance, or maximum ultimate Heat Rate efficiency or maximally, ultimately short paths-of-passage lengths' sums comprising a least sum (PPLSLS).

2. An ultimate induction device affects a plurality of sui generis successive boundaries perfections an ultimately compact energy structure, thermal energy maximum conductance, electrical energy maximum conductance, where electrical energy cycling densities transfer to electromagnetic flux cycling densities greatly increase over the prior art by the ultimate energy device said plurality of sui generis successive boundaries perfections in the ultimately compact energy structure. Where, thermal energy maximum conductance, electrical energy maximum conductance in said plurality of said sui generis successive boundaries perfections embody absolute maximum surface areas of respective interacting perimeter surfaces of stator coils and stator coils dual layer, which imposes electrical insulation compressed insulation volume least needed thicknesses least needed volume.

3. The maximum conductance of claim 2, engendering
Said plurality of said sui generis successive boundaries perfections of the ultimate energy device, where said ultimate maximum conductance of electromagnetic thermal energies cycling energies boosts cycling energies cycled Heat Rate efficiency of Earth's gravity field, where “the Wheel of Nature” said maximum conductance positively, absolutely minimizes global air warming effects.

4. The ultimate energy device of claim 1, engendering
the maximum conductance or maximum ultimate Heat Rate efficiency, the maximally, ultimately short paths-of-passage lengths' sums affecting the least sum (PPLSLS), the forever technologies, wherein, only at least one of said three can affirm positively, absolutely the forever technologies.

5. The ultimate energy device of claim 1, wherein
the ultimate device, the Earth's gravity field induction device spawned an in common a plurality of the suit generis boundaries Universe energy structure effectuates the Universe energy structure an in common, a plurality of boundaries perfections energy reactions to insolation energy actions balancing the lapping of the Universe, Milky Way Galaxy, Sun and Earth evolving gravity fields.

6. The Earth's gravity field induction device of claim 5, wherein
in the Solar System gravity field, technologies solution utilizes the lapping gravity fields cycling energy structure a model of the Universe, the Universe energy structure, comprising the potential energy field, the potential energy one field that balances itself by balancing cycling energy inside the planets and the Solar System respective boundaries perfections; wherein, space rocket launch from the Earth disintegrates outermost Ring of Saturn Rings, directing most of disintegrated ring pieces towards the Earth, the Sun, which, of course, only possesses a marginal chance of success.

7. The energy dynamics forever technologies, planet genesis, gravity field spawns of claim 1, claim continuation in part continuity of the prior applications claiming sciences and technologies under the cosmological (FEIIPMII) global PMII technologies, herein, the forever technologies, affected sciences and technologies inventions and innovations, according to criteria of the ultimate energy device, claim 1 states, affect sole solutions to global air warming phenomenon.

8. A three phase, four pole induction motor of ultimately compact device utilizes a stator, a yoke, a plurality of stator teeth, a plurality of stator slots, a maximum ultimate copper fill by a hexagonal barely rectangular cross-sectional area of wound coil rows, wound coil columns wound precisely concentric wire coils, the coils, comprising:
a maximum ultimate number of wound wire coils of a magnet wire, the magnet wire, in each of the slots;
a least length of the wire length in the maximum ultimate number of the wound precisely concentric wire coils in a magnetic pole, a magnetic pole pair and pairs of magnetic poles;
a column of pre-insulated coils, wherein the wound coil columns in position press and wedge in grooves and ridges of concentric wire coils in place and/or into insulation in base of the slot;
a row of pre-insulated coils, wherein the wound coil columns of the wound coil rows wedge the row each outermost coil into grooves and ridges in insulation of respective walls of each slot;
a volume of an electrical insulation in the coils of stator slots, wherein the maximum ultimate copper fill compresses the volume of the electrical insulation in a plurality of the stator slots;
a layer bundle, wherein perimeter coils of the layer bundle are pressing on and wedging into groves and ridges in the electrical insulation of the slot;
a coil, a coil pair and coil pairs, wherein the maximum ultimate number of the wound precisely concentric wire coils maximize the maximal ultimate number of the wound wire coils and, also, maximize the maximum ultimate copper fill in the slot;
a winding coils group of the wound precisely concentric wire coils of a dual layer bundle and a perimeter two surfaces of compress volume of an insulation lining the slot and surface perimeter of the slot affects an absolute maximum surface area of respective interacting perimeter surfaces;
a thermal energy most direct outflow path flows from maximum perimeter surfaces of each of the coils and from surfaces of slot perimeters within a stator yoke;
a rectangular hexagon cross-sectional area of the coils and the slots absolutely maximized respective perimeters surface areas maximized heat energy outflow conductance;
a structure configuration of the slot maximized respective electrical, thermal, electromagnetic energy cycling comprising the slot sui generis surfaces boundaries of the structure configuration;
a compacted configuration slot compacting the slot cross-sectional area, in turn, the steel laminations required a stator diameter size and, in turn, diameter size of the yoke, the motor;
a compacted slot cross-sectional area, in turn, minimized weight of the induction device;
wherein, the motor, the induction device, the induction motor, the ultimate induction device is one and the same device;
wherein, the layer bundle of the wound precisely concentric wire coils, the compacted columns of the wound wire coils of the layer bundle compacts the wound coil rows of the layer bundle;
wherein, the wound precisely concentric wire coils compress a thickness of an electrical insulation of the slot, compress a flexible coat portion of a pre-insulation insulation of the wound coil rows to a least needed insulation thickness in the layer bundle and an insulation lining the slot to maximize outflowing heat energy conductance of the coils and of the stator slots;
wherein, the hexagonal barely rectangular cross-sectional area of the wound coil rows, wound coil columns wound precisely concentric wire coils comprising said wires coils, a wire coil an absolute maximum surface area that conducts/transfers heat energy in a radial direction;
wherein, a biaxial compression of a compressed volume of an electrical insulation in the slot affects an ultimately compact volume, the ultimately compact structure of the slot;
wherein, a cross-sectional area of a hexagonal barely rectangular cross-sectional area a conforming to the equal entirely round cross-sectional area affecting a significant increase in the conductance of a heat energy dissipation increased conductance of cycling electrical energy and decreased a rising temperature increase by the heat energy dissipation of cycling heat energy;
wherein, the cross-sectional area of the hexagonal barely rectangular cross-section conforming to the equal entirely round cross-sectional area affecting the significant increase in the conductance of the heat energy dissipation, the increased conductance of the cycling electrical energy, a decreased rising temperature increases increase cycling electromagnetic flux density;
wherein, the cross-sectional area of the hexagonal barely rectangular cross-section conforming to the equal entirely round cross-sectional area an increase in electrical energy cycling transfer to electromagnetic flux density cycling increases Heat Rate efficiency of cycling energies transfer;
wherein, the cross-sectional area of the hexagonal barely rectangular cross-sectional area of the wound coil rows in each of the stator slots winds concentric without a torsional twisting;
wherein, the cross-sectional area of the hexagonal barely rectangular cross-sectional area of the wound coil rows in each of the stator slots winding concentric without the torsional twisting in the stator slots minimizes the torsional twisting on outside of the stator slots and minimizes the torsional twisting of the wire coil and the winding layer;
wherein, the cross-sectional area of the hexagonal barely rectangular cross-section no torsional twisting in the slots and torsional minimized twisting outside of the slots engenders compressed insulation volume maximized thermal energy conductance maximized electrical energy conductance;
wherein, the maximum ultimate copper fill, a maximum coil number, a compressed volume of insulation thicknesses, a maximum conductance of electrical energy, a maximum conductance of thermal energy respective cycling yield an electromagnetic maximum torque and a mechanical maximum torque at relatively low a slot temperature;
wherein, the structure configuration of the slot maximized respective electrical, thermal, electromagnetic energy cycling comprising the slot sui generis surfaces boundaries of the structure configuration comprising energy specific directionalities preferred directions;
wherein, electrical insolation in the slot, in the coil, in the coil pair, in the coil pairs comprises the compressed insulation volume least needed thicknesses of electrical insulation least needed volume in insulation coat of the wire windings of the coils and the insulation lining of the stator teeth; and,
wherein, 60 slot arrangement associated with the yoke illustrates the stator of the present invention;
and, the three phase, four pole induction motor of ultimately compact device further comprises a rotor yoke thickness of a rotor yoke comprising:
a plurality of rotor teeth which extend radially and outwardly away from a rotor center axis;
a common tooth length of the plurality of the rotor teeth:
wherein each tooth of the plurality of the rotor teeth has two sides;
wherein each pair of the rotor teeth has the side surfaces parallel;
wherein the plurality of the rotor teeth comprises the side surfaces in parallel;
wherein each pair of the rotor teeth embodies a rotor tooth slot;
wherein a rotor bridge seals the rotor tooth slot, therein, affecting a surface of the air gap; and,
wherein, the illustrated example shows 72 rotor teeth.

9. The forever technologies ultimate energy device according to claim 1, wherein
one cannot possibly evaluate a structure appearance and not do accurate energy genres tracing of cycling energy dynamics. Especially, an evaluating of an energy structure energy directionalities can mislead. Since the advent of science, a structure appearance misleads; it misleads Newton at al., Einstein at al., scientific community at al., all whom rely on apparent appearance of the Earth structure in the Universe structure; drawings illustrate, therein describe a device structure claims.

10. The three phase, four pole induction motor of ultimately compact device of claim 8, wherein the precisely concentric wire coils concomitantly affect the maximum conductance cycling electrical energy and the maximum conductance cycling thermal energy two priorities in the stator slot and the stator tooth construction, to unavoidably engender ultimate priority—an electromagnetic field cycling flux maximum densities which are the ultimate priority of the induction device—which is what winding the precisely concentric wire coils does.

11. The three phase, four pole induction motor of ultimately compact device according to claim 8,
wherein a compacting of the coil rows, where the coil rows, compacts the winding coils each coil column and the insulation volume thicknesses of electrical insulation in the stator slots biaxial compression, in thermal expansion triaxial stresses, compresses electrical insolation to the needed minimal insulation thicknesses in the slot, the coil, the coil pair, the coil pairs, compress to insulation volume needed least thicknesses.

12. The three phase, four pole induction motor of ultimately compact device of claim 8, wherein
another aspect of the present invention illustrated by example provides a procedure for packing the wound coil rows, the wound coil columns wound precisely concentric wire coils of said coils preferred cross-section of the magnetic wire. Each layer of the dual layer selected for illustration has 31 of the winding coils. The base of the stator slot is at a stator slot bottom and is a region of the stator slot away from the stator bore. A region of a stator slot opening is proximate the stator bore and is top of the slot. The dual layer in the stator slot has 5 coil rows in the dual layer lower layer and 6 coil rows in the top layer for a total of 11 coil rows. Each of the coil rows 1, 7, 9 and 11 has the coil group of five coils. Each of the coil rows 2, 4, 6 and 8 makes the coil group of six coils. Each of the of the coil rows 3 and 5 has seven coils in the coil row. Coil row 10 four coils pass thru the slot opening as one row. The other coil rows pass thru the slot opening split in two, having four coils on bottom with the remaining coils of the coil row on top. The coil rows 1, 7, 9 and 11 have coil number 1, 2, 4 and 5 positioned under coil number 3 positioned to be lowered to designated center position. The coil rows 2, 4, 6 and 8 have coil number 1, 3, 4 and 6 under coils 2 and 5 positioned to be lowered to respective designated positions. In positioning coil rows 1-9, an anvil bobbin preferably guides the coils to respective predesignated positions, while a hammer bobbin lowers the coils into designated positions. Where, the dual layer or multiple layers or one layer of said coils, the coils, spawns the maximum ultimate copper fill of the stator slots, wherein any number of said coils may comprise the dual layer, the multiple layers and the one layer. Any number of three phases and of each phase lapping, the wound precisely concentric wire coils row may affect, and each phase change the coil rows a coils row may affect lapping in any stator slot.

13. The ultimate induction device in accordance with claim 2, wherein
the stator slot illustrated example engenders the forever technologies four energy characteristics, comprising sui generis successive boundaries perfections an ultimately compact energy structure, electromagnetic, thermal energy maximum conductance, and transferring into mechanical energy cycled maximum ultimate Heat Rate efficiency under confining pressure of Earth's gravity field; where, unbalanced one of the four energy characteristics evolves the other three, where, the prior sciences, technologies and art not one energy device has the ultimately compact energy structure.

14. said plurality of sui generis successive boundaries perfections according to claim 2, wherein
the application explains the energy source of gravitational energy. The thermodynamics Second Law origin tracing of the gravitational energy in the Universe claims energy technologies science and cosmological gravitational dynamics science technologies, respectively. Proven and verified fundamental science and technologies correct the prior science profound deep flaws promulgated by classic science theories. The prior sciences corrected flaws allows licensing key technologies.

15. A forever technologies in accordance with claim 1, where
The forever technologies continued the Fluid Elements ions, isotopes, principles, methodologies, inventions, and innovations continue the continuation-in-part continuity of the prior applications, which disclose, illustrate and claim said sui generis boundaries perfections in ultimately compact structures of energy devices and set forth either the PPLSLS or Heat Rate maximum efficiencies; wherein, the forever technologies pack energy structures affected ultimately compacted, ultimate compact structures, the Universe energy structure packs energy into eternally compact structures.

16. The induction energy device said energy dynamics gravity fields do of claim 1, wherein
Said forever technologies with said energy dynamics gravity fields spawn, spawns energy modes cycling dynamics engendering those gravity fields do, yield energy structures and energy devices Heat Rate efficiencies maximum efficiencies, in turn, yielding maximum service life longevities.

17. A procedure for packing the wound coil rows, the wound coil columns, comprising a procedure, the procedure, for making of the coils sets forth the wound coil rows, the wound coil columns of each coil specific number, each coil row specific number and a number of coils in each coils row and a number of coil rows in each layer of a dual layer or in one layer are comprised to configure an ultimate maximum number of wound precisely concentric coils of magnet wire and which is a maximum ultimate copper fill in stator slots each slot of an ultimate induction device, or a motor.

18. The procedure for packing the wound coil rows, the wound coil columns of claim 17, wherein
the procedure winds precisely concentric the wound coil rows, the wound coil columns, by each coil specific number, each coil row specific number, a number of coils in each coils row having a number of coil rows in a layer or layers of the dual layer and is comprised to embody an ultimate maximum number of the coils of the magnet wire that yield the maximum ultimate copper fills in each of the stator slots of the ultimate induction device or an electrical motor; where, the wound coil rows wedge the coils row compressed in a winding pattern of each row of the wound coils of pre-insulated coils, where the wound coil columns push each of coil row each outermost coil into grooves and ridges in insulation of respective walls of each slot, which wedges in each coils row.

19. The procedure for packing the wound coil rows, the wound coil columns of claim 17, wherein
the procedure for packing of the coils grants lapping each of electrical phases by a coil and coils and lapping any two phases by a coils pair, or pairs of coils, or the three phases by three coils and pairs of the three coils and one phase, two phases, and three phase combinations of coils in a dual layer, each layer of the dual layers, or a single layer, or in any number of precise specific lapping dispositions comprised lapping dispositions in stator slots of an energy device, or a motor device.

20. An electrical wiring procedure that wires wound coil rows, wound coil columns wound precisely concentric magnetic wire coils comprised of a preferred gage of a hexagonal wire cross-sectional area, by designating coils row number with designated wire coils each wire coil number, in stator slots of a stator yoke in an energy device comprised an electrical motor or an electrical generator.

21. The three phase, four pole induction motor of ultimately compact device of claim 8, wherein
the ultimate energy device outflows thermal radiation to space and into ground surface, whereby thermal load is reduced on cycling phases in Air Cells energy dynamics; concomitantly air intake ports direct air circulation at the motor to run cooler at higher Heat Rate efficiency, which avoids a cooling fan and preferably further boost the motor Heat Rate efficiency.
